(19) United States
(12) Patent Application Publication
(10) Pub. No.: US 2016/0041965 A1
(43) Pub. Date: Feb. 11, 2016

(54) IMPROVED DATA ENTRY SYSTEMS

(71) Applicant: KEYLESS SYSTEMS LTD., Jerusalem (IL)

(72) Inventor: Benjamin GHASSABIAN, Jerusalem (IL)

(21) Appl. No.: 14/378,977

(22) PCT Filed: Feb. 14, 2013
(86) PCT No.: PCT/US2013/026044

§ 371 Date: Aug. 15, 2014

Related U.S. Application Data
(60) Provisional application No. 61/599,000, filed on Feb. 15, 2012.
(60) Provisional application No. 61/601,143, filed on Feb. 21, 2012.
(60) Provisional application No. 61/603,390, filed on Feb. 27, 2012.
(60) Provisional application No. 61/608,181, filed on Mar. 8, 2012.
(60) Provisional application No. 61/612,509, filed on Mar. 19, 2012.
(60) Provisional application No. 61/613,580, filed on Mar. 21, 2012.
(60) Provisional application No. 61/617,224, filed on Mar. 29, 2012.
(60) Provisional application No. 61/620,525, filed on Apr. 5, 2012.
(60) Provisional application No. 61/637,384, filed on Apr. 24, 2012.
(60) Provisional application No. 61/641,378, filed on May 2, 2012.
(60) Provisional application No. 61/647,611, filed on May 16, 2012.
(60) Provisional application No. 61/649,322, filed on May 20, 2012.
(60) Provisional application No. 61/651,089, filed on May 24, 2012.
(60) Provisional application No. 61/652,950, filed on May 30, 2012.
(60) Provisional application No. 61/656,091, filed on Jun. 6, 2012.
(60) Provisional application No. 61/659,536, filed on Jun. 14, 2012.
(60) Provisional application No. 61/660,755, filed on Jun. 17, 2012.
(60) Provisional application No. 61/661,390, filed on Jun. 19, 2012.
(60) Provisional application No. 61/663,582, filed on Jun. 24, 2012.
(60) Provisional application No. 61/669,152, filed on Jul. 9, 2012.
(60) Provisional application No. 61/671,741, filed on Jul. 15, 2012.
(60) Provisional application No. 61/674,358, filed on Jul. 22, 2012.
(60) Provisional application No. 61/679,858, filed on Aug. 6, 2012.
(60) Provisional application No. 61/683,219, filed on Aug. 15, 2012.
(60) Provisional application No. 61/697,414, filed on Sep. 6, 2012.
(60) Provisional application No. 61/699,408, filed on Sep. 11, 2012.
(60) Provisional application No. 61/704,682, filed on Sep. 24, 2012.
(60) Provisional application No. 61/705,164, filed on Sep. 25, 2012.
(60) Provisional application No. 61/711,798, filed on Oct. 10, 2012.
(60) Provisional application No. 61/714,842, filed on Oct. 17, 2012.
(60) Provisional application No. 61/718,297, filed on Oct. 25, 2012.
(60) Provisional application No. 61/723,860, filed on Nov. 8, 2012.
(60) Provisional application No. 61/730,130, filed on Nov. 27, 2012.
(60) Provisional application No. 61/730,584, filed on Nov. 28, 2012.
(60) Provisional application No. 61/737,951, filed on Dec. 17, 2012.
(60) Provisional application No. 61/746,581, filed on Dec. 28, 2012.
(60) Provisional application No. 61/749,338, filed on Jan. 6, 2013.
(60) Provisional application No. 61/754,707, filed on Jan. 21, 2013.
(60) Provisional application No. 61/760,770, filed on Feb. 5, 2013.
(60) Provisional application No. 61/761,321, filed on Feb. 6, 2013.
(60) Provisional application No. 61/764,078, filed on Feb. 13, 2013.

(51) Int. Cl. G06F 17/27; G06F 3/0488

(52) U.S. Cl. CPC G06F 17/276; G06F 3/04886

(57) ABSTRACT

A word predictive data entry system includes a plurality of first input signals to which one to a few characters are assigned, and an input signal, separate from the plurality of first input signals, to which a significantly larger number of characters are ambiguously assigned. The system uses a database of words wherein upon receiving a sequence of the input signals the system predicts one or more words from the database of words.

### RELATED APPLICATIONS

The present application claims priority from U.S. patent applications:
application No. 61/599,000 filed on Feb. 15, 2012
application No. 61/601,143 filed on Feb. 21, 2012;
application No. 61/603,390 filed on Feb. 26, 2012;
application No. 61/608,181 filed on Mar. 8, 2012;
application No. 61/612,509 filed on Mar. 19, 2012;
application No. 61/613,580 filed on Mar. 21, 2012;
application No. 61/617,224 filed on Mar. 29, 2012;
application No. 61/620,525 filed on Apr. 5, 2012;
application No. 61/637,384 filed on Apr. 24, 2012;
application No. 61/641,378 filed on May 2, 2012;
application No. 61/647,611 filed on May 16, 2012;
application No. 61/649,322 filed on May 20, 2012;
application No. 61/651,089 filed on May 24, 2012;
application No. 61/652,950 filed on May 30, 2012;
application No. 61/656,091 filed on Jun. 6, 2012;
application No. 61/659,536 filed on Jun. 14, 2012;
application No. 61/660,755 filed on Jun. 17, 2012;
application No. 61/661,390 filed on Jun. 19, 2012;
application No. 61/663,582 filed on Jun. 24, 2012;
application No. 61/669,152 filed on Jul. 9, 2012;
application No. 61/671,741 filed on Jul. 15, 2012;
application No. 61/674,358 filed on Jul. 22, 2012;
application No. 61/679,858 filed on Aug. 6, 2012;
application No. 61/683,219 filed on Aug. 15, 2012;
application No. 61/697,414 filed on Sep. 6, 2012;
application No. 61/699,408 filed on Sep. 11, 2012;
application No. 61/704,682 filed on Sep. 24, 2012;
application No. 61/705,164 filed on Sep. 25, 2012;
application No. 61/711,798 filed on Oct. 10, 2012;
application No. 61/714,842 filed on Oct. 17, 2012;
application No. 61/718,297 filed on Oct. 25, 2012;
application No. 61/723,860 filed on Nov. 8, 2012;
application No. 61/730,130 filed on Nov. 27, 2012;
application No. 61/730,584 filed on Nov. 28, 2012;
application No. 61/737,951 filed on Dec. 17, 2012;
application No. 61/746,581 filed on Dec. 28, 2012;
application No. 61/749,338 filed on Jan. 6, 2013;
application No. 61/754,707 filed on Jan. 21, 2013;
application No. 61/760,770 filed on Feb. 5, 2013;
application No. 61/761,321 filed on Feb. 6, 2013; and
application No. 61/764,078 filed on Feb. 13, 2013.
   The titles used in this application and in the related applications may preferably not be considered as part of the descriptions.

### FIELD OF THE INVENTION

The present invention relates to data input systems and particularly systems and methods for entering letters, words, other symbols and/or other information.

### BACKGROUND OF THE INVENTION

Mobile devices including cellular phones, personal digital aids and miniature computers are widely used as they are easily carried around and can perform many tasks. One problem of the mobile devices is text entry, which is problematic due to their small size. One solution for text entry in mobile devices is using a limited key set in which at least some of the keys are ambiguously associated with a plurality of letters. Upon receiving a sequence of key strokes, a word predictive system proposes a word of a dictionary/database. If the system does not propose the desired word, the system proposes other words. The problem of such system is that when a word is not in the database the user must use another method of text entry.

Another problem of mobile devices is entering symbols other than letters.

With the emergence of devices having touch screens, on screen full (e.g. QWERTY) keyboard systems are used on most devices. Due to the size of mobile devices, and the number of keys of a full keyboard, such keys are reduced in size rendering the keyboard cumbersome and the data entry slow. The screen of a device is intended to display the output. Having a full keyboard with many keys on the screen covers a significant portion of the screen, hindering the use of many current applications and limiting creation of many other applications.

A real mobile data entry system must be mobile, enabling to enter data in any environment such as while standing, walking, in the dark, etc. In addition, such system must preferably free the screen from an interface that occupies a large portion of the screen.

### SUMMARY OF THE INVENTION

The data entry system, described in this application, provides a system that is adapted to mobile environments. It is also intuitive, accurate, fast, and easy to understand and use.

An aspect of some embodiments of the invention relates to an input interface adapted to identify user interactions and to associate at least some of the user interactions with different input signals. Optionally, some of said input signals are together associated with all the letters of a language such as the Latin alphabet or a phonetic alphabet. Optionally, at least one of the input signals is ambiguously assigned/related to more than one letter.

An aspect of some embodiments of the invention relates to an input interface (e.g. hereafter may be referred to as keypad/keyboard) wherein (e.g. at least) a few number (e.g. 4 to 6) of its input means (e.g. hereafter, may be referred to as keys or zones on a touch sensitive surface such as a touchscreen) ambiguously represent more than one characters/letter. According to first method said a few number of keys together represent all of the letters of an alphabet. According to a second method, said a few number of keys together represent some of the letters of an alphabet (e.g. hereafter may be referred to as Preferred characters). The rest of the letters (e.g. hereafter may be referred to as Non-preferred characters) of said alphabet are represented by a key/zone outside said a few number of keys. For ease of description, herein, such a key of the/a keypad and interaction with it may be referred to as “narrowly ambiguous key/interaction” providing “narrowly ambiguous input signal”, and said key/zone outside the keypad and interaction with it may be referred to as “broadly ambiguous key/interaction” providing “broadly ambiguous input signal”. In some paragraphs herein, said zone may also/is referred to as “navigation zone”.

An aspect of some embodiments of the invention relate to a procedure of assisting the user to correctly entering a word which may be missed typed by the user by assigning all of the characters (e.g. letters) of a language to the broadly ambiguous keys/interactions. This aspect may be referred to as Spelling Help feature.

Preferably, said a few number of keys are split to form two groups of keys. Preferably, said key/zone outside said a few number of keys is located between said split group of keys. Preferably, said keypad is a virtual keypad located on a touch sensitive surface. Optionally, said touch sensitive surface is a touch screen.

Preferably, said input interface is used with a word prediction system/software wherein upon/during providing a sequence of one or more interactions with the input interface, the system predicts one or more words from the corresponding entries of a database of words used by the system. A word predictive system/software predicting words as such is known by people skilled in the art and some of such software (e.g. T9, iTap, or auto correction software used with an on-screen QWERTY keyboard wherein an interaction with a key may ambiguously be related to said key and some of the surrounding keys because the keys are too small and the user may mispress a key) are implemented in a variety of mobile phones.

In one aspect, the letters are assigned to the user interactions/keys according to their shapes, in a manner which allows the user to quickly relate the shape of a letter to the interaction/key with which it is associated. In some embodiments, one of the user interactions/key is associated with all the letters meeting a specific shape feature.

Optionally, the letters are divided into several groups (e.g. four groups) based on a common characteristic in their shapes and wherein each group is assigned to a different user's interaction or to a different key of a keypad.

In some embodiments, the letters are assigned to the user interactions/keys according to whether they have a closed circle, standing on one point, standing on two points, or standing on a large base.

Optionally, a single letter may be assigned to two different groups.

Preferably, the input interface further includes additional input means relating to at least one symbol (e.g. letter, special character, function, etc.) such as the space character and the back space function. Optionally, each of, the space character and the backspace function, is assigned to a different input means.

Optionally, to at least one of the input means more than one letter of a language is assigned such that a predefined interaction with the input means ambiguously corresponds to any of said letters. In such case, herein, the system may be referred to as being in the Ambiguous Letter Mode.

Optionally, the system may be switched to a Precise Letter Mode, wherein a predefined interaction with a key may provide an individual precise/identified character. The interface of the system in such mode may preferably be different than the interface in the ambiguous letter mode. Optionally, the system may be switched to a Precise Symbol Mode, wherein a predefined interaction with a key may provide an individual precise/identified special character or function. The interface of the system in such mode may preferably be different than the interface in other modes. It may show the special characters. In such mode, preferably, to each of at least some of the input means a group of special characters and/or functions are assigned. Preferably, special characters are divided into a plurality of groups (e.g. four groups) based on a common characteristic. Optionally, each of the groups of special characters is assigned to one input means/key wherein each input means/key has several sub-input means/sub-keys. Optionally, said keys/zones on a touch sensitive surface, and said sub-keys are sub-zones on a zone. Preferably, each of said sub-keys represents a single symbol.

It must be noted that an ambiguous letter key of a keypad may be presented such as to relate to a key of the keypad in precise letter mode and/or to a key of the keypad in precise symbol mode. For example, the related keys may have the same color and/or be positioned in a same location on the touch sensitive surface in their respective modes. Such related keys herein may be referred to as different layers/levels of a same key of a keypad or as a same key in different modes. Although the presentation of a corresponding key of the keypad of the system in ambiguous mode, precise letter mode, and precise symbol mode may differ for each mode, according to a preferred aspect, they may be considered as a same key in different modes. Such related keys of a keypad, may also herein referred to as a first and second keys/keypad.

An aspect of some embodiments of the invention relates to an input system wherein a first predefined type of interaction with an input means ambiguously correspond to a first group of characters assigned to said input means, and wherein a second predefined type of interaction with the input means ambiguously correspond to a second group of characters assigned to said input means.

An aspect of some embodiments of the invention relates to an input system wherein a first predefined type of interaction with an input means ambiguously correspond to any character of a group of characters assigned to said input means, and wherein a second predefined type of interaction with an input means (precisely) correspond to an identified character assigned to said input means.

An aspect of some embodiments of the invention relate to an enhanced word predictive data entry system having a procedure to enter precisely one or more of the characters of a word precisely (e.g. assigned to an input means (hereafter, referred to as an “identified character/letter”)) and to combine it with received ambiguous input signals corresponding to the remaining characters of the word to predict a word.

An aspect of some embodiments of the invention relate to a procedure of accepting or rejecting a (e.g. one or more) word proposed/predicted by the system. Optionally, if the predicted word is rejected the system proposes at least another word. Optionally, the system enters into a Correction Mode, wherein a predefined interaction with an input means corresponds to correcting one or more of the letters of the predicted word, and based on that, the system may predict one or more other words.

An aspect of some embodiments of the invention relates to a data entry system using one or more N-gram database of words to predict a word.

An aspect of some embodiments of the invention relates to a first type of interactions (e.g. gliding actions) provided anywhere and/or on a virtual keypad on a touch sensitive surface to emulate a second type of interactions (e.g. tapping actions) with the keys of a virtual keypad (e.g. or keypad model).

An aspect of some embodiments of the invention relates to procedures of emulating mouse functions (e.g. moving a cursor/caret, copy, cut, paste, select, select-all) of a PC keyboard/PC mouse by providing interactions with a touch sensitive surface such as a touch screen.

An aspect of some embodiments of the invention relates to the editing directly on picture/video and method to share said edited picture/video with others.

An aspect of some embodiments of the invention relates to commenting (e.g. writing text) in text box relating to a picture/video (e.g. shared or to be shared). For an edited video such comments may be time-stamped at any particular point in the video.

An aspect of some embodiments of the invention relates to the selecting/grabbing a portion of text (e.g. a word) to modify the said portion.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIGS. 100-100B is a schematic illustration of arrangement of the characters of a language on the keys of a keypad respectively, in ambiguous letter mode, in precise letter mode, and in precise symbol/special character mode, in accordance with an exemplary embodiment of the invention;

FIG. 101 is a schematic illustration of a mobile device having a touch screen, and the keys of the data entry system in predictive mode, in accordance with an exemplary embodiment of the invention;

FIG. 101A is a schematic illustration of keys of the data entry system and a manner of entering precise/identified letters when the system is in Letter Mode, in accordance with an exemplary embodiment of the invention;

FIG. 101B is a schematic illustration of keys of the data entry system and a manner of entering precise/identified special characters when the system is in Special Character Mode, in accordance with an exemplary embodiment of the invention;

FIGS. 101C-D are schematic illustrations of keys of the data entry system and a manner of entering precise/identified character when the system is in Precise Letter/Special Character Modes, in accordance with an exemplary embodiment of the invention;

FIG. 102, is a schematic illustration of use of the keys of the data entry system to activate functions, in accordance with an exemplary embodiment of the invention;

FIGS. 376A, 376C, and 376D, are a schematic illustration of arrangement of the characters of a language on the keys of a keypad respectively, in ambiguous letter mode, in precise letter mode, and in precise symbol/special character mode, in accordance with an exemplary embodiment of the invention;

FIG. 376B is a schematic illustration of the keys of a keypad of the invention in symbol mode, when a key is pressed for a predefined laps of time, in accordance with an exemplary embodiment of the invention;

FIGS. 377, 377.1, and 377A to 377D, are schematic illustrations of emulation of mouse functions, in accordance with an exemplary embodiment of the invention;

FIGS. 378-380, are schematic illustrations of a Hindi keyboard, in accordance with an exemplary embodiment of the invention;

FIGS. 381A-381D, are schematic illustrations of manipulation of the characters of a word being entered, in accordance with an exemplary embodiment of the invention;

FIGS. 382A-382D, are schematic illustrations of manipulation of the characters of a word having accented characters being entered, in accordance with an exemplary embodiment of the invention;

FIGS. 383A-383B, are schematic illustrations of manipulation of the characters of a word having accented characters being entered, in accordance with an exemplary embodiment of the invention;

FIGS. 384, and 386-386A, are schematic illustrations of manipulation of the keys of a keypad for activating functions, in accordance with an exemplary embodiment of the invention;

FIGS. 387A-387B, and 388A-388B are schematic illustrations of word completion methods, in accordance with an exemplary embodiment of the invention;

FIGS. 389A-389B, are schematic illustrations of visualizing and hiding a keyboard, in accordance with an exemplary embodiment of the invention;

FIGS. 390A-390E, are schematic illustrations of arrangement of a letters on a keyboard in different modes and their manipulation, in accordance with an exemplary embodiment of the invention;

FIG. 391, is a schematic illustration of arrangement of a letters on a keyboard, in accordance with an exemplary embodiment of the invention;

FIGS. 392A-392C, 393A-393C, 394A-394C, 395A, 396, 397-397A, are schematic illustrations of arrangement of characters on keyboards in different modes, and their manipulation, in accordance with an exemplary embodiment of the invention;

FIGS. 398, 399, and 400, are schematic illustrations of arrangement of a letters on a keyboard and their manipulation, in accordance with an exemplary embodiment of the invention;

FIGS. 401A-401B, 402, 403-403B, 404A-404B, and 405A-405C, are schematic illustrations of arrangement of a characters on the keys of a keyboard and on zone outside said keys, and their manipulation, in accordance with exemplary embodiments of the invention;

FIGS. 406A-406L, are schematic illustrations of assignment of a characters to the keys of a keyboard in different languages, in accordance with an exemplary embodiment of the invention;

FIGS. 407A-407C, and 408, are schematic illustrations of methods of swapping words, in accordance with an exemplary embodiment of the invention;

FIGS. 409A-409B, are schematic illustrations of different keyboards, in accordance with an exemplary embodiment of the invention;

FIGS. 410A-410B, 411A-411B, and 411C, are schematic illustrations of an interface of a photo sharing application, in accordance with an exemplary embodiment of the invention;

FIGS. 412-412B, are schematic illustrations of presentation of predicted words, in accordance with an exemplary embodiment of the invention;

FIGS. 413A-413E, 414A-414B, 415A-415B, and 416A, are schematic illustrations of assignment of letters/characters to the different configurations of the keys of a keyboard and one or more predefined one or more zones outside said keys, in accordance with several exemplary embodiments of the invention;

FIGS. 417A-417C, and 418A-B, and 418D-418E, are schematic illustrations of assignment of letters/characters to the different configurations of the keys of a keyboard and one or more predefined one or more zones outside said keys, in accordance with several exemplary embodiments of the invention;

FIGS. 419A-419C, and 420A-420C, are schematic illustrations of presentation of predicted words in parallel modes, in accordance with an exemplary embodiment of the invention;

FIGS. 421A-421E, 422A-422D, 423A-423B, and 424-424D, are schematic illustrations of interactions with the keys of a keyboard by providing gliding actions, in accordance with an exemplary embodiment of the invention;

FIGS. 425A-425B, 426A-426D, and 427, are schematic illustrations of assignment of letters/characters to the different configurations of the keys of a keyboard and one or more predefined one or more zones outside said keys, in accordance with several exemplary embodiments of the invention;

FIG. 428 shows a slider relating to a spelling help mode, in accordance with several exemplary embodiments of the invention;

FIGS. 429A-429D, are schematic illustrations of assignment of letters/characters to the different configurations of the keys of a QWERTY keyboard and one or more predefined one or more zones outside said keys, in accordance with several exemplary embodiments of the invention;

FIGS. 430A-430B, and 431-431D, and 435A-C, are schematic illustrations of assignment of letters/characters to the different configurations of the keys of a keyboard in the visible and invisible mode and one or more predefined one or more zones outside said keys, and the methods of entering characters, in accordance with several exemplary embodiments of the invention;

FIGS. 432A-432D, 433A-F, 434A-B, 436A-B, and 438A-B, are schematic illustrations of an interface of a photo sharing application, in accordance with an exemplary embodiment of the invention;

FIGS. 437A-C, are schematic illustrations of an virtual key in transparent/invisible mode wherein the letters visible on the key are printed such that to be visible on any background.

### DETAILED DESCRIPTION OF EMBODIMENTS

The data entry system of the invention generally refers to using a predefined number of keys to enter text/data. The letters/characters of a language are distributed on at least some of said number of input means (e.g. hereafter may be referred to as “keys” and/or “zones”) such that to at least one of the keys (e.g. hereafter may be referred to as an “ambiguous letter key” or “ambiguous key”) more than one letter/character is assigned.

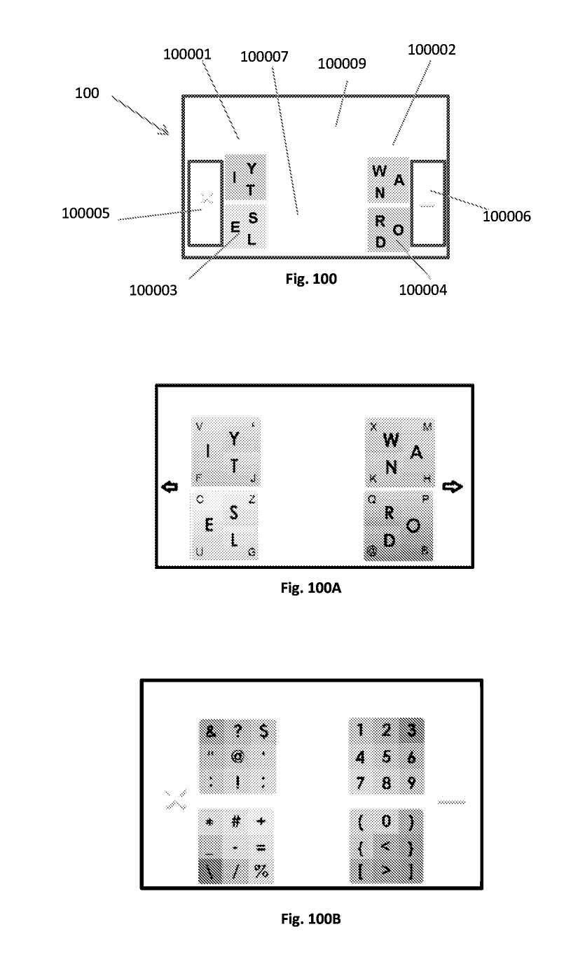

According to one embodiment of the invention the keypad may preferably have a few number (e.g. 4 to 8) of keys ambiguously representing more than one character/letter. According to one method, said a few number of keys together represent some of the letters of an alphabet (e.g. Preferred characters). The rest of the letters (e.g. Non-preferred characters) of said alphabet are represented by a key/zone outside said a few number of keys. FIG. 100A shows, as an example, a device 100 having 4 letter keys 100001-100004 located on a touch sensitive surface 100009 (e.g. such as a touchscreen) wherein each of said keys represents three characters/letters. In this example, each key has a commonly used vowel and two commonly used consonants. The rest of the letters of the alphabet, and preferably some of the special characters that may form words/stems independently or together with letters, may preferably be assigned to a zone 100007 outside said keys. Preferably said letter keys are divided into two groups of letter keys. Preferably said zone, may be the zone that is located between said groups of keys. In this example, the keypad included two more keys, namely the Space key 100006 and Backspace key 100005.

Note, that according to one method, all of the preferred and non-preferred characters may be assigned to said zone 100007, and the preferred characters may be assigned to the keys.

According to one method, said groups of keys are positioned on opposite sides of the touch sensitive surface and said zone 100007 is located between said groups of keys. Optionally, said number of keys may be any number of keys such as 2, 4, 6, or 8 keys. Optionally said number of keys form any number of groups of keys such as 2, 3, or 4 groups. According to a preferred aspect, said number of keys form two groups of keys and said zone 100007 being outside said keys. Preferably, said groups of keys are separated by the zone 100007 described above.

According to one embodiment of the invention, said zone may be comprised of more than one zone. According to a first method, said more than one zone may, together or separately, be related to the non-preferred characters. According to a second method, said more than one zone may, together or separately, may be assigned to all of the preferred and non-preferred characters.

Preferably, the letter keys are arranged such that to form two columns of letter keys. Preferably, the Space key is positioned on the side of a first column of letter keys and the Backspace key is positioned on the side of a second column of letter keys. Optionally, each of said space or the backspace keys may form a column of keys together a first and a second column of letter keys, respectively.

According to one embodiment, a word predictive system using a database of words may be used by the data entry system of the invention. Upon interaction(s) (e.g. tapping action(s)) with the one or more said keys/zones, the system may predict a word from the database and preferably propose it to a user.

In the example, FIG. 100 In order to enter the word “why” the user may provide input information corresponding to entering said word by for example interactions (e.g. pressing/tapping actions) on ambiguous key 100002, the zone 100007, and the key 100001. The system may propose/predict the word “why” which corresponds to said key/zone interactions and has the highest priority among the words of the database corresponding to said interactions. If the predicted word is the desired word, the user may confirm it by providing an end-of-the-word signal such as tapping on the space key. As such, according to one method, in addition to entering the predicted word, the system may provide a space character after the entered word.

Preferably, the system may simultaneous propose more than one word (e.g. preferably up to 5 words) corresponding to the input information provided by the user.

According to one embodiment of the invention, if a desired word is not among the words proposed to the user, upon providing a pre-defined interaction (e.g. a rightwards gliding action on a/the zone preferably between the keys) from the user, the system may show additional corresponding words to the user. Optionally, upon repeating same interaction the system may provide additional words. Preferably, upon receiving a predefined interaction (e.g. a leftwards gliding action on a/the zone preferably between the keys) from the user, the system may show the previously proposed words to the user.

Optionally, the user may be enabled to enter at least one of the characters of his desired word precisely so as to assist the system to enhance the quality of prediction by the system. By receiving and combining said at least one precise/identified character and key presses ambiguously corresponding to at least some of the other characters of a word, the system may more accurately predict a desired word. According to a first method, said one or more precise/identified characters may be appended to a predicted word (e.g. herein may be referred to as Insertion). According to a second method, said one or more precise/identified characters may replace one or more corresponding characters of a predicted word (e.g. herein may be referred to as Correction). As an example, by tapping on the key 100002, zone 100007, key 100002 and entering precisely the identified letter ‘z’ the system may predict the word ‘amazing’. These matters have already been described in detail in previous patent applications filed by this inventor.

According to one embodiment, the system may be switched to a Precise Letter Mode, wherein a predefined interaction with a key may provide an individual precise/identified character. The interface of the system in such mode may preferably be different than the interface in the ambiguous letter mode. FIG. 100A shows an exemplary preferred keypad of the invention when the system is in the precise letter mode. In this example, a tapping action on a (e.g. a zone relating to a) letter/character may enter said character precisely. In this example, the space and the backspace keys are invisible and are represented by corresponding icons (e.g. right arrow and left arrow).

According to one embodiment of the invention, the system may be switched to a Precise Symbol/Special Character Mode, wherein a predefined interaction with a key may provide an individual precise/identified special character or function. The interface of the system in such mode may preferably be different than the interface in other modes. It may show the special characters. In such mode, preferably, to each of at least some of the input means a group of special characters and/or functions are assigned. Preferably, special characters are divided into a plurality of groups (e.g. four groups) based on a common characteristic.

Optionally, each of the groups of special characters is assigned to one of the input means/key wherein each input means/key has several sub-input means/sub-keys. Optionally, said keys/zones on a touch sensitive surface, and said sub-keys are sub-zones on a zone. to which the letters are (e.g. ambiguously) assigned. Preferably, each of said sub-keys represent a single symbol.

Symbols such as special characters, commands, and functions, of PC keyboard and/or customized functions, may be grouped in different categories based on their common characteristics (e.g. digits 0-9, punctuation marks, arithmetic characters, PC commands, etc.). Each of said groups of symbols may be assigned to one of the keys of the first keypad.

The special symbols used with the data entry system are divide in four groups based on their common characteristics:
1. A first group generally includes the punctuation mark characters;
2. A second group generally includes the digits 1-9;
3. A third group generally includes arithmetic characters;
4. A fourth group generally includes at least some of the other special characters, generally, the open and close brackets. According to one embodiment, digit 0 (zero) is also assigned to this group.

FIG. 100B shows an exemplary preferred keypad of the invention when the system is in the precise symbol/special character mode. In this example, a tapping action on a (e.g. a zone relating to a) special character may enter said character precisely.

Some special characters such as, for example, dot “.” may belong to more than one groups of characters.

Preferably, the system may be designed such that to support the entry of words including letter and/or special characters. According to one embodiment, the word predictive system supports ambiguous special characters (too). According to a first method, the ambiguous special characters assigned to a letter key may be a group of special characters that are assigned to said key in precise symbol mode.

According to one embodiment, a predefined interaction such as a tapping action on an ambiguous key may preferably ambiguously correspond to any character of mainly a group of letter, and/or special characters assigned to said key.

Preferably, according to a second method, the ambiguous special characters are assigned to the zone(s) outside the letter keys.

According to one embodiment, a predefined interaction such as a press-hold-and-releasing action with an ambiguous key may preferably ambiguously correspond to any character of a group of special characters assigned to said key.

According to one embodiment, a first predefined interaction such as a tapping action with an ambiguous key may preferably ambiguously correspond to any character of a mainly group of letter, and/or special characters assigned to said key, and a second predefined interaction such as a press-hold-and-releasing action with an ambiguous key may preferably ambiguously correspond to any character of a group of special characters assigned to said key.

The system may include a plurality of mode states/instances. Depending on the mode state, the keypad of the invention may change its appearance.

1. Predictive/Ambiguous Letter Mode

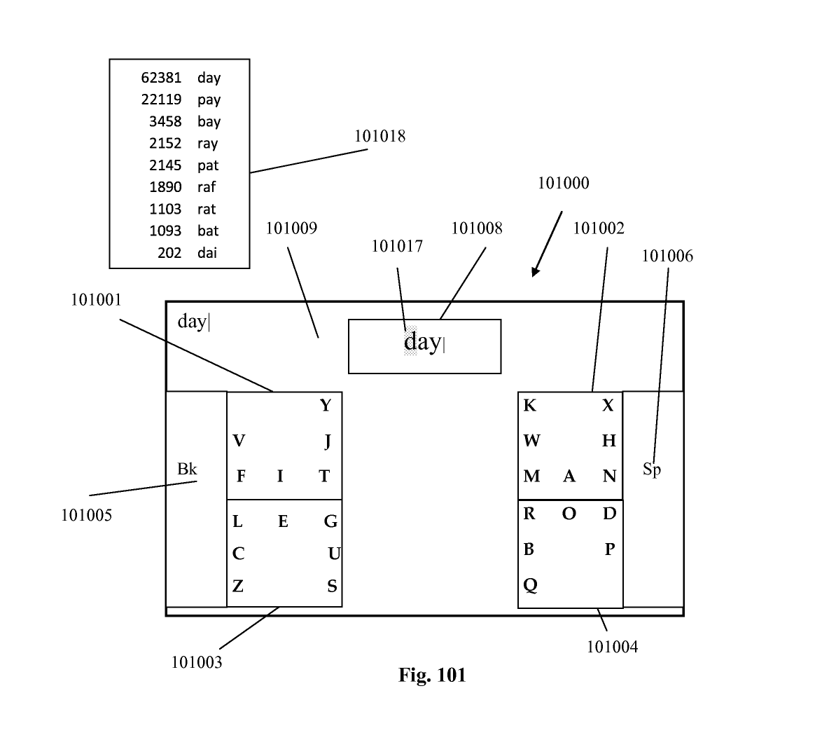

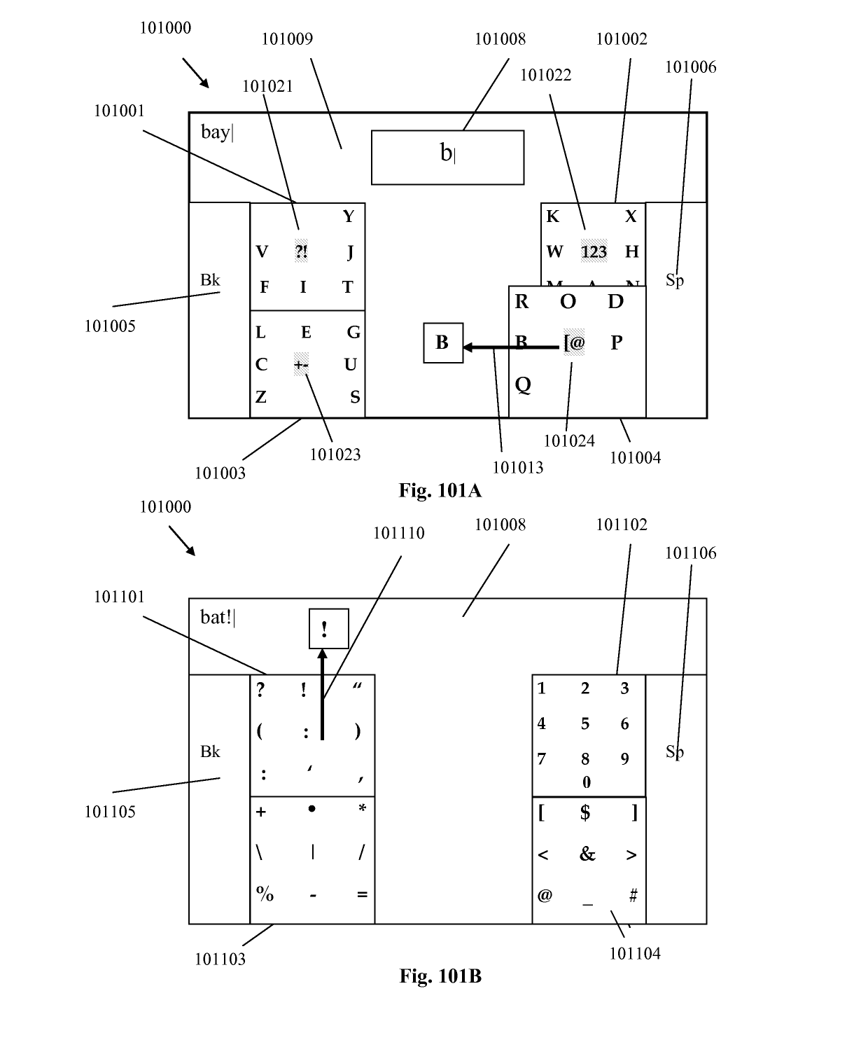

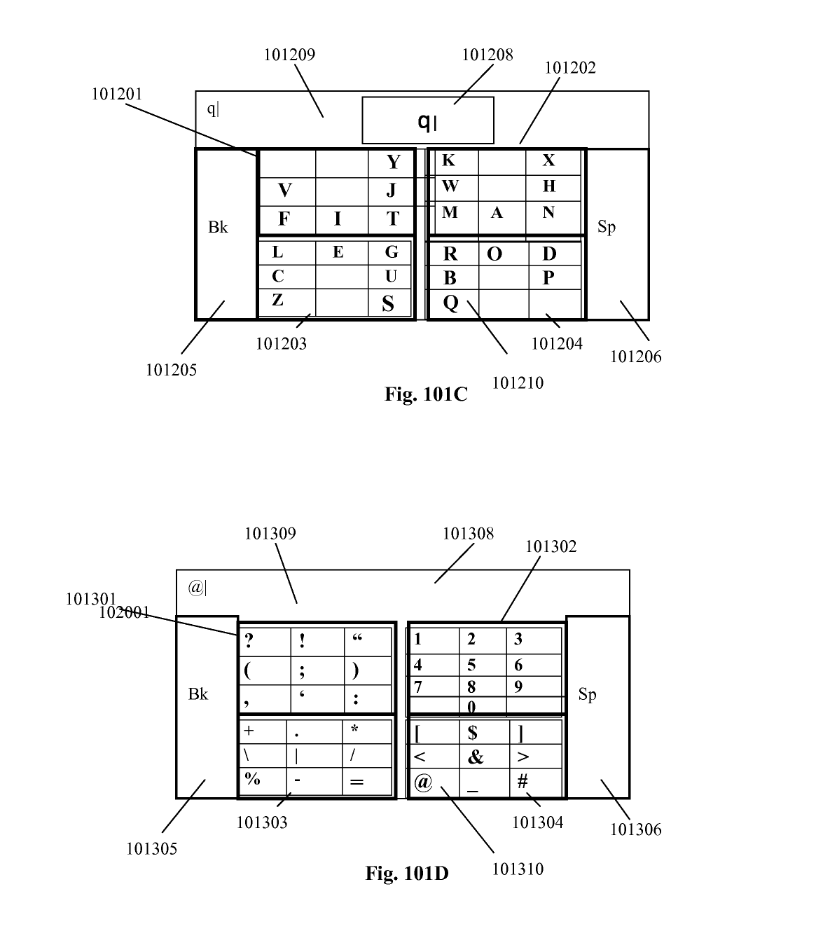

Preferably, by default, the system is in the predictive mode wherein a predefined interaction such as a tapping action on a key may preferably ambiguously correspond to (e.g. entering) any of a group of characters assigned to said key. An example of the input interface in this mode is shown in FIG. 101.

2. Predictive/Ambiguous Special Character Mode

Preferably, when a user presses and holds a (letter) key for a predefined laps of time, the system may enter into a predictive special character mode. According to one method, if the user removes his finger from the key without providing a gliding action, said interaction may preferably ambiguously correspond to (e.g. entering) any of a group of characters assigned to said key.

When a user touches a letter key in the predictive mode instance, and begins to provide a predefined gliding action on said letter key, the system may enter into a precise letter mode instance, wherein after terminating the gliding action, the system enters an identified character relating to said gliding action. According to a first method, the key appearance in this mode may not change. According to a second method, in this mode, the key may be enlarged. According to one method, when a user provides a gliding action on a key, said key is enlarged. Preferably, when a user touches a key to provide a gliding action, a copy of said (e.g. original) key may be located under the user's finger wherein the center of said key is located at the user's touching point. By doing so, the direction of the gliding action from a touching point towards a predefined letter on a key remains the same regardless of the user's finger touching point on the (e.g. original) key. To enter precisely a character that is assigned to the center key/zone, a predefined interaction such as a short gliding action or a back-and-froth gliding action (from the touching point) may be provided. An example of the input interface is shown in FIG. 101A, gliding wherein (beginning provide) a gliding action 101013 enters a system into this mode.

3. Precise Special Character Mode (e.g. Activated from an Ambiguous Key)

When a user presses and holds a (letter) key for a predefined laps of time, the system may enter into a predictive special character mode. If the user begins to provide a predefined gliding action on said key, the system may enter into a precise Special Character Mode instance, wherein after terminating the gliding action, the system enters an identified special character relating to said gliding action. According to a first method, the key appearance in this mode may not change. According to a second method, in this mode, the key may be enlarged. According to one method, when a user provides a gliding action on a key, said key is enlarged. Preferably, when a user touches a key to provide a gliding action, a copy of said (e.g. original) key may be located under the user's finger wherein the center of said key is located at the user's touching point. By doing so, the direction of the gliding action from a touching point towards a predefined special character on a key remains the same regardless of the user's finger touching point on the (e.g. original) key. To enter precisely a character that is assigned to the center key/zone, a predefined interaction such as a short gliding action or a back-and-froth gliding action (from the touching point) may be provided. An example of the input interface in this mode is shown in FIG. 101B, wherein providing a press-and-holding action and providing (e.g. beginning to provide) a gliding action 101110 enters a system into this mode.

4. Precise Letter Mode Using Second Keypad(s) Having Specific Zones

Each of the keys of the predictive keypad may be replaced by a corresponding plurality of specific zones/keys, referred to as a second keypad of the invention, Each of at least some of said zones may represent an identified character, preferably a letter. A predefined action such as a tapping action on a specific zone/key of a second keypad may enter an appropriate character/letter precisely.

A first predefined user's interaction such as a gliding action in a first direction on the backspace key, or a predefined response of the system to a user's input information/interaction (e.g. during the entry of a word) may activate this mode. An example of the input interface in this mode is shown in FIG. 101C. In this example, each of the ambiguous keys of the first keypad is replaced by a corresponding second keypad of the invention. For example, a tapping action on a zone/key 101210 of the second keypad 101204 may correspond to entering the letter “Q”.

5. Precise Special Character Mode Using Second Keypad(s) Having Specific Zones

Each of the keys of the predictive keypad may be replaced by a corresponding plurality of specific zones/keys referred to as a second keypad of the invention. Each of at least some of said zones may represent an identified character, preferably a special character/function. An example of the input interface in this mode is shown in FIG. 101D. A predefined action such as a tapping action on a specific zone/key of a second keypad may enter an appropriate special character/function precisely.

A second predefined user's interaction such as a gliding action in a second direction on the backspace key, or a predefined response of the system to a user's input information/interaction (e.g. during the entry of a word) may activate this mode. In this example, each of the ambiguous keys of the first keypad is replaced by a corresponding second keypad of the invention. For example, a tapping action on a zone/key 101310 of the second keypad 101304 may correspond to entering the character “@”.

According to one embodiment, when the system or a key of the first keypad enters into the special character mode, the system preferably shows a corresponding second keypad of the invention, for at least said key or for all of the keys of the first keypad (e.g. by replacing said key, or all of the keys of the first keypad).

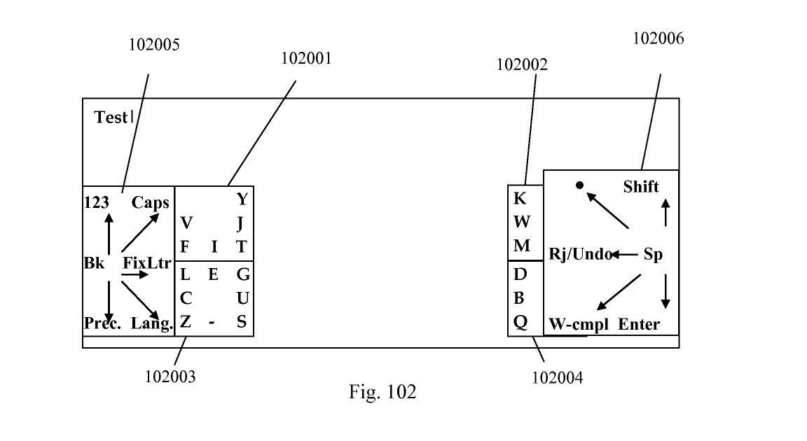

Some frequently used Special Characters and Commands may be assigned to interactions such as taping or gliding action in different (predefined) directions on or from the keys (preferably other than the letter keys) of preferably the first keypad. As described for the letter keys, preferably when a user touches a key (e.g. 102006 of FIG. 102) other than the letter keys, said key may be enlarged and centered under the user's finger.

FIG. 102 shows as an example, a device having the first keypad of the invention having four letter keys, and two additional keys 102005 and 102006, to which some frequently used characters and commands are assigned. As an example, on the Backspace Key:
1. A pressing action anywhere on the key 102005 may correspond to the backspace (“Bk”) function.
2. A gliding action departing anywhere from said key upward may correspond to entering the system into the Precise Special Character mode.
3. A gliding action departing anywhere from said key downward may correspond to entering the system into the Precise Letter mode.
4. A gliding action departing anywhere from said key towards upper-right side may correspond to the CapsLock function.
5. A gliding action departing anywhere from said key towards lower-right side may correspond to a procedure of replacing the current database by another database. One type of said databases are the databases of words in different languages. According to one method, after the user provides such gliding action, the system may show a list corresponding to number of alternative databases. As an example, said number of databases may be represented by/on different keys of a second keypad of the invention, for example, having a three-by-three matrix of keys. The user may select one of the databases to be used by the system by providing a predefined interaction such as tapping on a zone corresponding to the desired database.
6. (a) A short/quick gliding action departing anywhere from said key rightward may correspond to fixing (e.g. keeping as is) a selected/highlighted character of a current predicted word. The system then selects/highlight another (e.g. the subsequent) character of the predicted word. (b) A long/press-and-holding-the-key-and-providing gliding action departing anywhere from said key rightward may correspond to fixing (e.g. keeping as is) all of the characters of a current predicted word. According to one method, additional (ambiguous) input information corresponding the current word may be added to the fixed characters so that the system better predicts aa current word being entered.
   Also as an example, on the Space key:
7. A pressing action anywhere on the key 102006 may correspond to the space (“Sp”) function.
8. A gliding (e.g. and holding) action upward departing anywhere from said key may correspond to the Shift function (↑) function.
9. A gliding action departing anywhere from said key downward may correspond to the “Enter” function.
10. A gliding action departing anywhere from said key towards upper-left side may correspond to dot “.” Character.
11. A gliding action departing anywhere from said key towards lower-left side may correspond to entering a predicted word wherein its beginning characters correspond to the input information provided by the user.
12. (a) During entering a word by interacting with the ambiguous keys, a gliding action departing anywhere from said key leftward may correspond to the rejecting (e.g. described later in this application) the predicted word. (b) During the correction procedure or when a word is not being entered the same gliding action may correspond to Undoing the last interaction with a key.

It is understood that although in this example (e.g. because the keys 102005, 102006, are close to the edge of the device) only five symbols on each key are considered to each being assigned to a gliding action in a different direction on/departing from the corresponding key, obviously, more or other symbols/function relating to different gliding directions may be considered for each key.

According to one embodiment of the invention, after interacting with the keypad relating to entering a precise/identified character, if said character has related accented characters, the system may show the accented characters so that the user may select one of accented characters.

According to one method, said accented characters may be shown around the user's fingers (e.g. touching a zone/sub-zone corresponding to a precise character) and the user may slide his/her finger to a desired accented character to select it.

The words of the/a database used by the system may include special characters, and they may be predicted by the system. According to one embodiment of the invention, in addition to the (e.g. at least some of the) letters of a language assigned to a number of keys such as for example four keys, special characters also may be divided into several groups preferably based on their common characteristics and each group being ambiguously assigned to a different ambiguous letter key in ambiguous mode. According to one method, the special characters may form four groups, such as those shown and described throughout this application and other patent applications filed by this inventor and being ambiguously assigned to said keys. According to one method, if the system includes a/the broadly ambiguous key/zone as described before, in addition to or in replacement of the principle of assignment of special character to the letter keys as described, at least some (e.g. preferably all) of said special characters may also ambiguously assigned to said broadly ambiguous zone/key.

With continuous description of the current embodiment, after the system receives a sequence of one or more interactions signals with said letter keys (e.g. and zone), the system may predict one or more words of a database of words used by the system.

Alternatively or in addition to the principles described above, according to one embodiment of the invention, providing a first type of interaction for example such as a short pressing action (e.g. a tapping action, pressing a key for less than a predefined laps of time) on a key of the first keypad may ambiguously correspond to one of the letters assigned to said key, and providing a second type of interaction such as a long pressing action (e.g., pressing a key for at least a predefined laps of time) or a (very) quick/short gliding action (e.g. in any/a predefined direction) on a/said key may ambiguously correspond to a special character ambiguously assigned to said key (or vise versa). This may help the system to better predict a word that includes letters and special characters, because the user may inform the system which type of character (e.g. a letter or a special character) must be in a specific position within a word being entered by providing corresponding short and long pressing actions. It must be noted that according to one method, the short gliding action may ambiguously correspond to both letters and special characters, and the long pressing action may correspond to the special characters only (or vise versus).

According to one embodiment of the invention, a special character may (e.g. ambiguously) be assigned to more than one key of the keypad of the invention.

According to one embodiment of the invention, during the entry of a word any of a group of characters such as letters and/or special characters entered (e.g. by any means such as a tapping action or a gliding action during the entry of the original input information and/or during the correction procedure) may preferably be considered as part of a word by the system, and one or more predefined characters such as a space character, or a predefined code (e.g. ASCII code) not representing a character may be considered as end-of-the-word signal. This matter has already been described in previous patent applications filed by this inventor, and are being incorporated here by reverence.

According to one embodiment of the invention, when a new word is being entered by the user, the system may first search in a corresponding N-gram (e.g. N>1, preferably, N=2) database. If the system does not find a corresponding word, he may then add the new word in the corresponding N-gram (e.g. 2-gram) database (e.g. by considering/combining the previous word already entered). If the system also does not find said new word in the corresponding 1-gram database, the system may preferably also add said new word in said 1-gram database.

A word of a database used by the system may be deleted from said database. According to one embodiment, the user may select a word in a document (e.g. by tapping on sais word, or positioning a cursor at the end of said word, grabbing said word, etc.) and provide a predefined interaction (e.g. for example, by providing a gliding action towards lower-left side on the backspace key or pressing on said word for at least a predefined laps of time) to inform the system to deleted said word from the corresponding database. Preferably, such word combined with its previous word(s) (e.g. or the one(s) after) in the document may be deleted from the corresponding N-gram database (N>1). Preferably, the user may not be asked for confirmation of such deletion. According to one method, the system may also delete said word from the corresponding 1-gram database after asking the user and the user's confirmation.

According to a preferred embodiment, the system may search within the N-gram (e.g. 2-gram) database for several types of words, such as below:
at least one word of a first type of words, wherein all of its characters correspond to the input information provided by the user; and
at least one word of a second type of words wherein its beginning characters correspond to the input information provided by the user;
   According to one method, the system may preferably propose/present one word from the first type of words and/or one word from a second type of words to the user.

According to one embodiment of the invention, providing/performing gliding actions in four different directions provided anywhere on a touch sensitive surface may respectively correspond to interacting with four letter keys (e.g. in the predictive mode) of the system. Accordingly, a tapping action on anywhere on the screen or on a predefined zone may correspond to interaction with the broadly ambiguous zone. Preferably, the directions may be towards any of the following: upper left, upper right, lower left, and lower right. Furthermore, gliding actions in other directions such as left, right, up, and down, may correspond to other symbols/keys such as special characters/keys, and functions/keys. For example, a gliding action leftward may correspond to backspace function/key, and a gliding action rightward may correspond to providing a space character/space key.

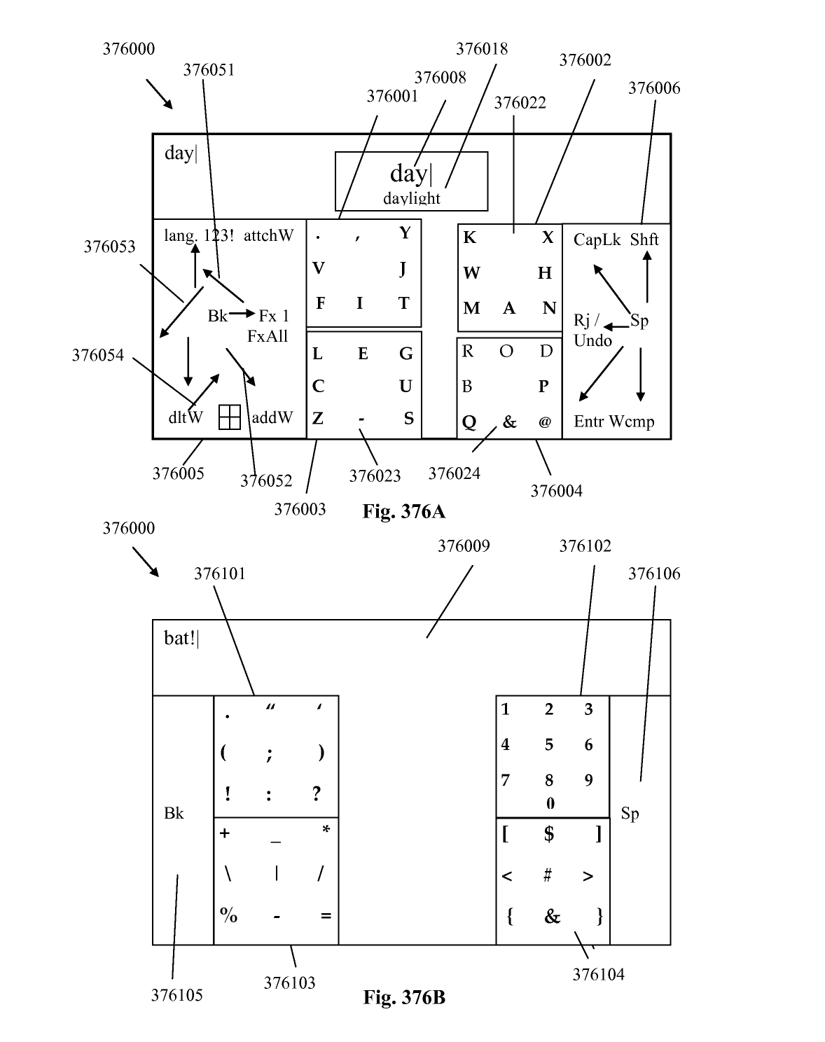

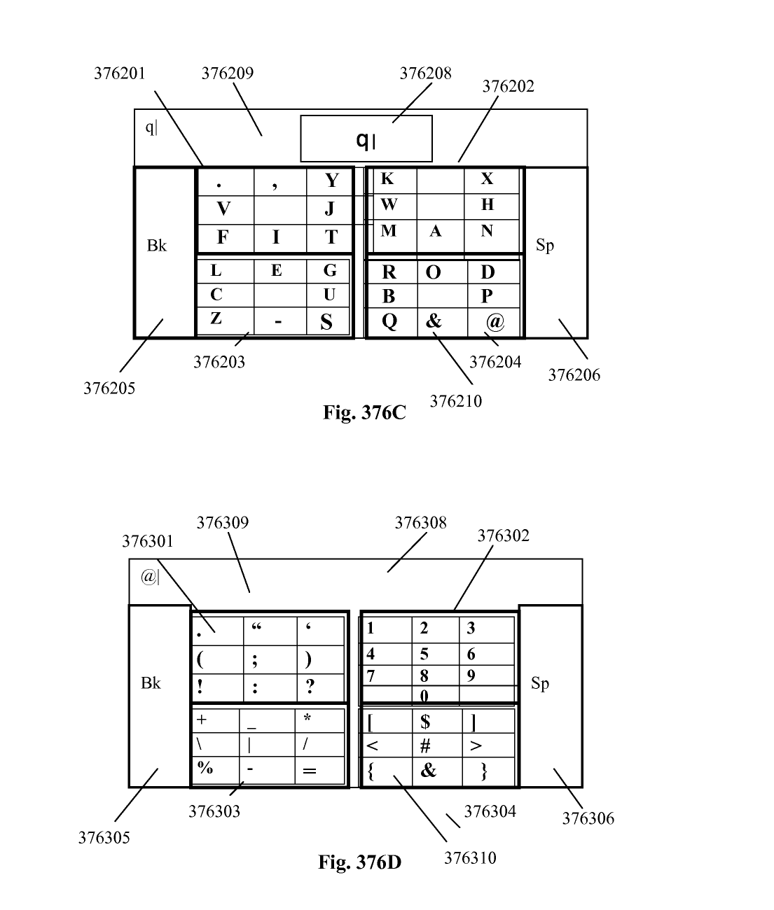

FIG. 376A-B, show another exemplary method of configuration of the characters and functions on the keys of the keypad of the invention. In this example, to each of at least some of the keys of the keypad two groups of symbols are assigned. Preferably each of said groups of symbols is assigned to a different predefined interaction (e.g. the first type of interaction is providing an interaction that includes a short amount of time of touching action with a key, and the second type of interaction is a longer amount of time of touching action with said key. In some cases each of said interactions may be initial/portion-of interactions of a complex interaction). In some cases, said interactions are used for entering precise characters. In some cases, said interactions are used for entering ambiguous characters precisely. These matters have already been described. In case of entering ambiguous characters, according to one embodiment, a first type of interaction such as a short tapping action on a key may preferably correspond to any of the characters of both groups of characters assigned to said key. Alternatively, a short tapping action may ambiguously correspond to a first group, and a long pressing action may correspond to a second group on a key. Based on a sequence of one or more tapping/pressing actions the system may predict a word.

According to one method, during the entry of a word, if a user provides a second type of interaction such as a pressing action including holding the key for a longer time, the system may be informed that in the corresponding position of the current word being entered, a character of the second group may preferably at first may be considered for predicting a word. According to another method, said interaction may correspond to any special character assigned to said key. According to another method, said interaction may be assigned to a predefined group of characters assigned to said key. Said characters may include any type of characters such as for example to include at least one of the characters of the first group and at least one of the characters of the second group in any and/or a predefined case such as in uppercase or in lowercase.

As an example, FIG. 376A shows the characters of the first group, and FIG. 376B show characters of the second group. In the example of FIG. 376A, in additions to the letters, some of the special characters such as “.”, “,”, “-”, “@”, and “&”, that are assigned to a same/first group. Some characters for example such as “.”, and “&”, may be assigned to both groups. According to one example, tapping action on the keys 376001, 376001, 376001, and 376003, may provide the word “it's”, because for example this word has the highest priority, although the character “′” belongs to the second group of letters assigned to said key. On the other hand, tapping on the keys 376001, 376001, 376001, 376003, and 376003, may correspond to the word “title”, but tapping on the keys 376001, 376001, then long pressing on the key 376001 (e.g. informing that in the this/third position the system should preferably first consider a character of the second (e.g. special characters group) assigned to said key 376001), and finally tapping on the keys 376003, and 376003, may result in predicting the word “it'll”.

Methods of adding word to the a database have been described before. As mentioned, when the user enters a word (e.g. “what”), he may add one or more (special) characters (e.g. “?”) to its end. The system may show the word “what?” as the current predicted word. According to one method, if such word including the special character(s) (“what?”) is not in the database, the system may preferably alert the user by a means (e.g. appearing a colored and/or blinking frame around the current predicted word, blinking the current predicted word, etc.), and add said word to the database, either automatically or based on user's request. If the system is designed to require confirmation to add a word to the database, then the user may provide a predefined interaction for example a predefined gliding action from a key (e.g. SP/BS key). According to one method, after a word is added to the database, the word is still considered as a current predicted word. If the user continues to add/append characters to the current predicted word, the new current word most probably is not included in the database too. In this case, the user/system may also enter the new current word (s) to the database (e.g. until the user provides an end-of-the-word-signal such as pressing on the space key).

According to another method, after confirmation the system may add the current predicted word in the text and preferably provide a space after it.

According to one embodiment, when the user performs an interaction regarding the deletion of a word from the database, the system may first (e.g. without asking user's confirmation) delete the corresponding N-gram (e.g. N>1) entry from the database. The system additionally may also ask for confirmation regarding deleting said word from 1-gram database too. If the system confirms the deletion, then the system deletes said word from the corresponding 1-gram database too.

In the example of the key 376005 (e.g. enlarged) of FIG. 376A:
a gliding action 376051 from anywhere on/from said key towards upper-left direction may correspond to “switch to a (another) language” function.
a gliding action 376052 from anywhere on/from said key towards lower-right direction may correspond to “adding the current proposed/selected word to the dictionary” function.
a gliding action 376053 from anywhere on/from said key towards lower-left direction may correspond to “delete the current proposed/selected word to the dictionary” function.
a gliding action 376054 from anywhere on/from said key towards upper-right direction may correspond to “Attach the current proposed/selected word to the next word/chain-of-characters” function.

Other exemplary functions on the key 376005, and 376006, have been described before, or they are self-explanatory.

With the continuous description of the current embodiment, FIGS. 376C, and 376D, show the keypads of the invention of FIGS. 376A, and 376B, in their Precise Character Modes, respectively. According to one embodiment of the invention, a word/gram of the database and/or a current word being entered may begin with any character. For example, the chain of characters “2xm” may be considered as a current word being entered. As such, according to one method, beginning to enter ambiguously/precisely the first character of a chain of characters comprising one or more characters may be considered as a first character of a corresponding current (predicted) word.

According to one embodiment of the invention, after the system enters in the Correction mode and eventually enters the letter keys into their corresponding Precise Letter Mode (e.g. second keypads) for correction, the tapping actions on the zones corresponding to the precise letters (or other characters in said modes) may correspond to entering corresponding precise letters/characters of the corresponding (first) group, and optionally the gliding actions on the second keypads in said mode may also correspond to the appropriate precise letters/characters of the same group. Accordingly, during the correction procedure, if the user manually switches the system into the Precise Special Character Mode he may tap on the corresponding zones to enter special characters (e.g. corresponding second group), or alternatively, he may provide gliding actions as described above on the second keypad for entering in said mode (characters of the same second group).

According to one embodiment of the invention, during the entry of a word (e.g. preferably not during the correction), when the user switches manually the system into the Precise Letter Mode, providing a tapping action on a zone/key may correspond to entering the corresponding character (e.g. Letter) (of a/the first group), and providing a gliding action may correspond to entering precise special characters (e.g. of a second group).

According to another embodiment of the invention, during the entry of a word (e.g. preferably not during the correction), when the user switches manually the system into the Precise Letter Mode, providing a tapping action on a zone/key of a second keypad and/or providing gliding actions on said second keypad may correspond to entering the corresponding character (e.g. Letter) (e.g. characters of the first group), and providing a long pressing action and providing the gliding action may correspond to entering precise special characters (e.g. characters of the second group).

It must be noted, that although throughout this application the first groups of characters to a key is referred to as mostly including letters, and a second group of characters are referred to as special characters, said first and second group of characters may include any other one or more characters or they may comprise another group of characters.

According to one method, after rejecting a word, and accepting another word (e.g. a second word proposed by the system, or another word proposed after correction) by, for example, providing a space character, if the user provides one or more special character(s), said character(s) may be attached to the end of the accepted word followed by the space character.

The keyboard would preferably have 4 onscreen keys; each key would have several letters of the Japanese alphabet, Kana. Each of the 4 keys might have more than 1 layer, i.e. for example, 3 or 4 layers (i.e. key 378.4, 378.4.1 and 378.4.2). Each layer may have more kana symbols or any other symbols on it such as special characters, emoticons, etc.

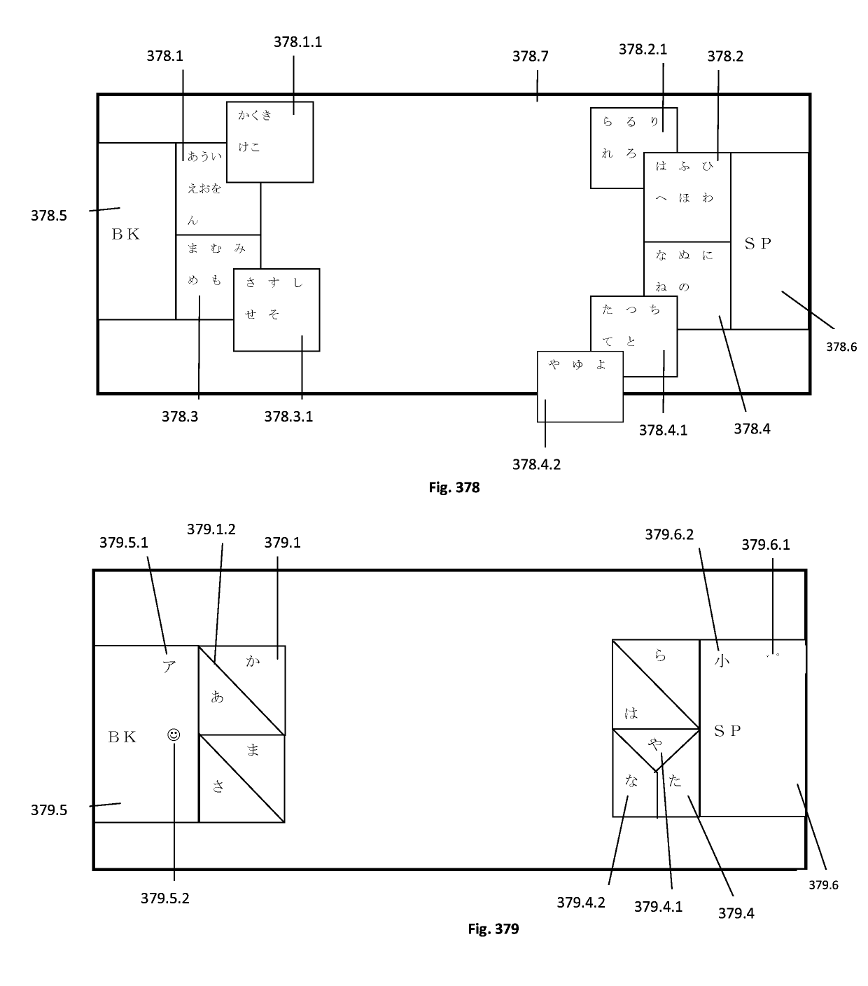

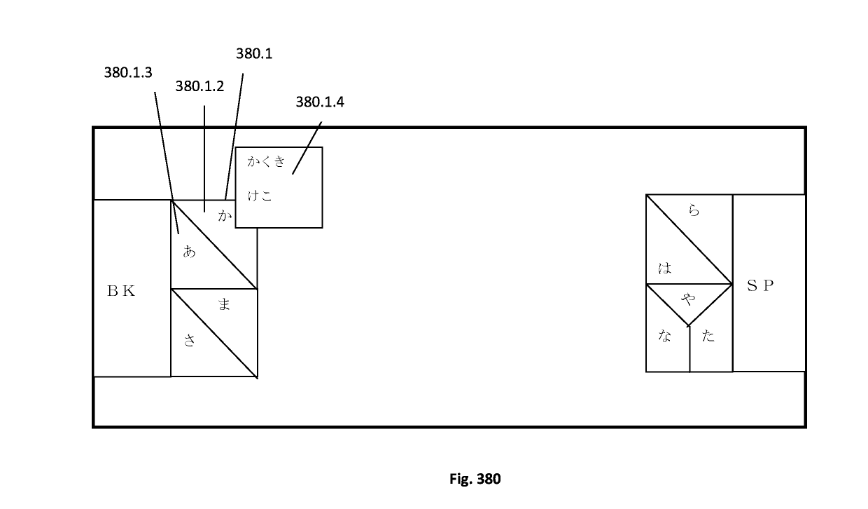

The kana characters are arranged/grouped according to their sound so that it would be easy to remember their location. The kana characters are arranged by their consonants, i.e. for example, consonant R and its' derivatives on one key and consonant Y and its' derivatives on the other key. In FIG. 378, the consonant K and its' derivatives are on key 378.1.1. The vowels which do not have a consonant attached are all on the same key, for example, key 378.1. The current arrangement of the kana characters on the keys is only an example and there might be other arrangements possible.

As mentioned above, each key on the Japanese keyboard may have more than one layer. One possible way of integrating the different layers into one keyboard is explained hereafter, see FIG. 379:

Each key would contain within itself several layers, but the user would not see said layers. Each key might have a diagonal line running through it, for example, in case of 2 layers (see 379.1.2), dividing said key into 2. The user then knows the placement of the different vowels and consonants and their derivatives and may tap anywhere on the key like he/she would on, for example, the European versions of the keyboard.

As mentioned above, each key could have more than 1 layer (i.e. FIG. 378: 378.4, 378.4.1, 378.4.2). For, In the case of more than 2 layers, the key would be divided into said number of possible layers and would form corresponding areas on key (i.e. 379.4, 379.4.1, 379.4.2). The user would also tap anywhere on said key just like he/she would on the European languages of the keyboard.

The SP (379.6) and BK (379.5) keys on the Japanese keyboard might serve a different purpose than they would on the European keyboards as described. In the Japanese keyboard the SP key might serve 2 purposes when tapping on it once. i.e., for example, as a way to confirm an entry as well as entering a space character.

The Japanese SP and BK keys may have additional features such as phonetic marks (i.e. Dakuten, Handakuten, etc. see 379.6.1). Other features would include a way to input yōon characters with, for example, the following symbol: [symbol] (379.6.2). In order to activate said additional features, the user would do a sliding motion from the SP key towards said features.

An additional feature that could be placed on the BK key would be [symbol] (379.5.1). This feature would give the user instant access to Katkana characters, enabling the user to choose between Hiragana and Katakana. The user would do a sliding motion towards said feature to turn it on. He later would repeat said action to turn it off Another feature, [symbol] (379.5.2) would enable the user to insert different emoticons. To turn this feature on, the user would do a sliding motion from the BK key to the right. The user would then repeat the action to turn it off. All said features on the SP and BK keys, when turned on, may appear in place of the 4 onscreen keys.

All said additional features could be placed on different keys and are not restricted to the SP and BK keys alone.

As mentioned before, each of the onscreen keys of the Japanese keyboard may have more than one layer. Each key may be divided into corresponding areas with a line going through the key (i.e., see FIG. 379; 379.1.2). In order to access each individual layer, the user would press and hold his finger on a chosen area and the corresponding layer would then appear.

For example, if the user wants access to the kana symbols belonging to [symbol] , which is on the first key (380.1), he would select the corresponding area by pressing and holding said area (380.1.2). Then, a new key with the chosen consonant and its' derivatives would appear (380.1.4). In order to select a symbol, the user would do a sliding action towards the desired symbol. When the user takes his finger off the screen, the new key (380.1.4) would disappear and the first key would appear (380.1).

Said correction method represents only one option for entering into the correction mode. Other methods of correction mode may be considered by people skilled in the art.

1. The invention may also be used to enter text/data in languages using the Cyrillic (e.g. Russian) alphabet.

Like in case of languages using the Roman alphabet, the Cyrillic (e.g. Russian) letters are divided into four groups, each represented on a separate key, i.e. the letters are distributed among four keys. The division into groups may follow any principle(s) that has/have to do either with graphic presentation of the letters, or with the sounds corresponding to the letters, or with the frequency of letters, or with the accuracy of prediction resulting from a certain distribution of letters among groups as compared to the other version(s) of such a distribution/division into groups, or with any other principle or combination of principles chosen by people skilled in the art.

1.2. The distribution principles applied do not have to cover all the letters in all the groups. There might be exceptions, which may be explained, for example, by any considerations of the user's comfort (e.g. by graphic resemblance between certain letters, which would facilitate on the user's memorization of the letters' arrangement), or by a group's being overloaded, or by any other reason.

1.2.a. When distributed in accordance with a graphic representation principle, it might be the case that the exceptions are font-depended, i.e. a letter may be perceived as an “exception” when depicted in a certain font, and, on the contrary, may fit the stated distribution principle when depicted in another font.

1.3. As mentioned above, the Russian letters can be divided into four groups according to the graphic presentation principle, i.e. each group/key will contain letters sharing (a) certain graphic feature(s)/element(s).

1.3.1. According to one embodiment of the invention, the features/elements common to each one of the four groups/keys (i.e. shared by most letters in each corresponding group) are as follows:

Group 1: Most letters contain either an arc or a closed area that occupies more than a half of its height.
Group 2: (Most) letters contain either a small circle or a small arc. Each arc/circle is placed at one side of a letter and occupies half of its height, i.e. if a letter were placed into an imaginary box, the arc/circle would occupy ¼ of this box.
Group 3: (Most) letters have at least one diagonal/curved line which occupies either a half or the letter's height, or the whole height of the letter.
Group 4: (Most) letters are composed only of the lines that are either strictly vertical or strictly horizontal.

1.3.2 In accordance with this distribution principle, the letters will be assigned to the four keys in the following way:

### Key 1:

### Key 2:

### Key 3:

### Key 4:

1.3.3 As might be noticed, letters “A” and “ [symbol] ” apparently do not fit the described distribution principle fully (see. Paragraph 1.2 of this section).

Letter “A” would better fit Group/Key 3. Yet it has been assigned to Group/Key 1. This was done due to its graphic resemblance to letter “ [symbol] ”, which is a part of Group 1. Besides, as pointed out in Paragraph 1.2.a, in some fonts, “A” may be depicted in a way that its closed area occupies more than a half of its height, so that in such a case it would fit the principle mentioned in 1.3.1. Letter “ [symbol] ” could belong to Group 3/Key 3, since it contains a curved line. Yet it has been assigned to Group 4 due to its graphic resemblance to letters “ [symbol] ” and “H”. Besides, in some fonts this letter may be depicted in a way that all its lines are straight, so that in this case it would fit the principle mentioned in 1.3.1.

1.3.4. Some letters might belong to more than one group/key. Unless another consideration has been applied, if a letter contains features/elements which may enable one to attribute it to more than one group/key, these features/elements are ranked in a way that a certain feature/element is considered dominant with respect to the others and, thus, predefines the letter's assignment to a certain group.

1.3.5 In case of distribution referred to in Paragraphs 1.3 of this section, the rank of the distribution principles is as follows:

1.3.5.a. The principles that define Group 1 are dominant over all the other principles. For example, as depicted in some fonts, letter “A” may contain a closed area which occupies more than a half of its height (Group 1). This letter also includes two diagonal lines (Group 3). In case that “A” contains such an area, it is this principle that defines its assignment to Group 1.

1.3.5.b. The principles that define Group 2 are dominant over the principles that define Groups 3 and 4.

For example, letter “ [symbol] ” contains elements/features that enable to assign it to both Group 2 and Group 3. Yet it has been assigned to Group 2.

1.3.6 According to another embodiment of the invention, the features/elements common to each one of the four groups/keys (i.e. shared by most letters in each corresponding group) are as follows:

Group 1: Letters have either one open end of a straight line, or no such elements at all.
Group 2: Letters have two open ends of straight or slightly curved (i.e. other than an arc-like) lines.
Group 3: Letters have three open ends of straight or slightly curved (i.e. other than an arc-like) line.
Group 4: Letters have four ends of straight or slightly curved (i.e. other than an arc-like) lines that are either open or have a diagonal line attached.

1.3.7 In accordance with this distribution principle, the letters will be assigned to the four keys in the following way:

### Key 1:

### Key 2:

### Key 3:

### Key 4:

1.3.7. With respect to letter “ [symbol] ”, the embodiment described in 1.3.6-1.3.7 may have to variations.

According to the preferred variation of the embodiment, though “ [symbol] ” has four open ends of straight lines and, thus, fits Group/Key 4, it has been assigned to Group/Key 3 due to its graphic resemblance to letters “ [symbol] ” and “ [symbol] ”.

According to another variation of this embodiment of the invention, letter “ [symbol] ” may be assigned to Group 4.

1.4. The order/arrangement of groups mentioned above as well as the arrangement of letters in each group may vary in accordance to any decisions made by people skilled in the art.

According to one method, after rejecting a word, and accepting another word (e.g. a second word proposed by the system, or another word proposed after correction) by, for example, providing a space character, if the user provides one or more special character(s), said character(s) may be attached to the end of the accepted word followed by the space character.

According to one embodiment of the invention, during the entry of a word if the last character (e.g. ambiguous or precise) being entered preferably corresponds to a special character, and then the user provides an interaction corresponding to a (e.g. an ambiguous or precise) character, preferably/such-as a letter, two scenarios may be considered:

1^{st} scenario) if a word (e.g. the entire word or it's beginning characters/stem) in the corresponding database used by the system corresponds to the input information provided until then said interaction corresponding to said letter being entered is preferably considered as part of the word being entered.
2^{nd} scenario) if none of the words (e.g. the entire word or it's beginning characters/stem) in the corresponding database used by the system corresponds to the input information provided until then said interaction corresponding to said letter being entered is preferably, considered by the system as part of (e.g. the beginning letter) a next (e.g. the following) word being entered. In this case, the system preferably attaches said/the two words (e.g. without adding a character such as space character between said two words). Preferably, after the user provides a space character, the system may add said attached words as a single word to the corresponding (e.g. 1 gram and/or N-gram) database(s). Note that, the procedure just described may be repeated for (e.g. and to attach) more than two words.

According to one embodiment of the invention, during the entry of a word, if the input information currently being provided by a user corresponds to a word/stem of an entry of a database used by the system, and the user adds an additional information corresponding to an additional (e.g. ambiguous or precise) character of a current word being entered, and the system does not find any word (e.g. or stem) of an entry of a database corresponding to the combined information, then different scenarios may be considered such as for example the ones described below:

1^{st} scenario) The system may considered the last character being entered as the first character of a new current word being entered, and provides a word corresponding to the rest of the input information (e.g. the information preceding the last character, including the last character) being entered).
2^{nd} scenario) The system may consider only the input information provided starting from the last special characters entered until (and including) the last character being entered, and may predict a word accordingly.

Note that at any moment during the entry of a current word, the user may use the word attaching words function as describe before.

According to one embodiment of the invention, the attaching words function may be applied or available to be applied at any moment during the entry of a current word, such as for example before and/or after a correction procedure. Preferably, after a correction procedure, providing an attaching function, the system switches to the predictive mode.

As described in different patent application filed by this inventor, gliding actions provided on/from anywhere on a surface, such as a touch screen, in a predefined direction (e.g. gliding actions having substantially parallel trajectory) may correspond to a same input signal (e.g. may provide a same function). As described, as an example, according to one method, said gliding actions may be provided in a number of different directions such as for example, four to eight predefined directions. According to one embodiment of the invention, providing such gliding actions on/from a predefined zone on the screen, preferably outside the/a keypad of the system, may correspond to different functions such as point and click actions of a mouse (e.g. controlling the movements of pointer, caret, cursor, on a screen, and other mouse functions such as copy, paste, selecting text, selecting icons, etc.), and/or other functions such as the native functions of the computer or customized functions, etc.

Moving a pointer (e.g. cursor, caret, etc.) on a surface of a (sensitive) screen based on providing a gliding action on departing from anywhere (e.g. preferably outside the on-screen keypad) on said screen had been described in previous applications filed by this inventor.

According to one embodiment, if a word is not being entered, gliding actions provided on or departing from the/a zone between the keys may preferably correspond to moving a cursor in the corresponding direction on the screen. If said cursor is a caret within a text, said gliding action move the caret in the corresponding direction within said text. A gliding action to move a pointer provided as such may have any trajectory, such as straight or curved trajectory, ant in any direction (e.g. towards, left, right, up, down, any diagonal direction, etc.). During providing a gliding action, a user may also change its direction as much as desired. Providing such a gliding action may preferably move the corresponding pointer (e.g. generally located on another location on the screen relating to the user's finger touching impact with the screen during the gliding action) on the screen, accordingly. Gliding (e.g. and the (corresponding) tapping action(s)) provided as such may correspond to mouse functions such as point and click actions of a mouse (e.g. controlling the movements of pointer, caret, cursor, on a screen, and other mouse functions such as copy, paste, selecting text, selecting icons, etc.), said functions preferably being similar (e.g. duplicate) the gliding (e.g. and the (corresponding) tapping action(s)) actions provided on a touchpad-mouse of a PC such as desktop/notebook and their corresponding mouse functions.

When a cursor/caret is positioned at a location within a text, a predefined interaction on the screen (e.g. preferably, on or from a/zone between the keys) may select a portion of said text. As an example, the user may provide a long pressing action on the screen, and (e.g. and with the same finger, or simultaneously with another finger) provide one or more gliding action in an appropriate direction to select a portion of a text in a corresponding direction of the cursor position.

After selecting a portion of a text, the user may provide a predefined interaction such as a long pressing action on the screen, (e.g. preferably, on or from a/zone between the keys), and the system may propose a copying choice to the user. If the user selects that choice the system may copy the selected portion of the text.

The user may provide a predefined interaction such as a long pressing action on the screen, (e.g. preferably, on or from a/zone between the keys) and the system may propose a pasting choice to the user. If the user selects that choice the system may insert a copied portion at a cursor position within the text.

When the user provides a predefined interaction such as a long pressing action, (e.g. depending on the instance) other choices may (also) be presented to the user. An example of such choices may be other mouse functions such as cut, select all, select text on the, left, right, (e.g. depending on the corresponding language, left or right and) above, (e.g. depending on the corresponding language, right and) below, etc.

According to one embodiment of the invention, the gliding action (e.g. motion events) corresponding to moving a pointer on the screen may be provided anywhere on the screen. For such purpose, preferably, a method of capturing events by the data entry system of the invention (e.g. instead of/before/after being captured by the application with which the data entry system of the invention is interacting) may be implemented. As an example, a virtual and/or hard in/visible surface (e.g. an object) covering the screen may be implemented. Said surface preferably may be sensitive to user's interactions (e.g. touch sensitive).

According to another embodiment of the invention, an interaction such as a gliding/tapping action corresponding to moving a pointer on the screen and/or other mouse functions, such as for example, copy, paste, etc., (e.g., and/or any other function other than mouse functions) may be provided on/departing from a predefine zone on the screen. According to one method, said zone may be the zone outside the keys of the keypad of the invention. If the keypad of the invention is a split keypad, preferably, said zone may be the zone between the split (e.g. on screen) keys of the system.

According to one method, the gliding action provided as such may end on at any location, such as for example, on said zone itself, outside said zone such as for example on the on-screen keypad of the invention, on any zone of text, on an edge of the screen, outside the screen, etc.

The system may be designed such that, the event interactions (e.g. motion events) such as tapping and/or gliding actions provided on/from said predefined zone as described above, is preferably first detected/captured by the data entry system before the application with before/instead of the application with which the data entry system is interacting.

It must be noted that the gliding actions may be of any type such as straight gliding actions, or they may have other arbitrary trajectories.

Different types of gliding actions my result in different types of movements of a pointer on the screen. For example:
1) A quick long gliding action may correspond to moving a pointer/caret for a predefined length (e.g. predefined number of character positions within a text).
2) A quick short gliding action may correspond to moving a pointer/caret one character positions within a text.
3) A slow long gliding action may correspond to moving a pointer/caret relative to the length of the gliding action. For example, such gliding action may move the cursor/caret a number of characters relative to the length of the gliding action and its direction (e.g. as for a computer touchpad mouse). According to one method, said relativity measure may be modified by the user if desired.
4) Any of the gliding actions 1, to 3, described above, may have it corresponding result regardless of the speed of the gliding action.
5) Any of the gliding actions of 1 to 3, described above, provided and ended without removing the finger from the screen may repeat the corresponding cursor movement, or may result in moving the cursor character by character in the text, preferably, after moving the corresponding cursor movement.
6) Other types of gliding actions may be considered by corresponding to different types of pointer/cursor/caret movements may be considered by people skilled in the art.

Any type of gliding action followed by a holding action may repeat the corresponding pointer/caret movement until a predefined interaction such as removing the finger from the screen. The types of gliding actions described above, and the corresponding movements, are preferably provided in a corresponding direction (e.g. as for a computer mouse touchpad).

It must be noted that a gliding action corresponding to moving a pointer may preferably begin outside the keys of a keypad of the invention. According to one method, it may end outside the keys or on a key.

According to one embodiment of the invention, when a cursor is next to/on a word, a predefined interaction such as a single tapping action, a long pressing action and/or a double tapping action anywhere on the screen or on a predefined zone (e.g. as described before) may select said word.

According to one embodiment of the invention, a press-and-holding action followed by a gliding action in a direction may correspond to selecting a corresponding portion of a text beginning from a cursor position in a corresponding direction.

According to one embodiment of the invention, after a cursor is attached to or is on a word, a predefined interaction such as a single-tapping and/or a double tapping action anywhere and/or on said predefined zone (e.g. on the screen) may select said word. Said word may be a single word or a chain of words.

It must be noted that the predefined gliding directions may be any direction such as upward, downwards, leftward, rightward, or any diagonal direction.

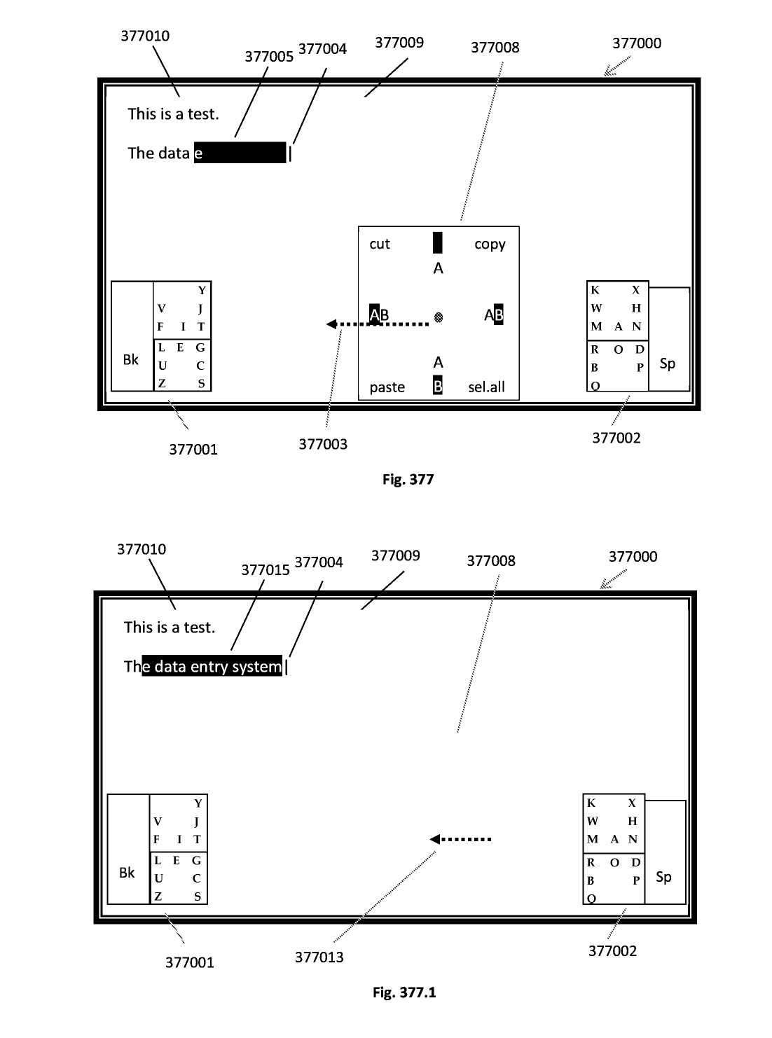

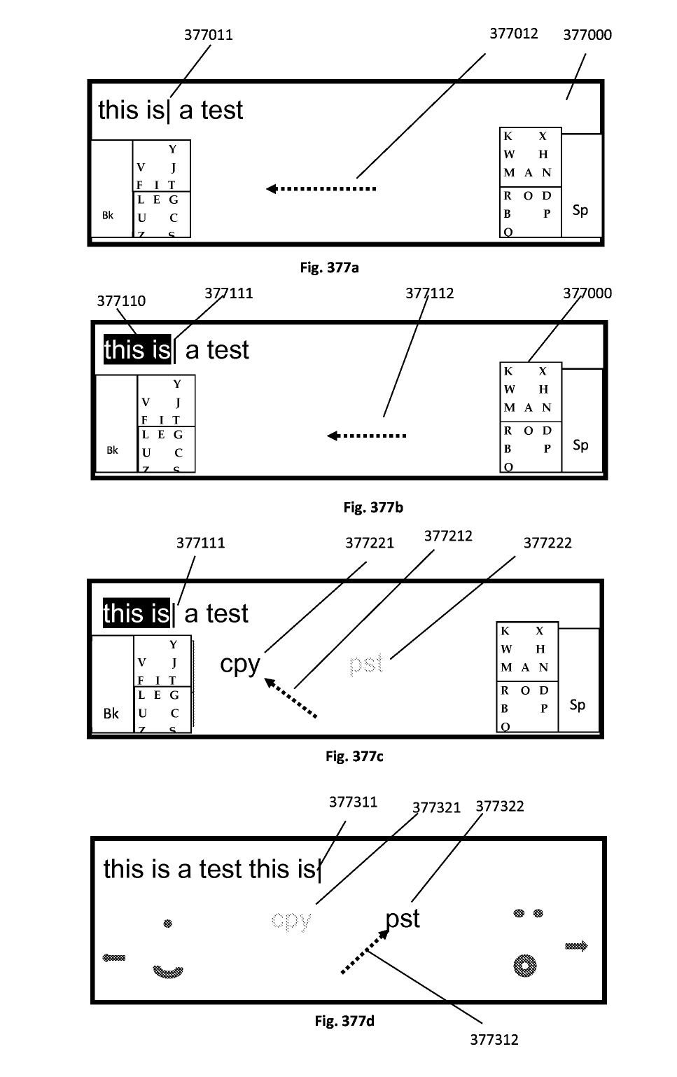

When a user provides a predefined interaction such as a long pressing action (i.e., a press and holding action for at least a predefined laps of time) preferably anywhere on the screen (e.g. preferably, outside the keypad of the invention), several (e.g. mouse function) choices may be presented to the user. Said choices may be presented in any type of format. According to one example they may be presented within a pop-up menu/list. According to another example, they may be presented on (e.g. or based on) a N-based matrix of keys such as a three-by-three matrix of keys (e.g. related to eight different gliding directions, and a tapping action corresponding to the center key of the said matrix of keys. This matter has been described many times during this and previous patent applications file by this inventor.). FIG. 377 shows as an example, a device 377000 having a touch screen 377009, wherein a text 377010 is printed on it. When a user provides a predefined interaction such as a long gliding action anywhere outside the keys on the screen, a three-by-three matrix of choices 377008 may be presented under the user's finger on the screen, such that preferably the touching point (e.g. impact) may be the center of said matrix of choices. According to a first method, a gliding action corresponding to one of the choices may be provided after removing the finger from the screen. According to another method (e.g. a preferred method) the gliding action may be provided after said long pressing action without removing the finger from the screen. In this example, after providing a long pressing action the gliding action, the user provided a gliding action 377003 towards left on the screen. This action corresponds to selecting a corresponding portion of the text 377005 before (e.g. on the left side, and eventually, upward, as for a corresponding regular computer mouse function) the cursor 377004 on the screen. According to one method, the length of the selected portion of the text corresponds to the length of the gliding action.

Different methods and/or scenarios for selecting the length of a portion of a text may be considered:
During the selection procedure, the user may change the direction of the gliding action, and the system may select an additional portion of the text (e.g. in this example, by changing the direction towards up (e.g. diagonally or vertically)), or to deselect a portion of the selected portion or to deselect the selected portion and selecting a portion on the right side of the cursor) (e.g. in this example, by changing the direction towards left or towards down (e.g. diagonally or vertically)). These functions may preferably duplicate/be-similar-to the functions of a computer mouse.
After selecting a portion of a text, the user may remove his finger from the screen, and long press again on the screen and provide another gliding action to select an additional portion of the text, or to deselect a portion of the selected portion.
   In the example of FIG. 377, when a user provides a long pressing action outside the keys on the screen several choices are presented around the user's finger touching point with the screen. Then:
Providing a gliding leftward and/or upward may correspond to selecting a portion of the text before the cursor.
Providing a gliding rightward and/or downward may correspond to selecting a portion of the text (e.g. if any) after the cursor.
Providing a gliding towards upper-left may correspond to cutting a selected portion of the text.
Providing a gliding towards upper-right may correspond to copying a selected portion of the text.
Providing a gliding towards lower-left may correspond to pasting a copied portion of the text
Providing a gliding towards lower-fight may correspond to selecting the whole text.
   The gliding portions provided s described above may preferably duplicate/be-similar-to the functions of a computer mouse.

If the system is in selecting (e.g. a portion of) text instance such as for example, if the user selects a portion of a text by long-pressing and providing a gliding action on the screen and removes his finger from the screen, then according to one method, the next gliding action on the screen to modify the portion selected (e.g. to enlarge selection of text or to reduce the selection of text) said gliding action may be provided without requiring a long pressing action (e.g. at its beginning).

As an example, after selecting the portion 377005 of text as shown in FIG. 377 and removing his finger from the screen, the user may provide another gliding action 377013 without providing a long pressing action as shown in FIG. 377.1 to select more text 377015 (e.g. to enlarge the selected portion 377005 of FIG. 377). In this example/method, although providing a gliding action without providing a long pressing action is assigned to moving a cursor/caret, because a portion of text 377005 was already selected (e.g. the system was in the text selecting instance/mode) providing a gliding action 377013 without providing a long pressing action (e.g. at its beginning) (e.g. in said instance) is related to enlarging the selected portion 377005 to select the portion 377015.

It must be noted that showing/displaying the choices on the screen may be optional. The user may activate or deactivate the presentation of such choices on the screen after the user provides the predefined interaction such as a long pressing action on the screen, For example, after a short amount time of practice, the user may not need to see the choices. In this case he may deactivate the presentation of choices. According to another method, after beginning a gliding action corresponding to one of the choices, the system may show said choice (e.g. by writing said choice, or by displaying a corresponding icon) on the screen.

An example of moving a cursor within a text, selecting a portion of a text, copying and pasting a selected portion of a text is described hereafter. As an example, in FIG. 377a, a text is printed on the screen 377000 of a device and a cursor/caret is at the end of said text (not shown). At this time a user may provide a gliding action 377012 from left to right on the screen between the split keys of the system, and the system may move the cursor 377011 within the text accordingly. Then, as shown in FIG. 377b, the user may provide a predefined type of interaction such as long pressing on the screen (e.g. between the split keys) and provide the gliding action 377112. This may result in selecting the portion 377110 that begins from the position of the cursor 377111 towards left accordingly. Now, as shown in FIG. 377c, the user may long press preferably anywhere on (e.g. a zone of) the screen and the system may show several options around the user's finger (e.g. preferably, based on a three-by-three matrix of choices. A (e.g. three by three) matrix of choices has already been described in different patent applications filed by this inventor). In this example, one of the choices is the “copy” function 377221. The user may provide an appropriate gliding action 377212, and the system may copy the portion 377111, accordingly. The, the user may move the cursor to a desired location within the text by for example, providing a gliding action as described before. In this example, the user moves the finger to the end of the text (e.g. not shown). Then, as shown in FIG. 377d, the user may provide a long pressing action preferably anywhere on (e.g. a zone of) the screen and the system may show several options around the user's finger (e.g. preferably, based on a three-by-three matrix of choices. A (e.g. three by three matrix of choices has already been described in different patent applications filed by this inventor). In this example, one of the choices is the “paste” function 377322. The user may provide an appropriate gliding action 377312, and the system may paste the copied portion 377111 at the cursor position, accordingly. Now, the cursor 377311 will/may be located at the end of the pasted portion.

Note that in FIG. 377d, the split keypad of the invention is in its invisible mode. Therefore, at least the text under the invisible keys may be visible to the user but may not be accessible to the user for manipulation. By using the method of moving the cursor/pointer/caret as described, and by using the methods of selecting, copying, pasting, etc., the text under the keys (e.g. invisible, visible) or under any other object on the screen may be accessible and manipulatable.

In the examples above, a first type of interaction such as a gliding action without requiring a long pressing action (e.g. before the gliding action) has been described to relating to moving a pointer/cursor/caret, and a second type of interaction such as a gliding action requiring a long pressing action (e.g. before the gliding action) has been described to relating to a function such as a selecting, copying, pasting, etc. It must be noted that said types of interactions and the corresponding functions shown as such have been used to describe the principles of providing mouse functions on the screen of a device. Other types of interactions and other types of functions may be used with the same principles by people skilled in the art.

According to one method, duplicating/providing the mouse functions as described above may be provided at any moment. According to another method, duplicating/providing the mouse functions as described above may not be provided during the entry of a word. In this case, providing the interactions outside the keypad of the invention on the screen may be assigned to (e.g. other) functions such as for example, moving a cursor/character-selector within a current word, etc.

According to one embodiment of the invention, a predefined interaction may correspond to cancelling (e.g. an “undo” function relating to) at least one of the last interactions and the corresponding provided instances/functions (e.g. cut, paste, etc.). As an example, said interaction may be a long pressing action outside the keypad of the invention on the screen and removing the finger from the screen without providing a gliding action. According to another method, said predefined interaction may be a gliding action from a key such as the space key towards a predefined direction such as towards left. Etc.

It must be noted that after providing a long pressing action, instead of or in addition to the gliding actions, the user may tap on choices (e.g. in form of a three by three matrix of choices) printed on the screen.

According to one method, the principles described above may be used on a none touch sensitive screen. For example, a screen of the device may be covered by a transparent sensitive pad. According to another method, said interactions may be provided in the air, and a movement detection means implemented in the device or outside it may detect user's finger movements in the air.

It must be noted that the principles, embodiments, and examples of editing functions generated by motion events (e.g. tapping/gliding actions) duplicating mouse functionalities (e.g. moving a pointer/cursor, selecting, copying, pasting, etc.) described above may be applied to any type of text editor and/or application using a text/data entry system regardless of said text/data input entry system.

According to one embodiment of the invention, the principles of interactions corresponding to the mouse functionalities (e.g. motion events) and/or corresponding other editing functionalities (e.g. copy, paste, etc.) functions described above may be used to create customized mouse functionalities within a specific application. According to another embodiment, events relating to moving a mouse (e.g. tapping or gliding actions provided/beginning-from outside the keys of the keypad of the invention) and other events corresponding to other mouse functionalities (e.g. long pressing actions and/or the corresponding gliding actions, etc., provided/beginning-from outside the keys of the keypad of the invention) as described above, may be captured-by/intercepted (e.g. or transmitted to) the operating system and/or sent/transmitted (e.g. in any transformed form) to a corresponding application to perform corresponding native mouse functionalities by and/or of said corresponding application.

It must be noted that the types of interactions such as tapping or gliding actions described throughout this application regarding the movements of pointer/caret/cursor, may apply to, moving a cursor, selecting/deselecting text, selecting/deselecting characters within the current word, etc.

It must be noted that according to one embodiment, the predefined zone described to be used for movements of the mouse and the like, may preferably include substantially all of the surface of the screen preferably, except the zone to dedicated to the on-screen keyboard/keypad.

It must be noted that although in different paragraphs of the specifications and drawings of this invention, any of the pointing means such as, Pointer, Cursor, or Caret, may have been used separately (e.g. not all of the pointing means have been mentioned together) to described the principles of the corresponding invention, obviously, said inventions described may be applied to any of the pointing means.

According to one embodiment of the invention, predefined interactions such as predefined types of gliding actions provided from anywhere (e.g. preferably outside the keypad) preferably in four directions on the screen as described above may correspond to emulate the functions of the (e.g. four) arrows of a PC keyboard on the corresponding screen.

According to one embodiment of the invention a predefined number of consecutive space characters may interrupt the contextual (e.g. N-gram, wherein N>1) consideration/aspect (e.g. linguistic rule) by the system for predicting/entering a next word (e.g. the system may look for a word in a 1-gram database). Said predefined number of spaces may be preferably more than one such as preferably two, or three, consecutive space characters.

As mentioned in different patent applications filed by this inventor, an interaction such as a pressing action on a key may correspond to any of several characters of a group of characters assigned to said key. In order to enter a precise character, the user may use an additional input information such as speaking one of said characters which may help the system to precisely identify a corresponding character (e.g. letter).

In some cases speaking one of said letters may be confusing for the speech recognition system because some characters such as the pair of letters “b” and “p” which may be on a same key, and the pair of letters “m” and “n”, which also may belong to a same key, may have resembling speech. According to one embodiment of the invention, in this case the system may consider said (e.g. both) characters and by using linguistic rules the system may provide the right suggestion/prediction.

As an example, by considering the split keypad of the invention as shown in FIG. 377a, if the user has entered the word “diamond”, and then provides the input information corresponding to the word “mine”, the system may propose the word “king” (e.g. in this case the 2-gram “diamond mine” does not yet exists in the database entry). Now the user may enter the system into the correction procedure through speech, and may say “m” (e.g. the first letter of the word “mine” The speech recognition system may hesitate between the letters “n” and “m”, because they have ambiguously similar utterance/sound. The system then may consider the previously entered word “diamond”, and find a corresponding entry “diamond mine” for the combined input information provided by the user, and therefore propose the word “mine” (e.g. The system does not consider the word “nine”, because the 2-gram “diamond nine” may most probably not exist in the database).

According to one embodiment of the invention, after the system predicts a word and the user enters said word by confirming it, the system may also consider the previous word and preferably adds an N-gram (e.g. a 2-gram) entry to the corresponding N-gram database if the database does not include such N-gram entry. According to one method, if the user moves the cursor back and modifies said predicted word, the system preferably delete said added N-gram word from the database, and preferably adds a new N-gram word (e.g. if any) in the corresponding database, if the database does not include such N-gram entry.

A method of using a matrix of choices and switching to use a word database of a different database such as a database of words of a different language to be used by the system has been described before by this inventor. According to one embodiment of the invention, after a user provides a predefined interaction such as a gliding action in a predefined direction, the system may present/print (e.g. on the screen) different databases (e.g. different word databases in different languages, or different databases for different contexts such for example different databases corresponding to different professions, or corresponding to different vocabularies, etc.). The user then may select one of the choices by either tapping on a choice or by providing a corresponding gliding action. According to one embodiment of the invention, if the user does not select any of those choices, and for example provides an interaction not relating to selecting one of the choices, then the system automatically (e.g. by default) selects one of said choices. According to one method, said choice may be the database that was used before the last used database. According to another method, the automatically selected choice may be the one defined by the user originally (e.g. through setting of the system), or defined by a supplier of the supplier of the data entry system.

It must be noted, that in any of the embodiments described throughout this application, instead of or in addition to providing/presenting the output on the screen, a text to speech system may be used with the data entry system of the invention to present the output to the user.

According to one embodiment of the invention, a predefined interaction such as for example a gliding action provided on/from a key in a predefined direction may correspond to a procedure informing the system that all of the words to be entered after said interaction their first characters will/should be capitalized (e.g. when presented/printed until an information relating to ending/cancelling said procedure is received by the system. Said information may be providing said predefined interaction one more time. This is beneficial in some cases such as when entering titles within a text. Because such words are preferably capitalized at the printing stage, they may not be added/entered as capitalized words in the corresponding database(s). In the current embodiment, some words (e.g. “of”, “the”, etc.) may be excluded from this rule when they are not at the beginning of a sentence. They may be included in a list.

In different paragraphs of this and previous patent applications filed by this inventor, the input information provided by a user may have been described to correspond to a current word being entered to predict a word from a database. It must be noted again that if the system is using an N-gram database wherein N>1, then said input information may be a combined input information including the input information provided by the user relating to the current word and the input information corresponding at least one of, the (e.g. last) previous word, one of the (e.g. last) previous special characters, the location of the word within the text, etc., as described in detail previously.

It must be noted that in the embodiments and examples used for describing some of the principles of the data entry system of the invention, selecting a word from a corresponding database may be considered to refer to any type of database such as a 1-gram database, or an N-gram database (e.g. a 2-gram database). If the corresponding database is an N-gram wherein N>1, then, the N-gram entries of the database corresponding to the input information provided by the user may be those that their Nth gram correspond to the information relating to a current word being entered, and their other grams is similar to a predefined number of corresponding previous words relating to the current word being entered.

Embodiment and methods for attaching words to each other have been described before. According to one embodiment of the invention, during the entry of a chain of one or more character such as a word, a predefined interaction such as a gliding action provided from/on a predefined zone/key may correspond to confirming (e.g. and entering) the corresponding current predicted word (e.g. hereafter referred to as “the first word”) without providing a space character at the end of said first word. Then, if the user confirms and enters another group of one or more character(s) such as another word (e.g. hereafter referred to as “the second word”), the system attaches said first and second word without having a space character between them. This procedure mat be repeated several times attaching several words and/or chains of one or more characters, At the end of the entry of such attached words and/or chain of one or more characters (e.g. by providing an end-of-the-word signal such as for example pressing the space key, the “enter” function, etc.) several scenarios may be considered such as those described below:

1^{st} scenario) The system adds the entire attached words as a single word/gram to the corresponding one or more databases (e.g. 1 gram, and/or N/2 gram database(s)).

2^{nd} scenario The user provides a predefined interaction such as a tapping action on the/a predefined zone/key and the system selects said entire attached word(s) and/or chain of character(s) as a/the current predicted word, and the user may provide a predefined interaction to inform the system to add said current predicted word to the corresponding one or more database(s). Preferably, when said chain of current predicted word will have an indicating means such as a red frame to inform the user that said current predicted word is not a word of the database.

In the embodiments described regarding interactions such as providing gliding/tapping actions relating to mouse functions, according to one embodiment of the invention, at least some of said interactions may be provided anywhere on/from one or more predefined zone outside the corresponding (e.g. on-screen) keypad/keyboard or on one or more zones/keys of the corresponding (e.g. on-screen) keypad/keyboard.

As mentioned before, the word completion feature of the system may preferably be activated after the system receives the input information corresponding to at least a minimum number (e.g. preferably, a number between two to seven) of characters preferably depending of type of word database (e.g. 1-gram, 2-gram, etc.). If the system is using an N-gram database wherein N>1, then, said received input information may be an input information including the input information provided by the user relating to the current word and the input information corresponding at least one of, the (e.g. last) previous word, one of the (e.g. last) previous special characters, the location of the word within the text, etc. On the other hand, if the system is using a 1-gram database, then said received input information may be the input information provided by the user corresponding/relating to (e.g. preferably only) the current word being entered. These matters have been described before.

According to one embodiment of the invention, after receiving the input information (e.g. by adding/appending a (e.g. an ambiguous) character) corresponding to a desired word the system may first predict a word corresponding to the length of the received input information by the system (e.g. hereafter may be referred to as the “current predicted word”), and in addition, if the received input information corresponds to at least said minimum number of character, then the system also predicts predicts/presents (e.g. at least) one corresponding longer chain of characters/word (e.g. hereafter may be referred to as the “longer predicted word”) wherein its beginning characters corresponds to the received input information.

After presenting said word(s), if the user provides a Rejection action (e.g. described in detail before), then, the system may replace the current predicted word by a new current predicted word corresponding to the input information provided until then, and preferably having the second highest priority. According one method, if the (e.g. potion of) received input information corresponding to the current (e.g. predicted) word being entered is less than a predefined number of characters (e.g. one of the numbers, two to four) (e.g. hereafter may be referred to as “minimum number of characters condition”), then, the system may also replace the longer predicted word by an additional corresponding new word wherein its number of characters is equal to the number of characters of the current predicted word, and preferably having the third highest priority. According to one method, in order to confirm/enter said word (e.g. that replaces the longer predicted word), the user may provide a predefined interaction such as the one that may have been used for entering/selecting the replace longer word (e.g. a gliding action downward on/from the space key 377006).

According to one method, in addition to the minimum number of characters condition just described, other conditions such as requirement of a minimum rate of frequency of use may be required a new predicted word preferably by replacing the longer predicted word. According to one method, the procedure described here may preferably be applied during the entry of the first word of a sentence. According to another method, the procedure just described may preferably be applied during the entry of a word anywhere in a sentence.

As an example, by considering the keypad of FIG. 377, if the user presses the keys 377002, and 377003, the system may predict the word “he” as the current predicted word, and a longer word “all”. At this time if the user provides a rejection action (e.g. by providing a gliding action towards left from the key 377006), the system may replace the word “he” by a new current predicted word “we”. The input information provided by the user until now corresponds to a word of two characters as a current predicted word. Supposing that the minimum number of characters condition is four characters, then the system may also present an additional new word, in this example, the word “as” having the same length as the current predicted word, preferably replacing the longer predicted word.

It must be noted that other types of presenting a current predicted word(s) and longer word(s) may be considered. For example, before rejection procedure, more than one current predicted words may be presented to the user. According to another example, after presenting a longer word before a rejection action is provided by the user, if the user provides a rejection action, the system may present another longer word corresponding to the input information provided by the user. Etc.

According to one embodiment of the invention, there may the system may not include/consider a minimum number of characters condition and for example, after rejecting a current proposed word by the system, and based on the input information provided until then, the system may propose additional one or more words as new current predicted word(s), preferably two other words preferably replacing the current predicted word and the longer predicted word. According to one method, if the user proceeds to correction procedure and the system identifies a character of the current predicted word, according to one method, the system may propose at least one additional corresponding word, preferably two words preferably replacing the current word, replacing the new current predicted word(s). And so on.

As mentioned before, different methods of controlling a current predicted word, such as for example, selecting, fixing (e.g. considering/blocking as precise), correcting (e.g. “undo” function), etc., of at least one of the characters of the current predicted word have been described before (e.g., by using an In-Word selection means/pointer). Some of said methods such as fixing at least one of the characters of a current predicted word, or, cancelling a corrected character, were described to be activated by interacting with a key such as the space and/or backspace key of the keypad. According to one embodiment of the invention, controlling a current predicted word and/or its corresponding In Word selection means may be provided on/from anywhere on a zone, preferably, the zone of the screen outside the on-screen keypad of the system. According to one method, said zone may be the same zone used for moving the pointer on the screen as described earlier.

According to one embodiment of the invention, during the entry of a word, providing a first type of interaction such as for example, a gliding action in a (e.g. one or more) predefined direction on the screen, preferably outside the keys, may correspond to navigating a character selection means (e.g. the In-Word character selecting means) on the characters of the current predicted word in a such as a corresponding direction. As an example, said direction may be from left to right, and/or right to left, moving the character selecting means from left to right and/or from right to left (e.g. back and forth) on the characters of the corresponding word). Optionally, when the characters selection means reaches the last character of a word, if the user continues the corresponding gliding action and/or does not remove his finger from the screen while gliding, the system may select the first character (e.g. acts like within a loop), and so on. According to one method, when a character of the current predicted word is selected (e.g., either by the system or by the user), providing a predefined interaction such as a tapping action on said zone may fix the selected character. After fixing a character (e.g. the user can fixed more than one character of a current predicted word through this method), the system may predict another word corresponding to the received input information relating to the current predicted word including the fixed character(s).

In the current embodiment, according to one method, a second type of interaction such as providing a gliding action preceded by a long pressing action in a predefined direction may fix one or more characters of the current predicted word, depending-on/relating-to, for example, the length of the gliding action (e.g. the longer the gliding action, the more characters being be fixed), and/or depending on the speed of the gliding action, and/or depending on a laps of time of holding action at the end of a gliding action, etc.

Embodiments and methods of fixing one or more characters of a current word by providing predefined interactions such as tapping and/or gliding actions on a zone (e.g. preferably, outside the keypad) have been described before. According to one embodiment of the invention, said tapping and/or gliding action may require a long pressing action preferably before/at the beginning of providing said interaction (e.g. hereafter may be referred to as “long-press and gliding action”) A gliding action requiring. During the entry of a word, according to one method, a predefined interaction such as a long pressing action (e.g. instead of a tapping action) on the/a predefined zone may correspond to fixing a selected character of the current word. Accordingly, a press and holding action and providing a gliding action in, for example, the direction of the writing, may correspond to fixing more than one characters of the current word depending of the length of the gliding action, etc. Accordingly, a gliding action corresponding to the undo function may also require a long pressing action prior to providing the gliding action. Accordingly, providing a gliding action without providing a long pressing action at its beginning in a predefined direction such as in the direction of writing may correspond to navigating the character selection means (e.g. the In-word selection means) in the respective direction on the characters of the current word, and providing a gliding action without providing a long pressing action at its beginning in a predefined direction such as in the opposite direction of writing may correspond to navigating the character selection means (e.g. the In-word selection means) in the respective direction on the characters of the current word.

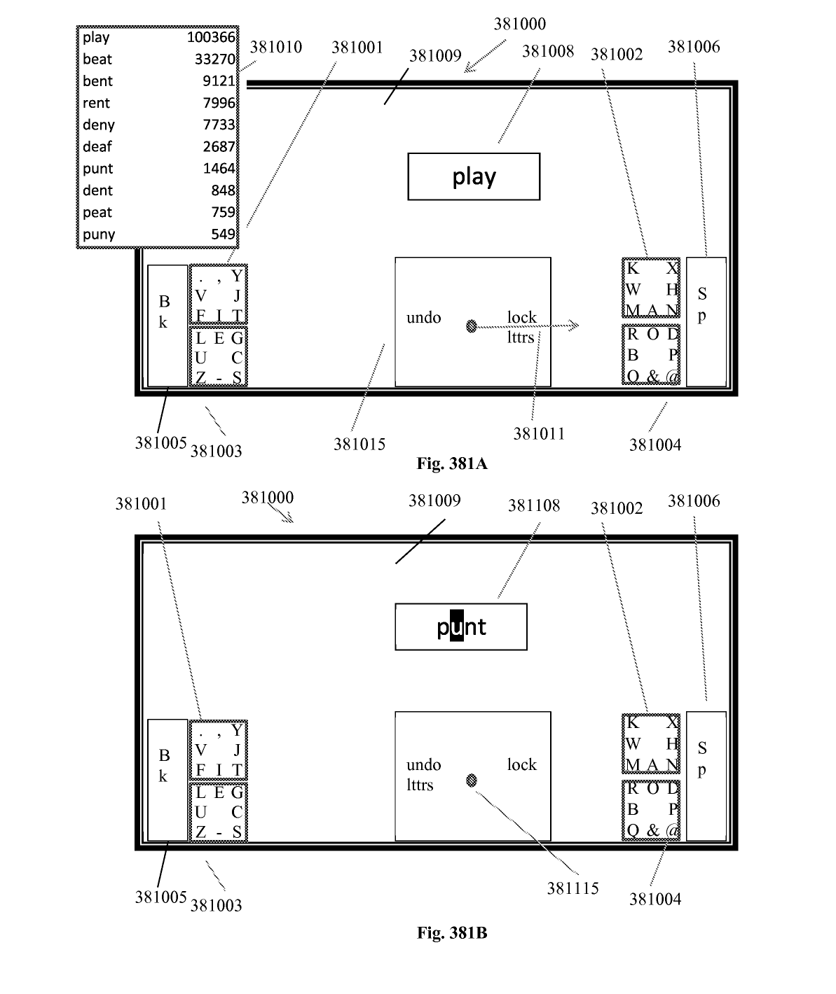

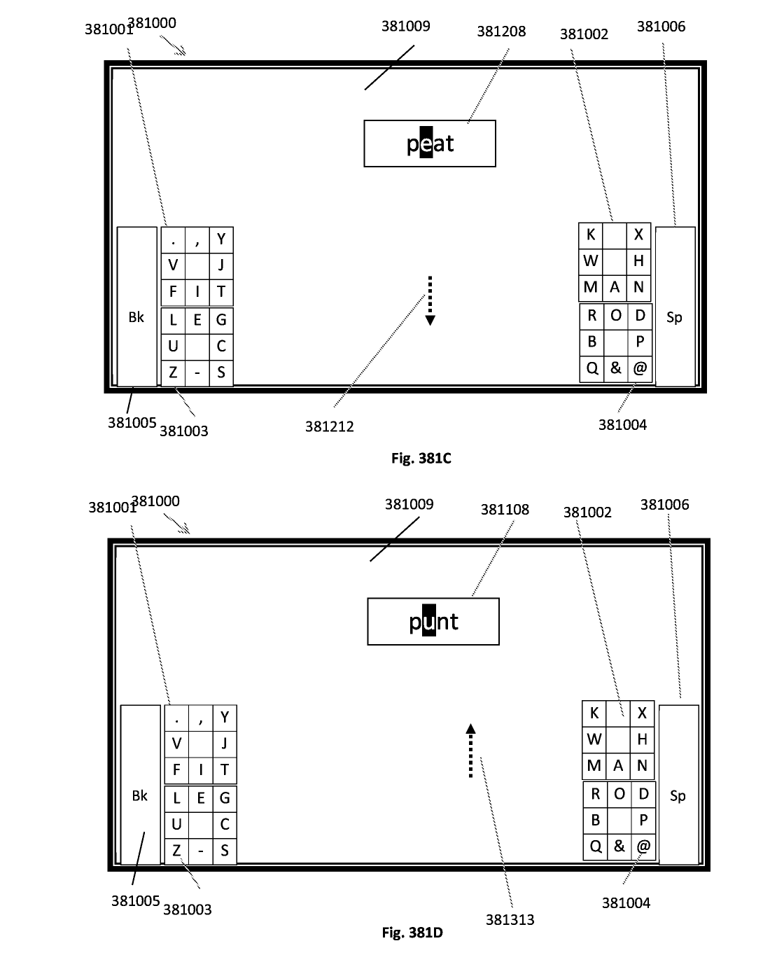

Embodiment and methods of providing one or more precise character during the entry of a word (e.g. through insertion and/or correction procedure (e.g. fixing a proposed ambiguous character/letter (e.g. before and/or after a rejection action), replacing an undesired ambiguous character by an identified character (e.g. before and/or after a rejection action), etc.) of the invention has been described before. FIG. 381A shows as an example, a portion 381010 of a (e.g. 1-gram database, or the 2^{nd} gram of entries of a 2-gram database having the same first gram) used by the system, and using a split on-screen keypad of the invention. In this example, after providing the ambiguous tapping actions 381004, 381003, 381002, and 381001, the system may propose the word “play” 381008. At this time, if the user long-presses anywhere on the screen and provides a long gliding action 381011, depending on the length of the gliding action, the system may fix one or more (e.g. in this example, all) of the characters of the current predicted word 381008. As shown, optionally, when providing the long pressing action, the system may show under the user's finger an indicator/icon 381015 showing functions accessible by providing girding actions in different corresponding direction, and wherein preferably the center of said indicator being at the user's finger's pressing point 381011.

With continuous description of the current example, according to another example, after providing the ambiguous tapping actions 381004, 381003, 381002, and 381001, the system may propose the word “play” 381008. At this time, as shown in FIG. 381B, if the user provides a long-pressing action anywhere (e.g. in this example, on position 381115 on the screen) and removes his finger from the screen, the system may fix the selected/highlighted character “p” of the predicted word “play” (e.g. not shown) and propose another word “punt” 381108 corresponding to the combined input information provided until then, and preferably having the next highest priority in the corresponding entries of the database 381010.

According to one embodiment of the invention, after presenting a current predicted word to a user, a predefined interaction such as gliding action (e.g. not requiring a long pressing action at its beginning, hereafter may be referred to as “simple gliding action”) provided by a user in a predefined direction such as downward on a zone described previously may inform the system to present to the user another word of the database corresponding of the input information provided by the user until then. Preferably, said another word is the word having the next highest priority in the corresponding entries. This procedure may be repeated several times until the system predicts/presents the desired word. According to one method, another type of interaction such as a gliding action provided as such in the opposite direction (e.g. towards up) may reverse/undo the presentation of the predicted/presented words (e.g. showing the words already presented to the user in the opposite order). As an example, after the system presented the word “punt” as described in FIG. 381B, if the user provides a simple gliding action 381212 downward, the system may propose the word “peat” 381208 corresponding to the combined input information provided until then and having the next highest priority. Providing a next simple gliding action (not shown) may result in presenting the word “puny”. And so on.

Accordingly, providing the gliding actions in the opposite direction (e.g. upwards) on the zone may preferably inform the system to navigate backwards within the words that were presented. As an example, after presenting the word “peat”, as shown in FIG. 381D, a gliding action 381313 provided upward on the zone may result in representing the previously presented word “punt” 381108. This procedure may be repeated if necessary. Accordingly, according to one method, at any moment, providing an undo function by for example providing a long press and gliding action on any location of the zone may result in presenting the previous word presented before providing the downward and/or upward gliding actions just described. In this example, providing the undo function at any moment (e.g. when any of the words “punt”, “peat”, “puny”, is presented to the user), may preferably result in presenting the word “play” to the user.

According to one embodiment of the invention, when the system predicts a word (e.g. of a current predicted word) based on an input information including at least one identified/precise character, then the system may propose a corresponding word of the database regardless of the accent of said at least one identified character.

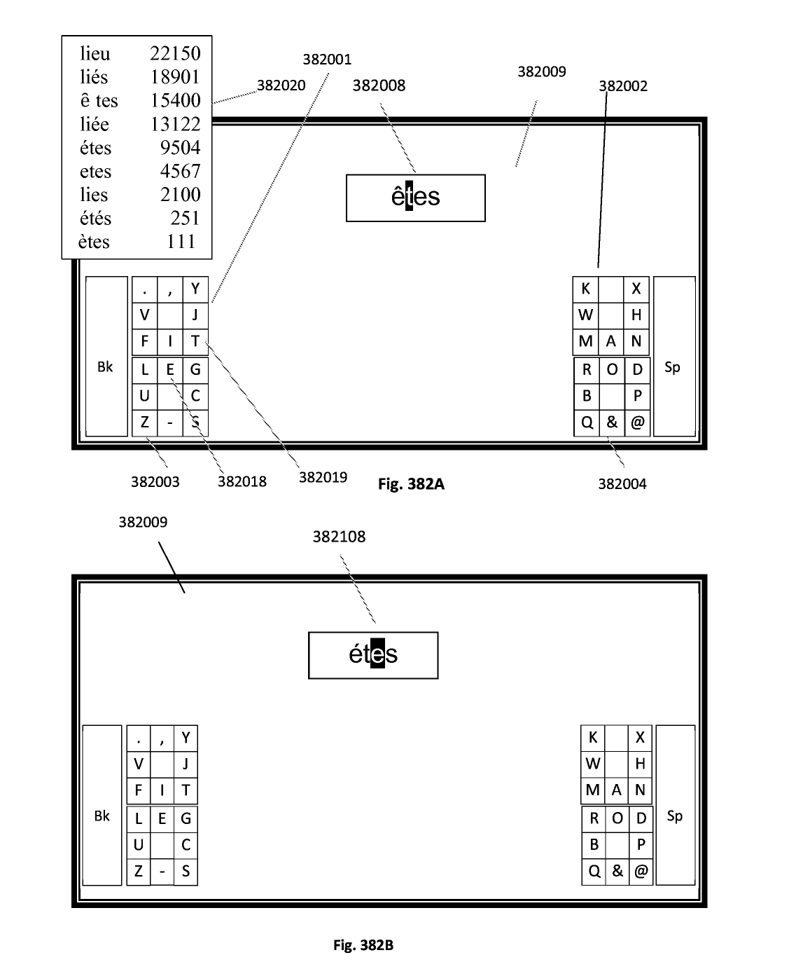

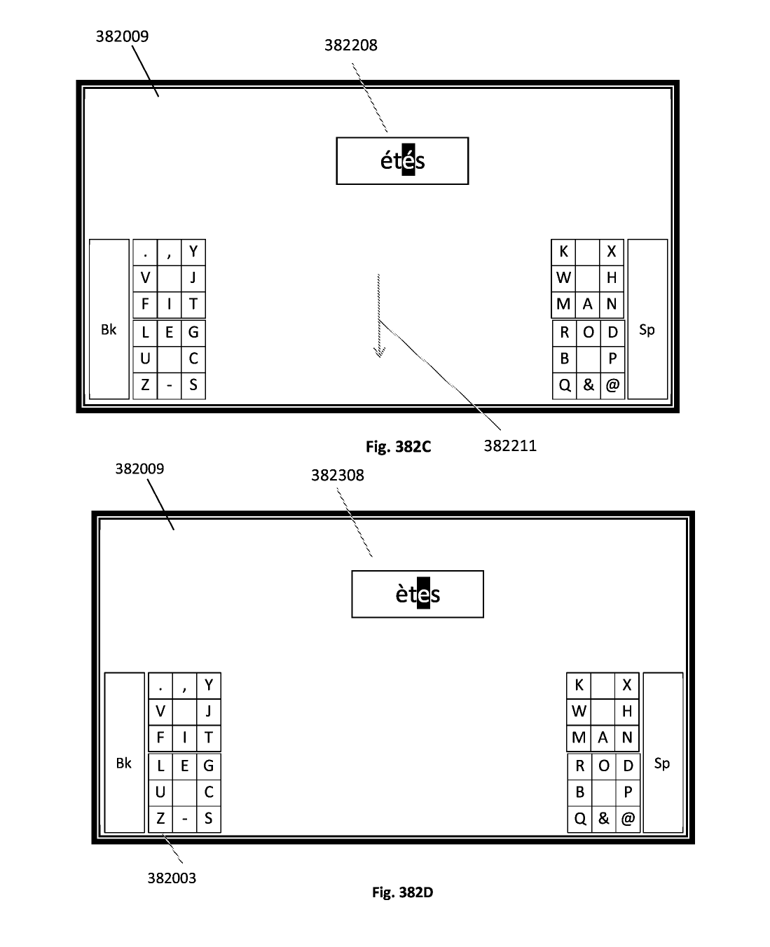

As an example, by considering the portion 382020 of a French database uses by the system as shown in FIG. 382A, if the user taps on the keys 382003, 382001, 382003, and 382003, the system may predict the word “lieu”. Now, if the user rejects said word, the system may predict the word “liés”. Now, if the user proceeds to the correction procedure and for example taps on the key 382018 of the keypad of the invention in precise mode to replace the first ambiguous/selected/highlighted character “1” of the current predicted word by the precise letter “e”, the system may consider any of the characters of the relating accented characters family corresponding to the letter “e” and predicts/proposes the word “êtes” 382008 as shown in FIG. 382A and selects/highlights its next/second ambiguous letter “t”. Now, as an example, if the user fixes the letter “t” by for example, either tapping on the key 382019 or by providing a long pressing action on preferably anywhere outside the keys of the keypad, then as shown in FIG. 382B, the system may propose the word “ét s” 382108 and selects/highlights the next letter (e.g the third letter). At this time as an example, if a user fixes the selected/highlighted letter of the current predicted word 382108, the system may predict another relating the input information regardless of the accent of the precise/identified characters. In this example said word is the word “etes”.

According to one embodiment of the invention, after predicting/presenting a word, a predefined interaction such as a tapping and/or a simple gliding action in a predefined direction, on a zone as described previously, may correspond to predicting another word of the database corresponding to the input information provided by the user regardless of the accent of the precise character(s).

In the above mentioned example, as an example, after predicting the word “etes”, if the user provides a simple gliding action downwards anywhere on the zone outside the keys, then as shown in FIG. 382C, the system may propose the next word “étés” of the database 382020 corresponding to the input information provided by the user. In this according to a preferred method, because the user has not provided any additional identified character, the highlighted character is in the same position as the previous predicted word. At this time, providing another gliding action downward 382211 on a/the zone as described above may result in predicting/presenting, by the system, a new word “étes” 382308 as shown in FIG. 382D, corresponding to the input information provided by the user. This procedure may be repeated, and each time the system may predict/propose another word as described above.

According to one method, providing another interaction such as one or more simple gliding actions in the opposite direction (e.g. upwards) on the zone may preferably inform the system to present in the opposite order one or more corresponding words of the database.

According to one embodiment of the invention, when a word is presented/predicted to a user and a selected/highlighted character of said word is not a desired accented character but both belong to a same family of accented characters, providing a predefined interaction such as a long-pressing action on the screen may result in making available the accented characters of said family to the user (e.g. presenting the accented characters on the screen). According to one method, at this time the user may select the desired accented character as an identified character of a word being entered, and preferably the system may propose another word corresponding to the input information provided until then.

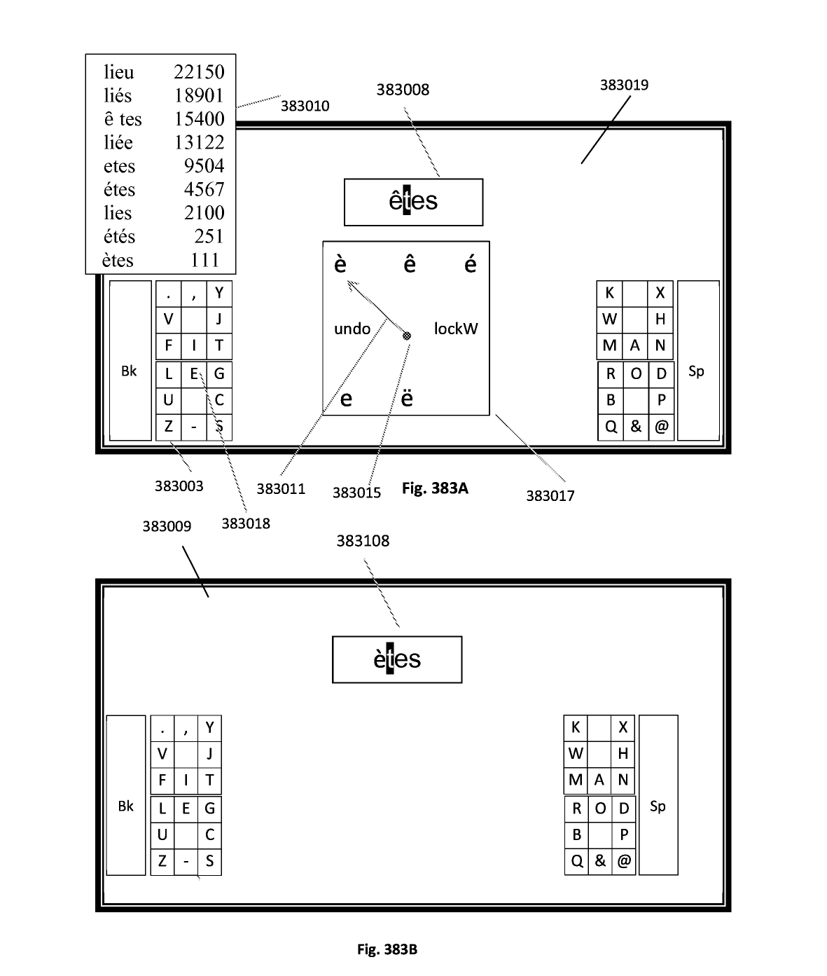

As an example, by considering the portion 383010 of a French database used by the system as shown in FIG. 383A, if the user taps on the keys 382003, 382001, 382003, and 382003, the system may predict the word “lieu”. At this time if a user rejects the predicted word, the system may propose another word corresponding to the input information provided by the user, and having the next highest priority in the word list of the portion of the database 383010. At this time, Now, if the user proceeds to the correction procedure and for example taps on the key 383018 of the keypad of the invention in precise mode to replace the first ambiguous/selected/highlighted character “l” of the current predicted word by the precise letter “e”, the system may consider any of the characters of the relating accented characters family corresponding to the letter “e” and predicts/proposes the word “ētes” 383008 as shown in FIG. 383A and selects/highlights its next/second ambiguous letter “t”.

As shown, the second character of said predicted word 383008 is selected/highlighted. At this time, as an example, if the user provides a predefined interaction such as a long pressing action anywhere (e.g. for example, long presses on the position 383015) on a zone of the screen as described earlier, the system may present at least some of the accented characters (e.g. or the accents) of the accented family corresponding to the last precise character (e.g. of the predicted word) identified by the system (e.g. the first character “ê” of the current predicted word 383008), preferably on an indicating means 383017, preferably under and/or around the user's finger impact 383015 with the screen. The user then may provide a gliding action 383011 towards the desired (e.g. accented) character “é”. Then, as shown in FIG. 383B, the system may predict/present another word “é es” 383108 corresponding to the input information provided until then.

Note that the indicator means may include other symbols/functions. As an example, the indicator means 383017 includes indication means for “undo” and “lock word” functions (e.g. corresponding to direction of corresponding gliding actions from the touching point 383015 on the screen), as described before in detail.

Note that, in the example of FIG. 383A as was shown above, after presenting the word “êtes” 383008, if the user proceeds to correcting a letter of the current word, by interacting with a key of the keypad, then, said correction is preferably related to the selected highlighted character “t” of the predicted word “êtes” 383008.

Note that in the embodiments and examples above, the order of presenting/predicting a word to the user is preferably based on frequency of uses/priorities of their respective words.

It must be noted that the user may enter any accented character precisely by entering precisely the mother base character, and replacing it by an accented character as described above. This way, a word not existing in the database and having accented characters may be entered.

According to one embodiment, if an accented character of a word is selected/highlighted, providing a long pressing action and removing the finger from the screen may fix said accented character as is.

According to one embodiment, each time the user précises a character, more then one corresponding word is predicted/presented to the user.

According to one embodiment of the invention, interactions such as gliding/tapping actions relating to functions such as customized function (e.g. mouse motion, undo, entering accented characters, etc.) of the data entry system of the invention may be provided anywhere on the screen, preferably outside the keys of the keypad of the invention (e.g. in this application may have been referred to as “a/the (predefined) zone”). For such purpose, preferably, a method of capturing events by the data entry system of the invention (e.g. instead of/before being captured by the application with which the data entry system of the invention is interacting) may be implemented. As an example, a virtual and/or hard invisible/transparent surface (e.g. an object) covering (e.g. e.g. if said surface is a soft surface it has the focus of the operating system) at least a portion (e.g. or all) of the corresponding screen may be implemented on said screen. Said surface preferably may be sensitive to user's interactions (e.g. touch sensitive). According to one embodiment of the invention, said surface may also be used to provide messages such as advertisement on it. Said advertising messages may be of any kind such as messages including audio and video. The messages may have a degree of transparency. Accordingly, said surface may be used to duplicate at least a portion of the (e.g. original) content shown on the screen below said surface. This way navigating within the original content of the screen may be duplicated by interacting with said covering surface.

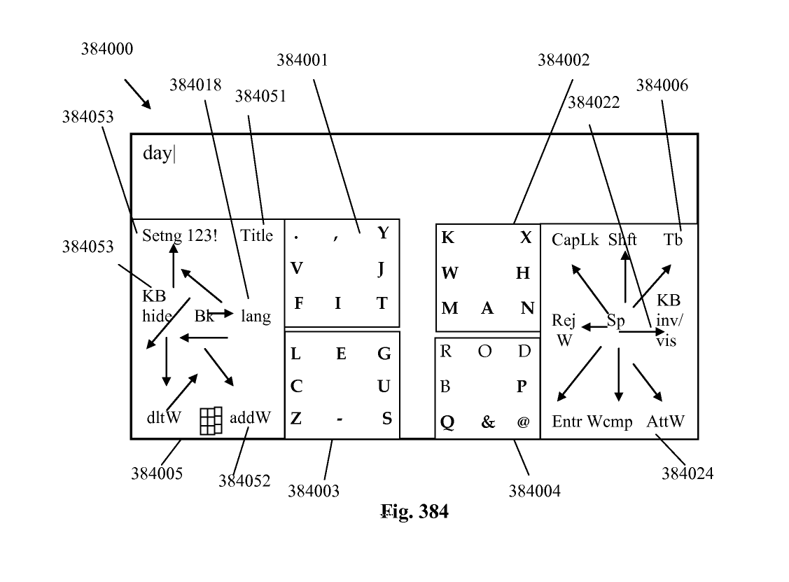

FIG. 384 shows another example of configuration/location of functions on the keys 384005, 384006, of the keypad of the invention.

According to one embodiment of the invention, at least for the esthetical reasons, preferably the backspace key (e.g. 384005) and the space key (e.g. 384006) of the system may have at least a degree of transparency.

It must be noted that in the embodiments and examples used for describing some of the principles of the data entry system of the invention, selecting a word from a corresponding database may be considered to refer to any type of database such as a 1-gram database, or an N-gram database (e.g. a 2-gram database). If the corresponding database is an N-gram wherein N>1, then, the N-gram entries of the database corresponding to the input information provided by the user may be those that their Nth gram correspond to the information relating to a current word being entered, and their other grams is similar to a predefined number of corresponding previous words relating to the current word being entered.

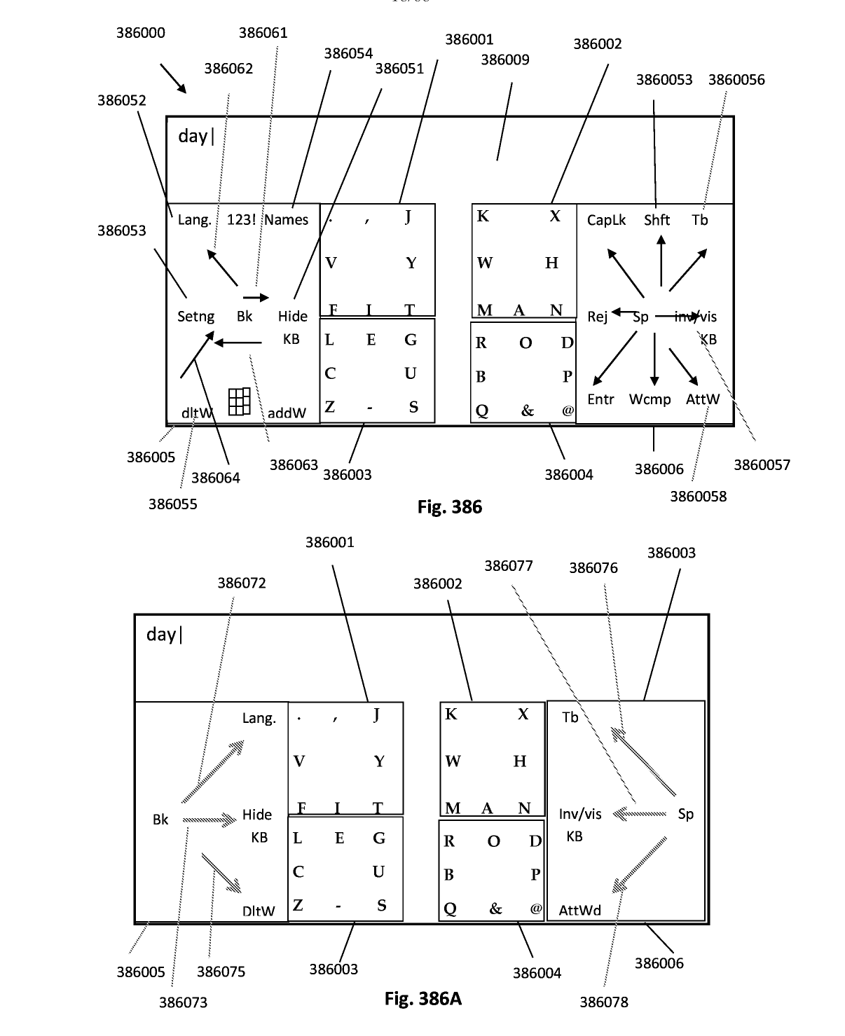

FIG. 386 shows another example of arrangement of functions on the keys 386005. In this example, said keys and their functions resemble to those described in FIG. 384 with the difference that functions 386051, 3860052, and 386053, are repositioned on said key 386005, and therefore their corresponding gliding directions (e.g. respectively, 386061, 386062, 386063) on/from said key 386005 are also modified. Also in this example, the location between the letters “J” and “Y” on the key 386001 are swapped.

In this example, activating the function “Names” is activated after a gliding action 386064 is provided. According to one embodiment, said function may inform the system to search the words having at least one capitalized letter in the corresponding database entries based on the input information corresponding to a word being entered.

According to one embodiment of the invention, some functions may be assigned to a first type of interaction (e.g. simple gliding actions in predefined directions on/from keys) with a keys such as a space key and/or back space key, and some (e.g. other) functions may be assigned to a second type of interaction (e.g. a long-press and gliding action in predefined directions on/from keys) with said keys. As an example, some of the functions assigned to the first type of interactions with (e.g. simple gliding actions on/from) the space 383006 key and backspace key 386005 of FIG. 386 may be assigned to different type of interactions with (e.g. pressing-and-holding-and-gliding actions on/from) said keys. In the example of FIG. 386A, some of functions (e.g. 383052, 386053, 386055, on the backspace key 386005, and 383056, 386057, 386058, on the space key 386006) are assigned to press-and-holding said keys and providing corresponding gliding actions (e.g. respectively, 386072, 386073, 386075 (on the backspace key), 386076, 386077, 386078 (on the backspace key).

According to one embodiment of the invention, when a symbol such as a single character, a stem (e.g. beginning of a word, etc.), a word, etc., (e.g. hereafter may be referred to as “the original symbol”) is being entered/selected/presented, providing a predefined interaction such as long pressing action on a/zone (e.g. preferably outside the keys) may result in presenting (e.g. on the screen) the related symbols of said original symbol to the user. According to one method, said related symbols may be presented to the user on at least some of the locations of a three-by-three matrix based zones as described before (e.g. preferably, the center of the matrix being under the user's finger touching the screen). Accordingly, then, a predefined interaction such as a gliding action in a predefined direction may select/enter a corresponding related symbol. Said related symbols may be symbols such, as for example, completed/related words of a stem/word (e.g. “understand”, “understanding, understood”, underestimate, etc., of the predicted/presented stem/word “under”) derivatives of a character (e.g. “com”, “net”, “org”, “0”, “00”, “000”, etc., relating “.”), currency symbols relating a selected/presented currency symbol (e.g. “£”, “ [symbol] ”, etc., relating to a selected/presented currency sign “$”), derivatives of a symbol (e.g. “gmail.com”, “yahoo.com”, etc., relating to the original symbol “@”), relating symbols of an emotional symbol, etc. It must be noted that in some cases such as for example selecting/entering a derivative of a stem, the original symbol may be excluded from the derivative, wherein in some other cases such as currency symbols, the original symbol may be excluded.

As an example, as shown in FIG. 387A, after predicting the word “under” 387008 by the system (e.g. based on a user's interaction), if the user long-presses the anywhere on the screen, the system may show different choices of words 387009 relating to the word predicted 387008 (e.g. in this example, words beginning with the current predicted word 387008). At this time, the user may provide a gliding action 387007 in the direction of the desired word “understood” to select/enter said word.

Also, as an example, as shown in FIG. 387B, after presenting the character “.” 387108 by the system (e.g. based on a user's interaction), if the user long-presses the anywhere on the screen, the system may show different choices of words 387109 relating to said presented character. At this time, the user may provide a gliding action 387107 in the direction of the desired word “.com” to select/enter said word.

In the examples above, in order to avoid ambiguity with other functions described earlier, some functions such as “undo”, and “LockWord”, are also shown as choices.

According to one embodiment of the invention, when the system is using a first database (e.g. a database of words of a first language), a switching means such as a predefined (e.g. a gliding action on/from a key in a predefined direction) may correspond to switching the system to use a second database (e.g. database of a second language). Accordingly, the switching means or another switching means (e.g. a gliding action in the opposite direction) may correspond to switching back the system to use the first database. According to one method, when the user uses the switching means, the system may also propose to the user a number of additional choices of databases (e.g. several different databases of languages), to the user, preferably, on a three-by-three-matrix based order on the screen of the corresponding device. According to one method, after the user uses the switching means, two scenarios may be considered:

Scenario 1) The user may proceed to entering text without selecting any of the additional proposed databases, in this case the system may preferably use the corresponding first or the second database as described above.

Scenario 2) The user may select one of the additional choices of databases and the system uses will use said database.

The databases of words of may be of any kind such as databases of, different languages, SMS database, different professions databases, capitalized words, names, a mixture of them, etc. According to one of embodiment, a database may include entries based the information of a user's documents (e.g. of the/his device such as for example a handset/table he usest) such as his emails, the email addresses he uses, his address book, etc.

It must be noted that all functions (e.g. mouse function, in a text, in a word, etc., provided on/from the zone/key) as described in this and previous patent applications filed by this inventor may be applied to/used with any type of text entry system such as a standard QWERTY-based touch screen keyboard.

In some languages a character without accent (e.g. “e”) (e.g. hereafter may be referred to as “the base character”) may derivative characters such as accented characters (e.g. “said characters and their base character herein may be referred to as “the accented characters family”.

Different methods of entering precisely (e.g. through insertion and/or correction) accented characters have been described before. According to one embodiment of the invention, after a user enters a precise character, if said character has relating accented characters, a second keypad of the invention such as a three-by-three matrix keypad (e.g. or a corresponding circular keypad as described in previous patent applications filed by this inventor) may represent at least some of the accented characters relating to the main character. At this time several scenarios may be considered:

Scenario 1. The user taps on a zone/key or provides a corresponding gliding action anywhere on the screen to select an accented character. Said accented character will preferably replace the main character in the current word, and the system may propose a new word including said accented character in the corresponding character position within said new word.

Scenario 2. The user does not consider the second keypad and does not select any of the presented accented characters and proceeds to another task such as entering another character or function. In this case, the system removes the accented characters from the screen. In the current scenario, according to one method, a predefined interaction such as a tapping action (i.e. a short pressing action) anywhere on a/the zone on the screen may correspond to removing said second keypad relating to the accented characters from the screen.

According to one method, during the entry of a word, if the selected character of the current predicted word is an accented character a predefined interaction such as a (e.g. long) pressing action on a predefined zone on the screen as described before, may fix said accented character.

Accordingly, the system may propose another word corresponding to the input information provided until then including the accented character.

According to one embodiment of the invention, the system may include a mechanism of predicting/presenting one or more words that their beginning sequence of characters corresponds to the input information provided by a user (e.g. hereafter may be referred to as a “longer predicted word”). According to one method, during the entry of a word, preferably each time the user pauses for at least a predefined lapse of time after one or more input (e.g. key) interaction(s), the system may predict a different longer predicted word. As an example, if the user is a novice, he/she may type slowly and may pause between two key presses, and therefore, for each key interaction the system may propose/predict a different longer word. Accordingly, if one is an advanced user, then, he/she may type several consecutive characters quickly, and at some point during the entry of a word he/she may pause for a predefined lapse of time. At this time the system may propose a first longer word, and if he/she continues typing one or more characters of the current word and again pauses, the system may propose a different longer word, and so on.

With continuous description of the current embodiment, during the entry of a word, if the user is using a backspace function/key, then according to one method, each time he/she pauses for a predefined lapse of time, the system may propose a different longer word previously proposed to the user during the entry of the current word.

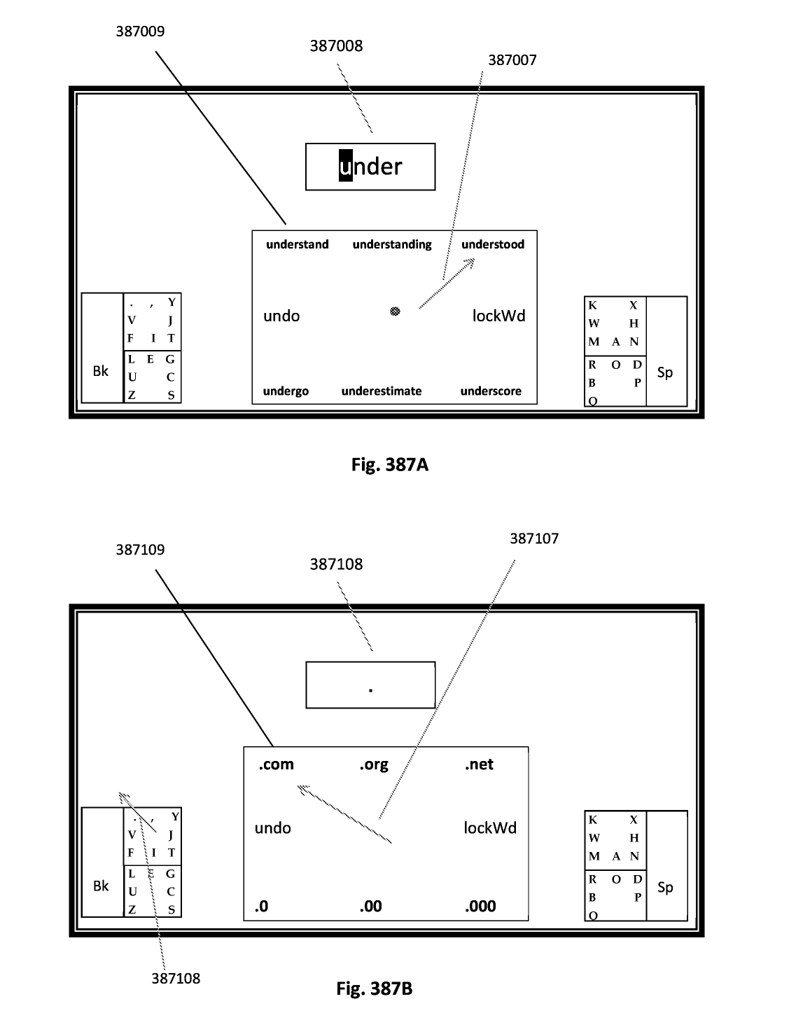

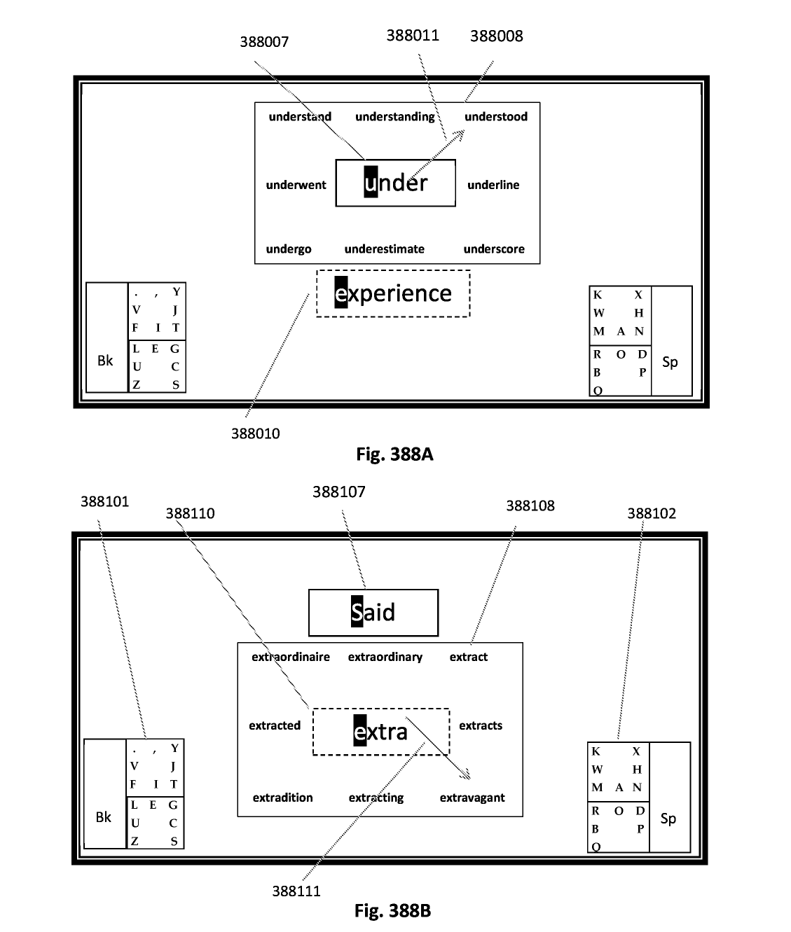

As mentioned before, when the input information corresponding to a word is being entered, two (or more) types of words may be predicted and presented to a user. According to one method, a first presented word is a word wherein all of its characters corresponds to the input information provided until then (e.g. the current predicted word), and the second presented word is preferably a longer word (e.g. wherein the input information provided until then corresponds to the beginning characters of said word). According to one embodiment, when a user touches any of said presented word, the system may present to the user a number of longer words that begin with the presented touched word. Said longer words may be presented in any manner such as in a pop-up list or in a three-by-three matrix manner preferably under the user's finger, as described throughout this application. In this case, after said corresponding longer words are presented under the user's finger, the user may provide a gliding action towards the desired longer word. As an example, FIG. 388A shows two predicted words 388007, 388010, proposed by the system based on the key presses provided by a user. The first word “under” 388007 is the current predicted word, and the second word “experience” 388010 is the longer word (e.g. predicted through a word completion procedure). At this time, if the user touches the current predicted word “under” 388007, the system may propose a number of longer words beginning with the word/chain of characters “under”, preferably under/around the user's finger touching said word. In this example, said longer words are shown in a three-by-three matrix form factor 388008. At this time, the user may provide a gliding action 388011 corresponding to a desired longer word.

Also as an example, FIG. 388B shows two predicted words 388107, 388110, proposed by the system based on the key presses provided by a user. The first word “said” 388107 is the current predicted word, and the second word “extra” 388110 is the longer word (e.g. predicted through a word completion procedure). At this time, if the user touches the longer word “extra” 388110, the system may propose a number of longer words beginning with the word/chain of characters “extra”, preferably under/around the user's finger touching said word. In this example, said longer words are shown in a three-by-three matrix form factor 388108. At this time, the user may provide a gliding action 388111 corresponding to a desired longer word.

In the embodiments above, according to one method, when the user touches any of the characters of one of the predicted words, the system may consider the beginning chain of characters of said predicted word until said character being touched, as the beginning characters of the corresponding longer words to be predicted/presented by the system.

According to one embodiment of the invention, the number of longer words may include entries of the corresponding database that have N-gram words wherein N>1, such as 2 gram words. Optionally, said number of words may include words of a 1-gram database that include compound words. Specifications about compound words have been described before in detail. As an example, when a user taps on the keys 388102, and 388101, the system may propose the word “at”. The system may also propose a longer word/chain of characters corresponding to the input information (e.g. said tapping actions) as a second choice. As just mentions, said longer word may be a word constituted of one or more words. For example, said longer word may be a compound word or a 2-gram word (e.g. “my name”).

According to one method, after a compound word or a 2-gram word is presented to a user, if the user touches said word, the system may propose/present a number of words including compound words or N-gram (e.g. n>0) words wherein their first word is identical to the first word of the compound/N-gram word. In the example above, if the user touches the word “my name”, the system may propose other words such as “my”, “my phone”, “my number”, “my phone number”, “my dear” etc. Such words may be shown/presented on the screen as described above.

According to one method, if the user touches an Nth word of a compound/N-gram presented longer word then the system may propose a number of compound/N-gram words that their beginning words until and including Nth words are identical to the beginning word until and including the Nth word of the longer presented word. In the example above, if the user touches the word “name” of the compound/2-gram proposed word “my name”, the system may present a number of compound/N-gram words such as “my name is”, “my name is on the list”, etc.

In the embodiments relating to presenting other words beginning with at least a portion of the touched word, instead of touching a word, the user may provide another types of interactions for the same result. As an example, pressing a first zone such as the right side of the screen (preferably, outside the keypad) may correspond to presenting the (longer) words relating to the current predicted word, and pressing a second zone such as the left side of the screen (preferably, outside the keypad) may correspond to presenting the words relating to the longer predicted word. Or vice versa.

According to a preferred embodiment, the other/longer words relating to a proposed/predicted (e.g. longer) word as described in the above embodiments and methods may include compound words and/or N-gram words, when/wherein preferably said proposed/predicted word corresponds to the input information relating to a/the first word of a sentence.

According to one embodiment of the invention, when the system proposes a current predicted word and another word such as a longer word, tapping on the space keys may relate to confirming/entering the current predicted word, and a tapping action outside the keys on the screen, preferably on a predefined zone such as the one as described earlier in this application may correspond to confirming/entering the said another/longer word (e.g. or vise versa).

Optionally, providing a tapping action of any of the presented words may confirm/enter said word.

According to one embodiment of the invention, after positioning a pointing means (e.g. caret/cursor/pointer) on or attached (e.g. preferably attached to the of) a chain of characters such as a word for the selecting said word previously entered (e.g. not a current word being entered) the system may preferably require a predefined interaction such as for example a tapping action on the predefined zone as described before. Positioning the pointing means van be provided by any means such as the pointer movement/motion described before, by touching the desired chain of character/word, by using the backspace function, etc. The chain of characters may be a complete word or it may be a stem (e.g. a portion of a word). For example, if the user uses the backspace function and erases a portion (e.g. one or more characters) of an already entered word and by doing so the cursor is positioned at the end of a remaining chain of characters of said word, then providing a predefined interaction such as a tapping action on a predefined zone on the screen may select said chain of characters (e.g. and brings it in front, preferably as is, as a current word being entered) for editing. According to one method, if the user adds one or mere characters or deletes one or more characters from said current predicted word, then according to a first method the system preferably considers of the characters as ambiguous characters, wherein according to a second method, the system considers all said characters as identified (e.g. precise/fixed characters.

According to one embodiment, when a cursor/caret is placed after a chain of characters such as for example a word and the there is one (e.g. or more) space characters between said cursor/caret and the chain of characters, then providing a predefined interaction such as for example a tapping action on a predefined zone (e.g. as described above) may select said chain of characters (e.g. for editing).

According to one embodiment, if a character of a word is selected (e.g. preferably, by a user, and preferably by using an In-Word selector means), activating a/the shift function may result in changing the case of said character (e.g. from lowercase to uppercase, and vice versa).

Providing a predefined interaction such as providing a gliding action from outside the screen towards inside has been described before by this inventor. According to one embodiment of the invention, providing such gliding action may result in removing an on-screen keyboard such as the keyboard of the invention or any other keyboard from the screen. Accordingly, providing the same gliding action when a keyboard is not on the screen may result in bringing the keyboard on the screen. For such purpose according to one method, as shown in FIG. 389A, an object 389021, preferably in form of an invisible very thin line may be placed on one or more edges of the screen 389009 such that when the user provided a gliding action 389031 from outside the screen he/she first interacts said object and the event is captured by the (data entry) system of the invention. Therefore in forming the system to remove the keyboard from the screen (e.g. if the keyboard is on the screen) or bring the keyboard on the screen (if the keyboard is not on the screen). Optionally, instead of gliding action, tapping on said object may provide the same results. FIG. 389B shows the screen free of the keyboard after providing the gliding action 389031.

According to one embodiment of the invention, providing a predefined interaction on a zone/key on the screen may result in presenting a number of web sites/pages (e.g. in form of icons, web addresses, etc.) including the user's favorite web sites/pages to the user. Such websites or webpages may be presented in a three by three matrix based form factor on the screen. preferably, under/around the user's finger interacting with the screen as described before. Then, providing a gliding action towards the desired website/webpage may connect the user's device to that website/webpage. As an example, the website/webpages may be related to social websites/webpages such as Facebook, Twitter, etc.

Optionally, other types of functions such as switching to/opening different applications may be presented to the user as well. For example, one of the choices be opening a mail application, or a word processing application, etc. According to one method, said functions and web addresses may be assigned to a same predefined interaction resulting in presenting a number of choices, or they may be assigned to another predefined interaction.

As an example, in the FIG. 389A, a gliding action rightward from the key 389005 may result in presenting a number of choices such as of functions, and/or web addresses, and/or applications, and/or etc. to the user as described above. According to one method, more than one predefined interaction may be user to relate to more than one number of choices. According to one method, such choices may include a number of functions of a menu of a corresponding application such as the functions save, save as, open, undo, etc., of an application.

According to one embodiment of the invention, when the system is in invisible mode, switching the system into a/the special character mode may result in not printing the corresponding precise keyboard, and the gestures may preferably be used to enter precisely special characters. Accordingly, the system may print the corresponding icons representing different (e.g. four) (invisible) keys representing different groups of corresponding special characters.

The word predictive system of the invention may use an N-gram, preferably, at least a 2-gram word database. As such, when the user provides the input information corresponding to a desired word, in addition to considering said input information, the system may also consider at least one word and/or chain of characters preceding the current word being entered in the document. By considering/combining at least one preceding word (e.g. a precise character or a chain of two or more precise characters, and eventually also considering the delimitating characters such as the space key(s) after said word(s), and the input information (e.g. ambiguous key pressed and eventually one or more identified character, if any) corresponding to the current word being entered, the system may predict a desired word with high accuracy.

According to a first method, said preceding character and/or chain of characters may be at least one word (e.g. “the”) adjacent to the current word being entered (e.g. “mall”), that together may form a 2-gram word (e.g. in the given example, “the mall”). Accordingly, the N-gram database of words may preferably include corresponding N-gram entries.

According to a second method, said preceding character and/or chain of characters may not be (e.g. do not have to be) adjacent to the current word being entered. As an example, according to one method, a number of predefined words (such as “the”, “a”, “of”, “to”, etc.) that, in the framework of this invention, preferably, do not have a significant impact on the accuracy of word prediction can be preferably not be considered by the word predictive system when they precede the current word being entered. Accordingly, the N-gram database preferably will not include corresponding N-gram entries. As an example, in the phrase “go to the mall”, the considered 2-gram may be “go mall”. As such, after entering the consecutive words “go to the”, when a user is entering the input information corresponding to the word “mall”, it is the word “go” that may be considered as the previous (e.g. the adjacent) word by the system.

The preparation of the corresponding (e.g. large) database may involve the omission of some elements in the chain of words/items while counting the number of N-gram occurrences in a given corpus of texts. For example, one may count 2-grams the first gram of which precedes the word/s of the said list, whereas the second gram—follows it.

According to one embodiment, a word list including said predefined words may be created and used by the system. Accordingly, when using such a search method and a corresponding (e.g. large) database, when the input information corresponding to a current word is being entered, the system may first look in said word list to predict some words/a word that correspond to said input information. If there is/are such (a) word/s, the system may first propose it/them to the user. If there is a desired word in the words proposed (or if the single word proposed is the desired one), the user may confirm it. In this case, according to one method, the system enters said word and does not search for corresponding words in the database. On the other hand, if, in the list, there is no word that corresponds to the input information provided by the user, or if the user rejects the predicted word(s) from the list, the system may proceed to searching for the corresponding words in said/the (e.g. large) database.

Based on the principles described above, the term “previous word(s)” relating to a current word being entered as described throughout this application may preferably refer to the previous word(s) adjacent to the current word being entered. Depending on the method of the search and the corresponding database, according to one method, said adjacent word(s) may be the adjacent word(s) excluding the words of said wordlist described above.

According to one embodiment of the invention, the word predictive system may be designed to use at least one N-gram (e.g. 2-gram) word database, based on the principles just described.

According to one embodiment of the invention, a 2-gram database of words of the system may preferably exclude the 2-gram entries wherein their first gram is similar to one of the words of the list, but may preferably include the 2-gram entries wherein both of their grams (i.e. their first and second grams) are also found in the list.

According to one method, the system remembers two types of words and, based on some rules, it may use one/any of them as the immediately preceding item (e.g. the first gram) to the current word being entered and by combining said immediately preceding item and the information corresponding to the current predicted word the system may search the corresponding (e.g. 2-gram) words within the corresponding database(s). The first type of word is the last word entered before a current word being entered (e.g. hereafter referred to as “the/an adjacent previous word”). The second type of word is the last word entered before a current word being entered wherein said last word is not similar to any of the words of the list (e.g. hereafter said type of word is referred to as “the/a non-listed previous word”. Note that the adjacent previous word may often be the non-listed previous word.

When the system receives the input information corresponding to a current word being entered, it may first check to find out if said information corresponds to one of the words of the list. Some scenarios may be considered as specified below:
1) If the answer is NO, and the adjacent previous word is also not a word from the list, then the system may preferably consider the “adjacent previous word” (e.g. in this case the same as the non-listed previous word) as the immediately preceding item (e.g. the first gram) to the current word being entered and may predict a word accordingly. (e.g. Note that, after the current predicted word is confirmed/entered, it may become, both, the adjacent previous word and the non-listed previous word, relating to the next word to be predicted/entered.)
2) If the answer is NO, and the adjacent previous word is a word from the list, then the system may preferably consider the “non-listed previous word” as the immediately preceding item to the current word being entered and may predict a word accordingly. (e.g. Note that, after the current predicted word is confirmed/entered, it may become, both, the adjacent previous word and the non-listed previous word, relating to the next word to be predicted/entered.)
3) If the answer is YES, and the adjacent previous word is not a word from the list (e.g. in this case, it is also the corresponding non-listed previous word), then the system considers said adjacent previous word to be the immediately preceding item to the current word being entered and may predict a word accordingly. (e.g. Note that, after entering/confirming the current predicted word, said word just confirmed/entered may become the adjacent previous word relating to the next word to be predicted/entered, and said adjacent previous word relating to said word just confirmed/entered will/may be considered as the non-listed previous word relating to the next word to be predicted/entered.)
4) If the answer is YES, and the adjacent previous word is also a word from the list, then, the system considers said adjacent previous word to be the immediately preceding item to the current word being entered and may predict a word accordingly.
(e.g. Note that, after confirming/entering the current predicted word, said word just confirmed/entered may preferably become the adjacent previous word relating to the next word to be predicted/entered, and the non-listed previous word relating to said word just confirmed/entered will/may preferably be considered as the non-listed previous word relating to the next word to be predicted/entered, too.)
5) According to one embodiment of the invention, if the answer is YES, and the adjacent previous word is also a word from the list, then the system considers two types of words for prediction and may propose one or more corresponding word(s) of the bi-gram(s) entries, of the corresponding database, having the highest priority/priorities. For that, the system may consider two groups of corresponding words:
   a. The system may consider said adjacent previous word to be the immediately preceding item (e.g. the first gram) to the current word being entered and may consider one or more corresponding word(s) of the N-gram database accordingly.
   b. The system may also consider the non-listed previous word to be the immediately preceding item to the current word being entered and may consider one or more corresponding word(s) of the N-gram database accordingly.
   Then, as mentioned before, by considering the corresponding word(s) from a) and b), the system may propose one or more corresponding word(s) of the highest priority/priorities.
      As an example, by considering a/the LIST of words “a, any, the, few, not”, if the phrase “typing any of the” has already been entered, the word “typing” is considered the non-listed previous word (e.g. it is not a word from the LIST), and the word “the” of the phrase is considered the adjacent previous word. Now, if the user provides the input information corresponding to a new word (e.g. the current predicted word) “words”, by knowing that said input information does not correspond to any of the words of the list, the system may preferably consider the non-listed previous word “typing” as the immediately preceding item to the current predicted word, and may most probably find a bi-gram “typing words” within the database. If said bi-gram has the highest priority among other bi-grams corresponding to the combined input information (e.g. immediately preceding item, i.e. the first gram, and the input information) within the database, the system may propose/predict the word “typing” as the current predicted word.

According to a preferred method, after the system predicts a word based on considering a non-listed previous word and the input information corresponding to the current word being entered, before presenting said predicted word to the user, the system may look for 2-gram words having the predicted word as their second gram and the adjacent previous word as their first gram. On one hand, if such word is not found, the system considers said predicted word as a none valid word and the system may not present said predicted word to the user, and preferably considers a next word corresponding to the input information provided by the user and proceeds to the same procedure (e.g. to see if the next word is valid or not). And so on.

On the other hand, if such a word is found, then according to one method different scenarios may be considered such as:
a) the system presents said predicted word to the user;
b) the system compares the priority of the bi-gram word of the database corresponding to the non-listed previous word and the predicted word, with the priority of a word of the bi-gram word of the database corresponding to the relevant combination of the adjacent previous word (e.g. as a first gram), and the input information, provided by the user, corresponding to the current word being entered relating to a second gram of an entry, and presents the corresponding word (e.g. second gram) from the bi-gram having the higher priority.
   It must be noted that the procedure just described is used to provide an example of the principles of how to valid or invalid a predicted word by considering the/a non-listed previous word and/or an adjacent previous word as the first gram of a current word being entered to augment the accuracy of prediction of the system. Other methods/procedures may be considered by people skilled in the art.

It must be noted that the procedures of word prediction described throughout the applications filed by the inventor may be applies to any type of keyboard such as a keyboard wherein a key of it represents several characters, or a keyboard, such as a QWERTY keyboard, wherein a key represents a single letter.

According to one embodiment, different categories of N-gram words may constitute different databases or they may constitute a single database but have different indicating/indicator to distinguish them from one another. For example, the “common” bi-gram words may have a first (type of) separator character(s) (e.g. “˜”), the bi-gram words which are relating to names (e.g. commonly spelled with (a) capital letter(s), such as names, acronyms etc.) may have a second (type of) separator character(s), the bi-gram words wherein their both grams are within the list described above, may have a third (type of) separator character(s), and so on.

The embodiments just described referred to 2-gram words/databases. It is understood that such rules may be applied to any N-gram word/database.

According to another embodiment of the invention, in addition to at least one of a 1-gram and 2-gram word databases, the system may include some N-gram (e.g. preferably, three grams and/or more) words wherein in such an N-gram word the first gram is not a word from the list, and the other gram(s) except the last gram of such an N-gram word is/are word(s) from the list. Preferably, the last gram of such an N-gram word may be of any kind (e.g. said last gram, may, be or not be from the list). When the user provides the input information corresponding a current word, the system may consider a number of preceding words beginning from the previous none-listed word until the previous adjacent words (e.g. if the previous adjacent words is a none-listed word, then said number is one) and by combining them with the information being entered by the user corresponding to the current word, the system looks for the corresponding N-gram words that their beginning grams corresponds to said number of preceding words, and at least the beginning characters of their last gram corresponds to said input information.

By using this method, preferably, the number of entries of an N-gram word database wherein preferably N>2 may be reduced significantly without (e.g. significantly) affecting the accuracy of the prediction of the current word being entered by the system.

According to one embodiment of the invention, during the entry of a word (e.g. preferably, before and of/while typing its first typing its first character), a predefined interaction such as for example a gliding action from a key in a predefined direction, may inform the system that the current word going to be or being entered has at least a predefine d number (e.g. preferably, six or more) of characters. This will help to predict long words faster. By informing the system as such, when the users begins to interact with (e.g. tap on) the keys corresponding to a long word as described, the system preferably may preferably for the words having at least said predefined number of characters and wherein at least their beginning characters correspond to the key interactions being provided by the user.

The data entry of the invention can permit creation and/re-design of many applications. According to one concept, an application for sharing pictures may be designed to be used with a device in landscape mode as well as in portrait mode.

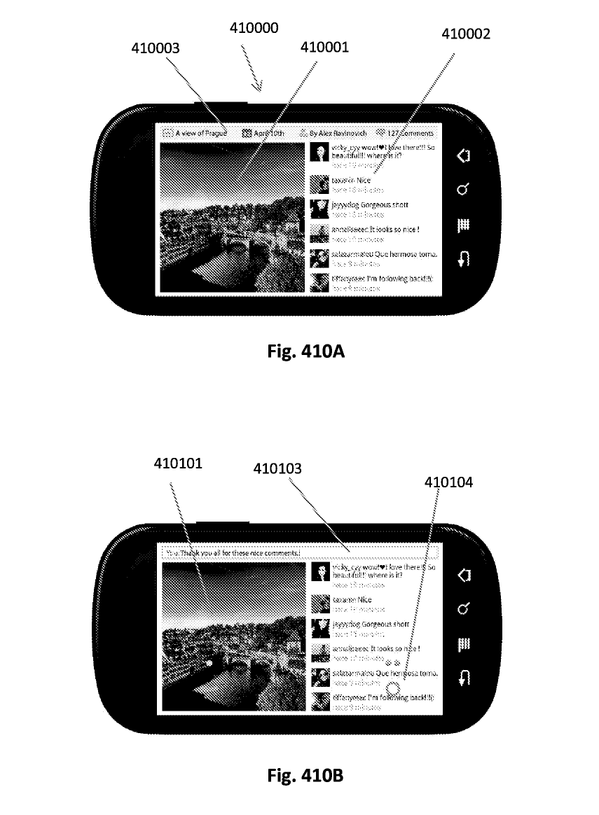

According to one embodiment, and as shown as an example through FIGS. 410A to 410B, when using such application with a device 410000 in the landscape mode, the screen is preferably divided into several main zones, preferably, three main zones 410001-410003, a picture zone 410001, a comment zone 410002, and a zone 410003 for a text box which may be replaced by other information when the user is not typing text/a comment. As an example, on a first zone 410003 such as on the upper part of the screen the information about the current picture 410002 may be displayed on the screen, containing information, such as, picture name, date the picture was taken, user's/author's name, and the number of comments, etc. When pressing on said zone 410003, it may change into a text box 410103 as shown in FIG. 410B and the keyboard 410104 of the invention, preferably in its invisible mode, may appear on the screen. The user is now able to comment on the picture within said text box 410101.

Also as an example, on a second zone 410001 such on the left side of the screen the current picture 410002 may be displayed. Providing an interaction such as a gliding action towards up or down, or left or right, on a zone such as said zone 410001 may correspond to scrolling within other pictures. Preferably, the pictures will be shown one by one in this zone. When a picture is show in the zone 410001, its corresponding comments and other information may be shown in the comment zones 410002.

As mentioned, a third zone 410002 such as on the right side of the screen may be dedicated to showing (e.g. previous) comments preferably related to the current picture shown on the screen. The user may swipe/glide his finger on said zone towards up or towards down (e.g. or optionally, towards left or towards right) to scroll the comments upwards or downwards to fro example read a desired comment. The comments may be printed in an order based on a parameter such as for example, the date posted, the user's name, etc. As an example, if the order is based on the posted date and/or time, the comments may be printed from top to bottom on the corresponding zone. According to one method, tapping on a first area on a comment may result in providing/showing a detailed information corresponding to the user that posted said comment such as his/her profile on a zone such as the corresponding zone. Said profile may include information such as his/her albums, name, latest comments etc., and tapping on a second area on the/a comment may correspond to expanding said comment.

According to one embodiment, a press-and-holding action provided anywhere on the screen or on a predefined zone on the screen may result in presenting under and/or around the user's finger several choices such as sending the comment just entered through an email, sharing the/a picture or the link corresponding to a/current picture and its corresponding comments, in an application, such as Facebook, sending the same to a twitter account, sharing the picture/comment with a community such as for example some friends, showing the/an album of pictures to the user, etc. A choice may be selected by the user by a providing a predefined interaction such as a gliding action towards the choice from example from the/a the press and holding point on the screen, as described throughout this application. It must be noted that a choice may have sub-choices (e.g. based on tree based concept) wherein after the user provides the gliding action, a predefined interacting with the screen, such as for example a press-and-holding action again on the screen may provide/show sub-choices relating to the selected choice, preferably under and/or around the user's finger as described, and the user may select a desired sub-choice.

As an example, after selecting a picture, the user may press-and-hold on the picture and the system may show several choices to the user as described. One of the choices may be related to selecting a community of user's friends. After selecting said choice by for example providing a corresponding gliding action, if the user presses-and-holds again on the screen, the system may propose under and/or around the user's finger the icons corresponding to and/or pictures-of a number of his friends, and the user may select one or more of them to share said picture with the selected friends. According to one method, providing a predefined interaction such as continuing pressing on the screen or a gliding action in a predefined direction may correspond to presenting another number of user's friends as described, and so on.

Note that a sub-choice may have its own sub choice and so on, and the procedure of selecting a desired choice/sub-choice described above may be applied at any step.

When using the current application with a device in the portrait mode, said zones may be located on the screen such that to form a vertical row of zones.

It must be noted, that the number of zones, the location of each zone, the directions of gliding/swiping actions, etc., shown in the example above, are provided to describe the principle of the current application. It is understood that other number of zones, different locations for said zones on the screen, different types of interaction for scrolling pictures/comments may be considered by people skilled in the art.

According to one embodiment of the invention, when the system is presenting a/the longer word (e.g. a Longer word was described before), the letters of the portion that their corresponding key presses are not provided yet may be presented-by (e.g. printed in/with) their corresponding buttons'/keys' colors.

According to one embodiment of the invention at any moment (e.g. preferably during the entry of a word) a predefined interaction such as for example a tapping action preferably anywhere outside the keys of a keypad may ambiguously correspond to an/any of a number of characters (e.g. letters, special characters). Preferably, said number of characters at least substantially includes all of the letters of a language and/or at least some special characters. According to one method, during the entry of a word, in addition to providing the input information (e.g. interacting with the keys of the keypad) relating to at least some of the characters of a desired/current word, one or more tapping actions on a zone other-than/outside said keys of the keypad may be provided. Said interaction may be provided one or more times during the entry of a word, and each of said interactions may correspond to an ambiguous character in a corresponding character position of a word being entered. Said interactions may be provided for the entry of the beginning and/or the middle and/or the last portion (e.g. character(s)) of a word. By combining said interactions provided on and outside the keypad as just described, the system may predict a corresponding word from a corresponding word database used by the system.

For ease of description, throughout the corresponding embodiments, an ambiguous key of the/a keypad and interaction with it may be referred to as “narrowly ambiguous key/interaction” providing “narrowly ambiguous input signal”, and outside the keypad may referred to as “broadly ambiguous key/interaction” providing “broadly ambiguous input signal/character”.

With continuous description of current embodiment, as an example, by considering the keypad of FIG. 389A, during the entry of a word, in order to enter the word “recipient”, after the user presses the keys 389004, 389003, 389003, and 389001, corresponding to its four beginning characters, the system may propose the word “best”, and a longer word “business”. These are not the desired word. Now instead of pressing the keys of the keypad corresponding to more of the remaining characters of the desired word, the user may provide one or more tapping actions outside the keypad and the system preferably considers each of said tapping actions outside the keypad as broadly ambiguous interactions corresponding to a character at the corresponding character position of the desired word. By considering the combined input information (e.g. narrow and broad ambiguous input signals) the system may predict a word.

For example, generally for entering an English 1-gram long word, it is preferable to type the five beginning characters and the last one or two letters of the word through the keys of the keypad. The rest may be provided by the tapping action(s) outside the keypad.

It must be noted that at any moment the user may insert a precise character and/or proceed to the correction procedure. The correction procedure may preferably be applied to any type of ambiguous character (e.g. narrow, or broad), preferably to the first ambiguous character of a word being entered.

One of the other advantages of such method is that if a user desires to press a key corresponding to a desired letter but does not remember to which key said letter is assigned, he may provide a tapping action on said predefined zone (e.g. anywhere outside the keypad). According to one embodiment of the invention, during the entry of a word, preferably if the user provides one or more broad ambiguous input signals, the system may show more than one words (e.g. preferably two words) wherein their entire characters correspond to the input information provided by the user.

According to one method, instead of tapping action for entering more than one consecutive broad ambiguous input signals, another interaction representing a number of input signals greater than one may be considered (e.g. a gliding action, etc.).

According to one embodiment, the group of letters that are assigned to the broadly ambiguous key/interaction may include only some of the letters of an alphabet.

It is understood that the method of prediction described above may be used with any N-gram word databases wherein N>0 and may be combined with any of the principles, methods, described throughout this and other applications filed by this inventor.

The principles of entering broadly ambiguous input signals may be applied to/used with any type of precise keyboard (e.g. a letter key of the keyboard represents one letter such as a QWERTY keyboard) and/or ambiguous keyboard (e.g. a letter key of the keyboard represents more than one letter). For example, a QWERTY keyboard may include a zone/key wherein a tapping action on said zone/key may ambiguously correspond to any letter of a language (e.g. a broadly ambiguous character). Entering words by entering one or more of their characters precisely and one or more of its characters broadly ambiguous may result in high accuracy of prediction of said words by the system. This may be very useful on on-screen (e.g. QWERTY) keyboard making such keyboards more user-friendly.

It must be noted that the keys of the keypad and/or the zone may be hard keys and/or soft keys.

Grouping the twenty six letters of Roman language on four keys of the system are preferably based on their common shape characteristic in uppercase. Each of twenty one of said letters have the same shape characteristic in both cases and only four of them (i.e. a, g, l, r, letter “e” may be excluded from this group because its closed section may not be perceived as roundish) have different shape characteristics in uppercase and lowercase. When the keypad/keyboard of the system is in invisible mode, for some users it may be more convenient to think in lowercase while they type in lowercase. In order to help such users, according to one method, the keycap of each key shown on the screen may be presented by these characters in preferably in uppercase, therefore for the rest of the letters, the user may think either in uppercase and/or in lowercase about a desired letter and to relate it to the corresponding invisible key.

As such, key to which the letters that stand on two points are assigned may be presented by the letter “A”, key to which the letters that stand on a wide base are assigned may be presented by the letters “GL”, and key to which the letters that have a closed circle in their shape are assigned may be presented by the letter “R”. Key to which the letters that stand on one point are assigned may be presented by any of its letters preferably in uppercase.

According to one method of correction, the system may include a method to replace an a broadly ambiguous character of a current predicted/proposed word by a narrowly ambiguous character (and vise versa). The system may then predict/propose another word.

According to one embodiment of the invention, a speech recognition system may be used for entering precise characters. Said system may be used for entering characters during the entry of a word/chain of characters. As an example, when the user presses a key for entering a letter he may pronounce the letter's appellation. By considering said key pressing action and the speech provided by the user, the system has to select one of the few characters/letters assigned to said key. Therefore the accuracy of such entry of precise characters may be very high even in a noisy environment. The speech relating a character/letter may be provided at any moment during the entry of a word. It may be provided simultaneously during a key pressing action (e.g. insertion), or it may be provided during the correction procedure. For example, if the user is not pressing a key, providing said speech may be related to a (e.g. an ambiguous, or a precise) selected character of the word being entered.

Some characters/letters assigned to a same key may have ambiguously resembling pronunciations (e.g. m,n, of p,b, or y,I, etc.). According to one embodiment of the invention, during the entry of a word, when the user provides a speech corresponding to a character/letter and the system considers more than one choice of corresponding letter/character based on the key press and the corresponding provided speech, the system may consider said more than one choices and by considering the principles of the word predictive system using N-gram (e.g. N>0) database(s) of words as described, the system may predict with very high accuracy a desired word and present it to the user. According to one method, the system may predict/present more than one word. If any of the predicted word(s) is not the desired word, then the system may proceed to the correction procedure of the invention by means of key interaction(s) and/or speech recognition corresponding to a (next) selected letter/character. And so on.

It must be noted that although the terms such as “key interaction” are used (e.g. for providing input signals) to described the principles of the data entry system of the invention, any other means such as gliding action, movements in the air, etc., may be used for the same purpose (e.g. for entering said input signals).

It must be noted that during the entry of a word different types of input signals (e.g. narrowly ambiguous, broadly ambiguous, input signals corresponding to precise characters, etc.) may be provided at any character position. Any of such type of input signals may be provided in different consecutive or none consecutive character positions of a word being entered.

According to one embodiment of the invention, a method of tapping and/or gliding actions may be used to enter ambiguous and/or precise characters. According to this principle, characters may be arranged such that to form several (e.g. three in this example) rows (e.g. columns) of characters on each key. When the system is in precise mode, a tapping action provided (e.g. anywhere) on a column may preferably correspond to entering the center character on said column precisely. A gliding action provided (e.g. from anywhere) on a column upward may preferably correspond to entering the precisely the character on the top of said column. A gliding action provided (e.g. from anywhere) on a column downward may preferably correspond to entering the precisely the character on the bottom of said column.

With continuous description of the current embodiment, according to one method, a gliding action provided (e.g. from anywhere) horizontally on/from a column may preferably correspond to entering precisely the character on the center of said column.

In the embodiment above, preferably, the most commonly used characters/letters may be located in the center of a column so that to be preferably entered by a tapping action on said column.

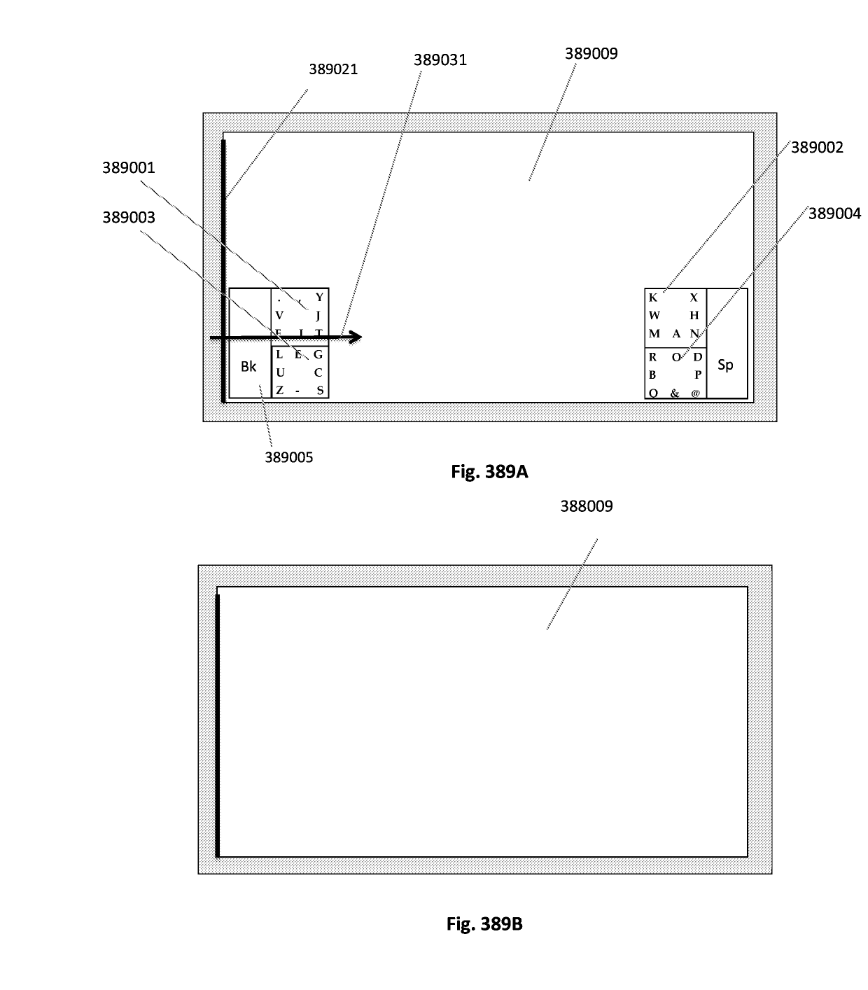

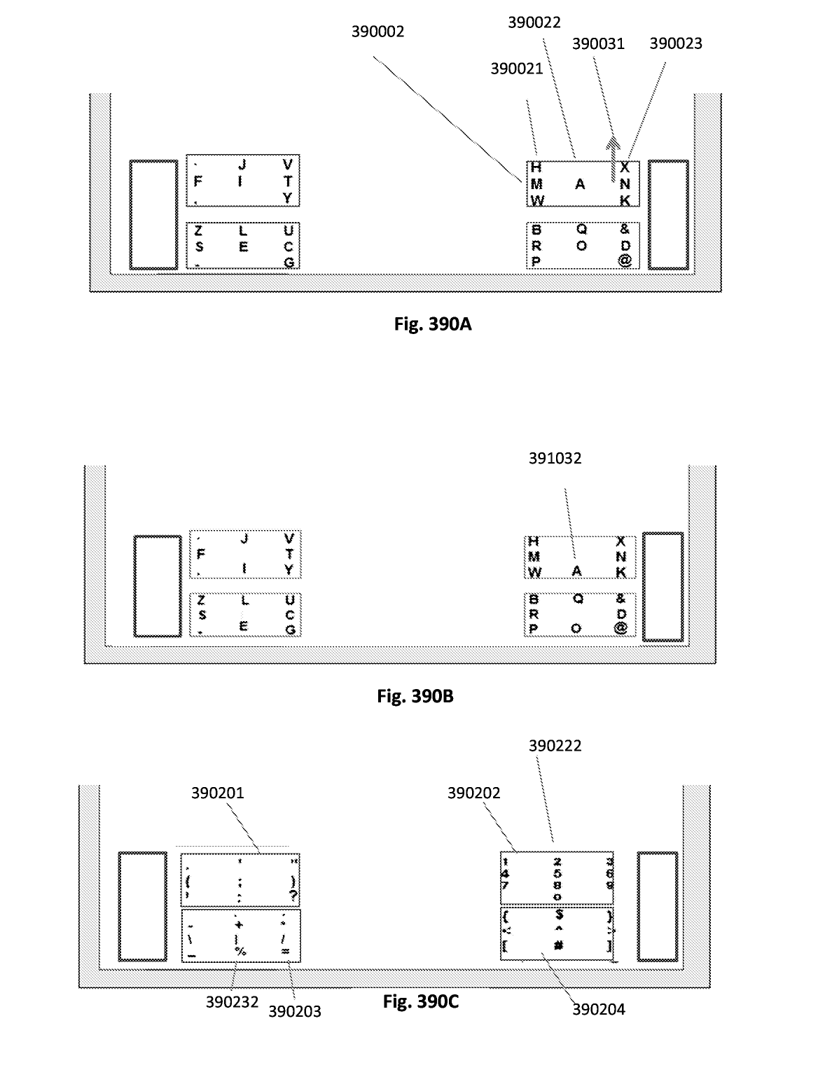

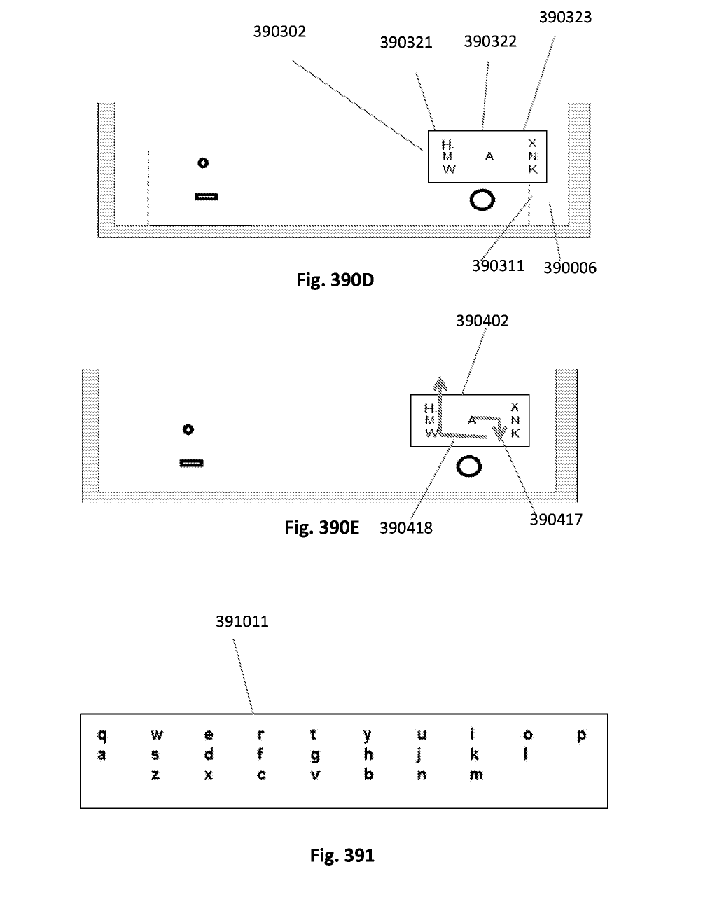

Example of FIG. 390A shows another type of arrangement of characters on the keys of the keypad of the invention and their arrangement based on the principles described above. As an example, characters on the key 390202 are arranged to form three rows/columns of characters 390021-390023 (e.g. in this example, the column 390022 includes one key). Based on the principles described above, as an example, a gliding action 390031 provided upward from anywhere on the column 390023 corresponds to character “x”, a tapping action provided anywhere on said column 390022 corresponds to character “n”, and a gliding action (not shown) provided downward from anywhere on the column 390023 corresponds to character “k”.

When the system is in the predictive mode, the principles of the gliding actions on a column may remain the same. On the other hand providing a tapping action anywhere on a key may preferably ambiguously correspond to any of a group of characters, such as any character of any of the columns of character, on said key. In this case/mode, according to one method, a gliding action provided (e.g. from anywhere) horizontally on/from a column may preferably correspond to entering precisely the character on the center of said column.

According to one method, in the predictive mode in order to avoid misunderstanding, the center of the center row providing horizontal gliding actions to enter a precise character assigned to a column, the center of the center column of characters on a key may not include a character. An example of such embodiment is shown in FIG. 390B.

The principles of entering precise and ambiguous characters as described above may preferably apply for entering characters in any mode of the system. For example, different types of interactions may enter the system into a different mode wherein a number of characters assigned to a key may be related to said type of interaction. In this case preferably said characters may be arranged/presented on a corresponding key based on the principles described above. A character may be entered by a corresponding interaction (e.g. tapping/gliding action) as described above. FIG. 390c shows as an example, the system being in the precise special character mode. As shown, the special characters on each key (e.g. in this example, except the digit key 390202) are arranged in rows/columns of three characters each. As an example, providing a tapping action on the row of characters 323232 may corresponds to the character “;”. Accordingly, providing a gliding action downwards on said row may correspond to entering the character “%”. And so on.

In the current example, the key 390202 is assigned to digits. In this example, the middle column 390222 of the key includes four characters. According to one method, a tapping action on said column 390222 may preferably correspond to the digit “5”. Another type of interaction such as a gliding action provided (e.g. from anywhere) horizontally on/from said column 390222 may preferably correspond to entering precisely the character/digit “8”. Accordingly, a gliding action provided (e.g. from anywhere) downward on/from said column 390222 may preferably correspond to entering precisely the character/digit “0”. Accordingly, a gliding action provided (e.g. from anywhere) upward on/from said column 390222 may preferably correspond to entering precisely the character/digit “2”.

It must be noted that according to a preferred embodiment, providing a press and holding action (e.g. before providing a gliding action) may first be provided on a key to enter the system/key into the special character mode.

It must be noted that the principles of entry of precise characters using columns of character as described above may be used to reduce the size of any type of keyboard such as for example a QWERTY keyboard. In this case, the keyboard may include as much as needed number of columns. FIG. 391 shows an example of arrangement of the letters based on a QWERTY keyboard arrangement of letters, wherein said letters are arranged in several columns wherein each column includes up to three letters. As an example, tapping anywhere on the column 391011 may correspond to the letter “f”, and a gliding action provided (e.g. from anywhere) downward on/from said column 391011 may preferably correspond to entering precisely the character “c”. and so on. Other characters/functions of such keyboard may be included in said and/or additional columns. It must be noted that the keyboard/key based on the principles described embodiments described above may include any number of columns/rows of character.

Also, it must be noted that instead of forming columns of characters, the letters may be include in rows of, preferably three/four characters. In this case, as an example, a gliding action leftward on a row may correspond to the left character, and a tapping action on said row may correspond to the center character, and so on.

It must be noted, that although preferably three characters may be included in a column of characters, but according to one embodiment, a column of characters may include more character wherein corresponding gliding actions may be used for entering different corresponding characters of said column.

When the system is in invisible mode, according to one embodiment, an icon such as in form of a corresponding common shape of the letters as describe before may represent a key. In this case, according to one method, when the user provides an interaction (e.g. a gliding action) on a location on a key corresponding to a corresponding column of characters on said key, said key may become visible to the user, so that he can see with which column he is interacting. FIG. 390d shows as an example, the system in the invisible mode and wherein one of its keys 390302 is being interacted (e.g. by a finger of a user). In this case, said key has become visible to the user and three columns of characters 390321-390323, corresponding to the user's type of interaction with said key, are shown to the user. The user now, may provide, for example a desired gliding action.

According to one embodiment of the invention, in the invisible mode, in order to for example enabling a user to blind typing, a different method of providing gliding actions may be used for entering precise character. As an example, a compound gliding action 390417 provided from/on anywhere on a key in several directions may correspond to a corresponding character. Different scenarios may be considered:

a gliding action towards left and down (e.g. or towards down and left) may preferably correspond to entering precisely the character located on the lower left side on said key.

a gliding action towards left and up (e.g. or towards up and left) may preferably correspond to entering precisely the character located on the upper left side on said key.

a gliding action towards right and down (e.g. or towards down and right) may preferably correspond to entering precisely the character located on the lower right side on said key.

a gliding action towards right and up (e.g. or towards up and right) may preferably correspond to entering precisely the character located on the upper right side on said key.

Note that in this embodiment, a gliding action provided anywhere from/on a key towards any of the directions, left, right, up, and down, may preferably correspond to the center character of the respective corresponding side of the key. To enter precisely the center character of the center column of characters on a key, the user may provide another interaction such as providing a back-and-forth gliding action anywhere from/on said key towards any of the direction.

FIG. 390e shows as an example such method, wherein the compound gliding action 390417 provided anywhere on the key 390402 corresponds to the character “k”, and the compound gliding action 390418 provided anywhere on the same key 390402 corresponds to the character “h”.

The principles described above, may permit quick and easy entry of precise and ambiguous characters using an extremely reduced input interface. They permits to have very narrow keys, therefore saving space on for example a touchscreens.

Preferably, when an interaction is provided on a key, the key may be relocated under the user's finger such that its center being under the user's finger point touching the screen.

It must be noted that the compound gliding actions provided on/from a key as described may extend out of said key, and wherein length of each of its different trajectories may be as much as the user desires. As an example, the compound gliding action 390417 provided from anywhere on the key 390402 corresponds to the character “k”, and the compound gliding action 390418 provided from anywhere on the same key 390402 but extending out of said key corresponds to the character “h”. In this example, the different trajectory portions 3904181, and 3184182, have arbitrary lengths.

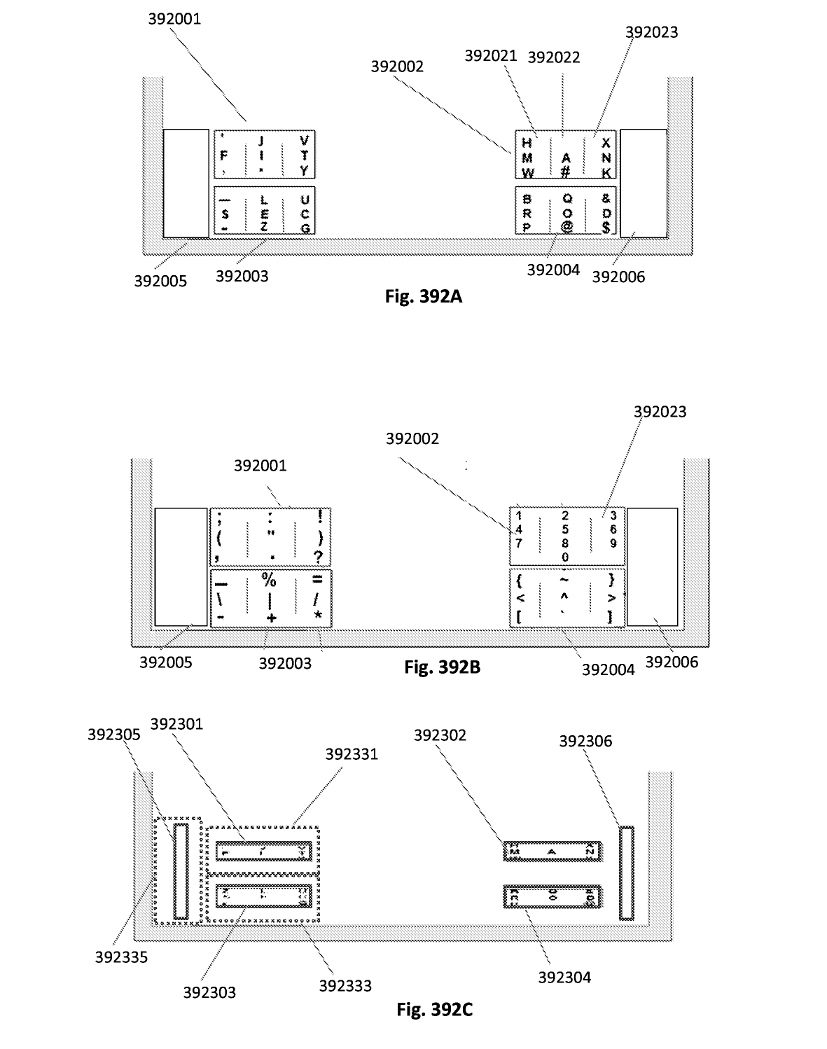

It must be noted that each of the rows/columns of (e.g. preferably, up to three) characters (e.g. and/or other symbols such as functions) as described earlier may occupy different zone of a key surface, and wherein a key may have one or more of such zones including said rows/columns of characters (e.g. and/or other symbols). FIG. 392A shows another example of arrangement of characters on different columns/zones on each of the ambiguous keys 392001-392004 of the invention. In this example, each zone relating to a column of characters is delimited by separating lines. For example the key 392002 includes three zones 392021-392023 relating to three columns of characters.

FIG. 392B shows another example of arrangement of special characters on different columns/zones on each of the ambiguous keys 392001-392004 of the invention. In this example, the keypad of FIG. 392A is in the special character mode.

The principles of entry of precise symbols described above may permit the use of very narrow keys (e.g. even in the form of a line representing a/each key. The length of the line may preferably be equal to the length of the corresponding key.).

According to one embodiment of the invention a large key may be shown/displayed in form of a narrow key to a user, wherein at least a larger zone relating to the actual size of the key may be invisible on the screen. FIG. 392C shows, as an example, a keypad of the invention having keys 392301-392306 shown in narrow form factor and wherein the actual size of each key is larger. As an example, the actual size of the narrowly presented keys 392301, 392303, and 392305, are respectively the large keys 392331, 392333, and 392335 where a large portion (e.g. represented, in FIG. 392C, by the discontinued lines around the narrow keys) of said keys is invisible/hidden. This enables the display of more of the other output such as the content printed on the screen under the invisible key's zones. Optionally, each of the keys may be shown as narrow as possible such as, for example, in form of a (e.g. straight) line.

As mentioned before, providing first type of interactions such as tapping/gliding action without providing a press-and-holding action before said interactions, on/from a key may correspond to a (e.g. ambiguous or precise, depending on the interaction) character of a first group of characters assigned to said key, and providing second type of interactions such as tapping/gliding action with providing a press-and-holding action before said interactions, on/from a key may correspond to a (e.g. ambiguous or precise, depending on the interaction) character of a second group of characters assigned to said key.

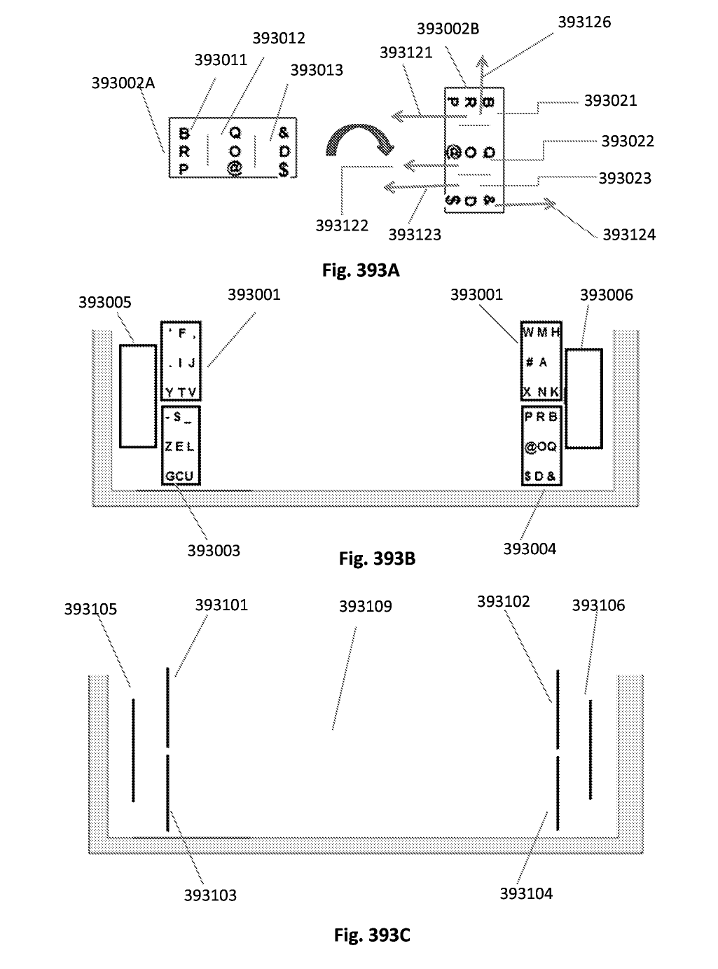

As mentioned, according to one embodiment of the invention one or more rows of symbols (e.g. wherein preferably each row including up to three symbols) such as characters on a key may be arranged horizontally. Therefore, according to one method, the principles of gliding actions from a vertical column/zone of symbols may accordingly adapted to such vertical rows/zones for entering symbols of such horizontal rows. FIG. 393A shows a key 323002A a group of characters arranged in three vertical rows (i.e. columns)/zones of characters 393011-393013. FIG. 393A also shows a key 323002B including the same group of characters arranged in three horizontal rows/zones of characters 393021-393023.

In this arrangement:

providing a gliding action leftward from anywhere on/from a zone/row of characters may preferably correspond to the character positioned at the left side of the row/zone. For example, providing the gliding actions 393121-393123 towards left respectively on the rows/zones 393021-393023, respectively correspond to the characters “P”, “@”, and “$”.

providing a gliding action rightward from anywhere on/from a zone/row of characters may preferably correspond to the characters positioned at the right side of the row/zone. For example, providing the gliding actions 393124 towards right on the row/zone 393023 corresponds to the characters “&”.

providing a gliding action upward or optionally leftward from anywhere on/from a zone/row of characters may preferably correspond to the character positioned at the center of the row/zone. For example, providing the gliding actions 393126 towards upward on the row/zone 393021, corresponds to the character “R”.

If the system is in the precise mode, providing a tapping action anywhere on a zone/row of characters may preferably correspond to the character positioned at the center of the row/zone. For example, providing a tapping action on the row/zone 393021, corresponds to the character “R”.

If the system is in the predictive mode, providing a tapping action anywhere on a key may preferably ambiguously correspond to any of a group of characters assigned to said key. As an example, providing a tapping action anywhere on the key 323002, corresponds to the any of the characters shown on said key.

FIG. 393B shows an example of arrangement of keys 393001-393006 of a keypad of the invention based on arrangement of horizontal rows of characters/symbols on said keys. Such arrangement may permit to have narrow keys having vertical form factor.

According to one embodiment of the invention, the keys of the keypad may not be shown on the screen, and instead their location and preferably their length may be indicated on the screen by printing (straight) lines on the screen. FIG. 393C shows an example of such embodiment, wherein the keys 393001-393006 of the keypad of FIG. 393B are shown through lines 393101-393106 on the screen 393109.

It must be noted that instead of a row/column of characters as described above, a row/column of symbols such as functions or a mixture of characters and functions may be considered by people skilled in the art, and a symbol may be entered based on principles described above.

For example, in FIG. 393B, the functions may be arranged (e.g. and shown) in horizontal rows, and the corresponding gliding actions from a zone/row in the directions as described above may preferably be related to activating corresponding functions on a row/zone. Preferably, providing a tapping action anywhere on a functions key may preferably ambiguously correspond to one of said function. As an example, tapping anywhere on the key 393005 may correspond to the backspace function, and tapping anywhere on the key 393006 may correspond to the space function.

The principles of embodiments above may also be applied for selecting other symbols such as for example accented characters, derivative characters, mouse functions, etc., that are generally presented on a separate keypad of the invention. In this case the system may preferably show the corresponding symbols in a column/row-based arrangement as described above, and the user may provide the different predefined tapping and/or gliding actions as described before, for entering the corresponding symbols.

It must be noted that the principles of the using different columns/rows of symbols within/on an ambiguous key and using tapping and/gliding actions to enter ambiguous and/or precise symbols as described before may be applied to keypads having any number of keys having any number of columns/rows of symbols. Any of all of the principles of the data entry system of the invention may be used with such ambiguous keys.

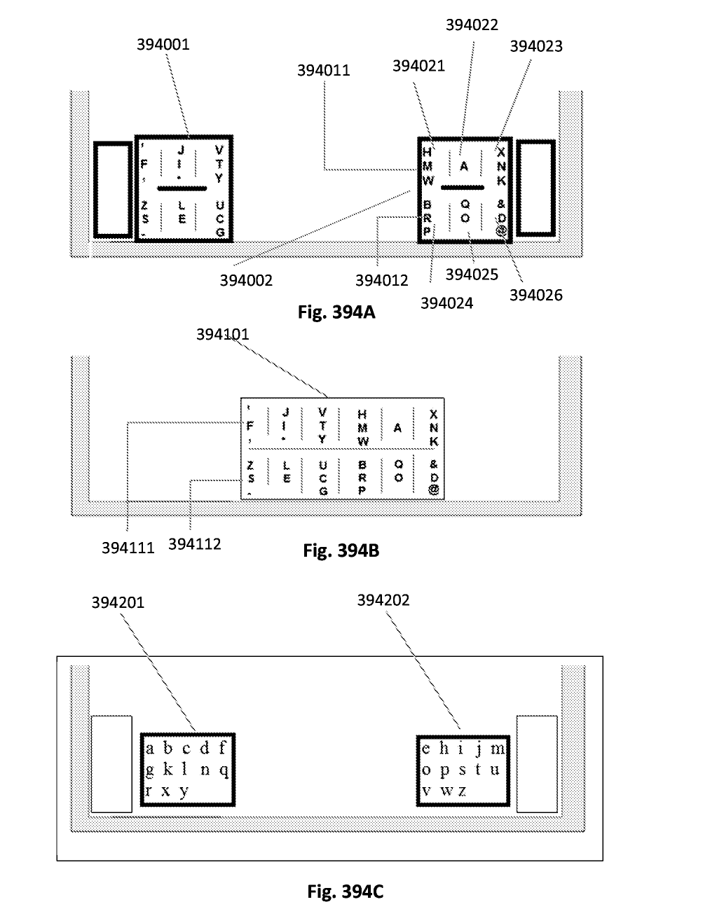

As an example, FIG. 394A shows a keypad of the invention having two ambiguous keys 394001-391002, and wherein each key has several columns of characters (e.g. 394021-394026 on key 394002) wherein the columns of characters are arranged in two rows of columns of characters (e.g. two rows of columns of characters 394011-394012 on key 394002).

As an example, in the predictive mode, tapping anywhere on said ambiguous keys may correspond to ambiguous characters. Also as an example, in the precise mode, providing a tapping action on the zone/column 394024 may correspond to entering the letter “r” precisely; providing a gliding action on/from the same zone 394024 downward may preferably correspond to the letter “p”; and providing a gliding action on/from the same zone 394024 upward may preferably correspond to the letter “b”. Also as an example, providing a gliding action upward on/from the zone/column 394021 may preferably correspond to the character “h”. By combining entry of ambiguous and precise characters (e.g. in other word, by providing ambiguous and precise input signals) an accurate and fast input system may be provided through two keys only.

According to one embodiment of the invention, the data entry system of the invention may include only one ambiguous key. As an example, FIG. 394B shows a keypad of the invention having one ambiguous key 394101, wherein based on the principles as described before, said key may include several columns/rows/zones of characters wherein, in this example, are arranged in two rows of columns of characters 394111, 394112. As an example, in the predictive mode, tapping anywhere on said key 394101 may correspond to entering ambiguous any of the characters assigned to/shown on said key. Also as an example, in the precise mode, providing a tapping action on a zone/column of characters may correspond to entering precisely the character located in the center of said column of characters. Also as an example, in precise/ambiguous mode, providing a gliding action in a predefined direction as described earlier on a zone/column of characters may correspond to entering precisely a corresponding character located in a corresponding position within said column of characters. By combining entry of ambiguous and precise characters (e.g. in other word, by providing ambiguous and precise input signals) an accurate and fast input system may be provided through one key.

According to one embodiment of the invention, the data entry system of the invention may include only rows/columns/zones of characters/functions to enter precise characters/functions based on principles (e.g. of tapping/gliding actions) as described earlier, and providing one or more tapping actions (anywhere on the screen) outside the columns may correspond to entering broadly ambiguous signals (described before) corresponding to any character/letter of a large group of characters such as a group of characters including at least all of the letters language, and/or special characters and/or functions.

By combining entry of ambiguous and precise characters/functions (e.g. in other words, by providing ambiguous and precise input signals) an accurate and fast input system may be provided without having a purely ambiguous key.

According to one embodiment of the invention, a handwriting recognition system may be used with any number of keys and even with no keys (e.g. as just described above) for the entry of precise characters. As an example, when the system has no ambiguous keys, the user may enter precise characters by writing them on the screen and use tapping action/s anywhere (on a zone) to enter ambiguous characters, and, as an example, thereby the system predicts words.

According to one embodiment of the invention, the system may use a voice recognition system to enter precise characters According to one method, the characters/letters of a language may be distributed on two ambiguous keys such that characters/letters having an ambiguously resembling spoken pronunciation/appellation may be assigned separately from each other to different keys. As an example, FIG. 394C shows a first number of letters “abcdfgklnqrxy” being assigned to a first ambiguous key 394201 and a second number of letters “ehijmopstuvwz” being assigned to a second ambiguous key 394202. In this example each letter of the pair of letters “mn”, “cz”, “de”, “pb”, having ambiguously resembling speech appellation is assigned to a different key of the two ambiguous keys 394201, 394202. According to one method, when the user taps on an ambiguous key, said tapping action may ambiguously be related to any of the letters on said key. In order to enter a precise character, according to one method, the user may press the corresponding key and pronounce/speak the desired letter. Tapping on an ambiguous key without providing speech may ambiguously correspond to any of said characters assigned to said key. By combining entry of ambiguous and precise characters/functions (e.g. in other words, by providing ambiguous and precise input signals) using two ambiguous keys only, an accurate and fast input system may be provided.

Each of the fingers of a user may represent an input means to which several characters are assigned. Providing predefined interactions with such fingers on a surface or in the air may correspond to entering a number of symbols assigned to the user's fingers. According to one embodiment of the invention, providing a tapping action by a first finger of a user (preferably, anywhere) on a surface such as the screen of a device may correspond to providing a first symbol (e.g. an ambiguous character) assigned to said finger, and providing a gliding action in several different directions with said first finger may correspond to entering precisely several corresponding symbols assigned to said finger. As an example, characters “a, b, c, d” may be assigned to the pinky finger of the left hand if a user. As an example:

Providing a tapping action with said pinky finger may ambiguously correspond to any of the characters assigned to said finger.

Providing a gliding action upward with said pinky finger may precisely correspond to a predefined letter assigned to said gliding action, in this example to letter “a”

Providing a gliding action downward with said pinky finger may precisely correspond to a predefined letter assigned to said gliding action, in this example to letter “b”

Providing a gliding action leftward with said pinky finger may precisely correspond to a predefined letter assigned to said gliding action, in this example to letter “c”

Providing a gliding action rightward with said pinky finger may precisely correspond to a predefined letter assigned to said gliding action, in this example to letter “d”

Note that more (e.g. preferably, up to eight) characters may be assigned to a single finger, and gliding actions in more directions (e.g. towards upper-left, upper-right, lower-left, lower-right) may be considered to enter precise characters assigned to a single finger.

Accordingly, providing the same tapping and/or gliding interactions with a second predefined finger of the user may correspond to entering a number of corresponding characters assigned to said second finger. Thereby, according to one method, all characters of a language may be assigned to several (e.g. 4 to 10) user's fingers and said characters may be entered according to principles as described above. By combining entry of ambiguous and precise characters/functions (e.g. in other words, by providing ambiguous and precise input signals) using several fingers, an accurate and fast input system may be provided anywhere on a surface such as on a touchscreen or in the air.

According to one embodiment of the invention, during the correction procedure, providing a (short) tapping action anywhere (e.g. on a predefined zone or on the screen) preferably outside the keys of the keypad may preferably correspond to fixing/setting the selected/highlighted character of the current word without predicting/proposing a new word, and providing a long pressing action in anywhere as such may preferably correspond to fixing/setting the selected/highlighted character of the current word and proposing/predicting of a new word (e.g. if any) corresponding to the input information provided by the user until then (or vice versus).

It must be noted that all interactions described throughout this applications may be provided in the air, thereby not requiring a sensitive surface such as a touch screen. Providing tapping/gliding actions in the air to simulate tapping/gliding actions on a surface have been described in detail in different patent applications filed by this inventor.

Although the terms such as “providing key interactions” (e.g., “tapping action/s on” and/or “gliding actions on/from” keys) for describing the principles of the entry of symbols (e.g. characters, functions, etc.), ambiguously and/or precisely, have been used throughout this application, it must be noted that said description have been used to demonstrate the principles of the data entry system of the invention only, and that the interactions provided as such provide different input signals wherein upon receiving said input signals the system relates them to corresponding symbols, ambiguously and/or precisely, depending on for example the type of interaction, the instance, etc. As such, instead of using the terms of assignment of symbols to an input means such as a key or to an interaction with an input means such as a key, said symbols may be considered to be assigned to the input signal provided through said interaction with the input means.

It must be noted that row/columns/zones of symbols the row/columns/zones of characters may have any types of arrangement on a key. For example, said row/columns/zones of symbols may be arranged differently on a same key in two different modes such as precise and ambiguous mode.

Also, characters within a zone of characters on a key may have different types of arrangement. For example, characters within one or more such zones on a key may be arranged based on a cross-shape arrangement, or based on an N-by-N (e.g. 2×2, 3-by-3) matrix of characters, etc.

It must be noted that according to one embodiment, instead of or in addition to gliding and/or tapping actions on a zone/row/column of symbols to precisely enter a symbol of said zone/row/column of symbols types of interactions such as double tapping action, voice command, handwriting, etc., may be used.

It must be noted that in different patent applications filed by this inventor, many types of elements such as, different number and types of input means, different types of interactions, different methods, etc., for entering ambiguous and/or precise characters, and combination of said characters for enhancing the system to predict a word quickly and/or accurately, has been described through specifications and drawings. A preferred data entry system of the invention may include a substantial number of those elements to enable the user to combine a number of said elements (preferably, dynamically during text/data entry) at her/his convenience to accommodate her/his way of typing/data entry.

As an example, some of the elements of the data entry system of the invention are listed below:
Narrowly ambiguous input signals
Broadly ambiguous input signals
Precise characters/input signals
Word completion
Correction
Insertion
   By combining one or more of said elements the user may enter a word the way it is convenient for her/him. As an example, for entry of a word, the user may provide one or more precise characters and one or more broadly ambiguous input signals with or without using the word completion element/function. According to another example, during the entry of a word, the user may provide one or more narrowly ambiguous input signals and one or more broadly ambiguous input signals, with or without using a word completion element/function. Also, according to another example, during the entry of a word, the user may provide one or more narrowly ambiguous input signals and one or more broadly ambiguous input signals, and one or more precise characters/input signals, with or without using a word completion element/function. Etc.

It must be noted that providing a first predefined interaction, such as a gliding action provided in a first predefined direction, with a row/zone of symbols such as characters, may correspond to entering precisely a first symbol located within said row/zone. Preferably, the direction of said predefined interaction, such as said gliding action, may correspond to the location of the corresponding symbol within said row/zone. Preferably, providing a second predefined interaction, such as a gliding action provided in a second predefined direction, with a row/zone of symbols such as characters, may correspond to entering precisely a second symbol located within said row/zone. Preferably, the direction of said predefined interaction, such as said gliding action, may correspond to the location of the corresponding symbol within said row/zone. As an example, providing a predefined interaction such as a gliding action upward from anywhere on/from a column of symbols on a key may preferably correspond to entering (precisely) the symbol located on the top of said column of symbols, and providing a predefined interaction such as a gliding action downward from anywhere on a column of symbols on a key may preferably correspond to entering (precisely) the symbol located on the bottom of said column of symbols.

As an example, providing a predefined interaction such as a gliding action leftward from anywhere on/from a horizontal row of symbols on a key may preferably correspond to entering (precisely) the symbol located on the left side of said horizontal row of symbols, and providing a predefined interaction such as a gliding action rightward from anywhere on a horizontal row of symbols on a key may preferably correspond to entering (precisely) the symbol located on the right side of said horizontal row of symbols.

It must also be noted that providing a first predefined interaction, such as a gliding action provided in a first predefined direction and predefined range of length, with a row/zone of symbols such as characters, may correspond to entering precisely a symbol located within said row/zone.

Accordingly, when the system is in the precise mode, providing a predefined interaction such as a tapping action anywhere on a column of symbols on a key may preferably correspond to entering (precisely) the symbol located in the center of said column of symbols.

Accordingly, when the system is in the predictive mode, providing a predefined interaction such as a gliding action leftward or rightward, from anywhere on a column of symbols on a key may preferably correspond to entering its center symbol (precisely).

Accordingly, when the system is in the predictive mode, providing a predefined interaction such as a gliding action upward or downward, from anywhere on a horizontal row of symbols on a key may preferably correspond to entering its center symbol (precisely).

Said principles may be applied to entering precise characters of the rows/column/zones of symbols arranged diagonally or obliquely.

As mentioned, when the system is in the predictive mode, providing a predefined interaction such as a tapping action anywhere on a key may preferably ambiguously correspond to any of the symbols of any of the rows and/or columns and/or zones of symbols (e.g. shown) on said key.

With continuous description of the principles of entering precise characters arranged in one or more (e.g. three) rows/columns/zones of characters, according to one embodiment of the invention, in Predictive Mode, characters that generally are of a high word disambiguation value (e.g. characters that if they are entered precisely during the providing of ambiguous input signals corresponding to a word being entered, can enhance the system to significantly quicker and more accurately predict said word) are preferably assigned to an easy type of interaction such as an easy type of gliding action with a zone/column/row (e.g. gliding actions towards up/down when the user holds the corresponding device with his/her hand(s)) and preferably are not located at the center of said zones/columns/rows. Accordingly, characters that generally are not of a high word disambiguation value (e.g. characters that if they are entered precisely during providing ambiguous input signals corresponding to a word being entered, do not significantly enhance the system to more quickly and more accurately predict said word) are preferably assigned to a less easier type of interaction(s) such as a less easier type of gliding action(s) with a zone/column/row (e.g. gliding actions towards left/right when the user holds the corresponding device with his/her hand(s)) and preferably are located at the center of said zones/columns/rows.

In the case of an interaction which is a tapping action anywhere on the key, the system may consider any character (e.g. any characters in any of the zone(s) in said key) ambiguously corresponding to such key. During the entry of a word, the system may predict/propose a word with each interaction (e.g. a tapping action, gliding action, etc.) by a user with an input means such the key.

As an example, by considering FIG. 395A, when the user desires to enter the word “frequently”, he may press (e.g. tap anywhere on) the ambiguous keys 395001, 395004, 395003, and enter the letter “q” precisely by providing a gliding action 395011 upward on/from the center column of characters on the key 395004. By considering the input information provided by the user, the system may more quickly predict the long word “frequently” than given the situation where the letter “q” is not precisely entered.

According to one embodiment of the invention, characters that generally are of a high word disambiguation value are preferably assigned to an easy type of interaction such as a tapping action on a zone/column/row, and preferably are located at the center of said zones/columns/rows. Accordingly, characters that generally are not of a high word disambiguation value are preferably assigned to less easier type of interaction(s) such as gliding action(s) with a zone/column/row. During the entry of a word, entering one or more precise characters as described in this application by providing broadly and/or narrowly ambiguous input signals for entry corresponding to one or more (other) character(s) of said word, may help the system to predict a word based on the combined input information.

According to one embodiment of the invention, a system may be designed to enter word(s) based on entering precise characters only.

Note that high frequency characters and high predictive value characters are not necessarily mutually exclusive. For example, the character ‘F’ (which has higher frequency of use than the character ‘Y’) is considered to be a high predictive value character because it is commonly found at several positions (i.e. character positions in word) in a large group of words that contain the character ‘F’ and, when ‘F’ is precised in a word, it enhances the accuracy of word prediction when used with a collection of ambiguous characters. Furthermore, the character ‘Y’ which has a very similar frequency of use to that of ‘F’ is not considered to have high predictive value because it is not commonly found in several positions (e.g. it is often found in a limited set of positions in a word, such as at the end of a word, and sometimes in the second letter position of a word, etc.) in words, and so not providing significant disambiguation to the predictive system because its characters are frequently found in limited positions in words that do not differentiate as well as characters found in words where such positions are not as limited.

According to one embodiment of the invention, entries in an N-gram (e.g. 2-gram) database may be arranged (e.g. frequency values may be calculated for each entry) to support the use (e.g. by the user) of high predictive value characters, such that when said high predictive value characters are used as precise characters in the input information containing ambiguous characters, the predictive system of the invention my provide improved prediction accuracy than if the user did not precise such high value characters.

According to one embodiment of the invention, when two words/stems correspond to a same (sequence of) ambiguous input information (e.g. ambiguous key pressing actions), and wherein a first word does not include one or more character/s that generally is/are of high word disambiguation value, and the second word includes one or more characters that generally are of high word disambiguation value, then when the user provides said ambiguous input information, the system may first propose the first word to the user, even if the second word has higher frequency of use than the first word. This principle, preferably, may be applied to words that have low frequency of use within a group of words corresponding to the same (sequence of) ambiguous input information (e.g. ambiguous key pressing actions). This principle can be expanded to a group of several words/stems corresponding to a same (sequence of) ambiguous input information in which (preferably, among the words having a low frequency of use in the group) the system first predicts those words having less characters of a high word disambiguation value.

According to one embodiment of the invention, short gliding actions provided anywhere on/from a zone/column/row of characters on a key may correspond to precisely entering corresponding characters of said zone/column/row, and long gliding actions provided on/from anywhere (regardless of the zone/column/row) on a key may correspond to entering corresponding characters on said key (or vise versus). As an example, based on this embodiment and by considering FIG. 395A, the short gliding action 395021 provided upward on/from the right zone/column of characters of the key 395001 may preferably correspond to the letter “V”, the long gliding action 395022 provided upward on/from the (e.g. left zone/column of characters of the) key 395001 may preferably correspond to the letter “J”, and the long gliding action 395023 towards upper right provided on/from the (e.g. left zone/column of characters of the) key 395001 may preferably correspond to the letter “V”.

According to one embodiment, at least for digits, the characters nay preferably be considered to be arranged in four horizontal rows of characters. In this case, a tapping action on a horizontal row may preferably correspond to the center character, and for the letter on the left and the right side of a row, the user may provide, respectively, leftward and rightward gliding actions on/from said horizontal row. As an example, this eliminates the ambiguity between the downward gestures corresponding to the characters 8 and 0 if the characters were arranged in a vertical column/zone.

According to one embodiment of the invention, the characters may be arranged in characters columns such as to reduce the number of gliding actions to enter a precise character for entering a word and preferably also to reduce the number of tapping actions on columns for entering a word. According to one method, when entering a word (e.g. by entering characters), the user, preferably provides tapping actions on the corresponding columns for entering precisely the characters that are positioned in the center of the column. For the other characters, the user may preferably tap outside the columns (e.g. providing broadly ambiguous input signals).

According to one method, the user may preferably enter the first character of a word by either entering it precisely or by tapping on the corresponding column regardless of its (i.e. the character's) location within the column (e.g. the tapping action on a column corresponding to the first character of a word may be considered as narrowly ambiguous input signal corresponding to any characters of said column).

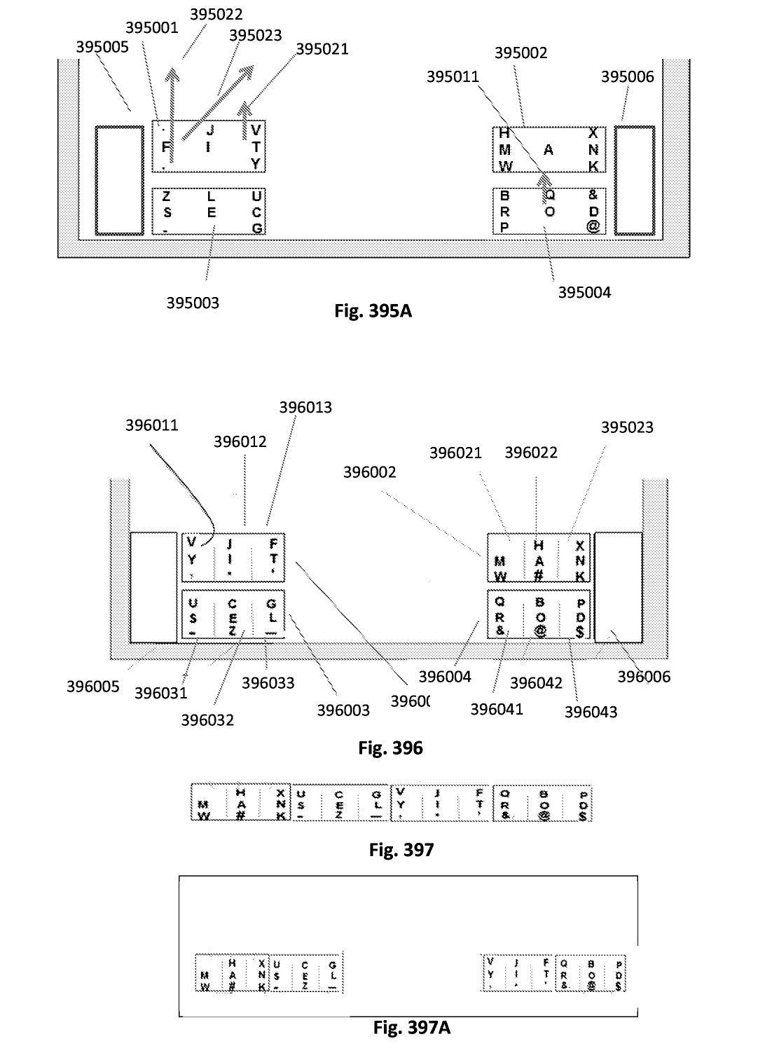

As an example, FIG. 396 shows characters arranged in different columns such that for example to correspond to principles just described in order to enter words in English language. As an example, for entering the word “amazing”, the user may tap on the columns 396022, 396021, 396022 (for letters “a, m, a”, tap (once) outside the columns (e.g. broadly ambiguously corresponding to the letter “z”), tap on the columns 396012, 396023, and tap (once) outside the columns (e.g. broadly ambiguously corresponding to the letter “g”). By considering the precise characters and the narrowly ambiguous input signal (e.g. corresponding to the first character of the word) and the broadly ambiguous input signals (e.g. corresponding to the characters “z” and “g” of the word) the corresponding word in the corresponding database is the word “amazing”. Said word may be proposed to the user.

It must be noted that the user may also be able to enter any character precisely by providing a corresponding tapping and/or gliding action on the corresponding column.

According to another example, in order to enter the word “struggle”, the user may tap on the corresponding columns/keys for the letters “s”, “t”, “r” (e.g. in this example, as an example, the first letter “s” may also be considered as being entered precisely), tap three times outside the columns for the letters “u”, “g” and “g”, and tap on the corresponding columns for the letters “l”, “e”. The corresponding word is the word “struggle”.

Preferably, after providing input-information by providing interactions (e.g. such as tapping and/or gliding actions) inside and outside the columns, among the words corresponding to the provided input information, according to a first method the system may exclude (e.g. does not consider) the word(s) for which at least one of its character(s) is in the center of a column and wherein said at least one character is in a character position that corresponds to a tapping action provided by the user outside the columns (e.g. may be hereafter referred to as “less considered word/s”, and other words among the corresponding words may be hereafter referred to as “more considered word/s”). According to a second method “less considered words” may be considered to be proposed after the other “more considered words” corresponding words are proposed. As an example, by providing tapping actions inside the columns corresponding to the letters “gra”, and a tapping action provided outside the columns, and a tapping action inside the corresponding column corresponding to the letter “e”, the corresponding words may be “grace”, and “grade”. According to the first method the system may exclude the word “grade” and propose the word “grace” because the letter “d” for which the user has provided a tapping action outside the columns is in the center of the corresponding column, according to a second method, the system may first propose the word “grace” even if its frequency of use is less than that of the word “grade”. According to one method, if there is more than one “more considered word(s)”, the order of their presentation to the user by the system may preferably be based on their frequency of use.

According to one embodiment of the invention, the user may be authorized/enabled to tap outside the columns also for the letters that are in the center of the columns. In this case, during the entry of a word if the user provides interactions including tapping actions outside the columns, according to one method, among a group of words corresponding to the user's interactions the system may preferably firstly propose the word(s) wherein their character(s) in the character positions corresponding to the tapping action(s) provided outside the columns are not located in the center of the columns. As an example, in order to enter the word “typewriter”, the user may first tap on the columns 396013, 396011 (for letters “t”, “y”), then tap once outside the columns (for letter “p”), then tap on the column 396032 (for letter “e”), and then tap several times (e.g. six times) corresponding to one or more (e.g. six) of the remaining characters of the desired word regardless of their location in the corresponding columns. Providing such combined input information may correspond to only one word in the database used by the system. Said word is the word “typewriter”.

It must be noted that the principles of entering text just described may be combined with principles of word completion, context consideration such as for example using one or more N-gram database(s) (e.g. N=1 to 5), auto correction, reject function, correction procedure, etc. By using the principles just described, an easy text input system may be provided wherein the user most of the time uses tapping action on a reduced number of columns and in most cases does not have to remember the location of the letters which are not in the center of the columns.

It must be noted that instead of a tapping action outside the columns, the user may be enabled to use any other predefined interaction such as a gliding action (e.g. anywhere on a predefined zone) outside the columns.

It must be noted that the columns of characters may be independently arranged on a touch sensitive surface such as a touch screen in any manner such as for example forming one (e.g. narrow) row of columns as shown in FIG. 397, or more rows of columns. They can also be included on different keys such as four keys as shown for example in FIG. 395A to also form ambiguous keys wherein when the system is in ambiguous mode said keys and characters may be used by a word predictive system of the invention to predict words as described throughout this and previous patent application(s) filed by this inventor. In such case, when the system is in precise mode, the data entry system using the methods of entering words using tapping actions and extremely reduced gliding actions as described above may be used.

It must be noted that in any embodiment/method, the number of columns may be considered to vary by people skilled in the art.

It must be noted that preferably in the embodiment/principles just described above, letters providing ambiguity (e.g. “n”, “h” for entering “now”, “how”, or “b”, “p” for entering “but”, “put”) may be located in different columns as shown in FIG. 396.

It must be noted that the arrangement of characters in different columns may vary. As an example, the arrangement of letters in different columns may vary depending on the language. For example, if the language in use is French, the character “x” may be placed in the center of a column. Using the principles just described, in order to enter a word which is not in the database of the system, the user may enter it by providing corresponding tapping and gliding actions on/from the columns of characters.

It must be noted that although in some paragraphs/embodiment the principles of the data entry system are shown through columns of characters, said characters may be arranged to form other types of rows/zones of characters as described before (e.g. forming horizontal rows of characters).

In the example of FIG. 391, and FIG. 397, the letters have been shown to form columns of letters, respectively based on a QWERTY keyboard order, and another order. It must be noted that the same principle of arrangement and entry of characters may be applied to entering special characters and function. As an example, any of the keyboards of FIG. 391, and FIG. 397 may have a mode function to switch the keyboard from letter mode to special characters mode and/or functions mode. Said mode function may be arranged in one of the columns and for example activated by a gliding action on said column.

It must be noted that although in different paragraphs describing the principles of the data entry systems of the invention such as that using the methods of entering words using tapping actions and extremely reduced gliding actions, the term of tapping action relating to the center character of a column is used, as described before said tapping action preferably may refer to a predefined (e.g. preferred) character of the corresponding column regardless of its location on said column. Preferably, such character is located in the center of the column.

FIG. 397A shows the keyboard of FIG. 397 being split in two portions wherein said portions are preferably positioned on opposite sides of a sensitive surface such as the touch screen of a device.

The principles described above may also be applied to a word predictive data entry system using ambiguous keys such as the four ambiguous keys of the invention. As an example, when the system is in ambiguous/predictive mode, during the entry of a word, tapping on the ambiguous keys (e.g. narrowly ambiguous input signals) may mainly be considered to correspond to a preferred group of characters (e.g. among a larger groups of characters) (e.g., the other characters on the ambiguous keys may be referred to as “non-preferred characters”) ambiguously assigned to said keys, and tapping outside the keys (e.g. broadly ambiguous input signals) may mainly correspond to the non-preferred characters assigned to any of the ambiguous keys (e.g. although according to one method it may also be assigned to any of all of the characters assigned to the ambiguous keys). By receiving narrowly and/or broadly ambiguous input signals and/or precise characters such as in a manner described before (e.g. together forming input information) corresponding to a word being entered, the system may predict a word.

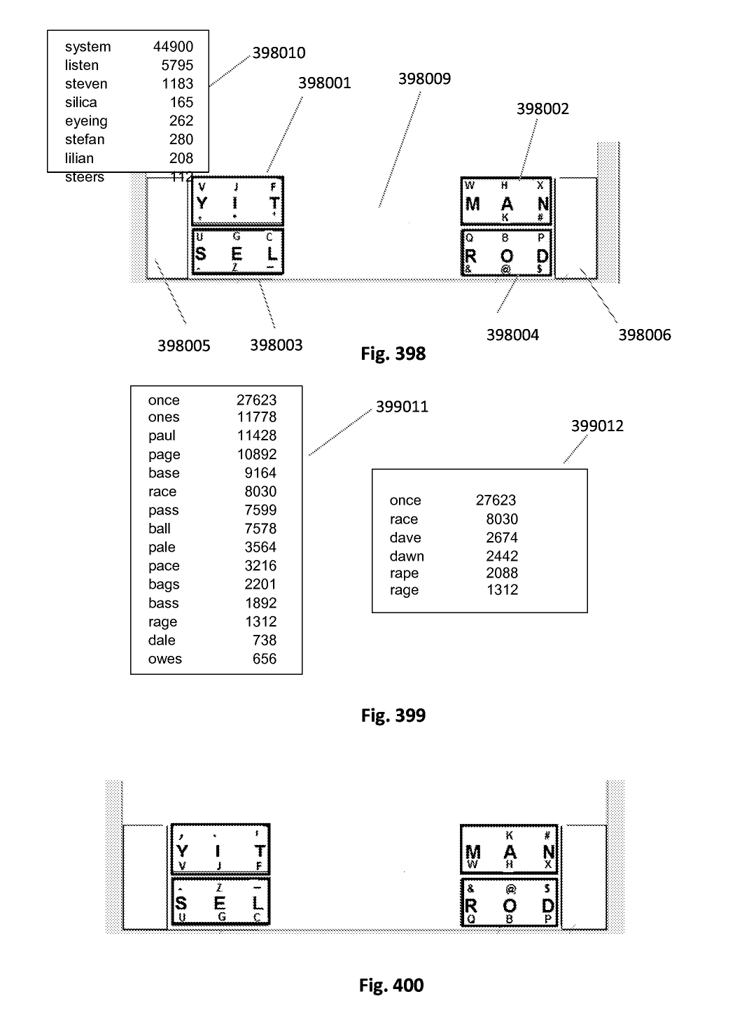

As explained for the precise mode, preferably, if the input information includes broadly ambiguous input signals (e.g. through tapping actions provided outside the keypad), the system may preferably at first propose the “more considered words” and then the “less considered words”. FIG. 398 shows as an example of a keypad of the invention wherein the preferred characters are shown in large characters and the non-preferred characters are shown in small characters. As an example, by considering the portion 398010 of a database used by the system and using the keypad of FIG. 398 and the touch sensitive surface 398009, in order to enter the word “steven” the user may tap on the corresponding keys 398003, 398001, 398003 (e.g. narrowly ambiguously corresponding to letters “ste”), then tap once outside the keys (e.g. broadly ambiguously corresponding to letter “v”), and then tap on the keys 398003, 398002 (e.g. narrowly ambiguously corresponding to letters “en”). By considering the portion 398010 of the database, the system may propose the word “steven” even though the other two words “system” and “listen” have higher priority because said two words at their fourth character position have the character “t” which is a character from the preferred groups of characters on its respective key 398001 for which the user provided a tapping action outside the keypad. Accordingly, if the user desires to enter any of said two words, she/he may preferably provide tapping actions on the keys corresponding to all of the characters of said words because all of the characters of both words are characters from preferred groups of characters on their respective keys.

According to one method, in some cases, such as for example during appending characters procedure when entering a word, in the predictive mode, the non-preferred characters may preferably not be shown on the ambiguous keys. By doing so, an extremely simplified user interface may be presented to the user, wherein during the entry of a word the user may preferably see the characters for which he/she may preferably provide tapping actions on the (e.g. ambiguous) keys (e.g. the preferred characters) and wherein the characters that are not shown are preferably typed (e.g. by providing tapping actions) outside the (e.g. ambiguous) keys. According to one method, the non-preferred characters may be shown on the corresponding keys after a predefined command such as a Reject command is provided (e.g. when the system enters into the Correction procedure).

According to one method, the user may preferably provide the input information corresponding to the first character of a word by either entering it precisely or by tapping on the corresponding key regardless of the status of said character (i.e., regardless of if said character is a preferred character or not). The system may treat said tapping action accordingly (e.g. by considering said tapping action as relating to both a preferred character and a non-preferred character for example by providing two types of searching actions).

As mentioned in the embodiments above, a tapping action relating to a non-preferred character is preferably provided outside the keys. Optionally, for a non-preferred character it may be also permitted to tap inside the corresponding key. During the entry of a word if one or more tapping actions are provided outside the (ambiguous) keys, then according to a first method, the system may at first propose the “more considered words” among the corresponding words. According to a second method, the system may propose the corresponding words in an order regardless of the location of the provided tapping actions.

As mentioned in the embodiments above, a tapping action relating to a preferred character is preferably provided inside the keys. Optionally, for a preferred character it may be also permitted to tap outside the corresponding key. During the entry of a word if no tapping action(s) is/are provided outside the (ambiguous) keys, then according to a first method, the system may at first propose the corresponding words that all of their characters are preferred characters. According to a second method, the system may propose the corresponding words in an order regardless of the type (e.g. preferred, non-preferred) of characters.

In any of the above cases, according to one method the system may propose one or more words of a group of corresponding words, and if none of them is selected by the user, the system may propose more corresponding word(s) for example based on a user's predefined command such as a Reject/Next command. This may be applied to short and/or long words as described before in previous provisional application(s). According to one method, in order to enter one of the proposed words (e.g. other than the main (e.g. current predicted) word) the user may tap on a proposed word.

The simplified user interface and methods of interaction with said interface (e.g. tapping inside, outside, the ambiguous-keys/keypad), and order of presenting corresponding words as described may in addition provide highly accurate prediction result(s). As an example, FIG. 399 shows two tables relating to two types of provided input information corresponding to the word “race”:
1) Table 399011 shows some of the words corresponding to tapping actions provided on/inside the keys of a keypad such as the keypad of FIG. 398 regardless of the status/type (e.g. preferred, non-preferred) of characters of the word “race” relating to tapping actions provided on the ambiguous keys, and wherein the system considers to present said corresponding word based on its frequency of use. In this case, the corresponding group of words includes a large number of words and wherein the word “race” is in the sixth position, and preferably the order of presentation to the user may be based on their frequency of use.
2) Table 399012 shows some of the words corresponding to the appropriate tapping actions provided on the ambiguous keys of a keypad such as the keypad of FIG. 398 for the preferred characters “r”, “a” and “e”, of the word “race” and the tapping action provided outside the ambiguous keys for the non-preferred letter (e.g. in this example, the letter “c”) (e.g. the order of tapping actions in this example is: tapping on the key 398004, tapping on the key 398002, tapping outside the keypad, tapping on the key 398003), and wherein the system considers to present at first the corresponding words that include a non-preferred character in (e.g. all of) their character position (e.g. in this example, the third) corresponding to the tapping action provided outside the keys. Preferably, the order of presenting said corresponding words is based on their frequency of use. In this case/example, the word “race” is in the second position.
3) According to one method, if none of the corresponding words is accepted by the user, the system may propose other words corresponding to the tapping actions provided by the user regardless of the status/type of the characters relating to tapping actions provided on the ambiguous keys and/or outside the keys.

It must be noted that the principles of entering text just described may be combined with other features/principles of the data entry system such as for example, word completion, context consideration such as for example using one or more N-gram databases (e.g. N=1 to 5), auto correction, insertion, reject function, correction procedure, etc.

According to one embodiment of the invention at least the words corresponding to the input information including non-preferred input signal(s) may be presented to the user one by one or several words by several words mostly based on a predefined (e.g. user's) interaction such as a rejecting/next function interaction.

It must be noted that at any moment during the entry and/or correction procedure of a word the user may provide (e.g. insert, correct) one or more precise character(s) of the word in any manner such as for example by providing a gliding action on a key/column as described throughout this patent application and/or the previous patent applications filed by this inventor. According to one method, by combining ambiguous input signal(s) and the one or more precise character(s) corresponding to a desired word, the system may predict one or more words.

It must be noted that the tapping actions provided outside the keys/columns corresponding to providing input information during the entry of a word may preferably be provided anywhere on a predefined zone such as anywhere outside the keys of the keypad/keyboard on the corresponding touch sensitive surface such as on the screen of an electronic device.

According to one embodiment of the invention, during the entry of a word, preferably after providing at least one tap on any key, if the user provides preferably several tapping actions (e.g. corresponding to any of each preferred and non-preferred character(s)), outside the keys, corresponding to some of the remaining characters of the word (e.g. ambiguous keys), the system may preferably not consider the location(s) of said tapping actions in the order of the corresponding words (because some of said tapping actions, provided at the end, may correspond to preferred characters).

According to another embodiment of the invention, another method of the order of presenting one or more of the words corresponding to the input information provided by a user based on the principles described above may be also based on the principles as follow:
Principle 1: The system considers all of the words corresponding to the tapping actions provided by the user on the ambiguous keys and/or outside the ambiguous keys for entering a word.
Principle 2: For each of the corresponding words, the system preferably compares each of the tapping actions with the character in the corresponding character position within the word and may count the total number of times that the type/status (e.g. preferred, non-preferred) of characters of the word correctly matches the impact position of the tapping action (e.g. on the ambiguous keys, or outside the ambiguous keys). According to one method, the order of presenting the said corresponding words to the user may preferably be based on the total number of matches from the highest to the lowest. According to one method, if two or more words have the same total number of matches the order of presenting said words may preferably be based on their frequency of use.

It must be noted that the keypad of the invention may have any number of ambiguous keys having any number of columns of characters. For example, according to one embodiment the system may have four ambiguous keys wherein one of the ambiguous keys may preferably correspond to non-preferred characters. According to another example, the system may include two keys/zones each corresponding to a number of non-preferred characters.

It must be noted that the non-preferred and preferred characters as shown in referred figures and descriptions are only demonstrative of the principle of the corresponding embodiments of the system, and may be varied by people skilled in the art. For example, according to one embodiment of the invention, the non-preferred characters may be those that their shape may provide ambiguity about their belonging to a key to the user. As an example, the letter “R” that has a closed circle and also stands on two points may cause ambiguity about its belonging to the key including characters with closed circle(s) or to the key with characters that stand on two points. This character may be considered as a non-preferred character and wherein the user may tap outside the keys to provide an input signal ambiguously corresponding to the letter “R”. In this embodiment, other non-preferred characters with shape ambiguity may be the characters “P”, “L” (e.g. in lowercase “l”), “j” (e.g. the user may mistakenly relate it to the key with characters that stand on one point), etc. According to another example, the preferred and non-preferred characters may vary depending on the language. Also, the number (e.g. quantity) of preferred and non-preferred character may vary.

According to principles described above at least three types of letter assignment to the ambiguous keys and a predefined zone such as the zone outside the keypad may be considered, such as:
1) A first group of characters including at least substantially all of the letters of a language ambiguously assigned to a number of keys such as four keys, and a second group of characters including at least substantially all of the letters of a language ambiguously assigned to a key/zone outside said (e.g. ambiguous) keys, wherein preferably each of said groups of characters includes preferred and non-preferred characters, and wherein preferably, the preferred characters of the first group are mainly the non-preferred characters of the second group.
2) A first group of characters including at least substantially all of the letters of a language ambiguously assigned to a number of keys such as four keys, and a second group of characters including some of the letters of a language ambiguously assigned to a key/zone outside said keys, wherein preferably said first groups of characters includes preferred and non-preferred characters, and wherein preferably, the characters of the second group are mainly the non-preferred characters (e.g. of the first group).
3) A first group of characters including some of the letters of a language ambiguously assigned to a number of keys such as four keys, and a second group of characters including substantially the remaining letters of said language ambiguously assigned to a key/zone outside said keys.

After rejecting a first group of one or more proposed word(s), the system may preferably enter into the correction procedure of the invention wherein the system may preferably switch into precise mode. In such a case, preferably, all of the ambiguous characters (e.g. preferred and non-preferred characters) assigned to ambiguous keys, may be show on the corresponding keys (e.g. in corresponding columns). Optionally, the system may also propose one or more new words corresponding to the input information provided by the user thus far. According to one method, the user, at his/her own discretion, may proceed to the correction procedure of the invention, and/or provide another one/more rejection function. According to one method, for each use of the rejection function, the system may preferably propose a new word.

It must be noted that according to one method, the first group of characters ambiguously assigned to a first type of interaction with a key (e.g. ambiguous key), may preferably substantially include special characters, and a second group of characters ambiguously assigned to a second type of interaction with a key (e.g. ambiguous key).

FIG. 400 shows another type of arrangement of characters on the ambiguous keys of the invention.

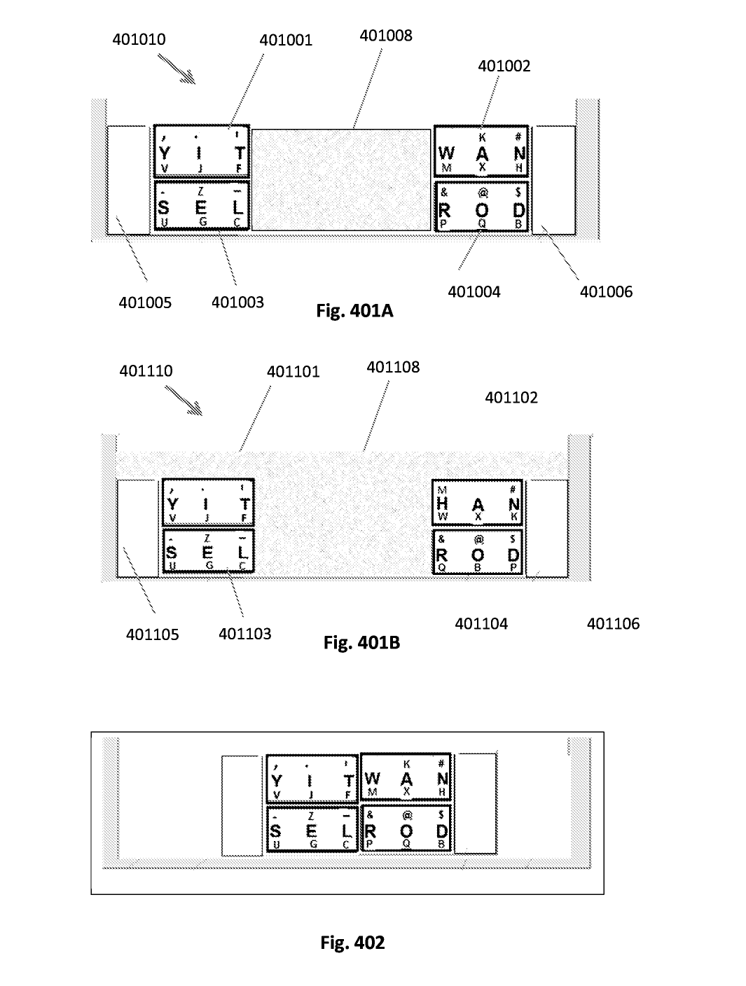

Preferably, the first number of (ambiguous) keys to which the first group of characters is assigned is four, although any other number of keys may be considered. Said (ambiguous) keys may be split in two groups of keys arranged on, for example, opposite sides of a touch sensitive surface such as a touch screen (e.g. as shown in FIGS. 401A, and 401B), or they may be grouped together for example by forming a two by two matrix of keys (e.g. as shown in FIG. 402). It must be noted that in addition to the (ambiguous) keys the keypad of the invention may include additional keys such as for example one, two or more keys (e.g. such as the keys 401005, 401006 to which at least the space and/or backspace functions are assigned).

As described before, in addition to the keypad of the invention to which a first group of characters is assigned (e.g. said keypad preferably having four ambiguous keys preferably mainly including a first group of character/letters, and preferably some (e.g. two) additional keys preferably mainly including functions), a predefined zone/key (e.g. such as a portion (e.g. 401008 of FIG. 401A, 401108 of FIG. 401B), or all of the zone (e.g. 401009 of FIG. 401A, 401109 of FIG. 401B) outside the keypad or outside the ambiguous keys of said keypad may preferably be assigned to a second group of characters, wherein during entering a word, interaction(s) such as (e.g. quick) tapping actions on said zone may ambiguously correspond to a/any of character of said second group of characters. This matter has already been described in detail before. It must be noted that instead of one outside zone, the system may include two or more outside zones wherein preferably said second group of characters are assigned (e.g. in a distributed manner) to said two or more outside zones. FIGS. 401A to 401B, show some examples of other types of arrangement/assignment of characters to the first group of (ambiguous) keys (e.g. preferably, when the system is using an English database). According to another example, the preferred and non-preferred characters may vary such as for example depending on and/or according to the language. Also, the number (e.g. quantity) of preferred and non-preferred character may vary.

As an example, in French language, in the example of FIG. 401A, the types of letters “W” and “H” may preferably be swapped, wherein in said language the letter “W” may be considered as a non-preferred character and the letter “H” may be considered as a preferred character.

According to one method, the preferred characters of the first group of characters and the preferred characters of another group of characters, each of said groups respectively assigned to a first number of keys and to a number of second zone(s) outside said first number of keys as described before, may include at least one common character. According to one method, the non-preferred characters of the first group of characters and the non-preferred characters of said another group of characters may include at least one common character. As an example, the letter “R” may be considered as being a preferred character of each of the groups of characters. In this case:
According to a first method, if two or more words corresponding to the input information provided by a user have the same total number of matched characters (e.g. matched characters have been described before in detail), among them the system may first propose those words that do not include matched characters that belong to both the preferred and non-preferred types of characters.
According to a second method, when two or more words have the same total number of matched characters, the system may propose those words regardless of having one or more matched characters belonging to both the preferred and non-preferred types of characters.

It must be noted that although the word “key(s)” is used in many paragraphs to demonstrate the principles of data entry system of the invention, said “key(s)” may be zone(s) on a touch sensitive surface such as a touch screen or in the air/space.

According to one embodiment of the invention, when the system is in the predictive mode, the gliding actions for entering precise letters and/or special characters may be provided on/from anywhere on a key (e.g. regardless of location of characters in corresponding columns/zones) in the direction of the character as described throughout different patent applications filed by this inventor. In this case, according to one method, preferably, when such system is in the precise mode, then a tapping action on a column may preferably correspond to a predefined character (e.g. in the center) of said column and gliding action(s) (e.g. upward, downward) on/from a column/zone may correspond to the corresponding characters (e.g. respectively, on the top and on the bottom of said column) within/on said column of characters.

According to one embodiment of the invention, after the system proposes one or more words, if the predicted word(s) are not what the user wants he/she may reject said word(s) by, for example, providing a predefined interaction such as a gliding action leftward from the space key. The system may again propose one or more words. According to one method, if the new predicted word(s) are not what the user desires, the user may reject said word(s) again. Furthermore, said word(s) may again be rejected if they are not what the user desired. According to one method, this procedure may be repeated.

According to one method, at any moment after providing a rejection action the user may proceed to the correction procedure. According to a second method, at some point such as for example if the frequency of use of the remaining corresponding words to be proposed is less than a result of a calculation and/or a predefined number (e.g. different calculations or a different numbers may be applied to the words with different number of characters), the system may provide an alert to the user so that he/she may proceed to the correction procure. As described before, if the desired word is in the dictionary providing one or some of the characters of the desired word during the correction procedure may (e.g. generally) be enough for the system to predict the desired word. If the desired word is not in the dictionary, generally, the user may enter precisely all of the characters of the desired word.

According to one embodiment, at some point during the proposal of predicted word(s) if the system does not find the user's word (e.g. according to one embodiment, the system may be designed such that words having less than a predefined number of frequency/priority may not be proposed unless using the correction procedure, such words at this stage may be ignored by the system) the system may alert the user and ask her/him to enter his word letter by letter precisely using the system keyboard in the precise mode. Preferably, the system may erase all proposed word(s) until then. According to one method, during the entry of precise characters, the system may search for word(s) corresponding to the input information provided until then including to the input information provided for the erased proposed words.

It must be noted that the principles of assignment of groups of characters (e.g. in a preferred and non-preferred manner) to a number of keys and to one or more zone outside said keys as described throughout this patent application and the related previous patent applications filed by this inventor may be applied to any kind of characters such as alphabetical characters (e.g. Roman, Korean, Arabic, Hindi), phonetic characters (e.g. Chinese characters, Japanese characters), etc. Some exemplary arrangements are described hereafter:

The keyboard has 4 keys. On each key are 3 preferred letters. The rest of the letters are on the outer zone. The letters are arranged according to a shape-logic, with some exceptions ( [symbol] would need to be on the third key, but is an exception to the rule).

On the first key the preferred letters are: [symbol] , [symbol] , [symbol]
On the second key the preferred letters are: [symbol] , ••, [symbol]
On the third key the preferred letters are: [symbol] , —, [symbol]
On the forth key the preferred letters are: [symbol] , •, ∘
On the outside zone are all the letters, including [symbol] , [symbol] , [symbol] , [symbol] , [symbol] , [symbol] , which are non-preferred letters, thus not appearing on any of the 4 keys.

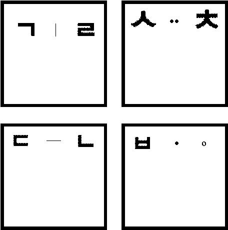

### Korean Double Consonants

A [symbol] or Shift key on the SP or BK would be used to enter these consonants. When turned on, the letters' value will changes to the following: [symbol]
turns into [symbol] [symbol]
turns into [symbol] [symbol]
turns into [symbol] [symbol]
turns into [symbol] [symbol]
turns into

[symbol]

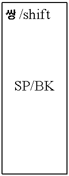

The next method for entering vowels is common in Korean cellphones (except from smartphones in which one can use different keyboards). The •• symbol is added by SnapKyes and should be used in instances where a vowel is doubled. The Korean keyboard could either include the •• or not.

The Korean vowels are constructed from these four symbols: |, ••, —, •.
The user would have to “draw” the wanted vowel. For example: [symbol]
would be constructed by first entering | and then •. [symbol]
would be constructed by first entering •• and then |

[symbol]
would be constructed by first entering •• and then — [symbol]
would be entered by following this sequence: —, •, •, |

The keyboard has 4 keys. On each key are 3 preferred letters. The rest of the letters are on the outer zone. The letters are arranged according to a shape-logic, with some exceptions ( [symbol] would need to be on the third key, but is an exception to the rule, as are some other Hangeul).

On the first key the preferred letters are: [symbol] , [symbol] , [symbol] , [symbol]
On the second key the preferred letters are: [symbol] , [symbol] , [symbol] , [symbol] ,
On the third key the preferred letters are: [symbol] , [symbol] , [symbol] , [symbol]
On the forth key the preferred letters are: [symbol] , [symbol] , [symbol] , [symbol]
On the outside zone are all the letters, including [symbol] , [symbol] , [symbol] , [symbol] , [symbol] , [symbol] which are non-preferred letters, thus not appearing on any of the 4 keys.

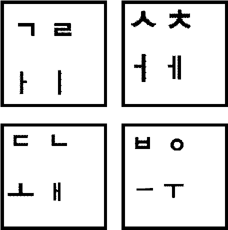

A [symbol] or Shift key on the SP or BK would be used to enter these consonants. When turned on, the letters' value will changes to the following: [symbol]
turns into [symbol] [symbol]
turns into [symbol] [symbol]
turns into [symbol] [symbol]
turns into [symbol] [symbol]
turns into

[symbol]

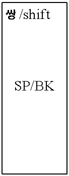

The Korean vowels will also change to the following when Shift is turned on: [symbol]
, [symbol] , [symbol] [symbol]
, [symbol] , [symbol]
The construction of the 7 diphthong vowels is as following: [symbol]
, [symbol] , [symbol] [symbol]
, [symbol] ,

[symbol]

[symbol]

### Chinese-Pinyin Letter Arrangement

The keyboard consists of 4 keys. Each of those keys includes 3 letters (hereinafter referred to as preferred letters) arranged by their shapes (as described above):
Key 1 includes letters J, I, V.
Key 2 includes letters N, A, M.
Key 3 includes letters Z, U, L.
Key 2 includes letters D, O, B.

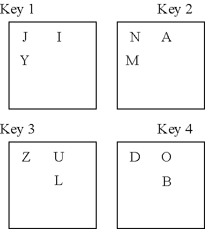

In order to type any of the preferred letters, the user has to tap anywhere on the respective key. In order to type any other letter which is not included in the four keys (hereinafter referred to as non-preferred letters, i.e. C, E, F, G, E, K, P, Q, R, S, T, V, W, X), the user has to tap anywhere outside the four keys.

The keyboard has 4 keys. On each key are 3 preferred letters. The rest of the letters are on the outer zone. The letters are arranged according to a shape-logic.

On the first key the preferred letters are: Y, T, I
On the second key the preferred letters are: N, H, K
On the third key the preferred letters are: U, S, E
On the forth key the preferred letters are: O, R, A
On the outside zone are all the letters, including C, M, W which are non-preferred letters, thus not appearing on any of the 4 keys.
The letter A is located on the forth key because it has a small closed area on top.
On the SP or BK key a handakuten (°) and dakuten (″) will serve the following purpose: When the ″ ° is turned on, the letters' value will change to the following:
T turns into D
H turns into P/B
S turns into J/Z
K turns into G

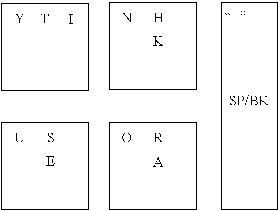

Video/Picture Sharing with Audio Message and/or Music
According to on e embodiment of the invention, a content (e.g. video/picture) sharing application may be created wherein the users can see a video and comment about it and/or provide live texting. According to one method, a shared content may be accompanied with a vocal message and/or a music provided by any user/person (e.g. in a live chat room, by any of said users). According to one embodiment, during watching a video, a predefined interaction such as a predefined type of gliding action on the screen of the corresponding device may provide an event informing the system to memorize that instance of the video being played, so that the system may replay that portion of video based on user's demand relating to that event.

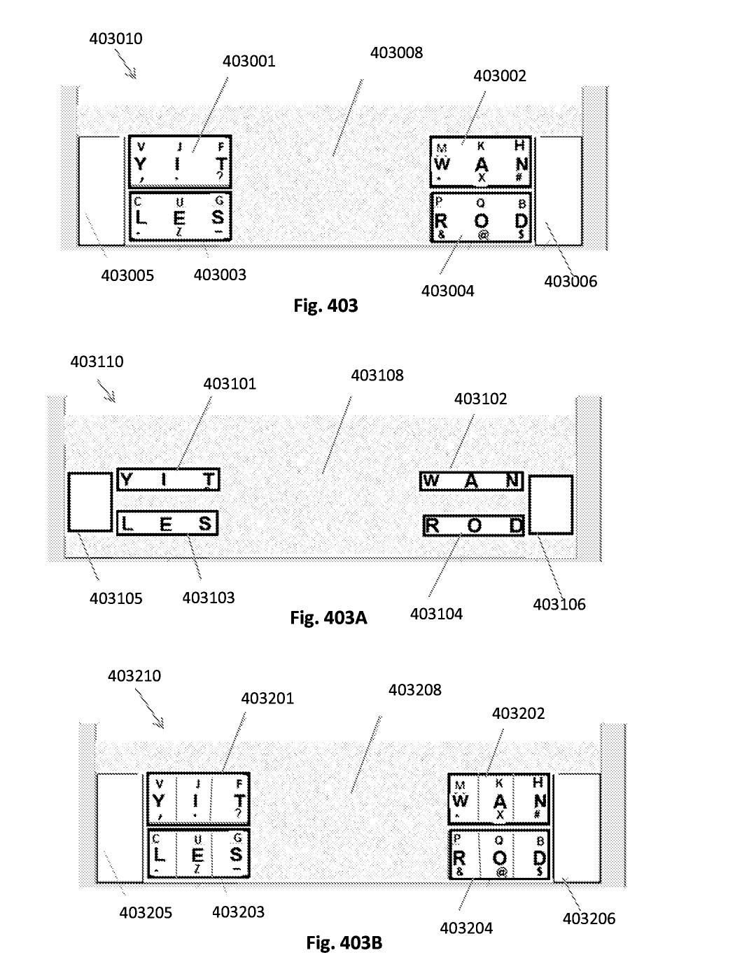

According to one embodiment, a first group of characters may ambiguously be assigned to a first number (i.e. one or more) of input signals such as four input signals (e.g. provided by interacting with a predefined number of keys such as four (e.g. soft, on-screen) keys), and a second group of characters may ambiguously be assigned to at least one other input signal (e.g. provided by interacting with one or more predefined zone/s other than or outside said first keys (e.g. preferably one or more large zone/s around and/or next/near to said first keys (e.g. see the gray zone 403008 in FIG. 403))). Preferably, the first group of characters may include a small number of characters (e.g. of a language), and the second group of characters may preferably include a large number of characters (of a/said language). According to one method, the second group of characters may preferably include at least some of the characters of the first group. According to a second method, the second group of characters may mainly exclude the characters of the first group of characters (e.g. may preferably complement a predefined set of characters).

As mentioned, the first group of characters may be divided into several sub-groups of generally at least two characters wherein each sub-group of characters being generally ambiguously assigned to one of a first number of keys such as four keys. A predefined first type of interaction, for example, such as a tapping action on a key of said first number of keys, may ambiguously correspond to any characters of the corresponding sub-group(s) of characters. According to one embodiment of the invention, at least one of said keys (of said first number of keys) may represent an additional number of characters wherein any character of said additional number of characters may be entered precisely by providing a predefined second type of interaction such as a gliding action with a/its corresponding key. According to one method, each of the ambiguous characters assigned to a key may also be precisely entered by providing a predefined interaction such as a predefined gliding action on the corresponding key. The arrangement of characters (e.g. ambiguous and/or precise) and the method of interactions with a key to enter a character ambiguously and/or precisely may be based on arranging said characters in one or more columns of characters on corresponding keys to which said characters are assigned. According to one method, the characters assigned to a key as described above may form a number of (e.g. three) columns of characters wherein preferably the characters printed/arranged in the center of the columns of characters of each key are preferably the ambiguous characters assigned to said key, and the additional characters assigned to said key are preferably printed on the top and/or on the bottom within said columns. As an example, in FIG. 403, the letters “Y”, “I” and “T” which are separately from each other located/printed in the center of a different column of characters on the key 403001 are in this example the ambiguous characters assigned to said key 403001, and the others characters assigned to the key 403001 are the characters that are designated to be entered precisely by respectively providing gliding actions upward or downward on the corresponding columns of characters on said key 403001. Also the ambiguous character (e.g. in this example, the ambiguous letter) of each column may be precisely entered by providing a gliding action leftward or rightward from the corresponding column. The gliding actions provided on/from a column for precisely entering the characters within said column have already been described in detail. In this example, the principles of entering characters ambiguously and/or precisely as described to the key 403001 may be applied to other keys such as the keys 403002-403004.

According to one embodiment of the invention, when the system is in the Predictive Mode, mainly/only the ambiguous characters assigned to the keys may be printed on the corresponding keys, and the additional characters may preferably not be printed on the corresponding keys. In this case, when the system is in the Precise Mode, all of said characters may be printed on the corresponding keys. As an example, FIG. 403A shows the keys of the system in the Predictive (e.g. letter) Mode, and FIG. 403B shows the keys of the system in Precise (e.g. letter) Mode.

According to one embodiment, preferably, the second group of characters are not shown (e.g. are not printed on the corresponding zone/s) to the user. Accordingly, some, most, or all of the characters of the first group of characters are preferably shown to the user (e.g. are printed on the corresponding keys).

According to one method, preferably the user interacts with (e.g. taps on) a corresponding key of the first number of keys for a shown/printed character on said keys, and interacts with (e.g. taps on) zone/s outsides the keys of the first number of keys for the non-shown/non-printed characters. Using this interface and method of text entry requires a small amount of cognitive effort. The first and the second group of characters may have any type of characters such as letters and/or special characters. Preferably, the first group of characters may include a small number of characters, preferably, mainly letters, and the second group of characters may preferably include any types of characters such as letters and/or special characters.

According to one method, each of both, the first number of keys and the one or more outside zones, may differently respond to different types of interactions with said keys or the outside zone(s). As described before, to each of said different types of interactions with a key or zone, a (e.g. different) number of characters may be assigned. The methods of assignment of characters to different interactions with an input means such as a key/zone have been described before in detail.

It must be noted that the order of assignment of the two groups of characters as described above may be swapped between the first and second groups of input signals (e.g. respectively, provided by interactions with key, zones).

According to one embodiment of the invention, generally after a short period of time of interaction with the simplified interface the user may remember the position of letters on the corresponding keys.

According to one embodiment, the surface of the keys may be used for other information such as printing contents such as menus of one or more applications, advertising, etc. According to one embodiment, the content (e.g. images) of the keys may be replace by and/or include other information (e.g. interactive and/or non-interactive, dynamic and/or static information/GUI controls) such as displaying content such as menus of one or more applications, links to web page(s), advertisement(s), navigation control(s), etc.

According to one embodiment, content (e.g. images) may be displayed/activated in a location relative to any of the location of the keys/zones/columns of the keypad (e.g. such content may augment the content (e.g. image(s)) of keys/zones/columns) and/or may include other information/content (e.g. interactive and/or non-interactive, dynamic and/or static information/GUI controls) such as displaying content such as menus of one or more applications, links to web page(s), advertisement(s), navigation control(s), etc.

By providing advertisements on the keys of the keypad, a discrete/non-invasive/invasive advertising system (e.g. such advertisements hereafter may be referred to as “Ad”) may be implemented with the system. Because such advertising information is shown on and/or near the keys, preferably the letter keys of the keypad in preferably the predictive mode, the user may not be bothered or distracted, and such user may consider such advertisement as being less of a distraction compared to other advertisement systems/methods. If the user is interested to know more about an Ad shown on a key, he/she may provide a predefined interaction such as a gliding action in a predefined direction (e.g. diagonal direction) on the corresponding key/zone/column/surface area having such Ad. In this case, preferably a corresponding expanded/larger Ad (e.g. than may generally be traditionally acceptable when having other advertisement systems) may be shown on the screen. Accordingly, a predefined interaction such as pressing a dedicated location on the Ad or a predefined gliding action on the Ad may remove the expanded Ad from the screen.

According to one method, the Ads may be transmitted/allocated to the keys based on user's text/content (e.g. keywords, sentences, paragraphs, images, icons, etc.) being entered. For example, if the user is communicating (e.g. texting) about his/her favorite soccer team, then advertisements regarding/corresponding to the selling the tickets for a match of said team may be displayed on one or more the keys of the keypad. Such display of said advertisements may be done a short time (e.g. almost immediately) and/or a long time (e.g. a few minutes/hours/days/weeks) later after said entry of said text/content.

It must be noted that the (e.g. expanded) Ad may be of any type such as an interactive Ad (e.g. presenting a form to fill) and/or a non-interactive Ad. Such Ads may also be dynamic (moving pictures) and/or static.

The surface of the keys of the keypad may be used for any other purpose. As an example, during any texting session between or more users, images (e.g. pictures, videos, etc.) of said users may be shown on the keys. As mentioned before, upon receiving any information such as information regarding a predefined interaction provided on one or more of the keys, said images or the relating content may be expanded/enlarged on the screen.

According to one embodiment of the invention, predefined interactions such as gliding actions in several predefined directions in/departing from a/the (e.g. large) zone (e.g. in this patent application may be referred to as “navigation zone”) may relate to scrolling within words corresponding to the input information provided by the user (e.g. until then) and, preferably eventually, selecting one or more words. As an example, FIG. 404A shows the words “Hello” 404008 and “Fellow” 404018 predicted by the system based on, for example, the tapping action provided on the navigation zone 404019 (e.g. relating to the first predicted letter of each of said words) and the tapping actions on the keys 404003, 404003, 404003, and 404004, on the screen 404009. In this example, the “Hello” is the current predicted word (e.g. the word that each time the user inserts/appends a/an additional character, said character is added to the end of the current word being entered) and the word “Fellow” is an alternative word. According to the current example, providing a gliding action upward 404011 from anywhere on the navigation zone 404019 may preferably correspond to entering/confirming the proposed/predicted word 404008 (i.e. printed on the top) (e.g. in this example, the current predicted word), providing the same result as a tapping action on the space key, and providing a gliding action downward 404012 from anywhere on the navigation zone 404019 may preferably correspond to entering/confirming the proposed/predicted word 404018 (i.e. printed on the bottom) (e.g. in this example, the alternative word).

With continuous description of the current example, as shown in FIG. 404A, a gliding action provided in a predefined direction such as rightward (e.g. forward) 404013 from anywhere on the navigation zone 404019 may preferably correspond to informing/instructing the system to show/present one or more additional/other words corresponding to the input information relating to the desired word provided by the user until then (e.g. scrolling forward in the words corresponding to the input information provided by the user), and a gliding action provided in a predefined direction such as leftward (e.g. backward) 404014 from anywhere on the navigation zone 404019 may preferably correspond to informing/instructing the system to show/present one or more words corresponding to the input information provided by the user that were previously shown/presented (e.g. words that were scrolled forward) to the user (e.g. scrolling backward in the words corresponding to the input information provided by the user).

In order to (e.g. dynamically) provide information to the user about the direction of the gliding action relating to each of the functions (e.g. scrolling-within/selecting word(s)) just described, an indicating icon such as the icon 404117 of FIG. 404B may be presented on the screen or preferably on the navigation zone. Preferably, said icon may be presented to the user after a predefined laps of time each time the user provides an additional information (e.g. insertion/appending, correction, rejection, backspace, undo) provided by the user. Accordingly to one method, the user may be enable to order/instruct the system not to show the icon to the user by, for example, providing a tapping action on a dedicated zone such as the zone 404118 on or close to the icon 404117.

Note that in the examples provided above, the order of gliding actions and/or presentation of words may be changed/swapped for any reason such as for example, when typing words in languages such as Arabic (e.g. from right to left), and Japanese (e.g. from top to bottom). It must be noted that the gliding actions provided on/from the navigation zone may end outside the navigation zone.

FIG. 404B also shows another example of assignment of symbols to the space and backspace keys. In this example, character “.” is preferably assigned to a gliding action which is provided downward on/from the space key, and a gliding action which is provided leftward on the space key is preferably assigned to the “Edit Word” function.

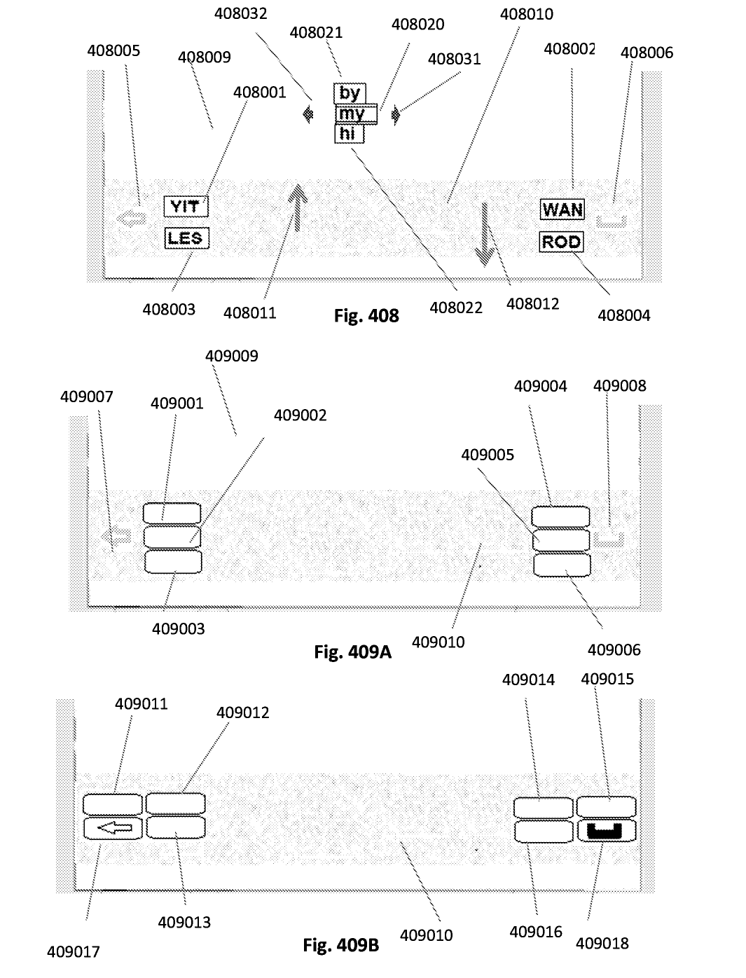

As mentioned before, by positioning the cursor/caret in a predefined position, preferably attached-to and/or on a word, and providing a predefined interaction such as gliding action in a predefined direction such as, for example, a gliding action provided leftward on/from the space key as shown in FIG. 408B, the system may select said word and consider it as the current predicted word (e.g. and preferably bring it to the front position) to be (re-)edited by the user. According to one embodiment of the invention, if the cursor/caret has another predefined position relating to a word such as being immediately positioned after a space character after a word, then providing the predefined interaction just described (e.g. a gliding action provided leftward on/from the space key) in addition to selecting said word the system may also show/present to the user at least one alternative word corresponding to the input information relating to said selected word. As an example, if the user is entering a word and the system presents for example two (e.g. or more) words (e.g. the current predicted word, and at least one alternative word) to the user and the user erroneously presses the space key and the system enters the current predicted word and adds a space character after the word just being entered, providing a gliding action leftward from the space key informs/orders the system to bring back said two (e.g. or more) words for editing (e.g. this may be considered as being similar to the functionality of an Undo function).

During the entry of a word and/or preferably during the correction procedure, providing one or more backspaces may correspond to providing one or more undo actions/functions. As an example, by tapping on the keys 404002, 404001, 404004, 404003, the system may first propose two words “wide” (e.g. the current predicted word) and the word “widely” (e.g. an alternative word). If the user rejects said words, the system may propose two more words “wire”, and “aids”. Now, if the user proceeds to the correction procedure and instead of providing an “h” enters the letter “k”, the system may propose/present the word “kire” (e.g. because the system does not find a word corresponding to the input information provided by the user until then (e.g. including the precise letter)), then the system only replaces the selected (e.g. first) ambiguous letter “w” by the precise letter “k”, and the rest of the characters of the current predicted word remain unchanged. Now, if the user provides a pressing action on the backspace key, the system preferably considers said action as an undo action and goes one instance back and re-proposes the words “wire” and “aids”.

At this time different scenarios may be considered:
Scenario 1: If the user enters precisely the letter “h”, the system may propose the word “hire”.
Scenario 2: If the user provides another pressing action on the backspace key, the system preferably considers said action as an additional undo action and goes one instance back and re-proposes the words “wide” and “widely”. Now, if the user provides an additional pressing action on the backspace key, the system preferably considers said action as an additional undo action and goes one instance back and re-proposes the words “air” and “wide” (e.g. a/the longer word) that the system had previously provided corresponding to the first three pressing actions 404002, 404001, 404004 already provided by the user during the entry of the a word (e.g. before providing the fourth pressing action 404004). And so on.
   According to one method, after switching the system into the Precise Special Character Mode, two scenarios may be considered:

1^{st} Scenario: if the user enters one or more special characters and then presses the space key, the system automatically switches to another mode, preferably into the Predictive letter mode.

2^{nd} scenario: if the user enters one or more special characters and then presses the space key, the system remains in the Precise Special Character Mode. In this case, the user may manually switch the system into his/her desired mode.

According to one method, by providing a predefined interaction such as glide-and-holding action on/from the backspace key towards the location of the Special character function icon printed on said key, the system may enter into the 2^{nd} scenario just described above.

Different types of assignment of characters, such characters including the letters of a language, to a number of keys and one or more (e.g. large) zones outside said keys has been described before in detail in different related patent applications filed by this inventor. According to one embodiment of the invention, the system may include at least two modes where in each of said modes the system is based on one of said types of assignments. Different scenarios may be considered such as:
In a first mode, the system may be preferably based on the ambiguous and/or distributive assignment of the letters of a language to a number of keys such as four keys and a (e.g. large zone) outside said keys. According to one method, at least some special characters may also be assigned preferably to the zone outside the keys. In this mode, preferably, if the last portion of the input information corresponding to a word is provided by tapping actions on said zone outside the keys, then preferably, the system may (e.g also) ambiguously relate said tapping actions to the letters that are assigned to the keys. This mode may be highly accurate. The desired word of the user may be predicted very quickly.
In a second mode, the system may be preferably based on the ambiguous and/or distributive assignment of some (e.g. preferably a small number) of the characters (e.g. preferably a small number of letters) of a language to a number of keys preferably four keys, and on the ambiguous assignment of at least substantially all of the letters of a language and/or (e.g. additionally) a number of special characters to a predefined (e.g. large) zone outside said keys. This type of assignment of characters has been described before in detail. In this mode, the desired word of the user may not be predicted as fast as in the first mode. This mode may greatly help/assist in the identification and/or correction of spelling/typographical mistakes. For example, in the word “receive”, if the user does not know that it is spelt “received” or “recieved”, he/she may provide the corresponding two tapping actions, corresponding to the letters “ie” or “ei” as the case may be, in the zone outside the keys. The system may predict the desired word after maybe one or more rejection action(s).

In the current embodiment, according to one method, a switching means may be available so that the user may switch the system between said modes.

Preferably, the system may be designed in such a way so as to enable the user to switch between modes during the entry of a word. In this case, one or more portions of a word may be entered by using the first mode, and one or more other portion(s) of said word may be entered by using the second mode, etc. In FIG. 404B, said switching means is provided by a gliding action 404126 from the backspace key towards the upper-right direction. According to one method, each time the user provides said gliding action, the system switches to another mode (e.g the other mode).

According to one method, one of the modes, preferably the first mode, may be the system's default mode. Accordingly, preferably, during the entry of a word if the system is in a non-default mode (e.g. in the second mode), after entering/confirming said word the system may preferably automatically switch into the default mode (e.g. the first mode).

It must be noted that the default mode may be changed/selected preferably by a user from one mode to another through a predefined interaction such as through the settings of the system. Preferably, the system may include/display a visual indicator to indicate the current mode of the system.

The use of tapping actions outside a number of keys to which a number of character(s) such as letters are assigned as described throughout this and the related patent applications may be applied to any type of keyboard such as keyboards having keys (e.g. each key possibly) representing a single letter/character such as a QWERTY keyboard.

As an example, in the embodiments just described above, a keyboard may have one or more lines of keys (preferably one line of keys) wherein each key represents one character such as a letter. As an example, such keyboard may preferably be composed of one of any one of the lines (e.g. preferably the top letter line) of keys of a QWERTY keyboard. Two scenarios may be considered:

1. The rest of letters and/or at least some of the special characters may be ambiguously assigned to a/said (e.g. large) zone outside said keys.

2. All the letters of a language may be ambiguously assigned to a/said zone outside said keys.

According to one embodiment of the invention, a (e.g. large) zone outside the keys of a (e.g. complete) QWERTY keyboard may ambiguously be dedicated to preferably all of the letters of a language.

In the embodiments above, as an example, during the entry of a word, the user may provide tapping actions on the keys of the QWERTY keyboard corresponding to some of the characters of a word, and he/she may (e.g. also) provide tapping actions in said outside zone ambiguously corresponding to at least some of the other characters of a word. This may enable the user to type faster and/or enter words for which he/she does not know the exact/correct spelling.

In the precise mode, according to a first method, the keyboard may include three lines of keys and the letters may be entered by tapping on these keys. According to a second method, the keyboard may include a first line of keys and the letters may be entered by providing tapping and gliding actions as described in the related previous patent applications.

The keyboard may have one or more instances of one or more lines of keys to enter special characters in precise mode by any of the means described before.

Said lines of keys may be presented/displayed in the vertical, horizontal, and/or oblique orientations.

Said line(s) in the QWERTY based example may contain changes of the characters assigned to one or more rows of keys.

According to one embodiment of the invention, during the entry of text, at least one of some of the keys of the keypad may represent an option/action to access/execute another application such as, for example, a search or a social networking application. As an example, providing a predefined interaction such as a long gliding action provided on/from a key may switch an operating system to a predefined application represented by said key. As an example, during the entry of text (e.g. using the system) in a first application, a portion of the information content (e.g text) may be selected. As an example, one of the keys of the keypad may represent the “Google search” application. By providing a predefined interaction with said key, the operating system may focus/activate the Google Search application and use/for use of the selected portion of said information content (e.g. text), for example, as a keyword of a search field. A searching action may be provided automatically. The user may switch back to the previous application by providing an Undo function of (for example) the device, or for example of the second application, or for example of the keyboard, etc.

It must be noted that in this and in the related patent applications, a predicted word may be predicted based on the principles of the use of the entries of N-gram (e.g. 1 or more grams) databases such as those described in detail in different patent applications filed by this inventor.

Different types of assignments of characters, such characters including the letters of a language, to a number of keys and one or more (e.g. large) zones outside said keys has been described before in detail in different related patent applications filed by this inventor. According to one embodiment of the invention, the system may include at least two modes where in each of said modes the system is preferably based on at least one of said types of assignments. Different scenarios may be considered such as:
In a first mode, the system may preferably be based on an ambiguous and/or distributive assignment of the letters of a language to a number of keys such as four keys and one or more zones, preferably one zone (e.g. large zone) outside said keys. According to one method, at least some special characters may also be assigned preferably to a zone outside the keys. In this mode (e.g. herein/hereafter may be referred to as “high accuracy mode”), preferably, if the last portion of the input information corresponding to a word is provided by tapping actions on said zone outside the keys, then preferably, the system may (e.g. also) ambiguously relate said tapping actions to the letters that are assigned to the keys. This mode may be highly accurate. The desired word of the user may be predicted very quickly. In this example, preferably, a small number of letters are assigned to said number of keys, and the remaining letters of a language and/or (e.g. additionally) a number of special characters are preferably assigned to a number of zones, preferably one zone, outside said keys. According to one method, each of the keys (e.g. four keys) and said zone(s) outside said keys may include a vowel letter of a language. FIG. 404A shows the arrangement of assignment of a small number of letters to four keys 404001-404004. The rest of the letters (e.g. not shown) are assigned to the zone 404019 outside said keys. In this example, interactions such as tapping actions on the four keys 404001-404004 provide four different input signals each ambiguously corresponding to three characters, and interaction such as a tapping action in the predefined zone 404019 outside the four keys provides an input signal ambiguously corresponding to at least the rest of the characters of the language.
In a second mode (e.g. herein/hereafter may be referred to as “spelling help mode”), the system may preferably be based on the ambiguous and/or distributive assignment of some (e.g. preferably a small number) of the characters (e.g. preferably a small number of letters) of a language to a number of keys preferably four keys, and on the ambiguous assignment of at least substantially all of the letters of a language and/or (e.g. additionally) a number of special characters to a predefined (e.g. large) zone outside said keys. This type of assignment of characters has been described before in detail. In this mode, the desired word of the user may not be predicted as fast as in the first mode. This mode may greatly help/assist in the identification and/or correction of spelling/typographical mistakes. As an example, each time the user is not sure about the correct spelling of one or more portions of a word, he/she may provide tapping actions corresponding to the letters of said one or more portions of the word in a predefined zone(s) outside the keys. For example, in the word “receive”, if the user does not know that it is spelt “received” or “recieved”, he/she may provide the corresponding two tapping actions, corresponding to the letters “ie” or “ei” as the case may be, in the zone(s) outside the keys. The system may predict the desired word after maybe one or more rejection action(s).
   In the current embodiment, according to one method, a switching means may be made available so that the user may switch the system between said modes.
   Preferably, the system may be designed in such a way so as to enable the user to switch between modes during the entry of a word. In this case, one or more portion(s) of a word may be entered by using the first mode, and one or more other portion(s) of said word may be entered by using the second mode, etc. In FIG. 404B, said switching means is provided, as an example, by a gliding action 404126 from the backspace key towards the upper-right direction. According to one method, each time the user provides said gliding action, the system switches to another mode (e.g the other mode).

According to one method, one of the modes, preferably the first mode, may be the system's default mode. Accordingly, preferably, during the entry of a word if the system is in a non-default mode (e.g. in the second mode), after entering/confirming said word the system may preferably automatically switch into the default mode (e.g. the first mode).

It must be noted that the default mode may preferably be changed/selected by a user from one mode to another through a predefined interaction such as through an interaction with the settings of the system.

Preferably, the system may include/display a visual indicator to indicate the current mode (e.g. first mode or second mode) of the system.

According to one embodiment of the invention, when the system is in the spelling help mode, each time the user provides a sequence of one or more input signals corresponding to at least one portion of a word being entered by providing tapping actions (e.g. in the zone) outside the (e.g. four letter) keys, in addition to ambiguously relating said sequence of interactions to the letters assigned to said zone the system may preferably also consider that said interactions may have been provided because the user does not know the spelling of that portion (e.g. herein may be referred to as an “unknown spelling portion”) of the word being entered (e.g. In this application said one or more input signals may be referred to as “unknown spelling input signal(s)”). In this case, according to one method, (e.g. if needed/designed) the system may append one or more (e.g. preferably one or two) unknown spelling input signals to said at least one sequence of unknown spelling input signals provided by the user during the entry of a word, and predicts more words by combining the input information provided by the user and said added spelling input signals provided by the system. Additionally/optionally, according to one method, the system may (also) exclude one or more (e.g. preferably one or two) spelling input signals from the sequence of unknown spelling input signals provided by the user and predict words based on the input information provided by the user excluding said one or more unknown spelling input signals that are excluded.

As an example relating the current embodiment, when the system is in high accuracy mode, in order to type the word “beethoven”, if the user is not sure about a number of letters representing the phoneme “eh” after the letter “b” such as “e”, or “ee” or “ea”, she/he may first tap in the zone outside the keys for the letter ‘b’, then switch the system into the spelling help mode, tap one time outside the keys for one (or more, as may be controlled by the system, if needed) unknown spelling character, then switch the system back to the high accuracy mode, tap on the key corresponding to the letter ‘t’, tap in the zone outside the keys for the letter ‘h’, tap on the key corresponding to the letter ‘o’, tap in the zone outside the keys for the letter ‘IT’, and tap on the keys corresponding to the letters ‘e’ and ‘n’.

After providing the input information (e.g. the tapping actions just mentioned), the system may search for one or more words corresponding to said input information. In this example, the user rejects all of the corresponding words (e.g. “pathogen” and “glycogen”) proposed/predicted by the system. The system then, may add/consider an additional unknown spelling input signal (e.g. immediately after the original unknown input signal provided by the user) within the input information provided by the user to provide a “combined input information” and searches for one or more words corresponding to said combined input information within the database used by the system. In this example the system may propose the word “beethoven” which in this example is the only word corresponding to the combined input information.

According to one method, if the user is not sure about the existence of a character within a word, he/she may switch the system into the spelling help mode and back to the high accuracy mode without providing any tapping action in the spelling mode action. In this case the system preferably first searches/proposes the words corresponding to the input information (e.g. tapping action) provided by the user and if none of them is accepted/confirmed by the user, the system may add one or more (e.g. preferably up to two) unknown spelling input signals relating to character position(s) within the word where the back-and-forth mode switching action was provided, and accordingly proposes more words to the user.

It must be noted that during the entry of a word the spelling of more than one portion of a word may have unknown to the user, and the user may provide more than one sequence of one or more unknown spelling input signals. The system may behave as described for one or more (e.g. all) of said unknown spelling portions.

It must be noted that preferably the number of unknown spelling input signals corresponding to an unknown spelling portion provided by the user may preferably correspond to or be close to the number of characters that the user believes said unknown spelling portion consists of.

According to one embodiment, the database of words used by the system may include a number of commonly misspelled words (e.g. ‘permiting’). Each of said misspelled words may point to its corresponding correctly spelled word (e.g. ‘permitting’). According to one method, if the user provides the input information corresponding to a word and the system finds one or more corresponding misspelled words (e.g. permiting), for each of the found misspelled words, the system may predict/propose its correctly spelled word (e.g. ‘permitting’) to the user.

With the continuous description of the current embodiment, according to one method, more than one predefined (input) zones outside the keys may be considered wherein interacting with a first zone may ambiguously correspond to characters/letters of a language preferably other than the letters/characters assigned to the (e.g. four) keys, and interacting with the second zone may correspond to providing an unknown spelling input signal as described above.

According to one embodiment of the invention, in the high accuracy mode, each of the tapping actions of a sequence of tapping actions, corresponding to the last portion of a word, provided on the zone(s) outside the ambiguous letter keys may ambiguously correspond to any of all of the characters including the characters that are assigned to the ambiguous letter keys.

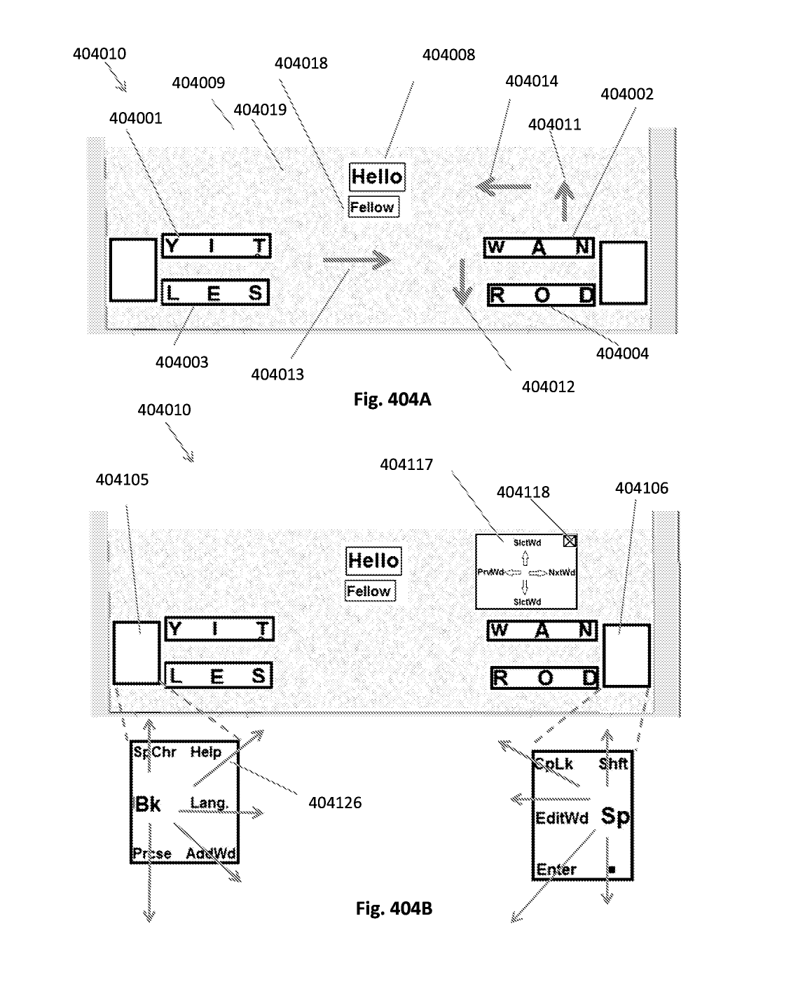

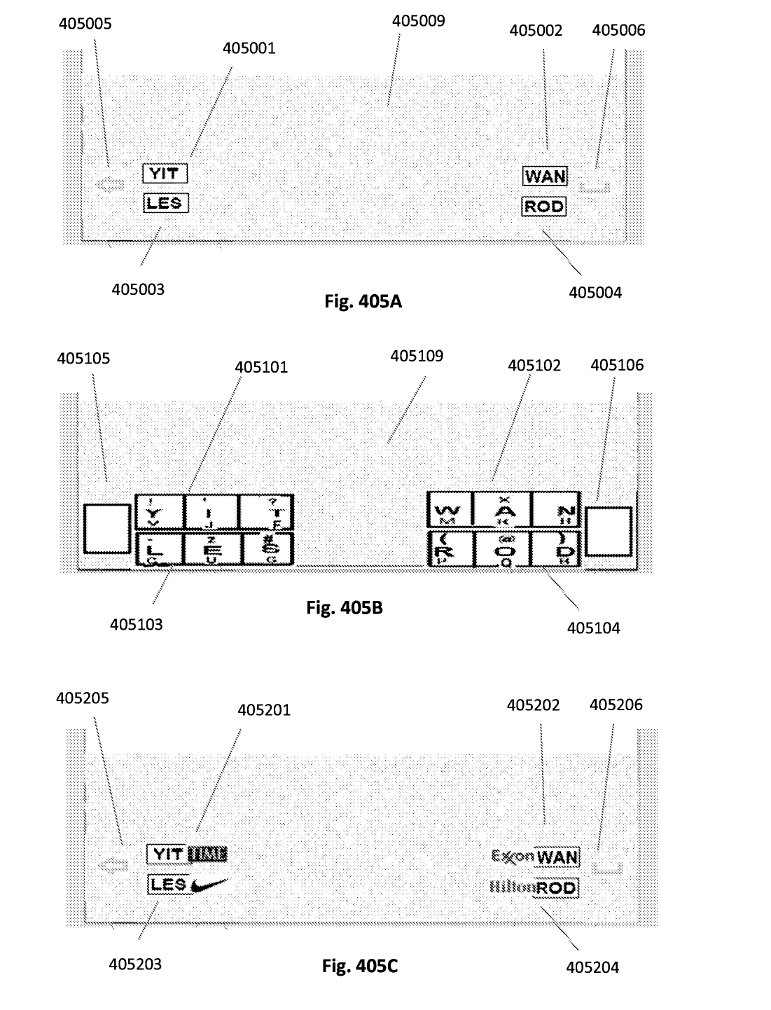

According to one embodiment of the invention, as shown in FIG. 405A, the (letter) keys of the keypad may be short in length when the system is in predictive mode, and as shown in in FIG. 405B the keys of the keypad may be long in length when the system is in precise mode. A means such as for example a slider bar or user's finger sliding action on the screen may be used to change the size (e.g. length and/or width) of the keys in one or in both (e.g. preferably, proportionally applying to both) modes. In this example, the space key 405006 and backspace key 405005 are invisible and each is represented by an icon.

As mentioned before in relating provisional patent applications filed by this inventor, the keys of the keypad may be used as banners to display advertisement and/or (other) interactive content. According to one method, as shown in FIG. 405C for example, preferably when the keys are short (in predictive mode), the letters of the key in the predictive mode may be displayed next (e.g. on any side of a key) to the advertisement. According to one method, (e.g. preferably based on predefined user interaction with a key which may display content such as an advert), at least one of said keys may be used to display one or more banners (which may be positioned next to each other). Said banner(s) may be a dynamic moving and/rotating information display.

According to one embodiment of the invention, in addition to the ambiguous keys, one or more keys of the keypad of the invention (e.g. preferably, space key and/or the backspace key) may be designed such as to provide one or more characters that may be considered as part of a word being entered during the entry of a the word. Preferably, said characters (e.g. ‘period’) may be provided precisely. Example of such words may be the words ‘www.google.com’, ‘2.5×’, ‘etc.’.

According to one embodiment of the invention the user may use a scrolling mode to scroll between different databases of words (e.g. languages, specialty word lists, etc.) to reach the database he/she desires to have used by the system. According to one method, for each scrolling action the system selects the next database by default, but also shows the icons representing additional databases so that the user can select one or more of said databases by using another means such as tapping on said one or more icons.

According to one embodiment of the invention, if there is no choice for the input information provided by the user, or if there is no more choice(s) after all of the words corresponding to the input information are presented to the user and none of them are selected/confirmed by the user, or after manually entering the system into the precise mode, a pop-up information may indicate to the user to how enter precise characters (e.g. by pressing and/or gliding actions provided on a column of characters).

It must be noted that in this and in the related patent applications, a predicted word may be predicted based on the principles of the use of the entries of N-gram (e.g. 1 or more grams) databases such as those described in detail in different patent applications filed by this inventor.

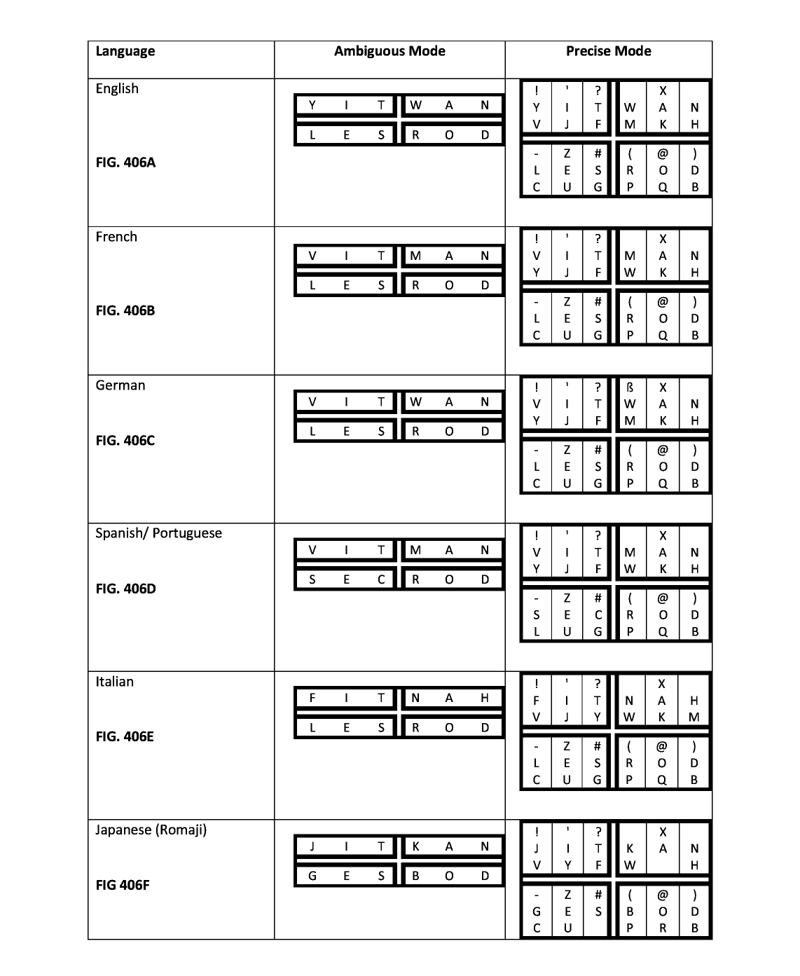

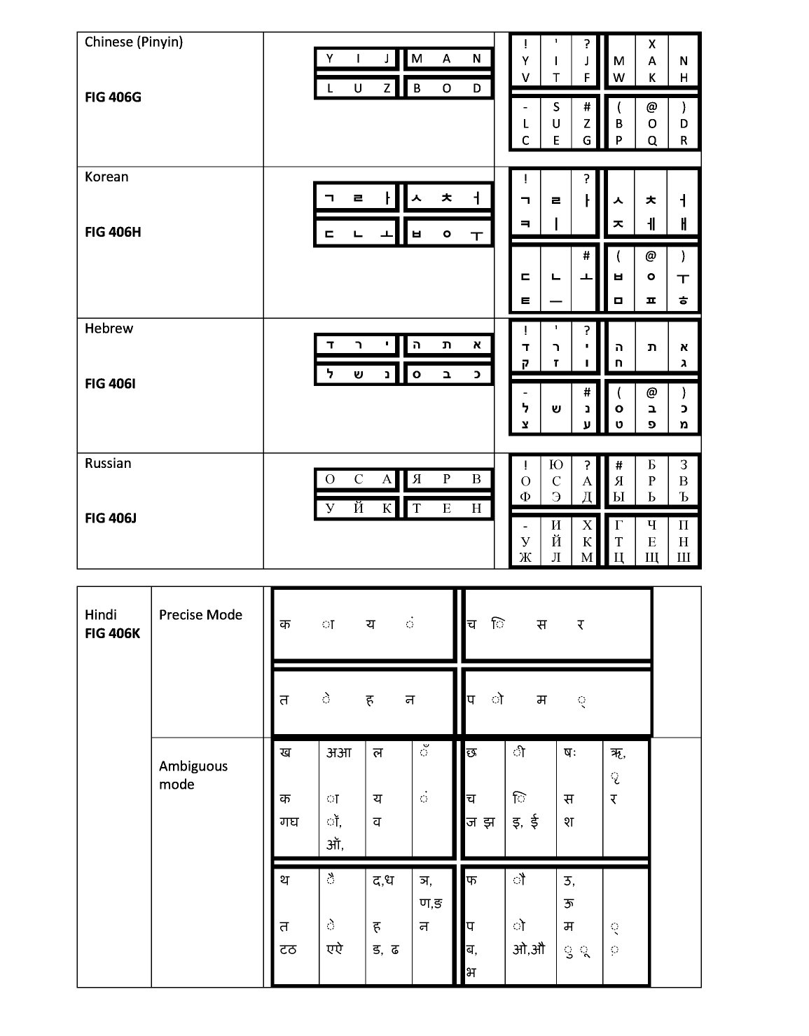

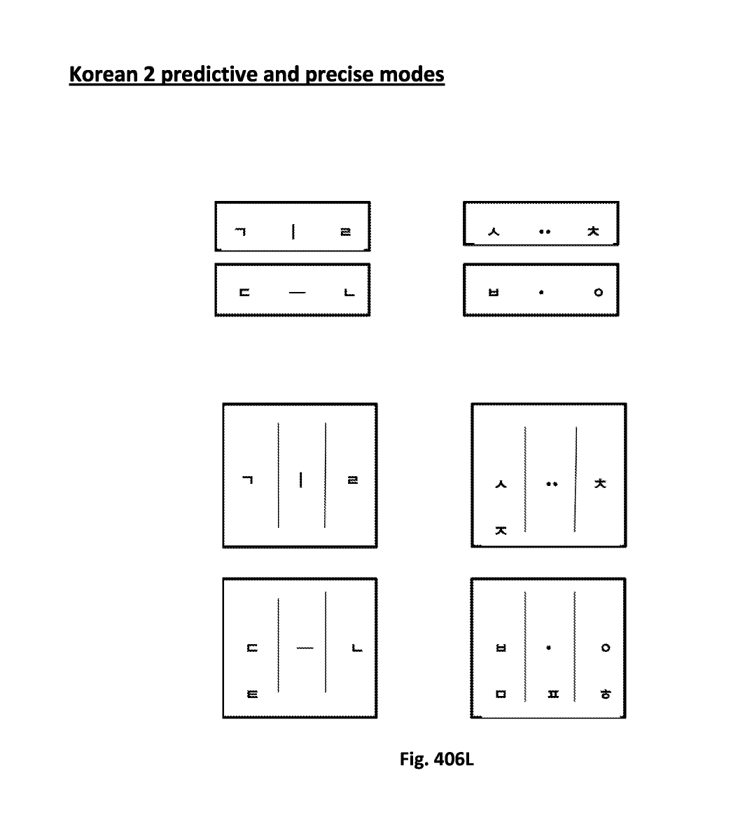

FIGS. 406A to 406L show exemplary arrangements of the characters on the (e.g. four) keys of the keypad of the invention in different languages. The zone(s) outside the keys preferably represent either the rest of the characters of each language or substantially all of the characters of the language based on principles described in different patent applications by this inventor. Note that in some languages such as Hindi and Korean in predictive mode may include keys having two or more (e.g. four) letters/characters ambiguously assigned to each of the (e.g. four) keys of the keypad, and preferably in the precise mode they may have the corresponding number of columns of letter/characters. As mentioned before in patent applications filed by this inventor, the letters may be alphabetical based or phonetic based depending on for example the language.

According to one embodiment of the invention, during the entry of a word, a predefined interaction such as for example a gliding action provided upward from anywhere in the/a predefined zone preferably outside the keys may correspond to replacing the first predicted/presented word (e.g. the current predicted word (e.g. printed on the top of the second predicted word)) by a/the second predicted/presented word. Now, the second predicted/presented word may preferably become the current predicted word. According to one method, the character(s) of the new current predicted word may be fixed as precise characters. The new current predicted word may be edited (e.g. by appending character(s) at its end if the user provides new interaction(s) (e.g. tapping actions) on the keys/zone and/or providing the correction procedure, etc.). Replacing a current predicted word by another proposed word herein may be referred to as Swapping words.

With continuous description of the current embodiment, according to one method, by considering the new current predicted word, the system may propose a (e.g. at least one) new second word.

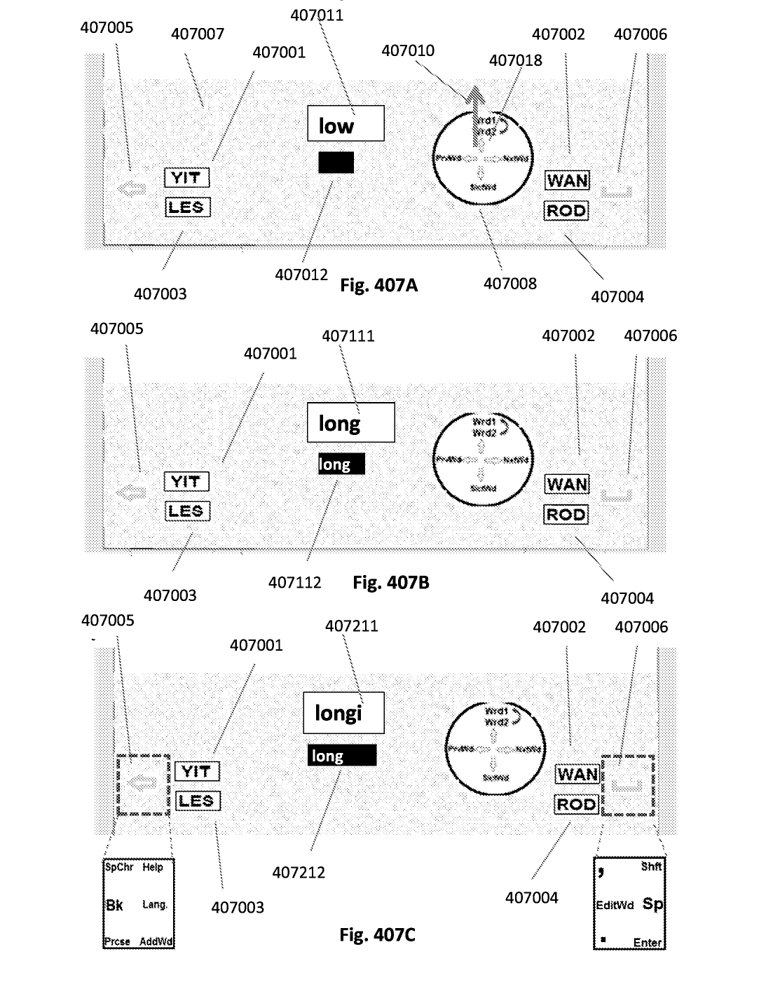

As shown as an example in FIG. 407A, after the user provides the tapping actions 407003, 407004, 407002, the system may propose a first word “low” (e.g. the current predicted word) 407011 and a second (e.g. longer) word 407012. By providing a gliding action upward 407010 from anywhere in the predefined zone 407007 outside the keys, then the system may replace the word “low” 407011 by the second word “long” 407012, and as shown in FIG. 407B the current word 407112 will become the word “long”. In this example, the system may propose a new second word “longer” 407112. Now, as an example shown in FIG. 407C, if the user provides a tapping action 407001, the system may propose a new current predicted word 407211, and a new second (e.g. longer) predicted word 407212.

FIG. 407C also shows an arrangement of symbols (e.g. period, comma, and some functions) on the space and backspace keys 407006, 507005, according to one embodiment of the invention. In this example, the said keys are invisible and are represented by their respective icons on the screen/sensitive surface.

Note that the replacement of the first predicted word by the second predicted word may be repeated several times if needed/desired.

Preferably, an indicator containing information showing the function/purpose of the various interactions, such the pop-up icon 407008 of FIG. 407A showing the direction 407018 of the corresponding gliding action, on the predefined zone may appear while entering a word.

According to one embodiment of the invention, during the entry of a word when (e.g. preferably, substantially each time) the system is in the precise mode (e.g. by being switched manually by the user or automatically by the system), providing precise characters by interacting with the keys of the system may correspond to the correction procedure of the invention. In this case, according to one method, if the current predicted word includes ambiguous characters, providing precise character(s) results in replacing the corresponding ambiguous character(s) of the current predicted word by the precise character(s) being provided. Accordingly, if the current predicted word does not include ambiguous characters, then preferably, the provided precise character(s) is/are appended at the end of the current predicted word.

According to one embodiment of the invention, during the entry of a word the (e.g. keys of the) system remains substantially always (e.g. before or after refusing/rejecting a current predicted word (e.g. by providing a ‘next word’ interaction)) in the ambiguous mode unless the system/keys are switched into the precise mode.

In some paragraphs of this patent application and the related patent applications filed by this inventor the terms such as “switching the system into the predictive mode” may have be used. It must be noted that such explanation are generally used to explain switching the keys of the system into their ambiguous mode. It must also be noted that terms predictive mode and ambiguous mode are preferably both be used interchangeably with identical meaning.

According to one method, in precise mode, after receiving a predefined signal for entering/confirming a current word (e.g. the space function) the system may preferably switch to ambiguous/predictive mode unless the user has entered the system into permanent precise mode by a predefined interaction for example glide-and-holding action (e.g. on a key/zone).

As mentioned previously in the related patent applications filed by this inventor, for predicting words the system may use four different input signals provided by interacting with, such as for example tapping on, four keys such as those 407001-407004 shown in FIG. 407A, and preferably an additional input signal provided by an interaction such as providing a tapping action on preferably one (e.g. or optionally more than one) predefined zone outside said keys. It must be noted that said input signals may be provided by any (other) type of input means and/or any type of interaction with input means. As an example, instead of providing a tapping action on said predefined zone outside the keys, the user may provide a (e.g. predefined) gesture/interaction (e.g. gliding-action) on/from said one predefined zone (e.g. or optionally more than one predefined zone) or on a predefined key such as for example a/any of the keys of the keypad of the invention.

It must be noted that different types of assignment of characters/letters of a language to said input signals/keys/zone(s), and the related principles of predicting words, etc., have previously been described in detail in this and previous/related patent applications filed by this inventor.

It must be noted that in this and in the related patent applications, a predicted word may be predicted based on the principles of the use of the entries of N-gram (e.g. 1 or more grams) databases such as those described in detail in different patent applications filed by this inventor.

The titles used in this application and in the related applications may preferably not be considered as part of the descriptions.

According to one embodiment of the invention, after providing the input information corresponding to the entering of a word, the system may propose one or more corresponding words. As an example, in addition to the current predicted/proposed word the system may propose one and/or two additional words from a database. According to a preferred method, one of the additional proposed words may be a word wherein its number of characters corresponds to the input information provided by the user and the other additional word may be a longer word. According to another method, both additional words may have either a number of characters corresponding to the input information provided by the user or they may both be longer words. According to one method, any of one or more additional words may be proposed only if it has a frequency of use higher than a predefined number.

According to one embodiment of the invention, preferably the current predicted word may be entered by providing a predefined interaction such as tapping the Space key or on said current word. To enter any the additional words, another predefined interaction such as tapping on any of said additional words may be used.

FIG. 408 shows, as an example, three words 408020-408022 being proposed to the user on the screen 408009, after the user tapped on the zone 408010 and on the key 408001. In this example said words form a column of three words according to one method. If the user presses on the key 408006, then the word in the middle (e.g. the current predicted/proposed word; in this example ‘my’) will be entered.

According to a first method, providing a gliding action 408011 anywhere (e.g. on/from zone 408010) upward may enter the word on the top 408021 (in this example, ‘by’). Accordingly, providing a gliding action 408012 anywhere (e.g. on/from zone 408010) downward may enter the word on the bottom 408022 (in this example, ‘hi’).

According to a second method, providing a gliding action 408011 anywhere (e.g. on/from zone 408010) upward may replace the current predicted/proposed word 408020 by the word 408022 on the bottom. Accordingly, providing a gliding action downward 408012 may replace the current predicted/proposed word 408020 by the word 408021 on the top. In the current method a tapping action on any of the words 408020-408022 may enter said word. It is understood that the gliding actions may have other (e.g. reversed) direction for the same purpose.

It must be noted that in another embodiment, the top word 408021 and the bottom word 408022 may be arranged/displayed on any location such as on the left and right of the current predicted/proposed word 408020, respectively. Similarly, the gliding action 408011 and the gliding action 408012 may be provided accordingly, such as in the leftward and rightward directions, respectively.

According to one method, a different type of interaction such as a gliding action(s) with any of the proposed words such as a gliding action provided on or from any of said words may not necessarily correspond to entering any of said words. As an example, in FIG. 408, arrows 408031 and 408032 may preferably be displayed next to the proposed/predicted words 408020, 408021, 408022 indicating direction (e.g. right and left, respectively) of the gliding actions relating to next or previous proposed words, as described before in the related applications. According to one method, the user may provide such gliding action(s) anywhere on the screen such as on/from said words or on the predefined zone. The system may propose/display the corresponding next or previous word(s) accordingly.

As mentioned before the keyboard of the invention may have any number of keys to which letters are assigned. According to one embodiment, said keyboard may have any number of keys, preferably six keys, to which some of the letters of the language are assigned, and other characters/symbols (e.g. rest of the letters in an alphabet or set of symbols, and/or special characters) may be assigned to one or more zones outside said keys as described before. FIG. 409A shows the arrangement of the keys 409001-409006 to which some of the letters/symbols of a language may preferably be ambiguously assigned on the screen of a mobile computer device. The rest of the letters/symbols of said language and preferably at least some special characters may be assigned to the zone 409010 on the screen 409009 of said device. In this example the keyboard has two additional keys 409008 and 409007 each representing at least one symbol such as a function (for example, the space and backspace functions, respectively).

FIG. 409B shows another example of arrangement of the keys of FIG. 409A on the screen of a device.

FIGS. 410A-410E show other types of arrangements of letters in ambiguous and precise modes on the keys of a keypad of the invention having four letter keys and preferably using one zone outside said keys as described before and in the related applications.

Until recently, text interaction (e.g. commonly known as texting) between people/devices/machines has been based on texting alone. The data entry system of the invention permits to remove the bulky keyboard from the screen therefore allowing texting while seeing pictures or videos and therefore the mobile handset of the future must be proportionately longer in size (than present day devices available in applicable commercial markets) while being preferably sufficiently narrow in order to be held in the user's hand. The length of such device may be defined based on the size of the frame of a picture and a preferably wide/large editable text box next to it. By providing such a device and preferably using the data entry system of the invention, users are enabled to see (any type of) content (e.g. seeing each other) and generated content (e.g. text) while interacting with each other, preferably at the same time.

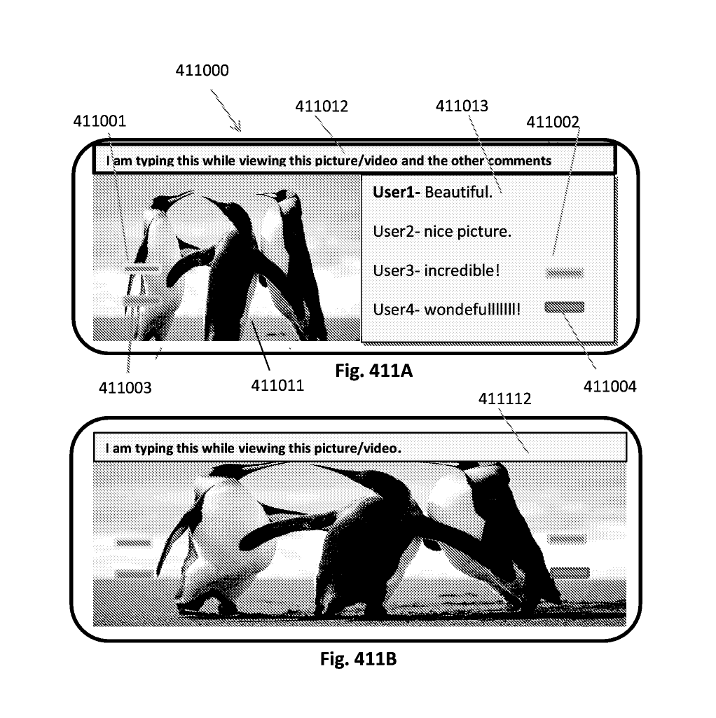

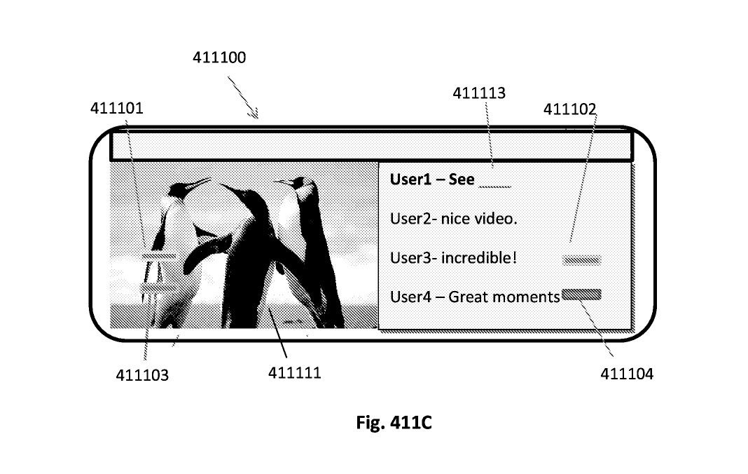

FIG. 411A shows an exemplary device 411000 as just described wherein its screen is divided into three zones 411011, 411012 and 411013 dedicated to viewing content (e.g. a picture/video), to a comment being typed by a user, and to other comment(s), respectively.

FIG. 411B shows the screen of said device when a video is enlarged. In this example the user can comment 411112 on/next to the enlarged video. The comment 411112 may be displayed on top of the video (with or without a transparent background, which may enable the user to see the video as the background content to/of the comment).

Methods of helping the user to spell words based on tapping outside the keys of the (e.g. four) keys of a keyboard have been described before. According to one embodiment of the invention, at some point (i.e. any one point) during the entry of a word, the system may automatically enter into a spelling help mode (e.g. spelling help mode and its related functions have already been described in detail in previous related applications filed by this inventor), for example based on the number of characters/letters being entered until that point. The number of characters defining the entry of the system into (i.e. activation of) the spelling help mode may vary for example based on the language that the system is using. For example in the English language said number of characters may preferably be five. After the user enters the input information corresponding to five (e.g. beginning) characters of a word the system may automatically enter into the spelling help mode wherein tapping outside the keys of the keypad in a pre-defined zone may ambiguously correspond to any character (e.g. of the language the system is using; in this example, English). According to one method, after the system enters into the spelling help mode, providing backspace characters until reaching a number of characters that would activate the spelling help mode (e.g. five) less one character (e.g. four) may preferably exit the system from the spelling help mode. Also, according to one method, providing an end of the word signal such as a space character may exit the system from the spelling help mode.

It must be noted that the keys of the keypad/keyboard may be soft or hard keys. Also the one or more zones outside the keys as described throughout this and the related applications may be represented by one or more hard key or zone, respectively. For example, a remote control device may include four hard keys and a touch sensitive pad used as a zone as described in detail throughout this and related patent applications already filed. Further to the current example, said zone may also be a hard key.

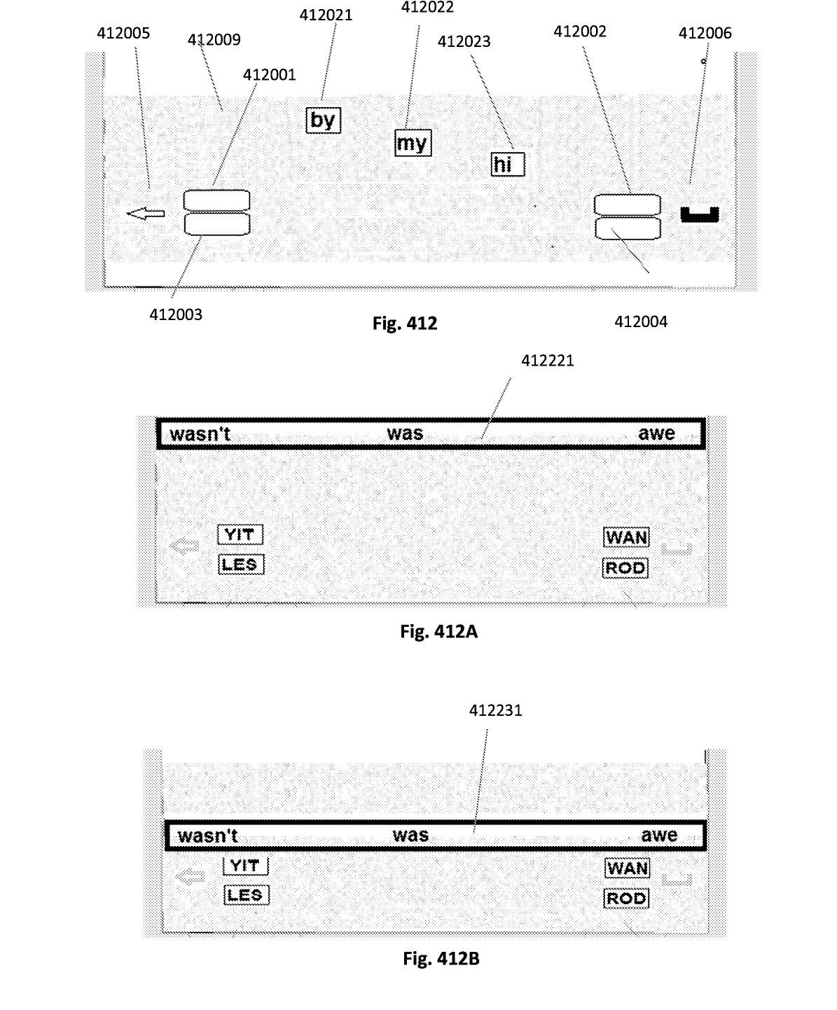

It must be noted that the words presented/predicted during the entry of the corresponding input information may be arranged on the screen in different configurations. As an example, they may be presented in a manner in order to represent a single row of words or they may be presented in a manner to form three steps 412021 to 412023 as shown in FIG. 412. According to another method, the current predicted word may be presented anywhere on the screen and the additional presented/predicted words may be shown vertically preferably next to the edges of the screen (e.g. opposite to each other).

According to one embodiment of the invention, a content (e.g. video/picture) sharing application may be created wherein the user(s) can see a video (e.g. video stream, a TV program, etc.) and comment about it and/or provide (e.g. live/instant, or delayed/queued) texting. According to one method, a shared content may be accompanied with and/or include a vocal or audio or graphic message and/or music content provided by any user/person (e.g. in a live chat room, by any of said users). According to one embodiment, while watching (and/or listening to) a video, a predefined interaction such as a predefined type of gliding action relating to (or on) the screen of the corresponding device may provide an event informing the system to memorize/record that instant/frame/timestamp of the video being played/watched. According to one embodiment of the invention, when a user provides an interaction such as a gliding action (e.g. relating to (or on) a video being played) as just described, the system may create a link or reference (of any nature or representation) to that instant/frame/timestamp of the video. According to one method, said link or reference may be (e.g. inserted within a comment typed by the user providing the gesture and) sent to other/any users/people. Said link/reference may also be sent to others users (e.g. any users receiving said link/reference). The receiving party may activate (e.g. tap on) said link/reference and the said video may preferably be played starting at the instant/frame/timestamp that the link/reference is pointing to. As such, many specific frames (or instants/timestamps) of a video may be memorized/recorded and links/references to said frames (or instants/timestamps) may be sent to different groups of users for any purpose such as, for example, to discuss about said frame or about the video starting at said linked frame (or instant/timestamp) or any part of said video or corresponding videos. As such, in a corresponding social application, one or more threads of discussion may be created for each of such links/references among a group(s) of users (public or private/preferred/closed community/group of users).

It must be noted that said groups of users may be any type of groups of users for example the groups of users of any (e.g. different) (e.g. social) applications such as Facebook, Twitter, Instagram, etc.

According to one method, the link/reference may be stored in a local or remote location (e.g. a remote server or cloud) for future use/access by any user.

According to one method, in addition to the link/reference said link/reference may be accompanied by a picture/frame of and/or corresponding to said frame/instant/timestamp of video. According to another method, the link/reference may be represented by a picture/frame of and/or corresponding to said frame/instant/timestamp of video. FIG. 411C shows, as an example, a social page of a user receiving a link/reference 411113 and a corresponding picture 411111 of a frame/instant of a video from another source such as another user. By activating (e.g. clicking on) the link or picture, the corresponding video may be played starting at least substantially (e.g. exactly) from the reference frame/instant/timestamp of the video to which the link refers.

Note that in the embodiments and the related principles just described and related methods, video may be interchanged with audio content (e.g. music or audio track).

According to one embodiment of the invention, a zone where one or more of the proposed/predicted word(s) are displayed on the screen may be relocated (e.g. anywhere on the screen) by the system and/or by a predefined user interaction such as a dragging/gliding action. According to one method, the one or more predicted word may be located on a single zone, and said single zone may be entirely relocated on the screen (e.g. as just described).

According to one embodiment of the invention, providing a predefined interaction such as a gliding action in a predefined direction on/from a word may replace the current predicted word by the word on/from which said gliding action is provided.

According to one embodiment of the invention, the current predicted word may be displayed/printed in a text field (or graphical component) including additional text.

As mentioned before, the words presented/predicted during the entry of the input information, corresponding to the presented/predicted words, may be arranged on the screen or by a display means (e.g. a projector) in different configurations. As an example, the presented/predicted words may be presented in such a way so as to represent a single row of words or they may be presented in a manner to form more than one row (e.g. three rows) 412021 to 412023 as shown in FIG. 412. According to one method, at the beginning of the entry of a word, the predicted words may form one row of words and after the words touch each other or nearly touch each other, the presented/predicted words may be presented in a form that has different rows of words.

According to one embodiment, the proposed/predicted word may be printed on a bar such as the exemplary bar 412221 of FIG. 412A. The bar may be relocated on (e.g. anywhere on) the screen by the user, for example, by dragging it as shown 412231 in FIG. 412B. The bar may be designed such that its transparency may be controlled by the user, for example to make it more or less transparent.

According to another method, the current predicted word may be presented anywhere on the screen and the additional presented/predicted words may be shown vertically, preferably, next to the edges of the screen (e.g. opposite to each other).

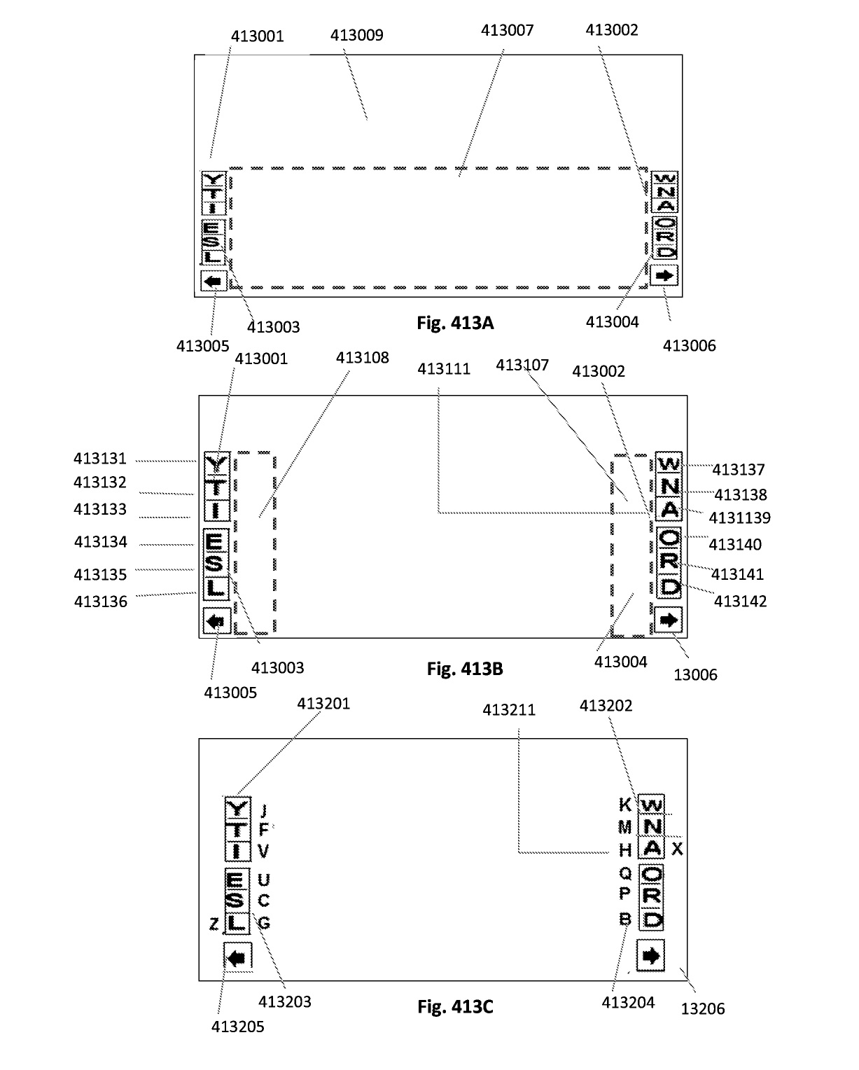

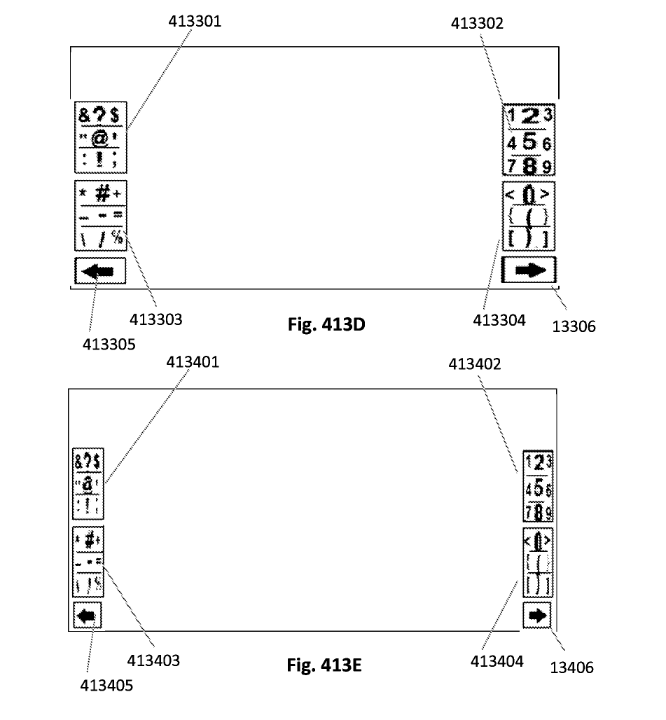

As mentioned before in the related patent applications filed by this inventor the user may enter precise and ambiguous characters in order for the system to predict a word. FIGS. 413A and 413B show, as an example the keypad of the invention having twelve keys 413131-413142 (e.g. letter keys) which in this example are arranged in four locations 413001-413004. In this example, each of the letter keys represents one letter precisely. According to one method, one zone (e.g. 413007, as shown in FIG. 413A) or more zones (e.g. 413107 and 413108, as shown in FIG. 413B) outside said keys may represent the rest of the characters of the alphabet ambiguously. In the current example said one zone 413007 or said two zones 413107 and 413108 represent the rest of the characters/letters. According to one method each of the zones may represent all of the remaining characters other than those represented by said keys. According to another method each of the zones represents a portion of said remaining characters/letters. According to a third method said one or more zones outside said keys may represent all of the characters of a language. Examples hereafter will demonstrate the use of such zones during entry of a word according to several exemplary methods.

According to a first method one or more zones outside the letter keys each may represent substantially all of the remaining letters of a language and/or at least some of the other characters that the words of a language may include. According to the current method, for letters of a word being entered that are located on said letter keys, the user presses the corresponding keys, and for letters of said word being entered which are not included in or represented by said letter keys, the user may tap on one or more zones outside said letter keys. By considering the precise and ambiguous entry of input information through letter key and/or zone interactions during the entry of the word, the system may predict one or more corresponding word/s.

According to a second method, the zones outside the letter keys may represent substantially all of the letters of a language/database and/or at least some of the other characters (e.g. special characters) of a language/database preferably those that are included in the words of said language/database. Accordingly, in order to enter a word, the user may preferably tap on the keys corresponding to (e.g. displayed/presented on the keys) the letters of the current word being entered and/or tap for any desired character (e.g. the letters that are not represented by any of the keys) of said word being entered on the corresponding one or more said zones outside said keys.

According to a third method, said zone(s) outside the keys (e.g. that each represent a single character as described before) may represent different groups of characters, for example based on a portion of the word during the entry of said word. According to one example, as an example, at the beginning of the entry of a word, during the entry of the first five characters, the outside zone(s) may represent all of the remaining characters of a/the language other than those represented by said keys, and during the entry of the remaining characters of said word, for example, starting with the sixth letter of said word being entered, said outside zones may represent substantially all of the characters of said language. As an example, during the entry of a word, for the first five letters of said word, the user may press on the precise letter keys for those letters of said word that are represented by said keys and may tap outside said keys on said one or more zones for the letters of said word that are not represented by said precise letter keys, and according to a first method, starting with the sixth character of the desired word, the user may tap outside said keys for all of the remaining letters of the word, while according to a second method the user may interact with such as a press on said zone(s) for any of the remaining characters of the word starting with a predefined letter position of the word (e.g. the sixth letter) and/or tap on the precise letter keys for any of said remaining letters that are represented by said keys.

The methods just described above, with keys each having a single precise character, combining precise input and ambiguous input may, herein, be referred to as ‘Semi-predictive System.’ Furthermore, the data entry system of the invention using only keys ambiguously corresponding to several characters may be, herein, referred to as ‘Fully Predictive’ system.

As an example, in order to enter the word “illustration” the user may tap on the keys representing the letters ‘i’, ‘l’, ‘l’ and then tap outside the zone for the letter ‘u’, then tap on the key corresponding to the letter ‘s’. Start from this moment, the user may tap for any remaining characters of the desired word on the outside zone.

One of the advantages of the current embodiment is that, despite it being a predictive system, as just described; the system at least mostly provides the right/expected characters of the word to the user as the user is entering the word.

It must be noted that the examples of methods described above are provided to describe the principles of the data entry system of the invention using precise and ambiguous key and/or zone interactions to enter a word. Other examples of methods of entry of words based on such principles may be designed by people skilled in the art. As an example, the number of the beginning characters of a word being entered wherein the zone(s) represent different groups of characters/letters may vary (e.g. four, six, etc.).

Accordingly, the change of representation by the zones of various groups of characters may occur dynamically by the system or manually by the user. These subjects have already been described in detail in the previous patent applications filed by this inventor.

With continuous description of current embodiments, according to one method, after/during the user provides the input information (e.g. key and/or zone interactions as described), the system may predict one or more corresponding words. If all of the words presented/predicted by the system are rejected by the user, the system may enter into the correction procedure of the invention, wherein the user may preferably correct the current predicted word. In the correction mode, the system may enable the user to enter any character precisely, for example, by showing a keyboard that when interacting with its keys or zones provides any needed character precisely. According to one method, preferably, the system is designed such that each of the precise characters being entered by the user may (e.g. shall) replace ambiguous character(s) of the current predicted word, preferably starting with the replacement of the first ambiguous character of said word. For example, after the user provides one precise character the system replaces the first ambiguous character of the current predicted word. Then afterwards, if the user provides another precise character, said new precise character may preferably replace the next (in this example, the second) ambiguous character of the predicted word which may now be considered as the new first ambiguous character after the original first ambiguous character of said predicted word was replaced. According to a first method the ambiguous character(s) and the precise character(s) may be represented by different means (e.g. display/presentation means) such as by two different colors (e.g. for foreground and/or background). According to a second method, at any moment during the correction procedure the first ambiguous character of a predicted word may be represented by different means such as a different color.

With continuous description of the current embodiment according to one method during the correction procedure the input means enabling the user to enter precise characters may be a keyboard wherein a tapping action on any of its keys provides a precise character. According to a second method, such input means may be a keyboard wherein tapping and/or gliding actions provided on said keyboard may provide precise characters. At least of such keyboards has been shown and described in previous related patent applications filed by this inventor. As an example, the keyboard having four keys as shown in FIG. 413C may provide precise characters when the user interacts (e.g. tapping and/or gliding actions) with the letters of said keyboard. As an example, providing a typing action anywhere on the row 413211 (containing letters ‘H’, ‘A’ and ‘X’) of said keypad/keyboard may provide the letter “A”. Accordingly, providing a gliding action rightward on said row 413211 may relate to entering the letter “H” precisely, and providing the gliding action leftward on said row may relate to entering the letter “X” precisely. By using the same type of interactions with other rows of said keypad/keyboard, any letter or character of a language may be entered precisely. FIG. 413D shows said keypad/keyboard in special character mode. Any of said characters may be entered precisely by the method just described. These matters have already been described in detail in the related patent applications filed by this inventor. According to one embodiment the size keypad of the invention may be decreased and/or increased by the user or by an automatic means. FIG. 413E shows the keypad of the invention, with size decreased, in the special character mode. It is clear that the keypad/keyboard of FIG. 413E is smaller in size than that of FIG. 413D.

According to another example of the second method just described above, for example, with continuous description of the above example relating to said second method, in addition to single gliding actions in each of leftward and rightward directions, on row 413211, a second type of interaction(s) such as a gliding action with distinguishing features (e.g. longer gliding distance) from the leftward and rightward gliding actions may be used by the user to precisely type additional characters on the row. Preferably, in this example, the letter ‘X’ can be located to the left of the letter ‘H’ and the user can use a long leftward gliding action to precisely enter the letter ‘X’. This provides the advantage of not requiring letters on the edge of the keyboard or on both sides of the center row of the keyboard, and that may require gestures that could include glides off the touch sensitive surface (or over the edge/boundary) of the gesture sensing technology).

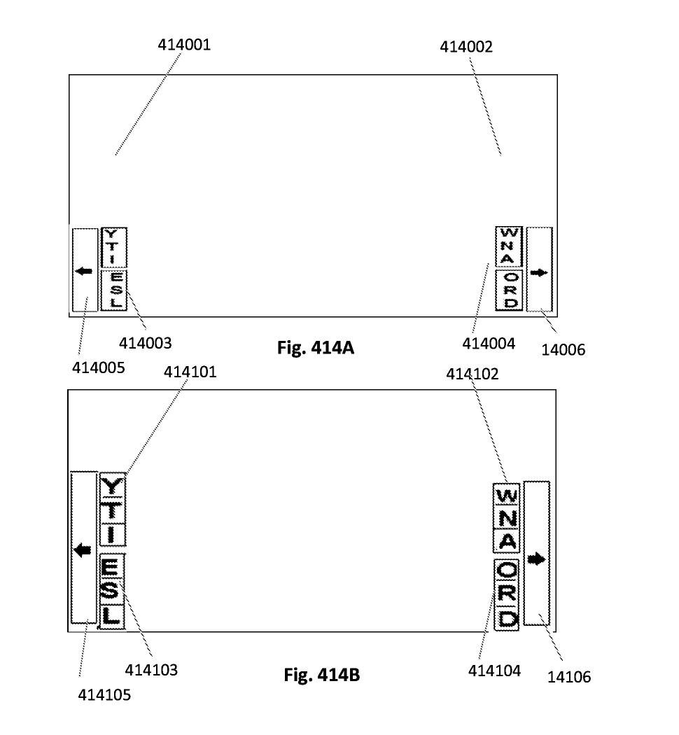

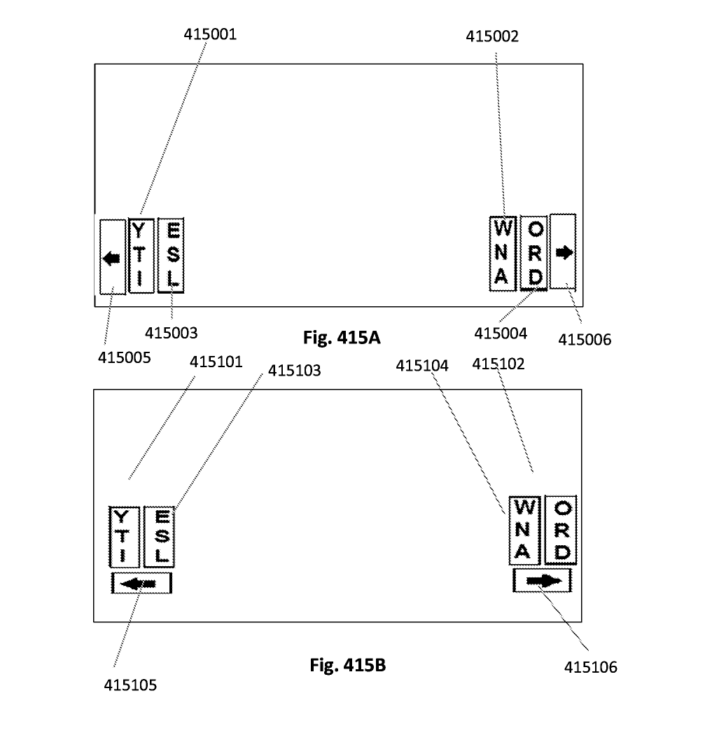

Different types of arrangements of the keys and/or the letters on the keys of the keypad/keyboard may be arranged vertically in both ambiguous and precise modes. FIGS. 413A-415B show exemplary different arrangements of keys and the letters of the keypad of the invention in the ambiguous mode. It must be noted that in said figures the space and backspace keys/zones are respectively demonstrated by the rightward arrow (e.g. 415006) and leftward arrow (e.g. 415005).

It must be noted that according to one method, the user may provide precise characters other than those characters that are presented/displayed on the keys (e.g. 12 keys) even if they are not shown/presented on said keys. According to one example, the keys of the keypad of the FIG. 413B may have the same functionality/ies (e.g. letter configuration) as the keys of the keypad of FIG. 413C (e.g. in the keypad of FIG. 413B other characters are not shown/presented but they have the same arrangement of characters as the keypad of FIG. 314C, even if the other characters (e.g. I, F, V, etc.) are not presented/shown on the keys of the keypad of FIG. 413B). For example, a gliding action rightward on/from the row 413111 (or, for example, 413211) may correspond to entering the letter “A” precisely.

The entry into the correction mode/procedure may be done automatically by the system or manually by the user. According to one embodiment of the invention, after the user rejects all of the words proposed by the system or if the system does not find a word corresponding to the input information provided by the user, the system may preferably enter into the correction mode of the invention. According to one embodiment, at any moment during the entry of a word the user may (e.g. manually) cause the system to enter into the correction mode/procedure. The user may use one or more predefined means such as providing a gliding action in a predefined direction (e.g. on a key or on a zone), preferably, to (e.g. manually) cause the system to enter into said correction mode/procedure.

According to one embodiment of the invention, the system may include an auto correction system by considering one or more of the keys/zone(s) being a neighbor(s) of a key/zone being interacted with by a user. As an example, if the user (e.g. accidentally) types on a wrong key (e.g. by typing near a border between two precise keys), the system may consider all of said keys for said interaction. According to one method, during the entry of a word, using the precise keypad of the invention, for example, such as the one shown in FIG. 413B, for one or more key interaction(s) (e.g. such as the interaction just described in the above example) the system may consider the neighboring characters as ambiguous input. By using the precise keypad of the invention, preferably the neighboring key/s for a key interaction provided by the user may at most be two keys. This will provide a highly accurate word entry system also relaxing the need/requirement of the user to very accurately tap on a precise key, therefore allowing the user to type faster and/or more comfortably.

According to one embodiment of the invention, the system may be switched between Fully Predictive and Semi-predictive data entry. In both cases when the system is in the correction mode and when the system exists from said correction mode, the system may switch back to either the Fully Predictive or Semi-predictive mode as was originally being used before entering the correction mode.

According to one embodiment of the invention, if the system is in the precise special characters mode, if the user taps on the space key different scenarios may be considered such as:
1) if the user had switched the system into the special character mode from the predictive letter mode, then after tapping on the space key the system may preferably automatically switch back to the predictive letter mode.
2) if the user had switched the system into the special character mode from the precise letter mode, then after tapping on the space key the system may preferably remain in the special character mode.
   It must be noted that during the entry of a word such as during the correction procedure of the invention instead of providing swiping actions to enter precise characters the user may tap on the letters located/printed on the keys in the precise mode.

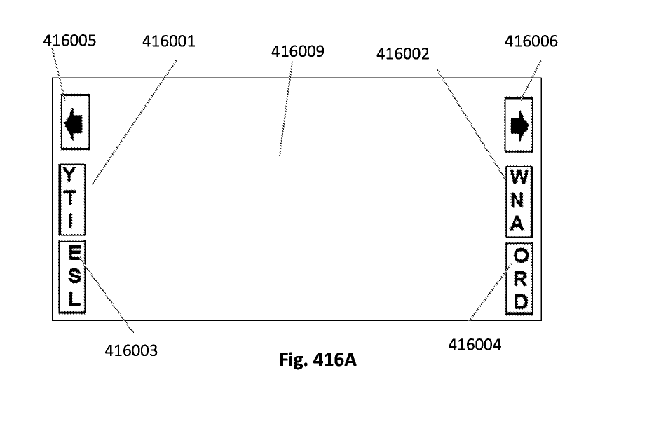

According to one method, the arrangement of letters on the keys may preferably be such that the main vowels being close to each other in their respective column/row. Preferably, the other characters are arranged such that the most used characters being close to each other on their respective column/row. As an example of FIG. 416A the vowels I, E are close to each other in their respective column. Also the letters T and S are closer to each other than Y and L which are used less than I and E in the English language.

According to one embodiment of the invention, the fully-Predictive mode and Semi-predictive Mode of the system may be combined. According to a preferred embodiment, when the user provides a pre-defined interaction such as a tapping action on a letter key (e.g. of the four letter keys (e.g. key 416001 of FIG. 416A).) of the system, the system may relate said tapping action to at least to types of input signals as follow:
1) The first input signal may be ambiguously related to any of a group of letters assigned to said key (e.g. letters Y, T, I on the key 416001). Preferably, the interactions such as typing actions on the outside one or more zones may ambiguously correspond to any of the characters assigned to said zones as described before (e.g. fully predictive mode).
2) The second input signal may precisely correspond to a precise letter related to the location of the interaction by the user on a key. As an example, if the user taps on the letter Y of the key 416001 the system relates said typing action also to the precise character Y. Preferably, the interactions such as typing actions on the outside one or more zones may ambiguously correspond to any of the characters assigned to said zones as described before (semi-predictive mode).
   With continuous description of the current embodiment, after providing a sequence of interactions such as typing actions on the keys and the outside one or more zones, the system may provide/predict words corresponding to both semi-predictive and fully predictive modes preferably simultaneously. Preferably, the current predictive word is a word based on a semi-predictive mode. Optionally the other candidates are mostly from the fully predictive mode.

With continuous description of the current embodiment, according to one method, after rejecting all of the words corresponding to the input information provided by the user, the system may enter into the correction mode. In this case, preferably the system proposes (e.g. again) a word corresponding to the semi-precise mode as the current predicted word. When the user proceeds to correcting the current predictive mode and enters precise characters at least two scenarios may be considered:
1. The system corrects the ambiguous letters of the current predicted words as described throughout this and previous patent applications filed by this inventor.
2. In addition, the system may form a new word from the precise letters provided by the user during the correction procedure.
   The user may select any of those corrected or formed words.

One of the advantages of the current embodiment is that the user may type very fast without worrying about the location of the letters on the (e.g. four) keys for the words that he prefers to type them fast which are most of the time in the database used by the system and as an example for the words that he doesn't know how to spell and he thinks that they are not in the dictionary he may tap on the letters that he sees on the (e.g. four) keys.

It must be noted that although in the FIG. 416A there are no lines defining the limits between the zones corresponding to the letters on the keys, said keys may preferably have a predefined zone for a letter located on that key. According to one concept, each of said (e.g. four) keys may be considered to have a subgroup of (e.g. three) keys (e.g. total of twelve subkeys). The system uses the main (e.g. four) keys for fully predictive system and the (e.g. twelve) subkeys for the semi-predictive system.

Methods of assignment of preferred and/or non-preferred characters, preferably respectively, to a number of keys and to one or more zones outside said keys have been described before (e.g. in the related patent applications filed by this inventor) in detail.

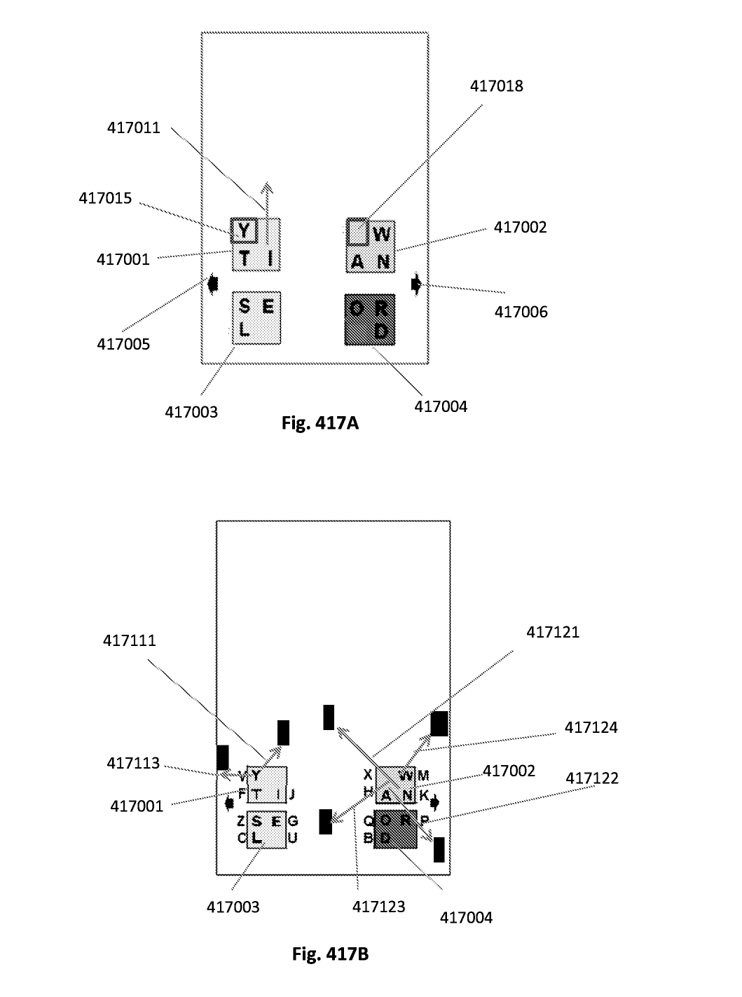

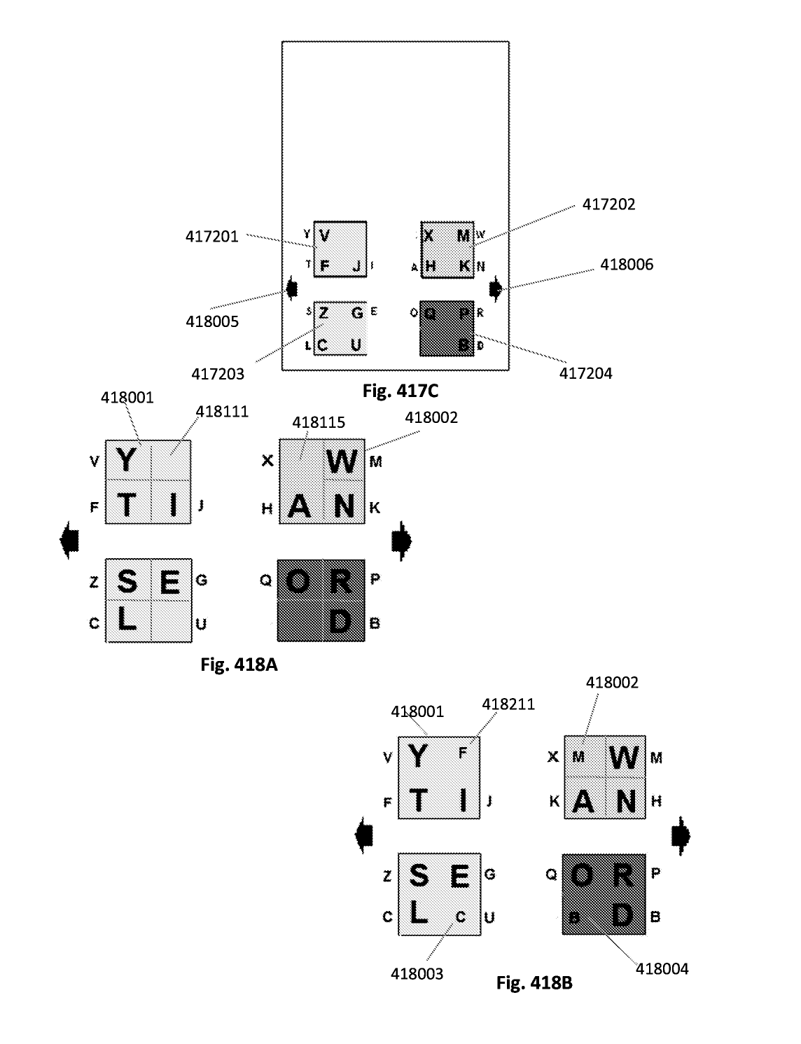

FIG. 417A shows another method of assignment of some preferred letters of a language to few keys (e.g. four keys 417001-417004). As described before a predefined interaction such as a tapping action on a key (e.g. 417001) may correspond to any of the (preferred) characters (e.g. y, t, i) ambiguously assigned to said key. In this example an interaction such as a tapping action on a zone preferably outside the keypad may preferably correspond to (entering) any of the other characters (e.g. non-preferred characters) of a language and/or any of all of the characters of a language as described before in detail.

As mentioned before according to one method a pre-defined interaction such as a tapping or a gliding action on a zone on a key assigned to a character such as a letter (e.g. printed) on a key, may correspond to entering said character precisely. As an example, tapping on (e.g. the zone 417015 on/around) the letter “Y” may enter said character precisely.

According to one embodiment of the invention, a pre-defined interaction such as a gliding action and/or a pressing holding action on/from a zone such as a zone (e.g. 417015) assigned to a preferred character/letter (e.g. “Y”) on a key (e.g. 417001) may correspond to entering precisely another character such as a non-preferred character (e.g. “V”). The pair of characters related as such may be herein referred to as “related characters”. (Note that some zones such as the zones such as the zone 417018 may not have a (e.g. preferred) character (e.g. or alternatively, it may have another type of character such as a special character (e.g. “#”))). Different scenarios may be considered, such as:
a. According to a first method, providing a gliding action departing from a letter/character towards any direction on a zone corresponding to a character/letter may correspond to entering another character precisely. As an example, any of the gliding actions 417111, and 417113, departing from the (zone corresponding to the) letter “Y”, may correspond to precisely entering the character “V”.
b. According to a second method, providing a long pressing action (e.g. a press and hoding action) on a zone (e.g. 417015) corresponding to a character may correspond to entering another character precisely. As an example, a long pressing action on the letter “Y”, may correspond to precisely entering the character “V”.
c. According to a third method, providing a gliding action departing from anywhere on a key towards a predefined direction may correspond to entering a corresponding non-preferred character. As an example, the gliding actions 417121, and 417124, departing from anywhere on the key 417002 may corresponding to precisely entering the character the characters “X, K, H, and M”, respectively.
d. Other methods for the same purpose may be considered by people skilled in the art.
   According to one embodiment the related characters may be printed next/close to each other. Preferably, the non-preferred character of a pair of related characters is printed outside the corresponding key. Preferably, a pair of related characters may have resembling shapes (e.g. “V, Y”, “O, Q”, “I, J”, “M, W”). An exemplary of related characters is shown in FIG. 417B. Preferably the assignment of letters (i.e. preferred and/or non-preferred characters) to the keys of the keypad may also be based on their common shapes.

The assignment of letters to few keys such as four keys based on their common shapes has been described in detail in the previous patent applications filed this inventor. In the example of FIG. 417B, the assignment of preferred letters and their related non-preferred letters to the four keys of the keypad are such that:
Letters that stand on one point (e.g. in their upper-case shape) are assigned to the key 417001.
Letters that stand on two points (e.g. in their upper-case shape) are assigned to the key 417002.
Letters that stand on a large base (e.g. in their upper-case shape) are assigned to the key 417003.
Letters that have a closed circle in their shape (e.g. in their upper-case shape) are assigned to the key 417004.
   According to one embodiment of the invention, a key of the keypad of the invention may have at least two layers/modes wherein generally/preferably the first layer/mode includes a first group of characters/letters such as the preferred characters (e.g. herein may be referred to as “preferred mode”) and the second layer/mode generally/preferably includes a second group of characters such as the non-preferred characters (e.g. herein may be referred to as “non-preferred mode”) and/or all of the characters of a language. It must be noted that according to one method, the first and the second group of characters may include one or more common (e.g. same) characters.

In the example of FIG. 417A the keys 417001-417004 of the keypad of the invention are shown in the first layer and in FIG. 417C said keys are shown in the second layer 417201-417204. In this example all of the letters assigned to the second layer are different than those assigned to the first layer. The user may switch the keypad from first layer to the second layer and vice versa by providing a pre-defined interaction for example a gliding action on any of the keys such as the gliding action 417011 provided on the key 417001 as shown in FIG. 417A.

With continuous description of the current embodiment, optionally, a pre-defined interaction such as a tapping action on any of the keys of the second layer may ambiguously correspond to any of the characters assigned to the second layer. Optionally, a pre-defined interaction such as a tapping action on a zone assigned to a character/letter on a key of the second layer may precisely enter said character.

Assignment of preferred and/or non-preferred characters, preferably respectively, to a number of keys and/or to one or more zones outside said keys have been described before (e.g. in the related patent applications filed by this inventor) in detail.

FIG. 417A shows another method of assignment of some letters (e.g. preferred) of a language to a few keys (e.g. four keys 417001-417004). As described before a predefined interaction such as a tapping action on a key (e.g. 417001) may correspond to any of the (preferred) characters (e.g. y, t, i) ambiguously assigned to said key(s). For example, an interaction such as a tapping action on a zone preferably outside said few keys may preferably correspond to (entering) any of the other characters (e.g. non-preferred characters) of a language and/or any of all of the characters of a language as described before in detail.

As mentioned before according to one method a pre-defined interaction such as a tapping or a gliding action on a zone (e.g. on a key) assigned to a character such as a letter (e.g. printed/presented) on a key, may correspond to entering said character precisely. As an example, by tapping on (e.g. the zone 417015 on/around) the zone to which a character such as the letter “Y” is assigned or on the letter/character itself may enter said character precisely.

According to one embodiment of the invention, a pre-defined interaction such as a gliding/sliding action on/from and/or a pressing holding action on a zone (or with an sub-zone/object/means relating to a zone) such as a zone (e.g. 417015) assigned to a preferred character/letter (e.g. “Y”) on a key (e.g. 417001) may correspond to entering precisely another/alternative character such as a non-preferred character (e.g. “V”). The pair of (assigned and alternative) characters (e.g. “Y” and “V”) related as such may be herein referred to as “related characters”. (Note that some zones (.e.g such as the zone 417018) may not have a (e.g. preferred) character (alternatively, it may, for example, have another type of character such as a special character (e.g. “#”, “.”))). Various scenarios may be considered, such as:
e. According to a first method, providing a gliding action departing from a zone (e.g. preferably corresponding to a character/letter/function) and/or from a letter/character/function towards any direction may correspond to entering a/another character precisely. As an example, in FIG. 417B, any of the gliding actions 417111, and 417113, departing from the (zone corresponding to the) letter “Y”, may correspond to precisely entering the character “V”.
f. According to a second method, providing a long pressing action (e.g. a press and holding action) on a zone (e.g. 417015) preferably corresponding to a character may correspond to entering a/another character precisely. As an example, a long pressing action on the letter “Y”, may correspond to precisely entering the character “V”.
g. According to a third method, providing a gliding action departing from anywhere on a key and/or zone towards a predefined direction may correspond to entering a corresponding non-preferred character. As an example, in FIG. 417B, the gliding actions 417121, 417122, 417123, and 417124, departing from anywhere on the key 417002 may correspond to precisely entering the characters “X, K, H, and M”, respectively.
h. Other methods and/or scenarios for the same purpose may be considered by people skilled in the art.
   According to one embodiment of the invention the related characters may be printed/presented next/close to each other. Preferably, the alternative character (e.g. non-preferred character) of a pair of related characters is printed/presented outside the corresponding key. Preferably, a pair of related characters may partially resemble each other in shape (e.g. “V, Y”, “O, Q”, “I, J”, “M, W” “I,i”, “L, l”). An exemplary of related characters is shown in FIG. 417B. Preferably, the assignment of letters (i.e. preferred and/or non-preferred characters) to the keys of the keypad may also be based on their common shapes. It must be noted that although related characters may be defined based on shape as described herein immediately above, other bases such as, for example, phonetic/appellation resemblance may be used/applied to define related characters.

The assignment of letters to a few keys such as four keys based on their common shapes has been described in detail in the previous and related patent applications filed this inventor. In the example of FIG. 417B, the assignment of preferred letters and their related non-preferred letters to the four keys of the keypad are such that:
Letters that stand on one point (e.g. in their upper-case shape) are assigned to the key 417001.
Letters that stand on two points (e.g. in their upper-case shape) are assigned to the key 417002.
Letters that stand on a large base (e.g. in their upper-case shape) are assigned to the key 417003.
Letters that have a closed circle-like shape in their shape (e.g. in their upper-case shape) are assigned to the key 417004, preferably regardless of their shape having any of the shape descriptions mentioned in the immediate previous three assignments.
   According to one embodiment of the invention, a key of the keypad of the invention may have at least two layers/modes wherein generally/preferably the first layer/mode includes a first group of characters/letters such as the preferred characters (e.g. herein may be referred to as “preferred mode”) and the second layer/mode generally/preferably includes a second group of characters such as the non-preferred characters (e.g. herein may be referred to as “non-preferred mode”) and/or all of the characters of a language. It must be noted that according to one method, any of the groups of characters of any of the modes or layers (e.g. the first and the second group of characters) may include one or more common (e.g. same) characters.

In the example of FIG. 417A, the keys 417001-417004 of the keypad of the invention are shown in the first layer and in FIG. 417C said keys are shown in the second layer 417201-417204. In this example all of the letters assigned to the second layer are different than those assigned to the first layer. The user may switch the keypad from first layer to the second layer and vice versa by providing a pre-defined interaction for example a gliding action on any of the keys such as the (e.g. long) gliding action 417011 provided on the key 417001 as shown in FIG. 417A.

With continuous description of the current embodiment, optionally, a pre-defined interaction such as a tapping action on any of the keys of the second layer may ambiguously correspond to any of the characters assigned to the second layer. Optionally, a pre-defined interaction such as a tapping action on a zone assigned to a character/letter on a key of the second layer may precisely enter said character. Preferably, any of the methods corresponding to interactions on one layer (e.g. in one mode) may be available/correspond/apply to any other layer (e.g. with such interactions corresponding to the group characters for that layer/mode).

It must be noted that by providing a simplified that by assigning the preferred letters to a first layer and the non-preferred letters to a second layer, during the entry of words that are not in a (e.g. word) database used by the system, most of the time (e.g. close to 80% of the time for the English Language on average), the user may provide a simplest interaction (e.g. tapping action) with the keypad. By considering that, during text entry, the desired words are not in the database about 10 percent of the time on average, the use of the gliding/siding actions for entering precise characters may be about 2 percent of all interactions during text entry, and the use of tapping actions may be around 98% of the time, unless the user desires to use gliding actions to enter precise characters for some of the words that are in the database.

Note that according to the preferred embodiment, the characters of a second layer (e.g. non-preferred characters) which may be shown on the keys of the first layer, may preferably ambiguously be assigned to one or more zones outside the keys of the first layer as described throughout this application.

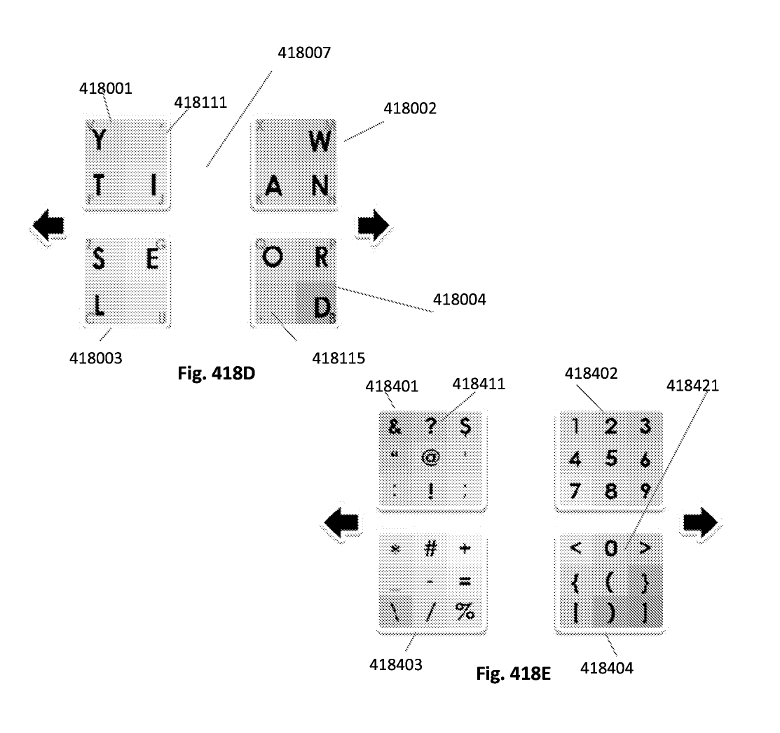

Characters assigned to any layer/mode (e.g. first or second layer) may be printed (separately or together) anywhere on the keys or outside the keys. FIG. 418D shows characters assigned, for example, to the second layer as being printed/presented inside the zones/keys.

The letter/characters corresponding to any of the layers (e.g. first and second layers) of the key may include special characters and/or functions. In the example of FIG. 418D, the comma (“,”) character is assigned to the second layer in the zone 418111 of the key 418001 and a period (“.”) character is assigned to the second layer in the zone 418115 of the key 418004.

FIG. 418E shows an exemplary keypad of the invention in Special Character mode. In this example, a tapping action on a zone of a key may enter a corresponding special character. For example, tapping on the zone 418411 may enter the question mark character (“?”). In this example, the key 418402 represents characters “1” through to “9” on nine separate zones and the character “0” is assigned the zone/sub-key 418421 of the key 418404 such that a telephone-like number pad is resembled in or as part of the keypad. Some of the zones/sub-keys of one key may have similar color and/or style of another key. In the example of FIG. 418E, the zone 418421 of the key 418404 has similar color (e.g. Green) to the zones of the key 418402. This may assist in emphasizing a group of characters.

According to one embodiment of the invention, as mentioned before, when the user taps on a key the system may consider two scenarios, in the first scenario the system may preferably relate said tapping action to any of the characters ambiguously assigned to the corresponding layer/mode (e.g. the system relates said tapping action to the fully predictive mode). According to the second scenario the system may preferably relate said tapping action to the character assigned to a predefined zone on the key on which the tapping action is provided (e.g. the system relates said tapping action to the semi predictive mode). As such, during the entry of the word the system may (e.g. preferably simultaneously) propose two types of one or more predicted words to the user. Accordingly, the first type of one or more predicted words may be proposed based on the fully-predictive mode and the second type of one or more predicted words may be proposed based on the semi-predictive mode. Note that in both, the fully-predictive mode and the semi-predictive mode, tapping on a predefined zone such as a zone preferably outside the keys may be related to any of the characters (e.g. non-preferred characters or any of the characters of a word) assigned to said zone. These matters have already been described in the related patent applications filed by this inventor.

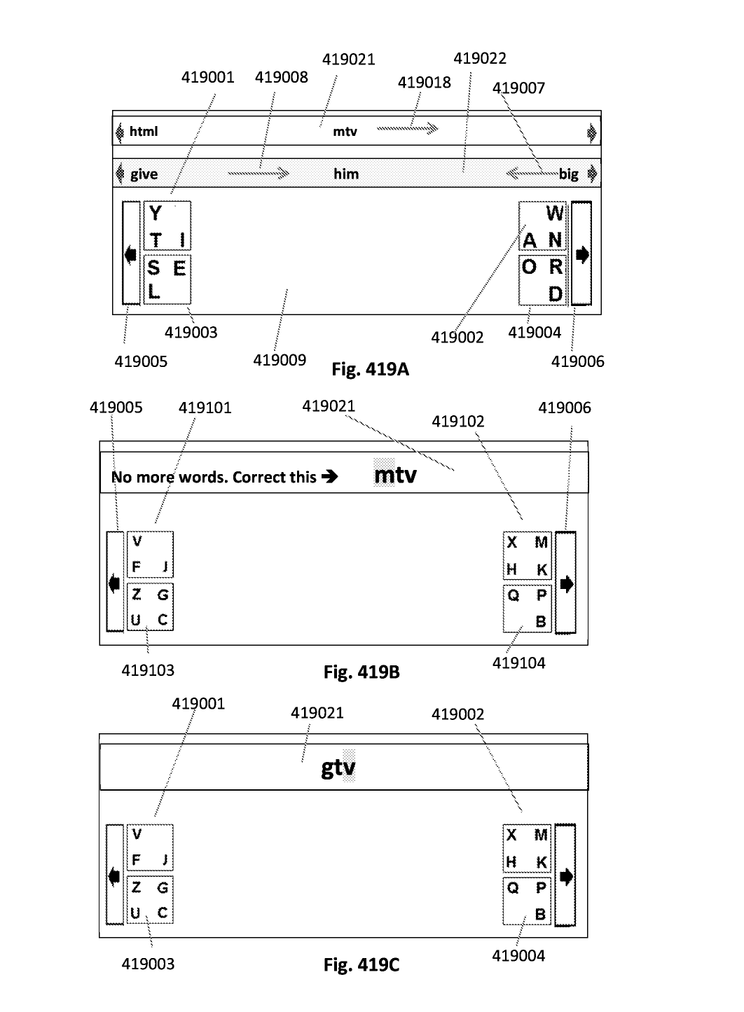

According to one method, each of said two types of one or more predicted words may be presented to the user, preferably in a different zone (e.g. on the screen of the corresponding device) (e.g. on two bars where a bar presents one or more words corresponding to an identical mode). As an example, FIG. 419A shows two bars 419021 and 419022 on which two types of predicted words as mentioned above are presented after the user provided a corresponding sequence of tapping actions on the keys:
The first bar 419021 may preferably correspond to the words predicted by considering user's tapping actions on the letters on the keys wherein said tapping actions are considered to correspond to precisely entering (e.g. preferably, the preferred) characters and/or the tapping actions provided outside said keys corresponding to ambiguously entering (e.g. preferably, the non-preferred) characters.
The second bar 419022 may preferably correspond to the words predicted by considering user's tapping actions on the keys wherein said tapping actions are considered to ambiguously correspond to any of the (e.g. preferred) characters on the corresponding keys and/or the tapping actions outside said keys ambiguously corresponding to (e.g. non-preferred) alternative characters and/or to any characters of a language.

Preferably, the words of the two bars are different from each other.

Preferably, the current predicted word is a fully predicted word (e.g. shown in the center of the corresponding bar). According to one method pressing on the space key confirms/enters said word. Preferably any of the other words may be entered by tapping on other word.

According to one method, all of the one or more words of the two bars, that may preferably be presented at the same time, are different from each other.

It must be noted that one or more types of one or more predicted words may be predicted by the system, each type different from each of the other types, and preferably a bar presenting a group of words corresponding to each type may be presented to the user. The predicted words for each type being computed on a different basis (e.g. fully-predictive and semi-predictive modes as just described above).

Preferably, the current predicted word is a fully-predicted word (e.g. shown in the center of the corresponding bar). According to one method pressing on the space key confirms/enters said word. Preferably any of the other words may be entered by tapping on said other word.

Optionally, each of the bars on the screen may be relocated by dragging them. According to one method a predefined interaction such as a press-and-hold and dragging action on one of the bars drags the other bars too (e.g. the bars may be consider to be grouped together for the purpose of display). According to another method, a bar may be (e.g. fully/partially) located on/over another bar. According to one method dragging a bar (e.g. substantially) towards the outside (e.g. edge of) the screen may remove the bar from the screen.

A predefined interaction such a gliding action on/near a first word (e.g. a word on a side) of a bar towards a neighboring word (e.g. the word in the center) on a (preferably the same) bar may replace said neighboring word by the first word. As an example, a swapping action 419007 on the word “big” may replace the word “him” by the word “big”. Preferably the characters of the first word (that replaces said neighboring word) may become fixed (e.g. precise) after the word replacing action. This matter has previously been described in detail in previous and/or related applications by the inventor. As such, according to another example, the gliding action 419008 results in replacing the word “him” by the word “give”.

If any of the predicted words are not the desired word, the user may provide a predefined interaction (e.g. such as a gliding action rightwards on the right side of a bar, herein may referred to as reject/next word interaction) so that the system may show more words to the user. Preferably, if the user provides such interaction with any one of the (e.g. two) bars the system may propose more words of the corresponding type on said bar and preferably hides the other bar(s). Alternatively, if the user provides such interaction with one of the (e.g. two) bars the system may propose more words on each bar where said more words are of the corresponding type of words of each bar and preferably does not hide the other bar(s).

It must be noted that, although, for the purposes of explanation regarding the presentation of one or more proposed/predicted word(s), one or more bars have been used to represent those zones, it is understood any other presentation of proposed/predicted word(s) may be used for such a purpose. For example, said one or more zones may have other shapes. Additionally, there may be more or less than two zones considered for the display of proposed/predicted words, for example, based on the number of types of prediction modes. Also, it must be noted that a single zone may present proposed/predicted words corresponding to more than one prediction mode (e.g. fully-predictive and semi-predictive modes).

Interacting with the content/words displayed on a from a predefined zone(s) preferably outside the keys of the keypad (e.g. next words, previous words/undo, swap words functions, etc.), has been described before in related patent applications filed by this inventor. According to a preferred embodiment of the invention, said interactions provided from a said one or more predefined zones outside the keys of the keypad, may preferably apply (e.g. preferably simultaneously) to any and/or all of the bars.

After providing one or more such interactions (e.g. reject/next word interaction), if there are no more words (e.g. words not found in a database of words) to propose to the user the system may enter into the correction procedure. During the correction procedure the user may be required to enter precise characters replacing the ambiguous characters of a predicted word, wherein at any moment the system may propose one or more words corresponding to the input information provided until then.

It must be noted that after correcting or rejection at least some of, preferably all of, the (e.g. ambiguous and/or precise) characters of a proposed word, interacting with the keys and/or zones may correspond to the appending of additional (e.g. generally precise) characters to the end of the current predicted word.

Preferably, the character to be corrected may be highlighted with the color of its corresponding key. If the highlighted character belongs to the outside zone(s), it may be highlighted with colors than those of the four keys or zones on the keys. Therefore, the highlighting of characters to be corrected may change according to the key(s)/zone(s) to which they belong. This may facilitate the focus of the user on the appropriate key of the character to be corrected.

As mentioned before, at some point during the entry of a desired word, the system may (e.g. automatically or manually by the user) be switched to the Spelling Help mode and the user may tap on the outside zone for the entry of any character of a desired word. In this case, during the correction procedure of the invention, preferably the keypad layer presented to the user for correction of said character (e.g. in the current predicted word) may be the one that has the most commonly used letters (e.g. the first layer such as the preferred character layer of FIG. 417A). Such character may be highlighted by another color different than the characters corresponding to the key(s)/zone(s) as just previously described.

According to one embodiment providing a predefined interaction such as a (long) gliding action on a key (e.g. on a letter key, on the space key, etc.) may switch the keys from one layer to another layer. As an example as shown in FIG. 417A a gliding action 417011 provided on a key 417001 may switch the keys from the first layer to the second layer (e.g. as shown in FIG. 417C) and vice versa.

After the user rejects all of the words proposed/predicted the system preferably alerts the user and may enter into the correction mode. According to one method, if the user rejects all of the fully-predicted words the keys remain in the same layer, preferably in the preferred letters mode. According to one method if the user rejects all of the semi-predicted words, the keys may preferably be switch to their non-preferred mode. This is because, during the entry of the input information corresponding to a semi-predictive mode, the ambiguous characters are preferably/generally those characters that are located outside the keys of the keypad (e.g. those characters or groups of characters that do not correspond to the preferred character mode). By doing so, the user can enter precise characters to replace the ambiguous characters of a predicted word by tapping on the letters of the keys in the non-preferred letter/character mode. After replacing the ambiguous characters by precise characters, entering additional precise characters may add a set of characters to the end of the current predicted word. According to one method, after providing an end of the word signal such as pressing on the space key, the system may switch back to another predefined layer/mode (e.g. the preferred character mode).

According to one embodiment of the invention, during the entry of the input information corresponding to a word, if there is no word corresponding to said input information the system may alert the user. Two scenarios may be considered:
A) If there are no words corresponding to the input information relating to the fully-predictive mode, the system may alert the user. If the user continues to type the system may preferably remove the bar corresponding to the fully-predicted words and predict corresponding words relating to the semi-predictive mode. Alternatively, after the alert, if the user rejects the fully-predicted word(s) the system may preferably (e.g. remove the semi-predictive bar and) enter into the correction procedure corresponding to a fully-predicted word.
B) If there are no words corresponding to the input information relating to the semi-predictive mode, the system may alert the user. If the user continues to type the system may preferably remove the bar corresponding to the semi-predictive mode and predict corresponding words relating to the fully-predictive mode. Alternatively, after the alert if the user rejects all of the fully-predicted words the system may enter into the correction procedure corresponding to correcting a semi-predicted word.
   According to one embodiment of the invention, if the keys of the keypad are in non-preferred character mode, providing an interaction such as a long pressing action and/or a gliding action on a zone corresponding to a character/letter of a key may correspond to entering a character of the first layer (e.g. a preferred character).

According to one embodiment of the invention, when the system/keys are in the non-preferred character mode, a predefined interaction such a long pressing action or a gliding action on a (zone corresponding to a) non-preferred character may correspond to entering a preferred character (e.g. it preferred related character). Alternatively, a long pressing action on a zone of a key may correspond to entering precisely a letter of the current layer and a gliding action on said zone may correspond to entering precisely the alternative character from the the other layer of the related characters, or vice versa.

Note that, when the keypad has switched from a first layer (e.g. preferred-characters) to a second layer (e.g. non-preferred characters), the characters of the first layer may preferably be assigned to the one or more zones outside said keys.

According to one method providing a long pressing action on a key of the keypad in the preferred character mode may ambiguously correspond to a non-preferred character assigned to said key.

According to one method, a precise character entered by interaction other than a short tapping action on a key (e.g. press-and-hold action, long pressing action and/or a gliding action) may preferably enter said character in the corresponding words of any of the types of words (e.g. corresponding to each bar) such as said first and second types of words.

According to one method, more than one zone or a larger zone on a key may be assigned to a character. As an example, in FIG. 418A, the empty zone 418111 may also be assigned to letter “I” on the key 418001. Also as an example, the larger zone 418115 on the key 418002 is assigned to the letter “A”.

According to one embodiment of the invention, a character assigned to a key may be considered by the system to be entered only precisely. Said precise character being entered, as such, may be considered in, both, the fully-predicted mode word prediction and in the semi-predictive mode word prediction. As an example FIG. 418B shows the keys 418001-418004 of the keypad in the preferred character mode. In this example, tapping on the zones other than the zone 418211 on the key 418001 may ambiguously correspond to any of the characters i, y, and t. In this example, said tapping action may not be related to the character “f” although said character is printed/presented on—and/or assigned to—said key on the first layer. Accordingly, a short tapping action on the letter “f” (e.g. zone 418211) may enter said character precisely and be considered by, both, the fully predictive-mode and the semi-predictive mode (e.g. and/or preferably any word prediction modes).

It must be noted that the system may have any number of keys wherein each of said keys may have any number of preferred characters and/or non-preferred characters. (e.g. respectively assigned to a first and a second level). As an example, the interface relating to a Hindi language may have four keys each having six preferred characters (e.g. and six non-preferred characters). In the case of this example, the non-preferred characters assigned to the zone(s) outside the keys may be twenty four characters.

According to one embodiment, after the user enters a precise character, providing a predefined interaction such as gliding action on a zone outside the keypad may correspond to replacing said precise character by its corresponding accented character, if any. Preferably the system may alert the user of such possibility by providing an icon as described in the previous patent applications filed by this inventor. According to one method, said icon may indicate the directions of the gliding actions corresponding to various accents relating to said character.

It must be noted that any other type of entry of precise characters may be used with the predictive system(s) of the invention. For example, the keypad of the system (e.g. in the correction mode) may be a full keyboard wherein a single precise letter is entered by providing a tapping action on a corresponding key.

It must be noted that although in different embodiments/paragraphs an interaction such as a tapping action is used to provide input information, any other type of interaction (e.g. gliding action, double/long pressing action, voice, etc.) may be used for the same purpose.

According to one embodiment of the invention, a predefined interaction such as a long pressing action on a zone corresponding to a character of a layer may enter said character precisely. Said character may be used by any of the fully-predictive and/or semi-predictive modes.

According to one embodiment of the invention, during the correction procedure of the system, the system may show/present/switch to the keypad layer (e.g. preferred or non-preferred layers) corresponding to the character to be corrected (e.g. the highlighted character) of the current predicted word. Preferably, said keypad layer corresponds to the layer containing said character to be corrected. As an example, if the user wishes to enter the word “dmtg”, given FIG. 418D, in the fully-predictive mode, if the user taps on the key 418004, on the zone 418007, on the key 418001, and on the zone 418007, the system predicts the word “ruth”. After the user rejects all the proposed words, the system may enter into the correction mode. At this time, preferably, the first character “r” is highlighted for correction. The presented layer corresponds to the layer that includes the character “r” (e.g. first layer of the keypad as shown in FIG. 418D). The user may now press on the zone corresponding to letter “D” on the key 418004 to replace the selected/highlighted character “r” of current predicted word by the character “d”. Now the second (e.g. ambiguous) character “u” may preferably be highlighted and the system may preferably switch to the layer (e.g. a second layer) corresponding to said highlighted character “u”, in this example the layer as presented in FIG. 417C. The letter “m” is included in this layer (e.g. second layer). The user now presses on the letter “m” to replace the character “u”. Now the third character (“t”) of the word is highlighted and switches to the corresponding layer (e.g. first layer). The user may tap on the character “t” of this layer to replace the ambiguous character “t”. Alternatively, according to one method, if the highlighted character is the same as the desired character, the user may tap on the zone (e.g. in this example 418007) and the system may change the status of the highlighted character from ambiguous to precise. Now, the last character of the word is highlighted and the system switches to the corresponding layer (e.g. the second layer) of the highlighted letter (in this example, the letter “h”), and the user press on the letter “g” to replace the highlighted letter “h”.

According to one embodiment of the invention, during the entry of a word, the user may reject all of the words presented on any one of the bars, after which the system may alert the user that there are no more one or more words for that bar, and may enter into the correction procedure of the system. The alert and/or the word to be corrected may be presented on said bar. Alternatively, each or any of the bars may include a means, such as a button, to switch the system to the correction mode corresponding to that bar, preferably at any moment during the entry of a word.

With continuous description of the current embodiment, while providing input information (e.g. key interactions) corresponding to a desired word, if there is no word corresponding to one of the modes (e.g. fully-predictive or semi-predictive modes), the system may alert the user preferably on the corresponding bar. If said bar corresponds to the user's desired mode, the user may proceed to the correction procedure corresponding to that mode, for example by providing a predefined interaction with said bar to cause the system to enter into the corresponding correction mode. Alternatively, if said alert does not correspond to the user's desired mode, the user may continue to provide additional information (e.g. keypad interactions) corresponding to, at least some of, the remaining characters of the desired word. At some point, if there is no more word/s corresponding to the user input information in the other mode, the system may preferably alert the user accordingly, and the user or the system may enter the system into the correction mode corresponding to the second bar. It must be noted, that according to one method, at any moment during the entry of the input information after the first alert, the user may be able to enter the system into the correction mode corresponding to the first bar.

It must be noted that for the characters to be corrected, the system may switch to the appropriate layer as previously described.

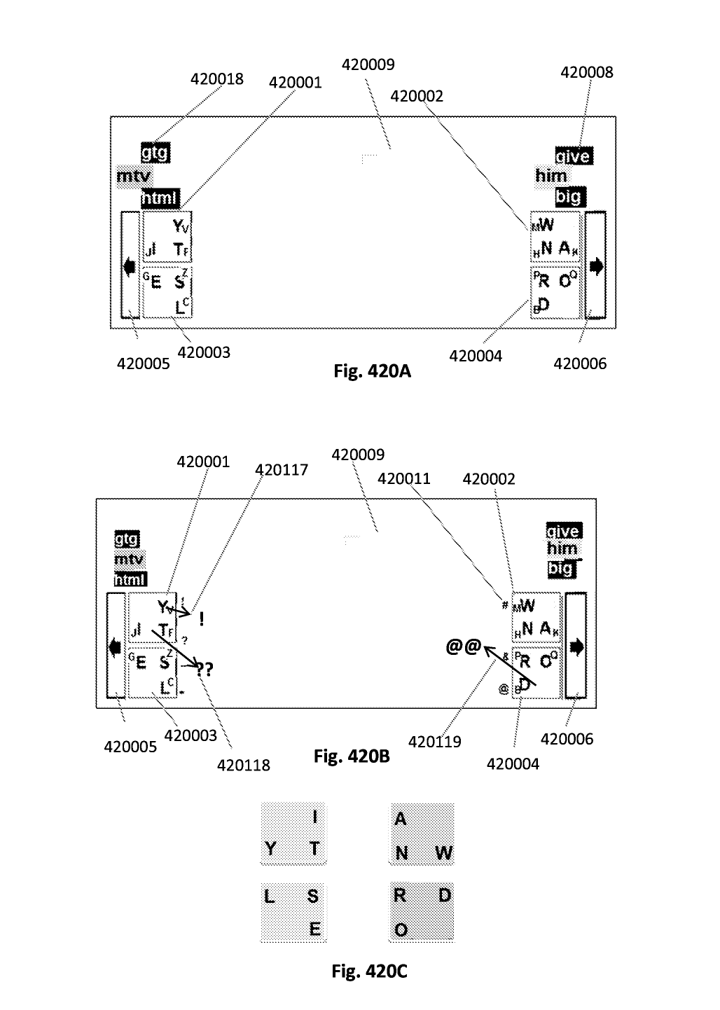

According to one embodiment of the invention, the arrangement of the characters on the keys, may be so arranged as to enable the user to quickly scan (e.g. visually identify) for a desired character. Preferably, consonants may be closer to each other on the keys, and at least the main vowels may be arranges such that they be positioned far from each other, to not distract a user when searching for a consonant, or vice versa. FIG. 420A shows, as an example, one such type of arrangement/assignment/configuration of characters on a layer (preferably the first layer) of the keypad. In this example, a first group of characters, preferably consonants, are arranged on four keys so as to be close to each other and a second group of characters, preferably the main vowels (e.g. i, e, a, o), are arranged in such a manner as to be farther from each other. Because the user knows that the main vowels are on the keys, all the user has to do is to scan mainly the eight consonants for any letter other than those main vowels. This permits/enables almost instant scanning of the keypad in order to identify/located the location of a specific character on a key or not. FIG. 420C shows another arrangement of characters on the keys of the keypad based on the principle just described. Other arrangements may also be considered by people skilled in the art.

According to one embodiment of the invention, groups (e.g. preferably lists of at least some) of predicted word(s) relating to the fully predictive mode and the semi-predictive may be separated from each other, preferably being located on opposite sides on the screen. Each group preferably, located close to user's different thumb. In the example of FIG. 420A, a first group of words (e.g. 420008) corresponding to the fully-predictive mode is located near/on the right side of the screen, and a second group of words (e.g. 420018) corresponding to the semi-predictive mode is located near/on the left side of the screen. The words are arranged (e.g. inter-digitated such that alternative words have similar offset) on the screen such as to be easily interacted with by the user's finger (e.g. to prevent the prevalence of miss-selecting a word in a group of words).

Preferably, words in a group may be located in the vertical, on top of each other. Preferably, the current predicted word may be located in the center of the list of words. Preferably, a current predicted word of a group is shown differently to the other words in said group. Preferably, a word of a group (e.g. a current predicted word) may be replaced by another word in said group. According to one method, all those functionalities/interactions may be applied to both groups of words. According to one method, said interactions may be provided on any group of words separately. According to one method, an interaction with both groups may be provided on a pre-defined zone, such as a zone outside the keys. Interactions with and/or functionalities of a group of predicted words has been described in detail in previous/related patent applications filed by the inventor. For example, providing a predefined interaction such as a gliding action, rightward, on a pre-defined zone may cause the system to show more words for each group. According to another example, providing an interaction such as a gliding action upward in a zone may cause the system to replace the current predicted word of each group by another word, preferable by the word below said current predicted word of each group.

As mentioned before, a long press action (e.g. a pressing action for at least a pre-defined time period) on a character of the first layer may correspond to its related character. According to one embodiment, a gliding action (e.g. in any direction) from said character may correspond to entering another character such as, preferably, a special character or function. As an example, a gliding action 420117 provided from the zone corresponding to letter ‘y’ in any direction, in FIG. 420B, may correspond to an exclamation mark. According to another embodiment, gliding actions from anywhere on a key in different pre-defined may correspond to different special characters and functions. As an example, in FIG. 420B the gliding action 420118, provided from anywhere on the key 420001 towards the lower-right side may correspond to the question mark character, and the gliding action 420119, provided from anywhere on the key 420004, towards the upper-left side may correspond to the ‘@’ character.
press and hold to add a word in the dictionary

During the entry of the input information corresponding to a word, if there is no corresponding word (e.g. in any entry of one or more corresponding N-gram database(s)), the system may inform the user by a means such as, for example, highlighting a corresponding presented word that is not in the dictionary. In this case, for example after correction (e.g. the correction procedure), a long pressing action on said word may add said word to the dictionary and eventually enter it into the corresponding text box/editor.
other languages such as phonetic based languages

It must be noted that the principles, functionalities, embodiments, methods, etc. describe throughout this patent application and related patent applications filed by this inventor may apply to any (e.g. other) type of language such as roman alphabets, phonetic alphabet-base languages and/or hieroglyphic-based languages such as, for example, Chinese, Japanese.

According to one embodiment of the invention, after a user rejects a current predicted word, the next current predicted word proposed to the user may be fixed (e.g. all of its characters may preferably be considered by the system as precise characters) as may be consider as a fixed portion of a longer predicted word. As an example, in this case, if the user appends more characters to the end of the current predicted word, said fixed portion will remain unchanged during the prediction/entering of a word.

As mentioned before, several different types of interactions may be used to provide a same/duplicate input signal(s) while interacting with input means such as the (e.g. touch sensitive) keys and/or (e.g. touch sensitive) zones. For example, according to one method, two different types of interactions (e.g. pressing action and gliding action) with an input means may provide a same input signal. According to another method, a single interaction (e.g. such as a simple gliding action, preferably having a substantially straight trajectory) with more than one input means (e.g. such as a more than one key/zone) may duplicate the providing of a sequence of input signals that may also be provide by single interactions with (e.g. each of) said more than one input means. According to one embodiment of the invention, a method of a simple sliding/gliding action(s) to duplicate tapping/pressing actions on the keys and/or zones may be considered. For example, instead of tapping on a first and second (or more) keys/zones, providing a gesture (e.g. sliding/gliding action) from/on a first key/zone towards/onto a second (or more) keys/zones may preferably represent/duplicate said tapping actions.

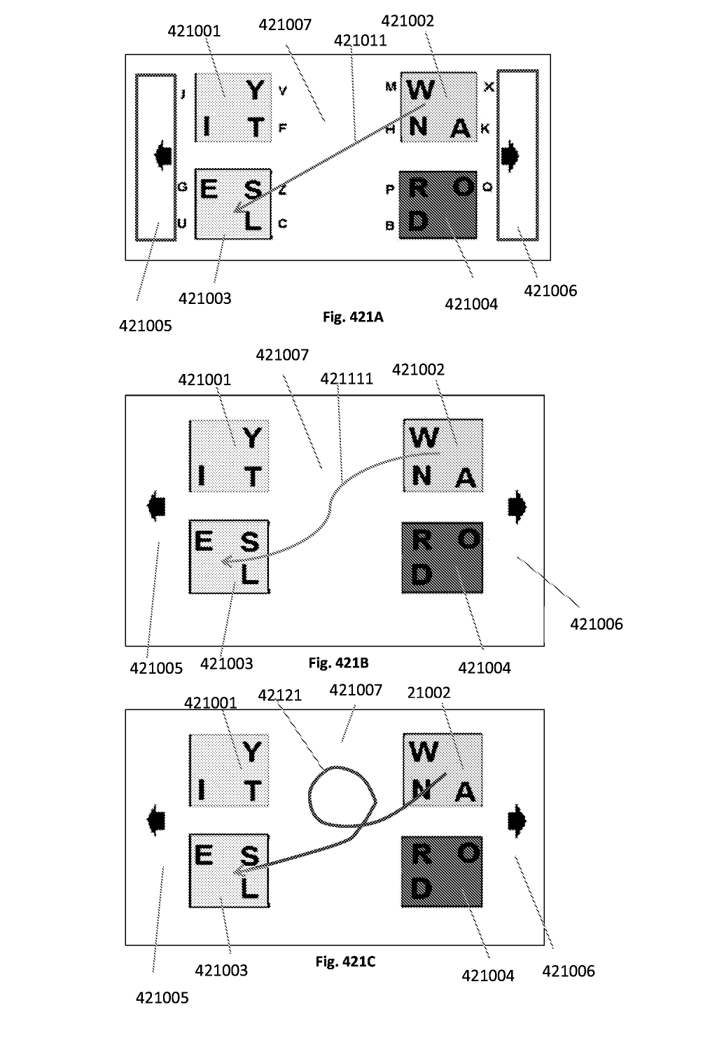

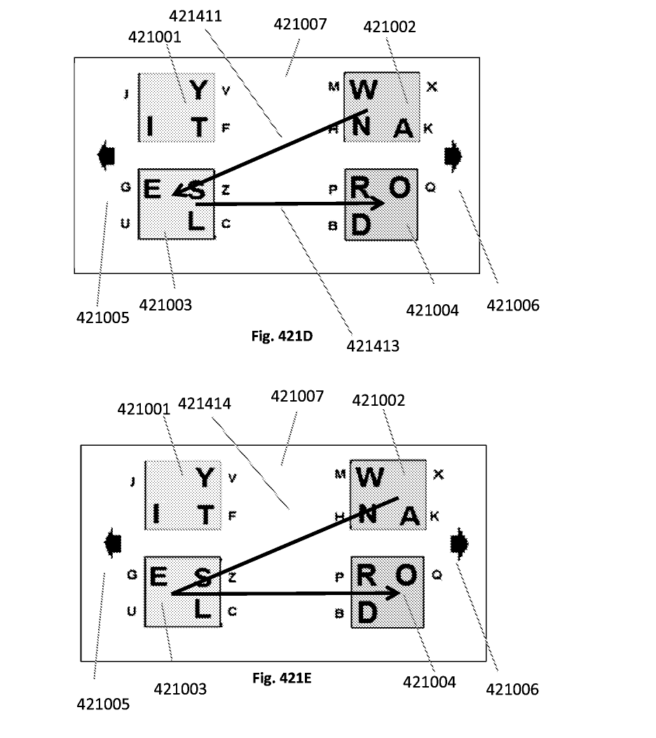

As an example, FIG. 421A shows the keypad of the invention having four keys 421001 through to 421004, the zone 421007 between the keys, and the space 421005 and backspace 421006 keys, similar to the keypads already described. In this example, providing a straight gliding action 421011 may duplicate the tapping actions on the keys 421002 and 421003. According to one method, in order to duplicate tapping actions on the key 421002, on the zone 421007, and on the key 421003, the gliding action may begin from the key 421002, as traverse the zones 421007, while changing the direction of gliding action over the zone 421007, and ending on the key 421003. In order to duplicate two or more consecutive tapping actions on a key or a zone, one of more circular gliding actions may be provided on said zone or key. In FIG. 421C, as an example, the gliding action 421211, duplicates one tapping action on the key 421002, two tapping actions on the zone 421007, and one tapping action on key 421003. For the same purpose, other methods may be considered by other people, skilled in the art. For example, instead of circular gliding actions, consecutive back-and-forth gliding actions, may be provided on a key/zone.

According to a preferred embodiment, a substantially straight gliding action represents two interactions, such as, for example, two tapping actions. If said gliding action is provided on a single key/zone such gliding action corresponds to two consecutive interactions, preferably with (preferably a single) key/zone. A complex gliding action may preferably by characterized by a single gliding action such as a gliding action forming two simple (substantially straight) gliding actions (preferably in significantly different directions) preferably without removing the finger from the surface on which the complex gliding action is provided. The complex gliding action preferably correspond to the number interactions equal to the number of said straight gliding actions plus one. As an example, in FIG. 412D, the two simple gliding actions 421411 and 421413 (e.g. by removing the finger from the key/touch sensitive surface between the two gliding actions) represent four interactions with keys (e.g. with keys 421002, 421003, 421003, and 421004) and in FIG. 412E, the complex gliding action 421414 (e.g. by NOT removing the finger from the key/touch sensitive surface when providing sais complex gliding action) corresponds to three interactions with keys (e.g. with keys 421002, 421003, and 421004).

According to a first embodiment of the invention, a simple/complex gliding action provided over several zone/keys may correspond to an entire word.

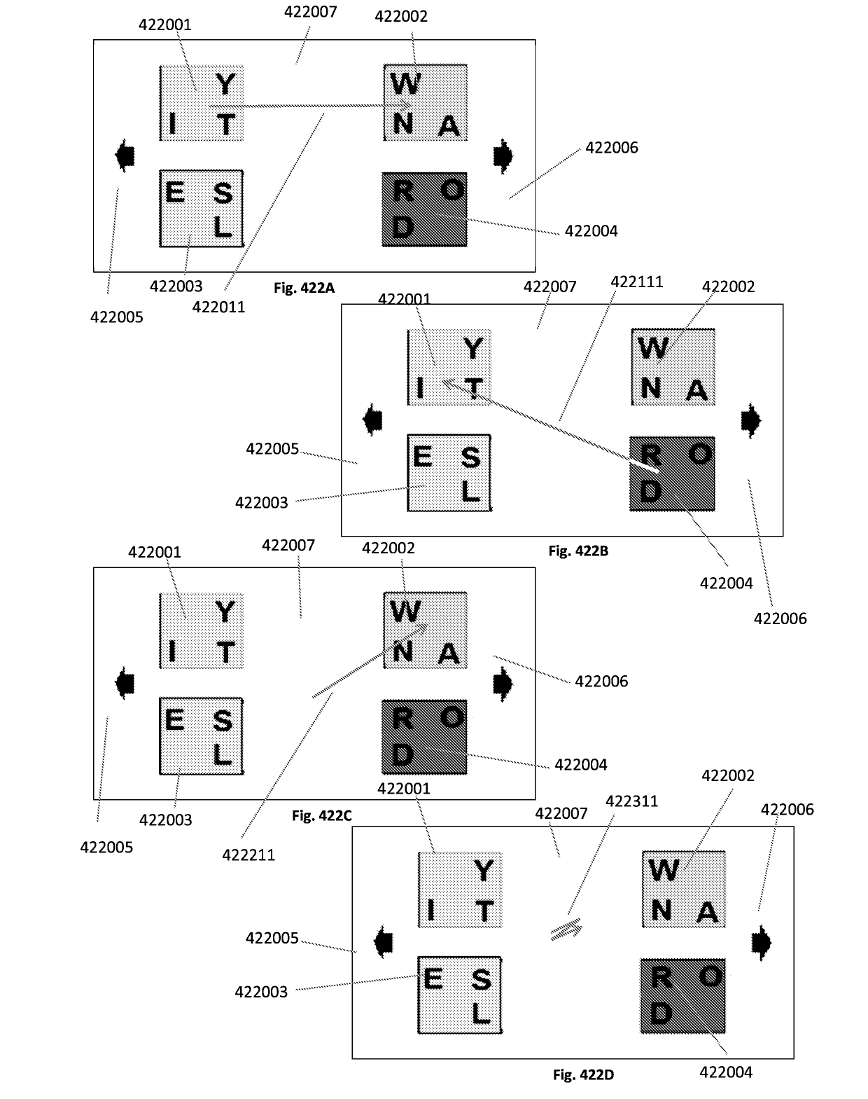

According to a second embodiment, a gliding action may correspond to a word or a portion/stem of a word. Optionally, a sequence of one or more interactions such as gliding and/or tapping actions provided separately (e.g. the user lifts his/finger from the corresponding touch sensitive surface each time he/she provides an interaction) may be combined to correspond to entering a word or a portion/stem of a word. As an example, FIG. 422A to FIG. 422D shows the procedure of entering the word “indication”. The gliding action 422011 of FIG. 422A corresponds to interacting with the keys 422001 and 422002. The gliding action 422111 of FIG. 422B corresponds to interacting with the keys 422004 and 422001. The gliding action 422211 of FIG. 422C corresponds to interacting with the zone 422007 and the key 422002. The gliding action (e.g. tracing a complex trajectory) 422311 of FIG. 422D corresponds to several interacts with the zone 422007. By considering said interactions and the (Automatic) Spelling Help feature of the invention (using the gliding action 422311), as previously described in related patented applications filed by this inventor, the input information may correspond to any of the words (in the English language): indication, indicating, indicative. Note that, in this example, the automatic spelling help may have been activated after the entry of a given number (e.g. five) letters/characters as previously described in detail. Also, note that the gliding action 422311 has three angles (e.g. comprised of four simple gliding actions), each angle representing an individual key/zone interaction and wherein considering that preferably the initial departure of the gliding action (e.g. of the first simple gliding action in the complex gliding action 422311) represents an additional interaction. Note that the gliding 422311 represents a total of four interactions with the zone 422007.

It must be noted that the embodiments relating to gliding actions provide over one or more zone(s) and/or key(s) being described duplicating interactions such as tapping actions with said zone(s) and or keys(s) are used for describing the duplication of the input signals provided by said duplicated interactions such as tapping actions. These type of interactions (e.g. gliding and/or tapping actions) may be used in at least some of the (preferably all of the) methods, systems, embodiments, principles of the invention. For example, use of the fully-predictive system and/or methods, use of the semi-predictive systems and/or methods, entering rejection, correction, inputting ambiguous characters, insertion of precise characters, swapping, automatic and manual spelling help functions, etc. may be used with these types of interactions to input text and/or data as described throughout this patent applications and the related applications filed by this inventor.

According to one embodiment of the invention, the gliding actions in a zone (e.g. outside the keys) may be used for functions such as Next Word or Previous Word, Word Swap, Mouse Functions, etc. in this case, gliding actions starting and/or ending on a zone may be replaced/emulated by tapping actions for entering characters corresponding to said zone.

As an example, in FIG. 423A, the trajectory of the gliding action 423511 passes on the letter A on the key 423002, over the zone 423007, and over the letter T on the key 423001. The system may relate said gliding action to, both, the fully predictive mode, and the semi-predictive mode. In this case, as an example, according to the fully predictive mode the corresponding word with the highest priority may be the word “why”, and in the semi-predictive mode the corresponding word with the highest priority may be the word “act”.

According to another example, in FIG. 423B, the trajectory of the gliding action 423611 passes over the letter M, the letter I on the key 423001, on letter T on the key 423001, the letter N on the key 423002, and the letter E on the key 423003. According to the fully predictive mode, the corresponding word having the highest priority may be the word “fine”. In this example, the semi-predictive mode may preferably not considered because the gliding action does not change its trajectory on the zone 423007. On the other hand, the gliding action trajectory passes over identified/precise letters. Therefore, as an example, the unambiguous words “mine” (e.g. from the dictionary used by the system) and the word “′mitne” (e.g. not included in the dictionary) may be proposed to the user.

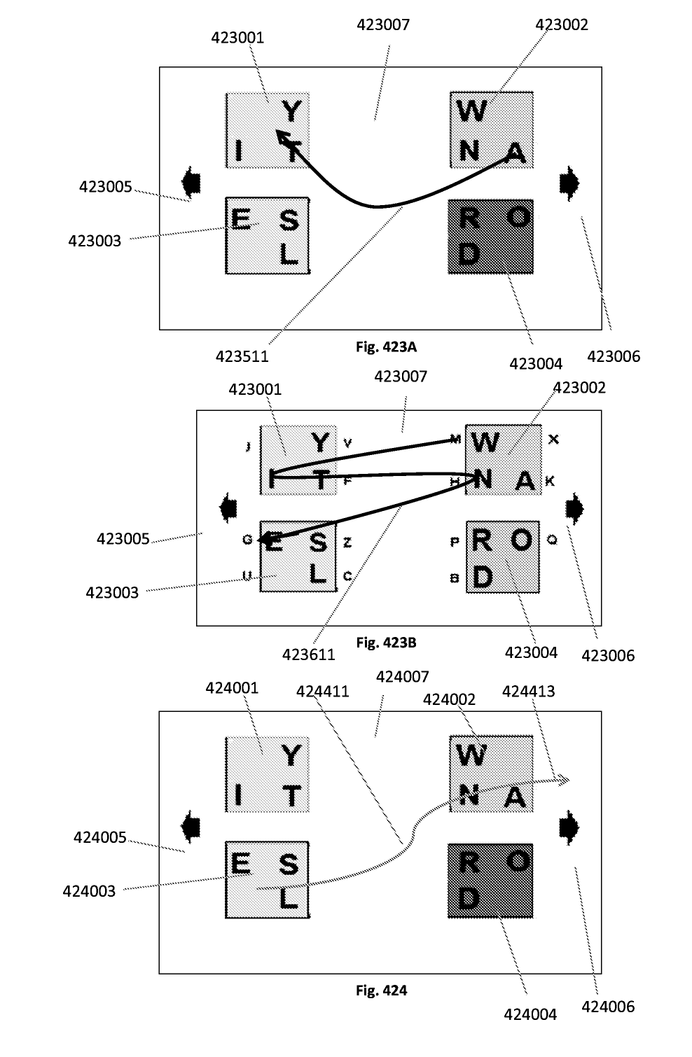

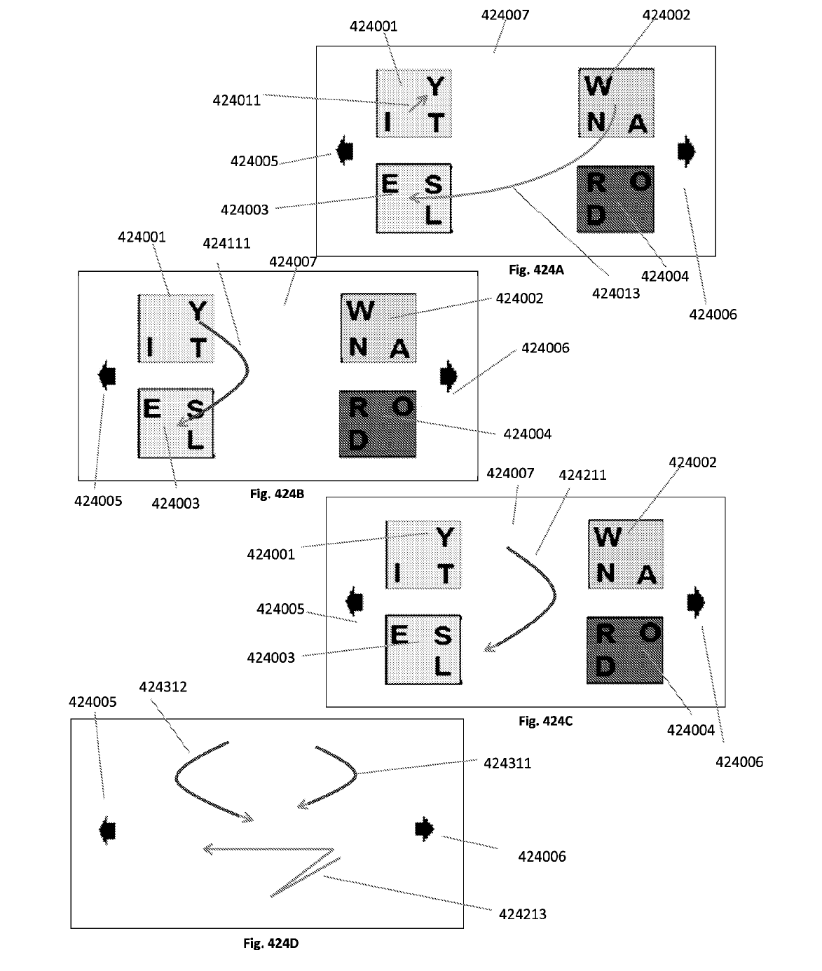

Gliding actions may also be provided on, towards, or from, other keys such as space key and/or backspace keys. As an example, FIG. 424 shows as an example, a gliding action 424411 provides over the key 424003, over the zone 424007, key 424002, and over the key 424006. In this example, said gliding action may for example correspond to entering the word “sun” and space character at the end of said word.

It must be noted that the invention may include a word auto-completion system so that by providing the input information (e.g. gliding and/or tapping actions) corresponding to one or more (preferably beginning) portions of a word, the system predicts completed one or more words that include said one or more portions.

According to one method, any type of non-straight gliding action provided over a zone/key may be interpreted by the system as interacting with said zone. FIG. 424A and FIG. 424B show two examples of such non-straight gliding actions 424013 and 424111 respectively. As an example, gliding action 424111 beginning on the key 424001, passing over the zone 424007, and ending on the key 424003, is related to the word ‘the’. Also, according to one method, a gliding action on a key may correspond to more than one tapping action on said key. As an example, the gliding action 424011 may preferably corresponds to two tapping actions on said key.

In the example, FIG. 424B, the gliding action 424111 was provided to enter a corresponding word such as the word ‘the’. According to one embodiment of the invention, such gliding action may be provided on a zone preferably outside said keys, such as the zone 424007. By considering the shape/trajectory of a gliding action, the system may easily relate said gliding action to corresponding words where ever a such gliding action may be provided, for example the gliding action 424211 in FIG. 424C which may represent interacting with the keys 424001, the zone 424007, and the key 424003.

According to one embodiment of the invention, at least one, preferably all, of the key(s) and/or zone(s) of the input means of the system may be removed, invisible, opaque, or transparent so as to permit entering text through the shape of gliding actions that duplicate interaction(s) with such key(s) and/or zone(s). FIG. 424D, shows as an example, different gliding actions duplicating interactions with such input means as just described. In this example, a gliding action provided anywhere on the a touch-sensitive surface, preferably in a pre-defined area such as the area between the space and backspace keys, which in this example, are shown on said surface, may relate to interacting with the key(s)/zone(s) of a virtual keypad model of the invention (which is not shown). As an example, the gliding action 424311 represents interacting with the key 424001, the zone 424007, and the key 424003 relating, for example, to the word ‘the’. Also, the gliding action 424312 represents interacting with the key 424002, the zone 424007, and the key 424004 relating, for example, to the word ‘who’. Also, the gliding action 424213 represents interacting with the key 424002, the zone 424007, the key 424002, and the key 424001 relating, for example, to the word ‘that’.

In this embodiment, at any moment during the entering of text, such as entering precise characters, the keypad of the system including corresponding zone(s) may be brought up/displayed. As an example, precise characters/words/chain of characters may be entered this way. It must be noted that the method of providing gliding actions over ambiguous keys such as four keys having been described in detail in previous patent applications by the inventor.

It must be noted that the input signals provided by interacting with keys and/or zones of a keypad, such as the keypad of the invention, may be duplicated by any type of input means such as, for example, stylus, fingers, camera, motion in air/space, etc.

According to one embodiment of the invention, the system may be designed such that during the entry of word(s) having up to a predefined number of characters (e.g. up to five characters) interactions such as tapping on a (e.g. one or more) predefined zone/key (e.g. preferably outside the keys of the keypad, as described in this and in the related patent applications filed by this inventor) (e.g. herein may be referred to as “the broadly ambiguous zone”. Note that this name is for naming purpose only and in no way specifies the nature of said zone/key) may preferably ambiguously correspond to (e.g. any of) the non-preferred characters, and for words having more than said predefined number of characters preferably all of the interactions such as tapping actions provided on said zone may preferably ambiguously correspond to any of preferred and non-preferred characters. As such, by assuming that a word having more characters than said predefined number of characters may be considered to have two portions, wherein its first (e.g. beginning) portion consists of a number of characters equal to said predefined number of characters and its second portion consists of the remaining characters of said word, according to a preferred embodiment of the invention, during the entry of the first portion of such word, interactions such as tapping actions provided on a zone (e.g. preferably outside the keys) may ambiguously correspond to non-preferred characters (e.g. and accordingly, one or more words may be predicted/proposed), and during the entry of the second portion of the word, all of the interactions outside the keys, including those provided during the entry of the first portion of the word, may preferably be considered as being ambiguously related to any of the preferred and non-preferred characters (e.g. and accordingly, one or more words may be predicted/proposed).

According to one embodiment of the invention, during the entry of a word, one or more interactions (e.g. one or more tapping actions) on a broadly ambiguous zone may be considered to ambiguously correspond to one or more characters of a broad group of characters. As such, for any character(s) of a word, preferably from the beginning character of a word, the user may be permitted to interact with (e.g. tap on) the broadly ambiguous zone for any character, preferably, even if said character in assigned to a key of the keypad. This permits a large amount/degree of freedom of typing (e.g. enables user's own style of typing) during the entry of content (e.g. a word/text/etc.). Most of the time, all the user may be required to do, depending on the type of a word (e.g. the length and on a number of characters of the word corresponding to the keys of the keypad), is to tap for few (e.g. two, three, or four) of (e.g. any of) the characters of the word on the corresponding keys, and for the rest of the characters of the word just tap on the broadly ambiguous zone, even if some of said characters correspond (e.g. grouped on the keys) to the keys of the keypad. As an example, by considering the keypad of FIG. 424A in order to type the word “friend”, the user may tap two times on the broadly ambiguous zone 424007 for the letters “f” and ‘r”, then tap on the keys (424001 and 424003) corresponding to the letters “i”, and “e” respectively, and finally tap two times on the broadly ambiguous zone 424007 (e.g. for the two remaining letters). According to another example, for the entry of the same word “friend”, the user may press three times on the broadly ambiguous zone for the letters “f”, “r”, “i”, and tap on the keys corresponding to the letters “e”, “n”, and “d”. In both examples, the word “friend” may be proposed to the user as the word of first choice.

It is understood that when the user taps on a key corresponding to a desired letter, he may either tap anywhere on said key, or he may precisely tap the desired letter on said key. The system may consider both input/entry possibilities for predicting a first and second types of word predictions (e.g. respectively, fully predictive, and semi predictive types of prediction) as described in detail before in the related patent applications filed by this inventor.

As mentioned before, if the system uses a keyboard having a number of keys for entering precise characters (e.g. QWERTY keyboard) (hereafter may be referred to as a precise keypad), a key or a zone (e.g. a broadly ambiguous zone) preferably outside said keys, may be used such that an interaction, such as a tapping action, on said key/zone may correspond to inputting an input signal ambiguously corresponding to a (e.g. any) character in a group of characters (e.g. preferably, all of the letters of a language, and eventually at least one/some of special characters. Such a group of characters wherein may be referred to as “broad group of characters”). All of the principles of using a predefined key/zone, preferably outside the keypad assigned to a group of characters such as non-preferred and/or preferred characters as previously described, may be applied to a precise keypad. As an example, during the entry of a word, the user may tap on the keys corresponding to one or more characters of the word to enter one or more characters of said word precisely, and provide tapping actions one or more times on said (outside) zone/key for ambiguously inputting input signals corresponding to one or more of its remaining character(s). As an example, in order to enter the word “correct”, the user may tap on the keys precisely corresponding to the letters “c”, and “o”, then tap two times on the (outside) zone/key ambiguously corresponding to the third and fourth characters of the word, then tap on the keys “e”, “c”, “t” for entering precisely the three remaining letters. By considering the input of the precise characters and the ambiguous input signals the system may propose the word “correct”.

According to one embodiment of the invention, such keypad may be a split keyboard wherein the keys are divided into two or more groups, preferably two groups, of keys preferably positioned on the opposite sides of a touch sensitive surface such as on the (touch) screen of a device. According to one method, said (outside) key/zone may be located between said two groups of keys.

It must be noted that the data entry system of the invention may include a word completion system such that based on entering a portion of a word the system may propose one or more corresponding (e.g. completed) word(s).

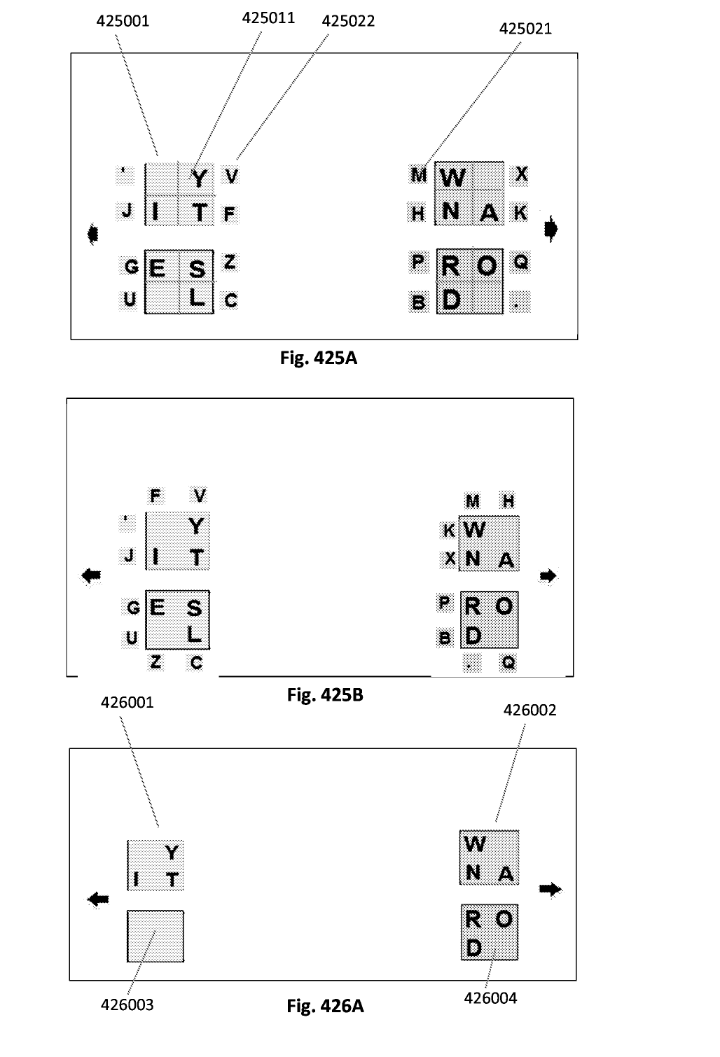

As mentioned before, the system may include a Precise Letter Mode, wherein during such mode instance the interface of the system shown to the user may be a keypad such that interacting with (e.g. tapping on) a zone/key of the keypad may correspond to entering precisely a single character/letter. FIG. 425A shows an example of such keypad. In this example, tapping on the (e.g. sub) zone 425011 of the key 425001 may preferably correspond to entering the letter “y”, and tapping on the zones/keys 425021, and 425022, may preferably correspond to entering precisely the letters “m”, and “v”, respectively. And so on.

According to one method, in order to switch the system into the Precise Letter Mode the user may provide a predefined character by providing a predefined interaction with the keypad of the system in its ambiguous mode. As an example, by providing a gliding action upward on the key 424005 (borders of the key are not shown in the example of FIG. 424A) of the keypad of FIG. 424A, the system may enter into the Precise Letter Mode.

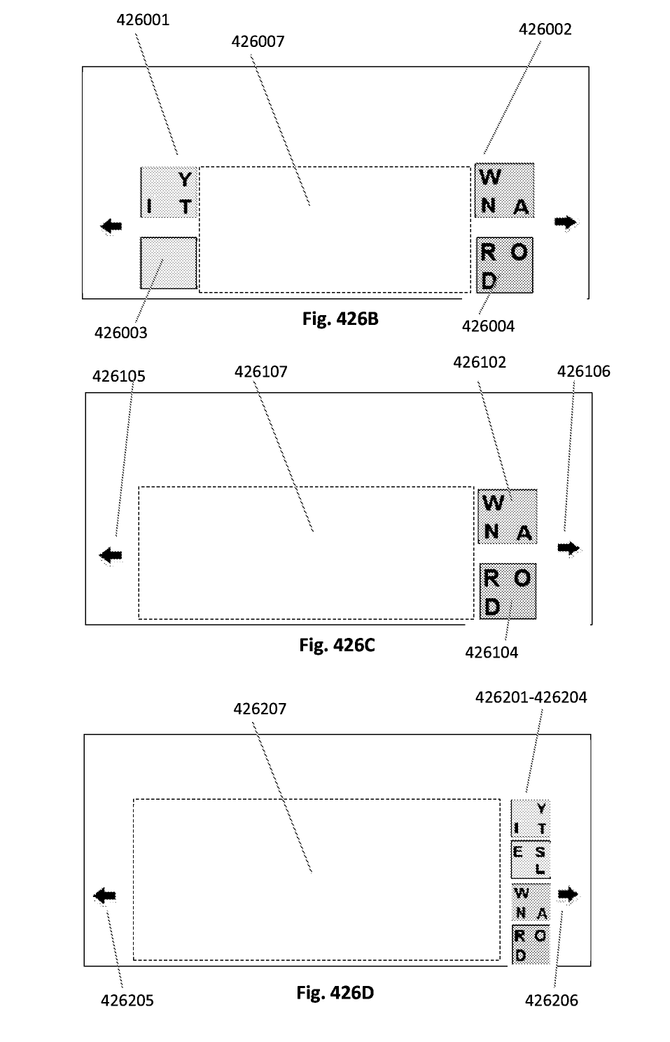

As mentioned, before, the keypad of the invention may have any number of keys (e.g. such as two, three, four, five, six, and more) (e.g. each) to which a few number (e.g. such as three, four, five, etc.) of (e.g. preferred) characters/letters are assigned (e.g. herein, such keys may be referred to as narrowly ambiguous keys), and one or more (e.g. preferably one) broadly ambiguous zone to which a large number of characters/letters (e.g. none-preferred characters, or all of the letters of a language and/or at least some of the special characters) may be assigned as described before (e.g. method of assignment of a large number of characters to a predefined zone, preferably outside the (e.g. letter) keys of a keypad have been described before in detail). As an example, FIG. 426A shows a keypad of the invention having three narrowly ambiguous keys 426001, 426002, 426004, wherein to each key three letters of a Roman alphabet are assigned. In this example, all of the other letters of the Roman characters are assigned to a broadly ambiguous key/zone 426003. Optionally, at least some of the special characters may either also be assigned to said broadly ambiguous key/zone 426003 or alternatively, by referring to FIG. 426B, they may be assigned to another broadly ambiguous key/zone 426007, or to another narrowly ambiguous key of the keypad such as the key 426001.

As another example, FIG. 426C shows the keypad of the invention having two narrowly ambiguous keys 426102, 426104 and one broadly ambiguous key/zone 426107.

As mentioned before, the keypad of the invention may have any key configuration. As an example,

as shown in FIG. 425A and in FIG. 426A, the narrowly ambiguous keys may be grouped in two groups of one or more keys and they may be positioned on the opposite sides of a touch sensitive surface such as a touch screen. FIG. 426D, shows another type of key configuration, wherein the narrowly ambiguous keys 426201-426204 are located on one side of the screen of a device, a broadly ambiguous key/zone 426207 is located in the (e.g. preferably) middle of the screen, said keypad also includes a backspace and/or function key 426205, and a space and/or function key 426206.

According to one embodiment of the invention, instead of or in addition to the narrowly ambiguous keys, the system may include a method for entering information corresponding to precise and/or ambiguous character(s). As an example, a handwriting recognition system or a voice recognition system may be used such that for example, during the entry of a word a user may speak/write one or more precise identified/precise characters/letters, and provide one or more tapping actions on a (e.g. one or more) broadly ambiguous key(s)/zone(s) for entering ambiguous input signals corresponding to one or more other characters of the word. By considering said information, the system may propose one or more corresponding words.

It must be noted that one or more of the different inventions, principles, concepts, methods, embodiments, features, etc. described in this patent application and other patent applications, may be used separately (when possible), or they may be combined together.

According to one embodiment of the invention, according to a first method, if the user positions a caret (i.e. cursor) at the end of a word which is already entered and types additional one of more characters at the end of the word, the system may consider the input information corresponding to said word already entered as the input information corresponding to the beginning of a word being entered that includes at least said additional one or more characters. In this method, according to one aspect, after positioning a cursor at the end of a word that is already entered, if the user taps on the space key and then taps one or more characters, said one or more characters may be considered as corresponding to a new separate word to be attached to said already entered word.

According to a second method, if the user positions a caret (i.e. cursor) at the end of a word which is already entered, then provides a backspace function, and then types additional one of more characters to the end of the word, the system may consider the input information corresponding to said previous word minus one character already entered as the input information corresponding to the beginning of a word being entered that includes at least said additional one or more characters. In this method, according to one aspect, after positioning a cursor at the end of a word that is already entered, if the user taps one or more characters, said one or more characters may be considered as corresponding to a new separate word to be attached to said already entered word.

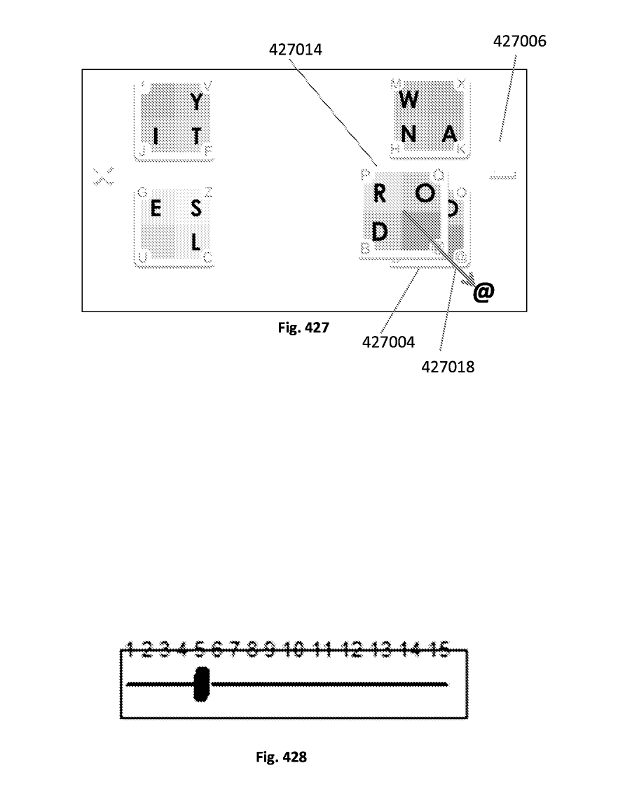

As mentioned before, the system may include one or more means so that the user may be able to define the number of characters for/related to which the system enters into the spelling help mode. According one method, a first means (e.g. a gliding action on a function key such as the key 427006 of FIG. 427) may be used to (e.g. dynamically) enter a single word being entered into the spelling help mode, and a second means (e.g. a slider in the settings of the system) may be used to enter all of the words being entered into the spelling help mode. The character position from which the system enters into the spelling help mode may be defined by interacting with a means such as for example with said slider. FIG. 428 shows an exemplary slider indicating digits from 0-15 wherein the user defines such character position. In this example, the character position is fixed on 5. During the entry of a text, the user may change/select another number as his/her discretion.

In the example of keypad of FIG. 427, the preferred characters are shown in large font, and the non-preferred characters ambiguously are assigned to a zone outside the keys (preferably, between the split keys). Note that the non-preferred characters are also displayed and/or positioned around the keys and shown in small font. As mentioned, a character of the second layer (e.g. a non-preferred character) may be entered precisely by, for example, either providing a press-and \-holding action on (e.g. a zone assigned to) said character or it may be entered by providing a gliding action from anywhere on/from the corresponding key in the direction (e.g. as if the direction of gliding action begins at the center of key/zone) of said character. Note that according to a preferred method, when the user provides such gliding action, the departing point of the gliding action may be considered as the center of said corresponding key. In this case, when the user touches the key to provide the gliding action, preferably a copy of said key may be shown under the user's finger such that the center of said copy of the key may preferably be located under the user's finger impact on the touch sensitive surface/screen. This matter has already been described before. In the example of FIG. 427, after a user touches on an upper-left location on the key 427004, a copy 427014 of said key 427004 may appear under the finger of the user such that the center of the copy is located under a portion of the user's finger touching the screen. The user may provide a gliding action (e.g. 427018) in the direction of a desired (e.g. of the second layer) non-preferred character) (e.g. ‘@’). It must be noted that according to one method, alternatively, no copy of the key 427004 is shown on the screen. With continuous description of the current embodiment, according to one method, another type of interaction such a long-press-and-gliding action may correspond to precisely entering a character of the first layer (or vice versa).

As described before, the character position from which the system enters into the spelling help mode may be different depending on the type of the mode in which a word is being entered. According to one method, defining said character position in a first mode may automatically define the character position in a second mode. As an example, the slider of FIG. 428 defines the character position for spelling help mode of a word being entered relating to the fully predicted mode. In this example, for the selected character position of the fully predicted mode, the character position relating to a word being entered in semi-predictive mode may be equal to the selected position minus N (e.g. minus 1) characters, where N is an arbitrary number.

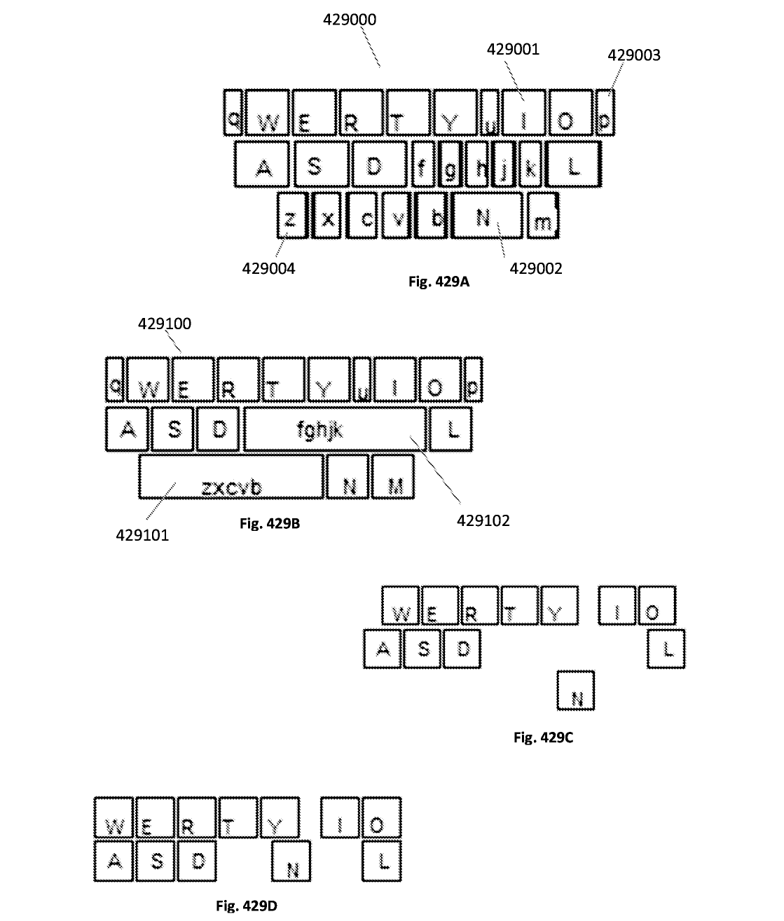

According to one embodiment of the invention, a (e.g. on-screen) keypad of the invention may be a full keyboard such as a QWERTY keyboard wherein the keys corresponding to the preferred characters may have distinguished form factor. FIG. 429A shows the keypad 429000, wherein the keys of the keypad have different size depending, for example, on the frequency of the characters. As an example, the size of the keys (e.g. 429001, 429002) corresponding to the characters having high frequency of use (e.g. preferred characters) may be larger than the size of the keys (e.g. 429003, 429004) corresponding to the characters having low frequency of use (e.g. non-preferred characters). Some keys may have other different size(s).

In the current embodiment, according to one method, a single key may represent several characters. As an example, in FIG. 429B, the keys 429101, and 429102, (e.g. ambiguously) represent several characters.

According to one method, the non-preferred characters may preferably not be shown and/or included in the keypad. FIGS. 429C and 429D, show exemplary versions of such keypad.

In all of the embodiments above described by the related exemplary keypads 429A to 429D or based on such principles, preferably, a predefined interaction (e.g. such as a gliding action on a zone on and/or outside the keypad, or a tapping action preferably outside said keys on a predefined zone (e.g. broadly ambiguous zone)) may (e.g. ambiguously) correspond to the non-preferred characters or another group of characters such as at least the preferred and none-preferred characters of a language.

In the embodiments above or based on such principles, the none-preferred characters may be entered precisely by any means known by people skilled in the art, for example, by pressing an ambiguous key, and sliding to different directions wherein each direction may correspond to an identified/precise character (e.g. that is also ambiguously) assigned to said key.

Note that the broadly ambiguous zone/key may be a (e.g. letter) key of a (e.g. any) keypad.

According to one embodiment of the invention, the system may be designed such that an interaction (e.g. tapping action) on any (e.g. zone assigned to a) character may enter said character precisely. As such the keys of the keypad may be designed to maximize the accuracy and speed of entering precise characters. Such precise characters may be used with any of the embodiments/principles of the invention. As an example, entering such characters may be used in fully predictive mode, semi-predictive mode, and/or fully precise mode wherein a word is entered precisely letter by letter.

FIG. 430A shows as an example, the keypad of the invention (e.g. in the precise mode) wherein, according to one embodiment. In this example, the zone(s) assigned to non-preferred characters are smaller than the zone(s) assigned to preferred characters. This may improve/increase the speed of typing for precise characters during the entry of information. In this example, the zone 430018 (e.g. assigned to letter M) on the key 430002 is smaller than the zone 430017 assigned to the letter ‘W’. In this example, zones 430019 and 413020 are both assigned to the vowel ‘A’. The same principles may preferably apply to other (letter) keys of the keypad. Note that a zone around a key or a zone on a key may include a portion invisible to the user, for example such as the invisible zone 430019 around the key 430002. In this example, in addition to the four keys, a zone 430007 between the keys may be assigned to broadly ambiguous characters.

FIG. 430B shows another arrangement of zone(s)/key(s) assigned to preferred and non-preferred characters. In these examples, the (e.g. diagonal) placement of the (e.g. zone(s) assigned to) non-preferred characters relating to preferred characters is such that the common (e.g. shared or connecting) boarder between the said zone(s) is minimized, such as to maximize the precision of selecting the individual/identified characters.

Note that, considering the smaller size of the zone assigned to non-preferred characters, and the situation where a user mistakenly touches the zone assigned to the neighboring preferred character, as such, a (e.g. simplified) means of auto-correction, may be provided with the system to predict the words by considering such a situation because only two neighboring characters require consideration by the auto-correction means. Said auto-correction means may include the use of a database of words.

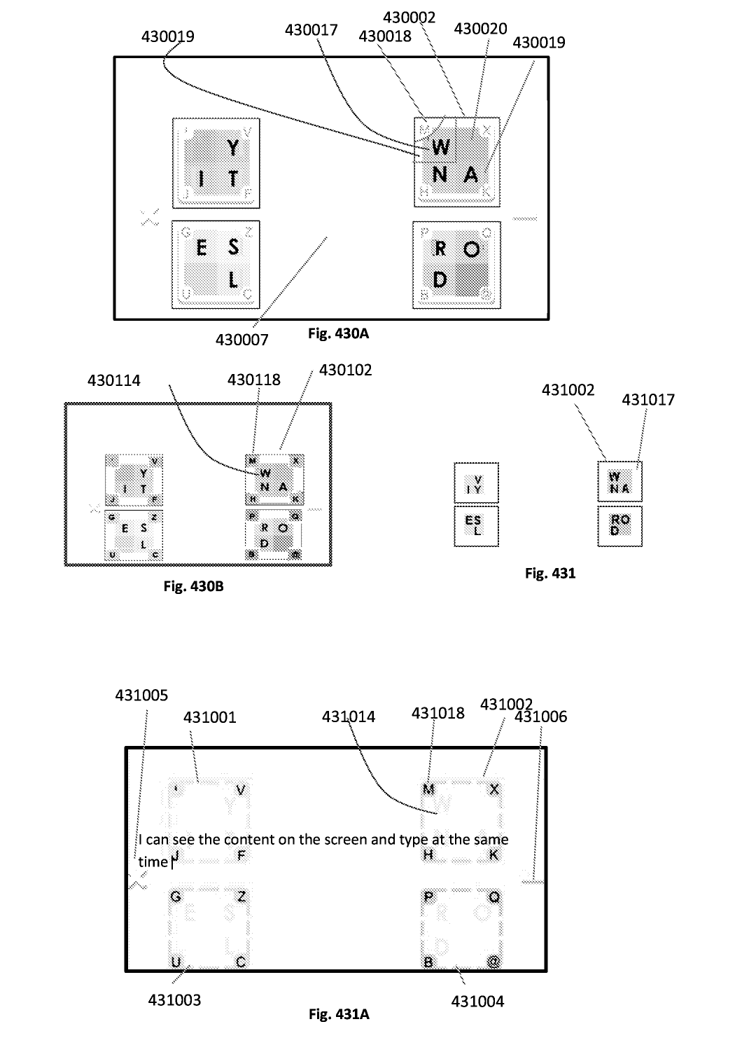

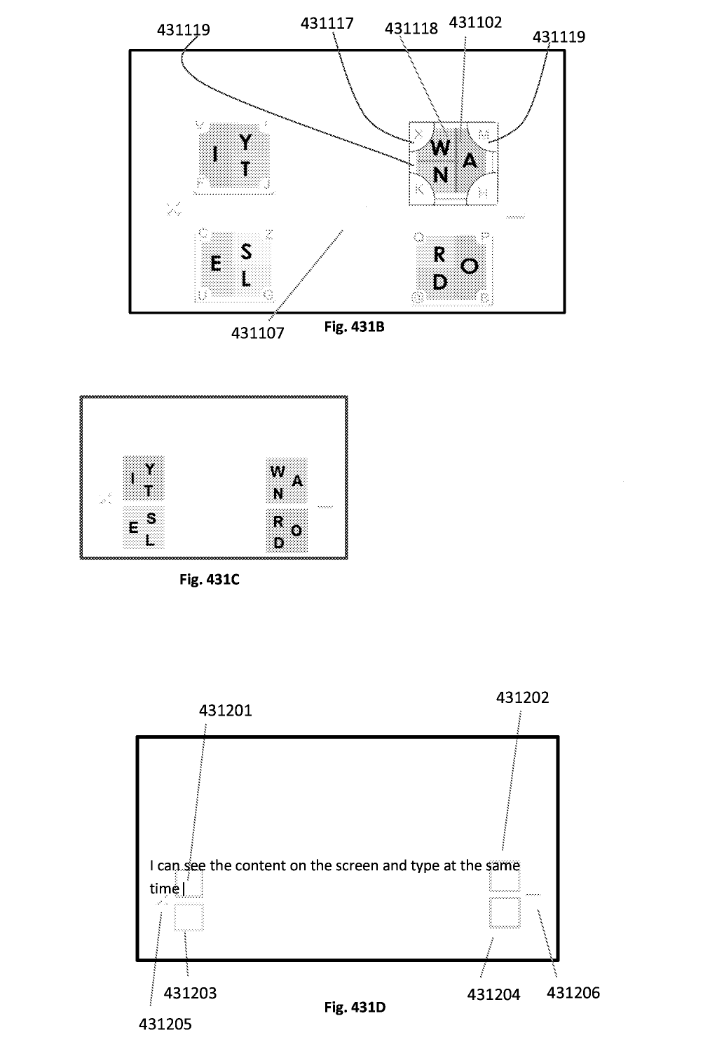

As mentioned above, according to one embodiment of the invention, a key may include an invisible/transparent zone around it which may be considered as part of the key. This way a keypad with large keys may be provided while the image of the keys are reduced such as to reduce the (e.g. visual) obstruction of the screen real estate. FIG. 431 shows, as an example, a keypad of the invention as just described. As an example, the key 431002 includes the invisible/transparent zone 431017.

FIG. 431A shows the keys 431001 to 431004 of the invention wherein the interior zones of the keys of the keypad are at least substantially invisible/transparent. In a preferred example, the non-preferred characters may be shown to the user. In this figure, as an example, the non-preferred character ‘M’ 431018 on the key 431002 is preferably visible to the user. According to one method, the preferred characters on a key may be translucent. In this figure, as an example, the letter ‘W’ 431014 is translucent. Note that, in the current example the space key 431006 and the backspace key 431005 are also invisible/transparent. In this example they are marked by space and backspace icons only. This way a keypad with such keys (e.g. fully transparent with translucent (e.g. visible) boarders) may be provided such as to reduce the (e.g. visual) obstruction of the screen real estate.

The keypad of FIG. 431B (e.g. in the precise mode) resembles that of 430A, with the difference that the zone assigned to the vowels (e.g. 431102) is smaller, enlarging the zones assigned to other preferred characters (e.g. 431118). Also in this example, among the non-preferred characters on a key, those having higher frequency of use (e.g. M, H) are assigned to larger zones (e.g. 431119) than those (e.g. X, K) which are preferably assigned to smaller zone (e.g. 431117). Same principles may preferably apply to other (letter) keys of the keypad.

FIG. 431C, shows the keypad of FIG. 431B when the system is in predictive mode. In this example, only the preferred characters/letters are shown. The non-preferred characters may be entered ambiguously by taping in a zone such as the broadly ambiguous zone. The non-preferred characters may be entered precisely by providing long-pressing action(s) and/or gliding action(s) on the predictive keys as described before, even if in this example they are not shown around the keys. The keypad of FIG. 431D is the same of FIG. 431C in its invisible mode. In this example, preferably only the frames of the keys in predictive mode are displayed on the screen.

The reduced size of the keypad of the invention specifically in its invisible/transparent mode (e.g. such keypad may hereafter be referred to as invisible keypad), as just described and previously described, may be beneficial for the use of existing application and/or for creating new applications. Such keypad may be positioned on the screen and the content being substantially visible (e.g. substantially unobstructed by the keypad) to the user. Said content may be of any type such as text and/or image(s). As an example, a text may be typed and/or entered over a photo/image/picture while the text area and the invisible keypad are positioned over the image/photo. This action may hereafter be referred to as editing an image/photo/picture. Editing of a picture may preferably include the direct manipulation of the picture such that an edited image/photo/picture may incorporate (e.g. actually manipulate the bitmap of the image/photo/picture) in the picture any edits/changes as part of the edit image/photo/picture. For example, the content of the textbox (and possibly the textbox itself) are also bitmaps incorporated into the image.

As an example, an invisible pop-up text field/editor (e.g. a bitmap, a text editor, etc.) may preferably be positioned over at least a portion of the surface, preferably substantially all of the surface, of a picture which is on the screen of a device such as a mobile telecommunication device. In addition, the invisible keypad of the invention may be positioned on the screen and be used to enter text in the text field.

Preferably, the text field may be designed such that the user may position a cursor/caret at any position within the text field. By having access instantly to any position on the text box, and therefore on the image/photo that the user is viewing, the user may be able to enter text at any desired portion over the image/photo. The user can type comments on said portion while having full viewing access to the photo/image.

Note that according to one embodiment, the image/photo by itself may be a text field.

After typing over the photo/image (e.g. this action herein may be referred to as editing a photo/image) a (e.g. manual and/or automatic) means may be used to combine the image and the text as a new image.

According to a first example, while/after editing an image/picture, the combined/new image may be produced/saved/considered as an image type of document such as .png, .bmp, etc.

According to a second example, after editing an image/photo the application may include a means such that after the user edits an image the user may use said means so that a snapshot of the new image may be taken. Preferably, before taking said snapshot, the invisible keyboard may be (e.g. automatically) removed (e.g. when such or similar means is used).

Note that, the combined/new image/photo may preferably exclude any visible portion (e.g. borders of the keys) of the keypad of the invention.

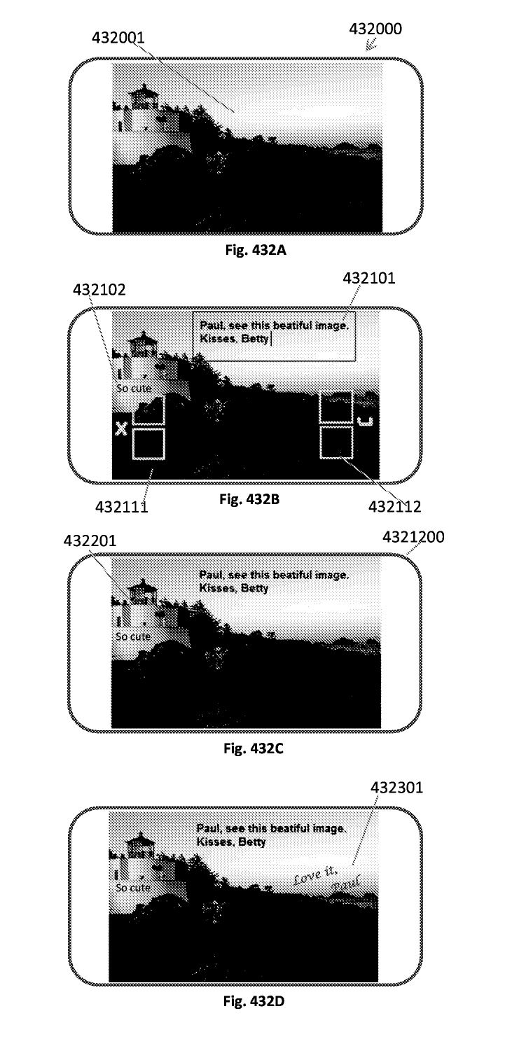

An edited image may be shared by any means (e.g. applications, social networks, etc.). The shared image may be re-edited (preferably in the same way) by recipients of shared image and further re-share to others and so on. As an example, FIGS. 431A to 431D show an exemplary demonstration of editing a picture and sharing it. In the example of FIG. 431A, a picture 432001 (e.g. by taking a photo, by downloading a picture, by opening a picture from a file, be receiving a picture through a socializing application, etc.) is printed/shown on the screen of the device 432000. As shown in FIG. 432B, the (e.g. invisible) keyboard of the invention (e.g. in this example shown by the borders of its letter keys in two portions 432111, 432112) may become available by a user (e.g. or automatically, when the picture pops-up on the screen) on the screen. In this example, the user has already typed a text on the portion 432102 on the (e.g. text box located on the) picture, and is entering a text in on a second portion 432101 on the (e.g. text box located on the) picture. After finishing to edit the picture, the user may share with/send to other people the edited picture. FIG. 432C shows, as an example, the shared edited picture 432201 on the screen of the device 432200 of a recipient. Then, as shown in FIG. 431D, the edited picture may be re-edited by the recipient(s) to produce a new edited picture 432301 and be shared with others. And so on.

Note that different fonts may preferably be available to the user, so as to satisfy their preference.

For example, note that the image and the text may be sent/shared without the means of combining the text information into a new image.

In addition to a socializing purpose, such method of editing and sharing images may be beneficial in many domains such as for example in the medical domain where a medical image such as an echography, X-ray, etc., image may be edited and/or re-edited (e.g. for example by commenting on several portions of the image) by doctors and be shared between doctors.

It must be noted that addition editing means such drawing means, handwriting, different fonts indifferent colors/styles, etc., may be available during editing an image/photo/picture. According to a preferred embodiment of the invention, the methods principles of editing an image/picture/photo as described throughout this application may be used in an (software) application or by themselves preferably may constitute an application. The system may also include other picture manipulation function(s) such as select, cut, paste, etc.

According to one embodiment of the invention, one or more filter(s) providing effects (e.g. color, shade, etc.) to the picture may be used during/with editing an image/photo. According to one method, the text field by itself may be such a filter or vice versa. According to one method, the filter may be included in the bounds/area of the text field. In addition, an edited image may also manually or automatically include a user's signature.

According to one embodiment the device and/or the input system of the invention may include a means such as a touchable zone on the screen of the device always available to the user to interact with it. Said zone may be in form of a key (e.g. to be pressed) or preferably it may be in form of a bar located on one or more edges of the screen of the device such that a gliding action provided from said zone towards inside the screen is captured by the (e.g. image editing) application. Based on said interaction the system may make available an interface including one or more function icon(s)/button(s) for functions such as camera functions (e.g. snapshot, brightness, etc.) and/or editing functions such as menus for selecting font, size of the font, color, open, save, send, share, etc.

According to one embodiment of the invention, based on an interaction such a touching action anywhere on a picture or on the screen, at the touching point (e.g. at the right-side/left-side/top/bottom of the touching point, depending on the language) the system may locate a textbox so that the user can type a text. The size of the text box may be dynamically adjusted based on the length of the text being typed. Note that for each touching action on the picture/screen a separate textbox may become available preferably at the touching location. Optionally, said interaction may be a long pressing action. This way, the user may have access to any portion of the picture/screen, even if said portion is under the input system area (e.g. keys or the space between the keys). In this case, a quick tapping action on the screen/picture may be used for other purposes such as popping up function menus or a textbox relating to entering comments which are preferably not being printed/positioned on the picture/image (e.g. the image is not being directly edited/manipulated by the text). According to one method, when the user touches the screen for editing purpose (e.g. for positioning a textbox at the touching point), the keypad of the invention may be automatically (re-) located such that it does not cover the textbox (e.g. or at least minimizing that portion of the textbox that is covered by the keypad).

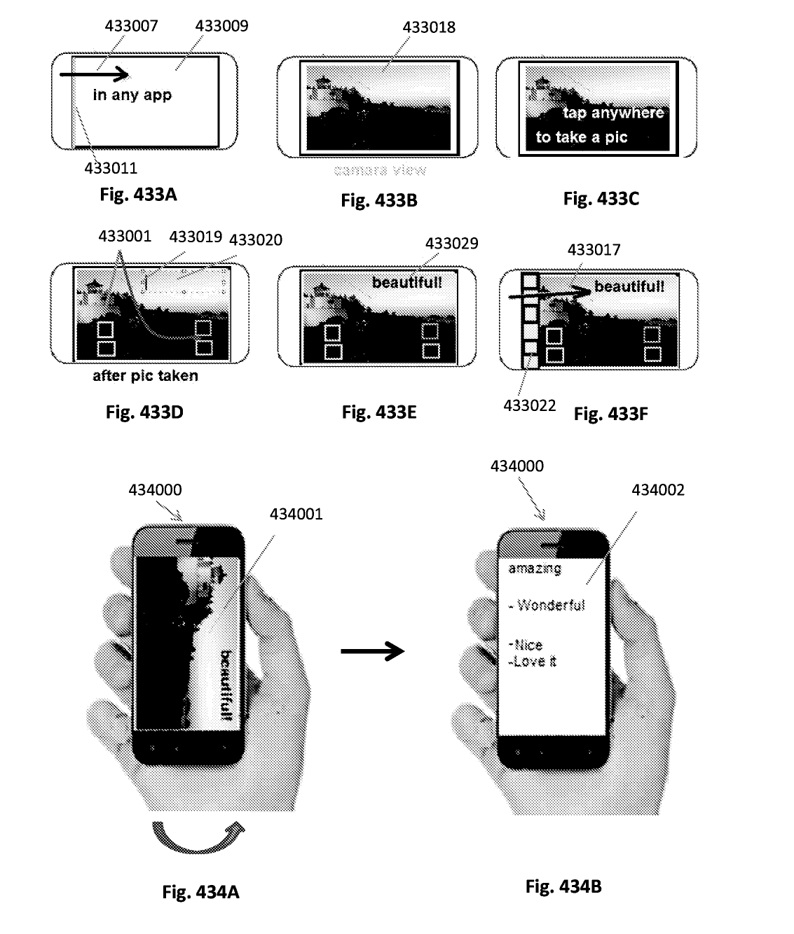

FIG. 433A-F, show another exemplary steps of taking a picture and editing it. In FIG. 433A, at any moment (e.g. during the use of any application) the hotspot 433011 may be used (e.g. by providing a gliding action 433007 from said hotspot toward the inside of the screen 433009 of the device). At this time, as shown in FIG. 433B, the picture editing application may become available. As an example, the camera may manually or automatically become available and the view 433018 of the camera may be shown on the screen. Then, as shown in FIG. 433C, the user may take a picture by using a means such as, for example, by tapping anywhere on the screen. The picture may preferably automatically be printed/become available on the screen for editing. At this time, as an example as shown in FIG. 433D, the user may tap on a location 433019 on the picture or on the screen and the system may provide a text field/textbox 433020 at said location. Preferably said tapping action may also cause the keypad of the invention 433001 to appear on the screen. Then as shown in FIG. 433E, the user may type a comment 433029 on the picture. Then, as shown in FIG. 433F, the user may provide an interaction to apply an action regarding the edited picture. Said interaction may be related to, for example, a saving action, sharing action, etc. In the example of FIG. 433F, the user may provide a gliding action 433017 making available several choices. According to another example (not shown), the choices may always be available to the user during editing for example through soft keys displayed on the screen.

As mentioned before, a (an edited) picture may be shared with others. The sharing action may be through any application such as facebook, twitter, massaging applications, etc. According to one method, the person who shares a picture with others may decide who (e.g. one or more person(s) among people whom to share the picture) can edit the shared picture. Others may not be allowed to edit the picture. According to one method, among the people who share a picture, one or more people can send a request for editing the picture to the supplier. The supplier may be able to accept or refuse the request. According to one method, the supplier may ask a price for a positive response to a request. Note that editing of a picture may require identification of a user through authentication means.

According to one method, the supplier of the (e.g. edited) picture may share said picture for an auction for editing said picture. He can then decide which one or more people can edit a single picture, and/or a number of copies of the picture.

According to one embodiment, the system may use an authentication procedure to authenticate the supplier and/or other editors.

According to one embodiment of the invention, a number of people may be permitted to edit an image/picture, and others may be permitted to comment about a/said (e.g. edited) picture. Said comments may be shown/shared separately from the image/picture (e.g. in a document).

According to one embodiment, a (e.g. an edited) picture shown to a user on a screen may have a virtual backside. Said virtual backside may include information, for example, in the form of a (e.g. text) document that may include the comments posted by the viewers of the picture and/or a zone to comment about that picture. According to one example, the background of said document may be the same picture being transparent or blurry. According to another example, the background may have some standard image of the background of a postcard. According to one embodiment, a means to show said virtual backside to the user may be used. Said means may be a means such as providing a gesture on the picture, or a tilting/pivoting/twisting/shaking action (e.g. quickly (e.g. partially) rotation movement preferably around any desired axis) (hereafter may be referred to as rotating action) of the device on which the image is shown. Preferably, an animation on the screen demonstrating a flipping action from the picture to its virtual backside may be shown when such a means is used. As mentioned, on the backside side, the user may see other people's comments and may be allowed to write/post his/her comment. FIG. 434A shows as an example, wherein an (e.g. a shared) edited image/photo 434001 is shown on the screen of a device 434000. By providing a rotating action, as shown in FIG. 434B, the system may show on the screen of the device 434000 the virtual backside 434002 of the image/photo 434001, wherein some comments are shown and the user may enter/add a comment.

According to one embodiment, after using said means and before showing the backside to the user, one or more advertising pages/banners may be shown to the user on the screen. The user may be permitted to skip the ads.

It must be noted, that the application regarding image editing may include features such as following/followers of a user, one or more albums of (edited) images of a user, preferably based on their category. A search field and/or procedure to search within a database of, for example, images/users. The application may use/include some or all of the (e.g. edited) images of some or all of the users which may be saved in one or more (e.g. cloud) server(s).

It must be noted that the tilting action as described, may be used to switch from any type of page (e.g. of a document displayed on the screen) to another/next/previous page (e.g. in the document to be displayed on the screen). It can also be used to switch the system from a first function to a second function. It must be noted that according to one method, a tilting action towards the right may be related to the next instance, while a tilting action towards left may be related to the previous instance/page, or vice versa. Also as an example, a tilting action towards up may correspond to going to the first/main instance/page (e.g. to the edited picture) while a tilting action towards down may be related to the last instance/page (e.g. or alternatively to the instance/page before going to the first/main page), or vice versa.

It must be noted that the procedures of capturing and/or editing an image/picture as described above are created to permit capturing, and/or editing and/or sharing an image/picture with others, etc., quickly and easily by using the data entry system of the invention and its reduced/invisible user interface.

According to one embodiment of the invention, the data entry system of the invention may include a means such the (e.g. such as a hotspot), for example, the hotspot means 433011 which permanently may be available to the user (e.g. on the screen) such that by using said means, a text field may appear on the screen for entering text. Said text then may be sent/shared with others through methods of socializing such as an application.

It must be noted that the principles and or functions described for editing an image/picture as described may be used with any type of keyboard.

According to one embodiment of the grabbing method, after a cursor/caret is positioned at the end of a first word which is already entered, entering/appending new one of more character(s) may constitute a new/separate second word attached to the first word. In this embodiment, according to one method, after a cursor/caret is positioned at the end of a first word which is already entered, providing a backspace may preferably grab said first word as the current predicted word. Said current predicted word may be re-edited.

According to one embodiment of the invention, a group of special characters may mainly include the closing and opening symbols such as parenthesis symbols. They may be assigned to a different sub-zone forming a single zone (e.g. forming a key of the keypad in special character mode) on the screen.

According to one embodiment of the invention, when a user is providing the input information (e.g. tapping actions) corresponding to a desired word through the predictive mode, in addition to the predicted word appearing in the text, the system may propose additional words such as, for example, three more words, preferably positioned on the top of each other. According to one method, predefined interaction(s) such as gliding action(s) in predefined directions may replace the predicted word in the text by a corresponding word among the additional predicted words. For example, a gliding action upward or downward may replace the predicted word by the top or bottom additional predicted word, respectively. Also as an example, a gliding action rightward may replace the predicted word in the text by the additional proposed word located in the middle. Preferably, after that action, the system may propose more additional words (e.g. if any) corresponding to the input information.

According to one embodiment of the invention, during the entry of a word, a list of predicted/proposed words may be shown to the user. Said list may preferably include the current predicted word and preferably one or more other words which hereafter may be referred to as “other candidates”. According to one method, said other words may preferably include one or more words (e.g. preferably up to two words) based on bi-gram search (e.g. from bi-gram database), and one or more (e.g. preferably up to two) words based on 1-gram search (e.g. from 1-gram database). The word list may be shown horizontally, or preferably vertically. Preferably, the current predicted word may be shown/located in the center of the list. Pressing the space character may preferably enter the current predicted word, and tapping on any of the words (e.g. including the current predicted word) may enter said word. According to a first method, tapping on a word may enter said word without adding a space character, while according to another method it may automatically add a space character at the end of said word.

With continuous description of the current embodiment, according to one design, the length of some (e.g. two) of the other candidates may be limited to a predefined number (e.g. preferably, four) of characters. In this case, according to a one method, if the length of the current predicted word is more that said predefined number of characters, the system may propose less number of words and the list may have less words. As such according to one example, during the entry of a word, if the length of the current predicted word is up to four characters the system may propose a list of words including:
The current predicted word, plus
Up to two words from the bi-gram search, plus
Up to two words from the 1-gram search
   and if the length of the current predicted word is more than four characters the system may propose a list of words including:
The current predicted word, plus
Up to two words from the bi-gram search, plus
   According to one method, in addition to be included in the word list, the current predicted word may or may not be shown simultaneously within the text while being typed.
   According to one embodiment, a word list (e.g. proposed/predicted words) may be dragged (e.g. to be relocated) on the screen by a user.

According to one embodiment of the invention, the system may (also) include a special database including, for example, proper names (e.g. John), user's slangs, SMS words, professional words, etc. According to one embodiment, during (e.g. at the beginning of) the entry of the input signals (e.g. key presses) corresponding to a word, a predefined interaction may inform the system to search for words within said special database. According to one method, said interaction may be providing a Shift function. In this case, according to one method, in addition to searching for words in the main database(s) used by the system the system may also search for words in said special database. The results of both searches may be proposed to the users in two separate word lists.

Preferably, said two word lists may be printed on opposite sides on the screen of the corresponding device.

Note that the term “word” used throughout this application may be referred to complete words and/or non-completed words (e.g. stems).

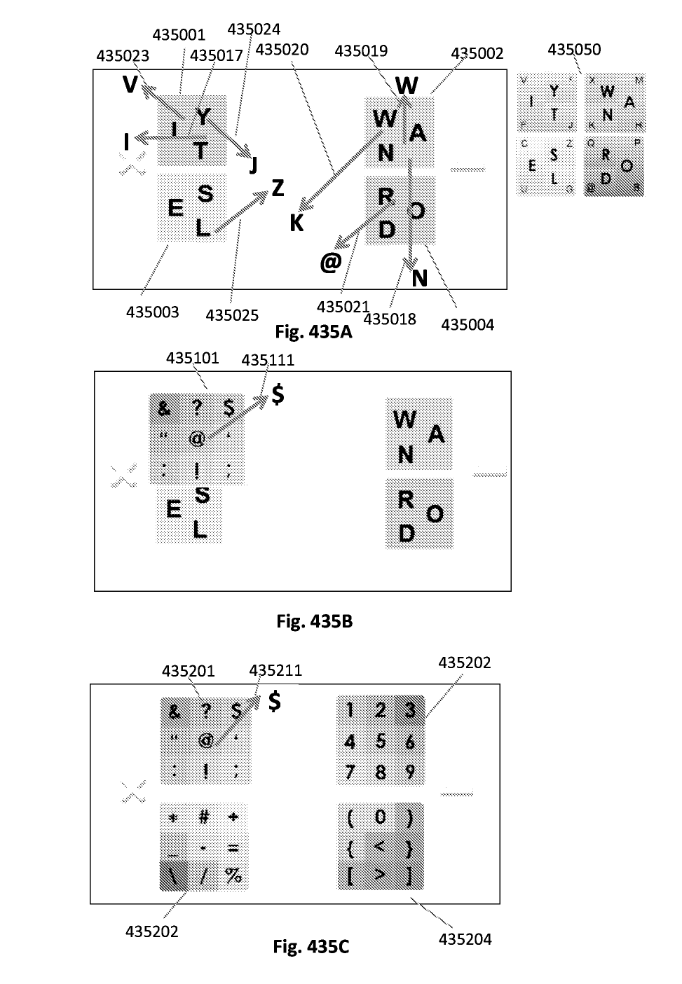

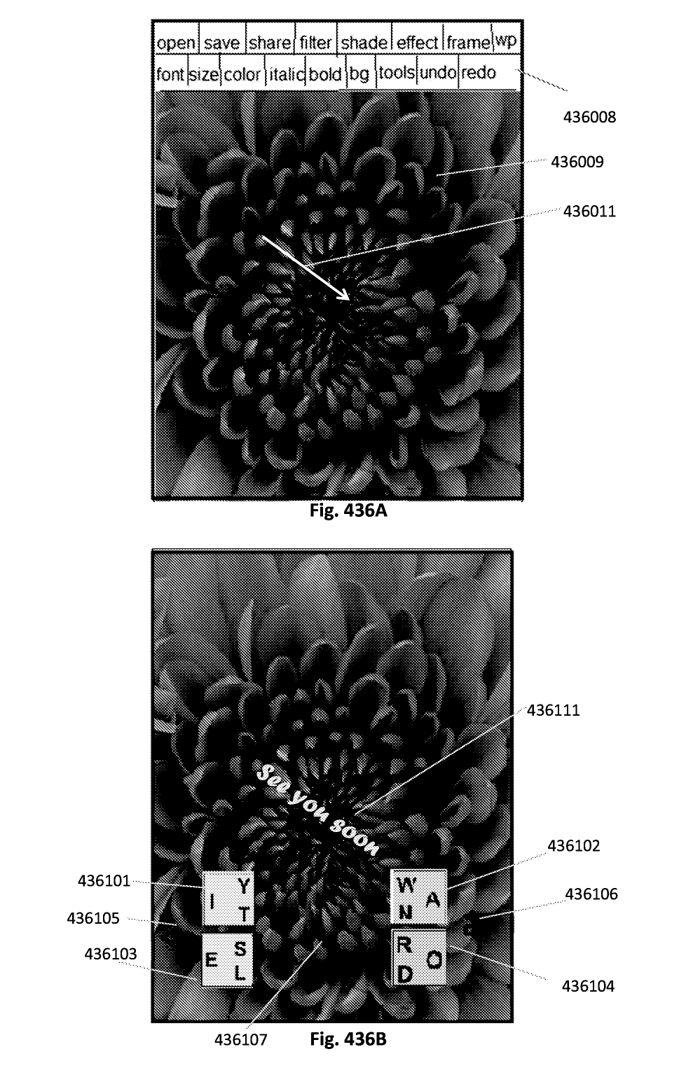

According to one embodiment of the invention, gliding actions in different directions (e.g. 8 directions) on/from a key may be used to precisely enter characters assigned to a key. FIG. 435A shows, as an example, a keypad of the invention, the predictive mode (e.g. having ambiguous letter keys 435001-435004) and the precise mode (keypad 435050). By considering the letter arrangement(s) assigned to said keypad (e.g. in the predictive mode the non-preferred characters are not shown around said keys in this example, and they are similar to the configuration of letters of keypad 435050). As an example, a gliding action upwards (e.g. gliding action 435019 corresponding to the letter ‘W’) from anywhere on a key may correspond to the preferred character shown on the top of the key, and a gliding action downwards (e.g. gliding action 435018 corresponding to the letter ‘N’) from anywhere on a key may correspond to the preferred character shown on the bottom of the key, and a gliding towards the left and/or right (e.g. gliding action 435017 corresponding to the letter ‘I’) may correspond to the preferred character shown in the middle of the key.

As an example, a gliding action towards the upper left (e.g. gliding action 435023 corresponding to the letter ‘V’) from anywhere on a key may correspond to the non-preferred character located/shown (e.g. preferably not shown) on the top-left (in this example, said character is only shown on the corresponding key of the precise keypad 435050) of the key, and a gliding action towards the lower-left (e.g. gliding action 435020 corresponding to the letter ‘IC, and for the gliding action 435021 corresponding to the character’@′) from anywhere on a key may correspond to the non-preferred character located/shown (e.g. preferably not shown) on the bottom-left (in this example, said character is only shown on the corresponding key of the precise keypad 435050) of the key, and a gliding towards the lower-right (e.g. gliding action 435024 corresponding to the character T) may correspond to the non-preferred character located/shown (e.g. preferably not shown) on the bottom-right (in this example, said character is only shown on the corresponding key of the precise keypad 435050) of the key, and a gliding towards the upper-right (e.g. gliding action 435025 corresponding to the character ‘Z’) may correspond to the non-preferred character located/shown (e.g. preferably not shown) in the top-right (in this example, said character is only shown on the corresponding key of the precise keypad 435050) of the key.

According to one embodiment of the invention, a press-and-hold action on a letter key (in ambiguous and/or precise mode) may switch the system/key to the symbol mode. Preferably, upon such press-and-hold action anywhere on a letter key, the corresponding symbol key may preferably be presented under the touching/locating point of the user's finger/stylus of the screen and/or other means of pointing, such that the center of said symbol key is under said touching/locating point. The user may then provide a gliding action towards a desired character of said symbol key.

According to one method, if the user does not provide a gliding action after providing press-and-hold action, then the character assigned to the center of said symbol key, may be selected/entered. In the example of FIG. 435B, after the user presses and holds the letter key 435001 (not shown), the system may show the corresponding symbol key 435001 under the user's finger. After providing the gliding action 435111 the corresponding character ‘$’ is selected/entered. In this example, other letter keys remain unchanged (e.g. during the press-and-hold and gliding actions). In FIG. 435C, after providing such press-and-hold action, all the symbol keys are shown.

As mentioned before, in addition to the text entered to be printed on the picture, additional text corresponding to the picture may be provided/entered and may be shown/presented separately from said image/photo/picture. According to one method, said additional text may be in a form of text, and/or image, and/or other form. As mentioned before, for example, such additional text may be shown to the user as if it was typed/written on the back side of the picture (e.g. like backside of a postcard). Same may apply to the text provided/entered on the picture itself, where in a copy of the text may be stored separately from the data of the image/picture/photo.

As for text on the picture, the additional text (e.g. on the backside) may be typed, written, have several various fonts, sizes, styles, orientations, presentations, etc. It may also include handwritten text, drawings, objects, etc.

According to of the invention, the entered onto an image/photo/picture may be presented in any desired location and/or orientation/direction. According to one method, the location and/or orientation/direction of text being entered may be defined by a gesture/gliding action provided with a touch screen or some other input means (e.g. in the air).

According to one embodiment of the invention, any text (e.g. additional text) entered/provided/related/associated with an image/picture/photo may be stored together and/or separately from the data of the image in a network cloud and/or some other data storage system/mechanism. Such storage may take on various forms including, for example, image data, text data, etc. A user may download and/or access/use the image data and text data in a combined fashion and/or in a separated fashion (e.g. such that the data may be accessed separately from the text and/or vice versa). Access and/or use of image data may be done in such a fashion such that it may contain information that relates text or other data corresponding to any image/picture/photo (e.g. edited image), such that to be accessed manually or automatically upon reception and/or presentation and/or use of the image by a user. As an example, after an image is edited by a user, it may be shared with other users and any text corresponding to that image (e.g. text not contained as part of the image) may be (e.g. separately) sent and/or stored in a (e.g. separate) cloud/server. In this example, the shared image may contain a link to said separated data. After receiving the edited image by another user, as an example, accessing such link and/or interacting with the image itself (e.g. by said another user), may access the corresponding separate text/data (e.g. that was sent/stored in cloud/server).

According to one embodiment of the invention, (preferably, when a picture/image is displayed on the screen) an interaction such as a tapping action (short pressing action) on the screen may cause the system to show/print/display an input means, such as a menu, preferably corresponding to functions generally relating a/the picture/image such as editing the picture/image and/or other functions such as saving, sharing, opening a/the picture/image. According to one method, providing another tapping action may remove/hide the input means, such as a menu, from the screen. Printing/showing input means, such as a menu on the screen may or may not result in resizing the picture and/or displaying the picture/image in some other manner. If the picture/image occupies the portion of the screen corresponding to the menu (e.g. input means) being printed, preferably the menu will be printed over the picture without resizing it. According to one embodiment, when the menu is displayed, the system may also display/present (e.g. in form of a banner) an advertising message (e.g. text and/or image and/or audio) preferably next to the menu. Preferably, when the user removes the menu from the screen, the advertisement also is removed. According to one embodiment, interacting with (e.g. tap/glide on) the advert may result in the expansion of the banner and/or bring more information corresponding to the advert to the user.

According to one embodiment, after a menu is displayed, a tapping action on a predefined zone/button (e.g. in the menu) may result in removing/hiding the menu.

According to one embodiment, (e.g. when a menu is not printed/displayed on the screen) a tapping action provided on a picture/screen may result in opening (e.g. displaying and activating) a menu relating to function(s) relating to the picture as described before, and also may be related to a predefined trajectory (e.g. preferably, horizontal) of a text to be entered. Preferably at the same time the keyboard pops up on the screen. After such tapping action at least two scenarios may be considered:

Option 1) The user may proceed to entering text (e.g. by tapping on the keyboard). In this case, the text may be entered in said predefined direction. Preferably, when the user begins to enter the text, the menu disappears.

Option 2) the user may interact with the menu. In this case, according to one method, the keyboard remains on the screen. According to another method the keyboard disappears. This another method is preferred because after/during interacting with the menu the user may have an almost full screen/image/picture view (e.g. except the menu). After interacting with the menu, according to a preferred aspect, if the user provides a tapping or a gliding action on the screen (e.g. to define the trajectory of a text to be entered), the menu may disappear (e.g. but, preferably, the keyboard remains on the screen).

According the one embodiment of the invention, when a picture is shown on the screen for editing, the editing procedure may be enabled according to the orientation (e.g. landscape or portrait) of the image/picture in which the image/picture was originally taken/developed and/or stored. As such, preferably features such as at least the keyboard (e.g. and other features such as a menu) may be popped up/displayed accordingly (e.g. in the same orientation as the image/picture).

As mentioned before, according to one embodiment, providing a gesture on the picture/screen may correspond to the direction of the text to be entered by the user. The trajectory of said gesture may be straight and/or may be any other type of trajectory such as a curved or complex trajectory. According to one embodiment, when a user provides such gesture, a keypad such as for example, the keypad of the invention may pop up on the screen. According to one method, if a/the menu is shown on the screen such a gesture (e.g. similar or different gesture) may preferably hide/close the menu.

According to one embodiment of the invention, (e.g. preferably, when a word is not being entered) providing a gesture (e.g. also) beginning from (e.g. within) the zone between the keys (e.g. and/or beginning from a key) may be related by the system to the beginning point and the trajectory of the text to be entered (e.g. this may preferably define the trajectory of the text to be entered).

According to one embodiment, upon providing a gesture, the system may show a caret/cursor corresponding to a text being entered at the beginning point of the trajectory.

It must be noted that a gesture corresponding to the trajectory of a text to be entered, and preferably the corresponding text, may begin at any point on the screen/picture (e.g. preferably not from a key) and may end at any point on the screen/picture. According to one method, said gesture/text may begin/traverse over a key, and/or end on a key.

Note that according to a preferred embodiment, the text corresponding to a provided gesture trajectory may preferably begin at that the beginning point of the gesture trajectory in the direction of the gesture trajectory, but may be longer or shorter than or equal to the length of the gesture in its trajectory. If the text is to be equal to the length of the gesture, then, the system may resize the font of the text so that to adapt it to the length of the gesture.

According to one embodiment, a long pressing action on a picture/screen may be related by the system to a predefined trajectory such as a horizontal trajectory in the direction of a text to be entered from said touching point. Said long pressing action may be provided anywhere on the screen/picture including the zone between the keys (e.g. preferably excluding the zones corresponding to the keys). Upon such a long-pressing action, preferably a caret/cursor may be positioned at the touching point of the long pressing action on the picture/screen.

FIGS. 436A to 436B show, an exemplary method of procedure of editing a picture in a picture editing application is demonstrated. In FIG. 436A, a picture is being displayed on the screen 436009 of a device and wherein a menu 436008 corresponding to the picture editing application is popped up/displayed by a tapping action provided by a user (e.g. anywhere) on the picture/screen. In this example, after selecting desired functions on the menu, if the user provides a gliding action/gesture 436011 to define the direction of a text to be entered by him/her on the picture, then according to one method, as shown in FIG. 435B, a keyboard, may be popped up, such as preferably the keypad of the invention (e.g. having the letter keys 436101-436104, the zone 436107, and the (e.g. space/function and backspace/function) keys 436105, 436106. Optionally/preferably, upon such gliding action/gesture, the system may also remove/hide the menu from the screen. In this example, when the user types a desired phrase, the system prints the corresponding text 436111 in the direction of the gliding action on the picture.

In the example above, the related titles of the functions on the menu may be represented by corresponding icons instead of/combined with a text.

During the entry of at least a portion of a text (e.g. a word), the user may be permitted to access the menu and affect the characteristics (e.g. color of the font, size of the font, style of the font, etc.) of said portion of the text. Optionally, the user may also be enabled to change the trajectory/direction of said portion of the text.

According to one method, if during providing a gliding action to define the direction/trajectory of a text to be entered, the user change the direction of the gliding action, then, the direction of the trajectory of the text to be entered is in the direction of a straight line connecting the beginning and the ending point of said gliding action.

According to one method, the trajectory of a gliding action/a text to be entered may be marked by a corresponding line/arrow on the screen.

According to one embodiment of the invention, (e.g. in the image editing procedure/application) during the entry of a word (e.g. during typing the word, or after selecting/grabbing a word for, for example, re-editing/modifying it) the user may apply modification to the word which is being typed. As an example, providing a predefined interaction such as a gliding action on the in a predefined zone or preferably anywhere on the screen may rectify the direction/trajectory of the word being typed to that of the gliding action. According to a first method, the beginning point of the word being entered remains the same location. According to a second method, the beginning point of the word being entered is relocated to the beginning point of the gliding action.

With continuous description of the current embodiment, when a word is being typed, a predefined interaction such as a tapping action on the screen (e.g. preferably anywhere outside the keyboard and the corresponding navigation zone) may pop-up the/a menu corresponding to editing the text and/or the picture. As such, activating some of the functions of the menu may apply to editing the word being typed. For example, the user may select another color for the word being typed in real time. He/she may also change the size of the font, the shadow, or even the font itself, preferably, while viewing the image. According to one method, if the user begins to type on the keypad, the menu disappears.

According to one embodiment, during the entry of a word, an interaction such as a press-and-holding action on either on a predefined zone or preferably anywhere on the screen, may result in permitting to move said word. As such, according to a first aspect, the word will be relocated to the touching point on the screen of said press and holding action. According to a second aspect, if the user provides a gliding action on the screen, the word being entered is also being moved on the screen in a parallel relationship relating to the gliding action.

During the entry of a word, according to one method, different predefined interaction such as press-and-holding action on different locations, relating to the word or on the word itself, may permit to move the word differently. As an example, if the press-and-holding action is provided in the middle of the word, then providing a sliding action preferably moves the word in the corresponding direction. As an another example, if the press-and-holding action is provided in at the begging or at the end of the word, then providing a gliding action preferably may be related to rotating the word.

It must be noted that, during the entry of the word, any of the functions, embodiments, aspects, concept, etc., described above, may be related not only to the word alone, but also to a at least a portion (e.g. a line) or to all of text being entered in one or more text fields.

Optionally, during the entry of a word, a predefined interaction such as a long-pressing action on a/any location on the screen may relocate/position a word being entered under the user's finger providing said interaction.

According to one method, preferably during the entry of a word or after a word is selected, if a user provides a predefined interaction such as gliding action including a long-pressing action, the system may apply a function to the selected word such as preferably relocate/position the selected word (e.g. or the word being entered) under the user's finger in the direction of the gliding action. According to another method, if a user provides another interaction such as a gliding action not including a long-pressing action, the system may preferably apply another function to the selected word or to the word being entered such as preferably maintain the selected word at its current position but preferably adjusts its trajectory of writing to the trajectory of the gliding action. (or vise versa). As such, a chain of consecutive words wherein each of one or more of them having a different trajectory may be easily entered on an image/screen forming a line of text having a desired complex trajectory. The current method may help to adjust the trajectory of entering short words or word having small font with ease.

It must be noted that in all of the paragraphs herein relating to the image/picture editing procedures/application, a function (e.g. change color, change or trajectory) intended/mentioned to be applied to a words being entered may also be applied to a selected word or to a word to be entered after providing said function, or vise versa.

According to one embodiment, mouse function of the system may be used to edit an image. As an example, if the user provides a press-and-holding action (e.g. anywhere or between the keys) on an image/screen, the system may show several mouse functions such as select, select all, copy, cut, past, preferably around his/her finger. The user them may slide the finger towards one of the functions to activate it. As an example:

Select: a portion of an image may be selected by many means. As an example, the menu of the system may have several selection pattern (e.g. square, round, free pattern, etc.) buttons, wherein after interaction with such a button, the use may provide a gliding action on a desired location on the picture, and the system may select a portion of the picture according to the shape of the selected pattern and preferably the length of the gliding action. Optionally, a press-and-holding-and-gliding action at any moment on the screen/image may result in selecting a portion of the image based on a predefined or the last selected pattern.

According to one embodiment, the selected portion may be resized by for example touching a predefined point of it and dragging said point. According to one method, providing a long pressing action combined with gliding action in s predefined direction may resize the selected portion accordingly. According to one method a such gliding action in the middle of the selected portion drags the portion in the corresponding direction on the screen.

Copy: after selecting a portion of picture, a press and holding action combined with a gliding action in the direction of the Copy function/icon may preferably copy the selected portion of the image.
Cut: after selecting or copying a portion of picture, a press and holding action combined with a gliding action in the direction of the Cut function/icon may preferably cut the selected portion from the image.
Paste: after selecting or copying a portion of picture, a press and holding action in a desired location on the screen/picture combined with a gliding action in the direction of the Paste function/icon may preferably paste the copied portion, preferably on in the pressed position, on the image/screen.
Select-All: a press-and-holding-and-gliding action at any moment on the screen/image in the direction of Select-All function may select the whole image.

It must be noted the features and methods of editing an image/picture as described herein are created to permit a simple and quick picture taking/picking, editing, and sharing procedure(s).

Preferably during the modifications/editing (e.g. of the/a word/text) described above, the image/picture on which the editing procedures are being applied is shown to the user so that he can rectify apply and/or rectify his/her modifications accordingly (e.g. according to the image or a portion of the image characteristics).

According to one embodiment of the invention, preferably, an interaction, such as press-and-holding action or a gliding action, corresponding to mouse functions is not provided on a text or on a selected portion of an image (e.g. herein may be referred to as the selected content) to not interfere with other functions such as dragging a selected content. As such according to one example, after selecting a content such as an image or a text (e.g. one or more words. Note that a grabbed word or a word being entered is also considered as a selected text) if a user provides a gliding action including a press and holding action (e.g. at the beginning of the gliding action) at a position/location on the screen wherein said gliding action corresponds to a pasting action, the selected content may be pasted at that position/location. FIG. 438A shows as an example, a picture 438010 being displayed on the screen of an electronic device such as a smartphone or tablet, and wherein a menu 438011 relating to selecting patterns is also shown/poped up. After the user selects one of the patterns 438012, he may provide a gliding action 438013 on a desired location on the screen to select the portion of the image 438014 at that location corresponding to the shape of the pattern and the length of the gliding action. Then, as shown in FIG. 438B, by providing a press and holding action (e.g. or a press and holding action combined with a gliding action in a predefined direction) on a desired position on the screen/image and the system may paste the selected portion at that location. Preferably (not shown), after selecting a selecting pattern, the menu is removed from the screen so that to permit the access to the whole image/screen for the pasting action. Note that, (e.g. after providing a press-and-holding action) the different directions of the gliding actions corresponding to different mouse function may be those described before in related/previous patent applications filed by this inventor (e.g. gliding towards lower-right direction may correspond to selects all/select the whole picture, towards lower-left may correspond to paste function. Gliding towards upper-left direction may correspond to cut function. Gliding upper-right direction may correspond to copy function, etc.

It must be noted that the functions, interactions, procedures, methods. etc., relating to editing a picture as described throughout this and the related patent applications filed by this inventor may not be restricted to editing a picture. The may be used to provide functions in any other application.

The keyboard used with the picture editing applications/concepts/functions/etc., as described in this and the related patent applications filed by this inventor may be of any type. As an example, said keyboard may be a keypad of the invention having any number of (e.g. letter) keys (e.g. two to eight) wherein at least some (e.g. one) of the keys corresponds to several characters/letters, and use a word prediction software to predict words from a corresponding database. According to one method, the letter keys of such keyboard may be related to all of the letters of a language excluding a/the predefined zone corresponding to non-preferred characters. According to another method, such keyboard may include one or more predefined zones corresponding to non-preferred character. Preferably, the letter keys may be split into two or more groups wherein each group is located on a different side/edge of the (e.g. screen of) the corresponding device, and wherein such a/the zone may be located between said split groups. According to another example such keyboard may be a QWERTY keyboard. According to another example, such keyboard may be a keyboard wherein each of its letter keys corresponds to a precise letter/character/symbol and wherein its keys may be (preferably) arranged on the sides of the screen of the corresponding device.

When a (e.g. an edited) picture is shared with another party, preferably at the similar time the receiving party may receive a means such as for example a link/button preferably next/on the picture such that interacting with said means may permit the user to type on the edited picture preferably instantly and may share it (e.g. back) with the sender and/or others. If the corresponding data entry/input system is not installed in the receiving party device, said system may automatically downloaded (e.g. and installed) into the receiving party's device.

A spelling help feature/method used by the system has been described before in detail. According to one embodiment of the invention, the system may be designed such that a user may enable/disable (e.g. switch on/off) said spelling help feature/method. According to one method, said method/features may be enabled or disabled from a settings menu corresponding to the system. According to one method, when activated, said spelling help method, may be applied from the first character of a word being entered. According to one embodiment of the invention (e.g. when the spelling help is enabled), (e.g. during the entry of a text) preferably, said spelling help may be applied to a word being entered only if the user provides at least a predefined number of (e.g. at least two) key presses (e.g. herein said predefined number may be referred to as “required minimum key presses”) from the (e.g. four) letter keys (e.g. from the narrowly ambiguous keys, and/or from the precise letter mode keypad). As an example, by considering the keypad of FIG. 436B, if said required key presses number is two and the user provides four consecutive tapping actions on the zone 436107 between the keys (e.g. broadly ambiguous zone), the system does not use the spelling help mode even if it is activated (e.g. from the settings), to for example provide the word “much”. In this example, the system relates said tapping actions to the non-preferred characters assigned to said zone and does not relate any of said tapping actions provided on the said zone to any of the preferred characters (e.g. which are assigned to the (e.g. four) ambiguous letter keys). Accordingly, according to one example, if the user taps on the key 436101, taps two times on the zone 436107, and taps on the keys 436101, the system may ambiguously relate each of the two tapping actions on the zone 436107 to any of all of the characters assigned to said zone (e.g. non-preferred characters) and to the characters assigned to the four letter keys (e.g. preferred characters) (This matter has been described before in detail) and proposes some words including the word that has the highest priority among the corresponding words. It must be noted that the system may also include a word completion means/software such that to, accordingly, propose completed words based on receiving partial input information corresponding to a (e.g. beginning) portion of a word being entered.

According to one embodiment of the invention, if the device/screen is in portrait mode, the word list may preferably be shown vertically and if the device/screen is in landscape mode, the word list may preferably be shown horizontally (e.g. as shown before).

According to one embodiment of the invention, if a word being entered is entered through interacting with the keypad of the system in precise mode, then preferably said word may simultaneously be entered in the text and in the word list (e.g. as the current predicted word). If a word being entered is entered through interacting with the keypad of the system in predictive mode, then preferably said word may be entered in the word list alone (e.g. as the current predicted word).

Methods of swapping words (e.g. in a word list) have been described before. According to one embodiment, if in the word list, in addition to the current predicted word, one or more candidates are also proposed, then a predefined swapping action for example by means of a gliding action simulating another gliding action provided from the current predicted word towards a candidate (e.g. or vice versa), wherein said gliding action is provided on the word list or in the zone between the keys, may replace the current predicted word by the first candidate word next to the current predicted word. Accordingly, an additional such gliding action may replace the current predicted word by another candidate preferably the second word next to the current predicted word, and so on. Note that, one or more such candidates may be shown on each side of the current predicted word. As such one or more gliding actions provided in a similar direction corresponding to each of the sides of the current predicted word may preferably correspond to the first, second, or other corresponding candidates on a corresponding side of the current predicted word.

With continuous description of the current embodiment, after providing a swapping action, preferably when the user appends a letter/character to or deletes a letter/character from the swapped word, the system may preferably consider the characters of the swapped portion as being precise characters (e.g. herein may be referred to as fixing a word/stem). According to one method, if the user desires to fix the current predicted word, he/she may provide a back and forth gliding action in a predefined direction such as upwards or downwards in preferably the/a predefined zone and/or on the wordlist. Now, a swapping action was applied on the current predicted word, when appending characters to said word or deleting characters from said word, the swapped portion of the new word may be considered as fixed (e.g. precise)

According to one embodiment of the invention, the system may use one or more database of words including 1 to N (e.g. 5) gram entries. When the user enters the input information corresponding to a current predicted word, the system may preferably consider N−1 words prior to the word being entered (e.g. prior to the cursor) in the text (e.g. herein may be referred to “prefixed portion”) and combine it with the input information corresponding to the current word being entered (e.g. herein may be referred to combined word information” to predict one or more words from the N gram database. Subsequently, then the system may consider N−2 words prior to the word being entered (prior to the cursor) combined said input information being entered to predict one or more words from N−1 gram database. And so on until (including) N=0 (e.g. until proposing 1-gram words). If the words preceding the current predicted word being entered are n number of words wherein n<N−1, then the system considers said n words combined with the input information corresponding to the current predicted word and begins to search in the entries of n+1 gram database then, then n, then n−1 until the 1 gram database. It must be noted, that after searching for the corresponding words, the corresponding words may be presented to the user (e.g. according to their priorities) until the user selects one of them. Note that in the search procedure as described, if a combined word information matches an entry in the database, then preferably, the system selects the last gram of said entry and proposes it to the user.

In most cases, a 2 gram word database may provide enough information to the word predictive system to accurately predict a word. But in some cases, in an N gram entry, the first beginning gram of the entry may not provide enough information to the system if it if constituted of one of a number of words such as “the”, “a”, “of”, “to”, etc. (e.g. herein may be referred to as non-informing words). In this case, an N gram database wherein N>1, may preferably mainly include entries that their first gram exclude a non-informing word. This may permit to have a reduced sized N-gram database (e.g. that also includes 1-gram entries) for an accurate prediction.

The arrangement of an N gram database to be used by a/the word prediction system for accurate and fast prediction have been described in detail in previous patent application filed by this inventor. They may preferably be included in/with this application by reference. As an example, the first gram of gram N gram entries (e.g. N=>0) may preferably include or be constituted of one or more special characters. In this case, for example, a dot character as the first gram of an N-gram entry (e.g. wherein N=2) may provide information to the system that the second word of the entry is a word that is generally entered at the beginning a sentence.

According to one method, different identified character/word (e.g. ‘˜’) or a predefined code may be assigned to different categories of entries in a database. For example, in an N-gram (e.g. 2-gram) database, a first type of character (e.g. “˜”) delimiting grams from each other, wherein the last gram letters are lowercased letters may be used. In a same database, a second type of character (e.g. “′”) delimiting grams from each other, wherein the at least one of the last gram letters is an uppercased letter, may be used. According to another example, a third type of character (e.g. “|”) delimiting grams from each other, wherein at least one of the characters of the last gram includes a character other than a letter, may be used. And so on. When the user enters a word having a characteristic such as those just described, the system may be designed such that the system searches for the corresponding word/entries within the database having at least one of said characteristics. This method permits a quicker search in the database.

According to a first method of search, when the system is looking for a word based on the input information provided by the user, the system first look in the corresponding N-gram (e.g. 2-gram) entries of the database wherein the input information provided by the user corresponds to all of the characters of the corresponding (e.g. last) gram. If there is no corresponding word found, the system may then proceed to the 1-gram entries wherein the input information provided by the user corresponds to all of the characters of the corresponding gram.

If there is no corresponding word found, the system then looks in the corresponding N-gram (e.g. 2-gram) entries of the database wherein the input information provided by the user corresponds to the beginning characters of the corresponding (e.g. last) gram. If there is no corresponding word found, the system may then proceed to the 1-gram entries wherein the input information provided by the user corresponds to the beginning characters of the corresponding gram.

According to a second method of search, when the system is looking for a word based on the input information provided by the user, the system first look in the corresponding N-gram (e.g. 2-gram) entries of the database wherein the input information provided by the user corresponds to all of the characters of the corresponding (e.g. last) gram. If there is no corresponding word found, the system then looks in the corresponding N-gram (e.g. 2-gram) entries of the database wherein the input information provided by the user corresponds to the beginning characters of the corresponding (e.g. last) gram.

If there is no corresponding word found, the system may then proceed to the 1-gram entries wherein the input information provided by the user corresponds to all of the characters of the corresponding gram. If there is no corresponding word found, the system may then proceed to the 1-gram entries wherein the input information provided by the user corresponds to the beginning characters of the corresponding gram.

According to one embodiment of the invention, the user may type a word or grab/select a word within a text and then he/she may be enabled to delete said word from the dictionary/word-database used by the system. According to one method, the user may long-press on said word (e.g. which is preferably in a word list) to delete it. After providing the long pressing action on the word, the user may be informed of the deletion of said word by, for example, changing the color of the word or the words background to, for example, red. Note that, before deleting a word, the system may ask the user to confirm the deletion action. A words/entry deleted from the/a database may be saved along with its frequency of use such that if the user decides to re-insert it in the database, the system may insert its corresponding frequency. According to one method, deleting a word from the dictionary may cause deleting it from all of the entries of an N-gram database. According to another method, said word may be deleted from the 1-gram database only.

As mentioned before, the keyboard used with the picture editing software/feature may be of any type such as for example a QWERTY keyboard. According to one embodiment of the invention, a gliding action or a long-pressing action provided from/on said keyboard may be related by the system to the trajectory of the text being entered over a/the image which preferably is printed on the screen wherein preferably a portion of it is located under said keyboard.

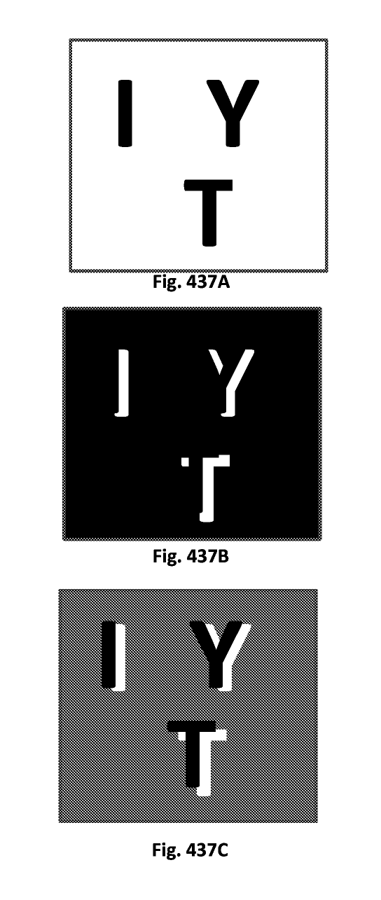

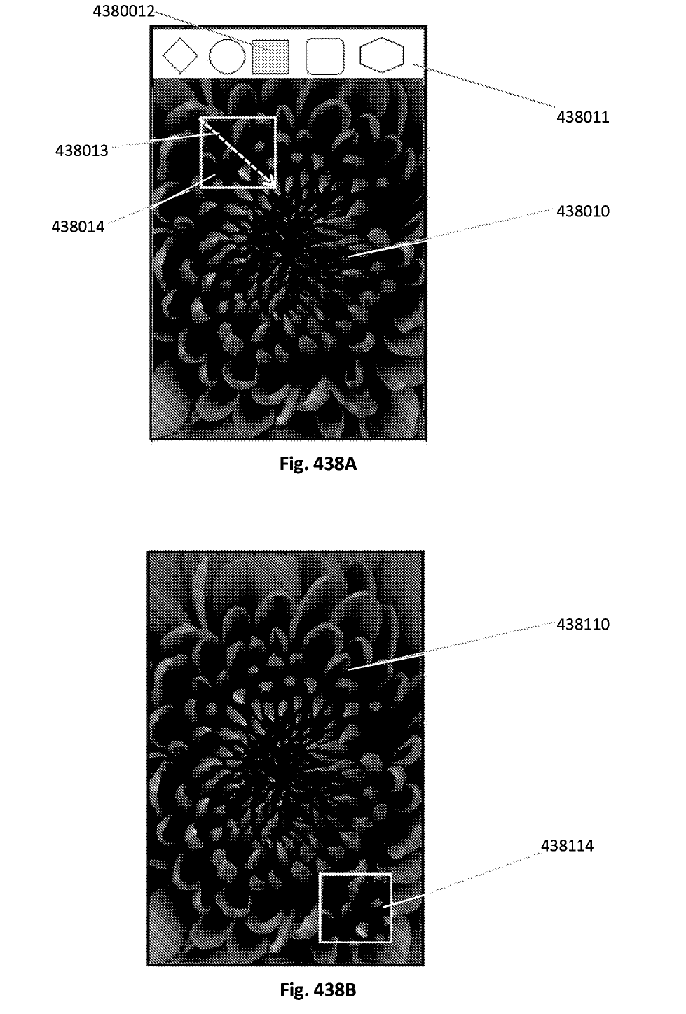

According to one embodiment of the invention, the keys of the keypad/keyboard (e.g. preferably in the ambiguous mode) of the invention used with a/the picture editing software/feature may be transparent/invisible so that to permit to see the content (e.g. a portion of a/the image) under said keypad/keyboard. As such, according to one embodiment, only a/the frame of a key may be shown on the screen. In the visible mode, in addition to the frame, the characters/letters assigned to a key may be printed within said frame but preferably, the rest of the key may be transparent/invisible. According to one aspect, the letters on such a key may be printed in two contrasted colors (e.g. white and black) such that regardless of the color of the content under a/the key, at any moment said characters/letters may be visible to the user. An example of a key of such keyboard/keypad is shown on different background colors (e.g. white, black, and red) in FIGS. 437A to 437C.

It must be noted that in different paragraphs in this application, a gliding action has been described to combine a long pressing action. It must be noted that the long pressing action can be provided at any moment such as at the beginning, in the middle, or at the end of during said gliding action.

It must be noted that throughout this application, the terms such as “interacting with the first keypad in the precise mode” or interacting with the first keypad to enter a precise character”, etc., may have been used. It must be noted that such terms are used for entering precise characters using the first keypad of the invention in its corresponding precise mode. In said corresponding precise mode, each of the keys of the keypad may be replaced by a another keypad/having different appearance. Optionally, the second keypad may have the same appearance as the first keypad, which in this application is referred to as the ‘second keypad”. According to one method, a key of a first keypad in the Precise Mode may be divided into a plurality of zone/keys each corresponding to an identified character. In the Precise Mode the plurality of divided zones/keys of the first keypad may be considered to form a corresponding second keypad. Therefore, tapping on a zone of the first keypad may be considered as tapping on the corresponding key of the corresponding second keypad.

It must be noted that in some embodiments the term “special characters” may be considered to refer to special characters and/or functions.

The keys of the first keypad such as the split keypad of the of system may be located on a single surface or they may be distributed on more than one separate surfaces.

A keypad of the invention may be positioned on a pop-up surface (or programmatic pop-up graphic and input mechanism) on the screen of a device. Accordingly, each of the portions of a split keypad may be positioned on a different pop-up. Said pop-up surfaces (or programmatic pop-up graphic and input mechanisms) may preferably have substantially the size of the keypad or its portions, respectively.

In the embodiments and examples described throughout this application, a first group of symbols (e.g. letters) to a key of the first keypad has been described to be selected by a first predefined type of interaction with a key (e.g. taping, double-taping, gliding on or from said key (if on screen key), press and holding, taping on said key and touching a zone of the screen outside said key, etc.) of the first keypad. Then, said selected symbols had been assigned to the keys of a second keypad of the invention. One of said symbols could be entered by a predefined interaction with (the appropriate key of) the second keypad. The same procedure was described for a second group of symbols (e.g. special characters such as digits 0-9) assigned to said key of the first keypad, wherein said second group of symbols could be selected by a second predefined type of interaction with a key of the first keypad, and one of said symbols could be entered as described foe the entry of the symbol of the first group as just described. Clearly, the examples of the embodiments have been provided to describe the procedure of the entry of a symbol through the data entry systems of the invention. It is understood that the order of the assignment of said groups of symbols to the key of the first keypad may be reversed (e.g. the digits group being selected by said first type of interaction, said letters group being selected by said second type of interaction) by people skilled in the art. Note that in all of the embodiments, the type of interaction described is exemplary and may be replaced by any other type of interaction such as those described known by people skilled in the art. For example, a press-and-holding action on a first key for at least a predefined of time to enter said key into a mode instance may be replaced an interaction such as pressing a second key and simultaneously interacting with said first key.

Additionally, many types of interactions with a key (of the first keypad) for assigning a different group of characters to each of them may be considered by people skilled in the art. For example, each of, touching a key and preferably touching another key, touching a key and touching a different predefined location on the screen, touching a key and touching any location on the screen, etc, may be considered as a different type of interaction with said key.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature. It must be noted, that any of the systems, features, means, methods, etc., described in this patent application may be used separately or being combined with systems, features, means, methods, etc., of other different embodiments of the invention.

It must be noted that the number of keys, configuration of letters on said keys, key arrangements, type of keys, etc., are being described as examples. They can be designed differently by people skilled in the art by considering the principles of the invention. It must also be noted that a touch sensitive surface may be touchpad, a touch screen, etc.

It must be noted that although during this application there has been described that a user may touch/press on a key such as the center key of a keypad to provide a gliding action, as described in detail before, if the second keypad of the invention is a dynamic keypad, then the user may touch anywhere on the screen/surface or anywhere on a dedicated zone on the screen/surface (e.g. such as the zone not including one or more keys of the first keypad as described in some embodiments), and that touching point may predefined to correspond to the center of said keypad which, preferably, may dynamically form under the touching point or on another location on the screen. The user then may provide the desired corresponding gliding action.

It must be noted that although in some embodiments through this application for describing the principle of the data entry system of the invention, a touch screen has been used as an example, obviously, any type of touch sensitive surface, any other type of surface, any number of said surfaces on which to which at least a portion on the input interface (e.g. the input keys/zones used by the system) may be considered for the same purpose.

Optionally all of the input interactions described throughout this patent application may be provided in the air. To intercept such interactions different types of detecting means such as camera(s), accelerometer(s), etc., may be user. According to one embodiment, as an example, a first predefined type of gesture(s) using a first predefined number if fingers (e.g. one finger) provided in the air may correspond to a plurality of first input signal, and a second type of predefined gesture(s) using a second number of fingers (e.g. more than one finger) provided in the air may correspond to a plurality of second input signal. As an example, the plurality of the first predefined gestures may be used for entering ambiguous input information corresponding to a word, and the plurality of the second predefined gesture may be used for entering precise/identified characters. This type of interaction may be used with the word predictive data entry system of the invention such as for example, the general data entry of the vertical (e.g. GPG, content search (e.g. relating to TV)) such as those described throughout this application.

It must be noted that the data entry system preferably in some cases uses more than one interaction with a key and/or zone simultaneously by for example press/glide and holding on/from a first key and pressing/gliding on/from another key/zone. Obviously, if the user desires to use one hand only with the system, then according to one method, the user may first press/glide on/from said first key and remove his finger. Then he may provide said pressing/gliding on/from said another key/zone.

It is noted that, although according the preferred principle/embodiment of the invention a full set of the letters of a language are distributively assigned to few (e.g. four) keys of a first keypad and another same full set of the letters of the same language are distributively assigned to few keys of a second keypad (e.g. to eight keys of a telephone-type) such that any key of said letter keys of said first keypad and any key of said letter keys of said second keypad have at most one common letter, however, minor modifications/variations may be considered/provided to this principle by people skilled in the art. For example, one (or more) of the (e.g. ambiguous) keys of the first keypad and one (e.g. ambiguous) key of the second keypad (e.g. as just mentioned above) (for some reason) may have more than one common character (although this may augment the ambiguity and slow down the recognition capacity of the system requiring more user's input information).

The input system of the embodiments of the present invention may be used with substantially any electronic and/or computerized device, such as cellular phones, GPS devices, remote controls, handheld devices, television settop boxes and music players. This input system is particularly useful for small sized and/or portable devices on which it is inconvenient to place an entire keyboard. In addition, these input devices may be used on appliances not primarily intended for data input, such as washing machines, refrigerators and the like, which conventionally do not include large keyboards.

It is noted in many paragraphs a first and a second keypad have been named to be used with the data entry system of the invention, obviously. The system may instead use a first and a second group of (different) input signals for the same purpose. Said input signals may be provided by any other input means.

It must be noted that although in this patent application “key” and “(predefined) type of interaction with key” has been used to demonstrate different embodiments and methods as described, obviously, any (predefined) input means (e.g. providing a first and a second group of input signals) and any (predefined) type of interaction provided through said input means to provide a (predefined/different) input signal may be used for the same purpose. For example, instead of distributively assigning the set of letters of a language to the keys of a first keypad, said letters may be assigned to a first predefined type of interaction (e.g. single-pressing action on said keys) with each of said keys of said keypad. Also, instead of distributively assigning another set of letters of said language to the keys of a second keypad, said letters may be assigned to a second predefined type of interaction (e.g. double-pressing action, pressing (e.g. and holding) a mode key and single-pressing, etc.) on/with each of said keys of said first keypad. Obviously, based on the principles of the data entry systems of the invention as described above, the distribution/assignment of the letters to said first and second type of interaction with said keys may be such that letters assigned to the first type of interaction with any on the keys of said keypad and letters assigned to the second type of interaction with said key of said keypad have at most one common character.

It must be noted that the features such as keypads, key arrangements, number of keys, assignment of a set of characters of a language to each of a first and second set of keys (e.g. or to each of a second and a second type of interactions with one set of keys), type of keys, type of interactions, etc., as described and shown in this patent application are shown as examples to describe different embodiments of the invention. Obviously, other type of such features can be considered by people skilled in the art.

It must be noted that the first and the second keypad of the invention can have any number of keys. For example, in some embodiments, the second keypad is shown to be a telephone-type keypad having nine keys and in some other embodiments it is shown to have twelve keys.

It must be noted that in addition-to or in replacing-of the correction procedure of the invention, the system may include a method to propose to the user words other that the one predicted by the system. For example, if the predicted word is not the desired word, the user may provide a predefined interaction for example on the screen and the system may show a second keypad wherein its keys include the other words (e.g. having less frequently of use) that correspond to the input information provided until that moment by the user for entering a desired word. Then if the user's desired word is one of said proposed word, the user then may for example provide the corresponding gliding action for selecting/entering his desired word. If any of the words proposed by the system is not what the user desires to enter, then, preferably while holding his finger on the screen, the user may touch another location on the screen and the system shows another second keypad with additional corresponding words (e.g. having less frequently use). And so on.

It must be noted that the procedure of entering a symbol of a group of symbols through the second keypad of the invention wherein the number of symbols of said group of symbols are more than the keys of the second keypad by providing multiple touches to provide multiple second keypads of the invention until the second keypad includes the user's desired symbol as described may be used for any symbol. For example it may he used for entering any punctuation mark character even if the number of the characters of the group is more than the keys of the second keypad. By using such procedure the there is no limit to the number of symbols that a each group may include. The same method may also be used for providing words during the word completion procedure. For example after the used enters into the world completion procedure, if he touches the screen the system may show the second keypad of the invention including some of the words beginning with the user's key presses. As an example if the desired word is not on a key of the presented second keypad, then preferably while holding that finger in touching positing on the screen the user may touch with another finger a location on the screen and the system may open another second keypad with more words. The user may repeat this procedure if the system does not show his word on said another second keypad.

As mentioned, according to one method, in embodiments such as the media search and word completion, a gliding action in a direction may correspond to a list of words or elements. If the list of the words/items/stems in a gliding action direction is long, then according to one method, several gliding actions in said direction may be provided wherein each of said gliding actions may correspond/include some of said words/items/stems. The order of said words/items/stems may be based on a predefined principle such as frequency of use or alphabetical order.

According to one embodiment of the invention, one of the groups of symbols assigned to a predefined interaction with a key of the first keypad such as the backspace key may be called MENU to which menu functions such as User Guide, Language, Reset Settings, etc. may be assigned.

It is noted that the first and second groups of keys may include substantially any suitable number of keys which may be hard or soft keys or combinations of hard and soft keys. The keys may be organized in various configurations and the characters and symbols may be assigned to the keys in any suitable manner. The symbols of the system may be grouped in any number of symbol modes based of any (e.g. arbitrary) category. Optionally, the first group of keys has fewer keys than the second group, as mainly the first group of keys are intended to be used in entering text.

The term key is meant to include any device which identifies finger actuations including pressure sensors, thermal sensors, acceleration sensors, optical systems for tracking movements of the finger, finger caps and gloves with sensors. The sweeping gestures of embodiments of the invention including embodiments for dialing telephone numbers may be identified using various touch sensitive surfaces including internal or external touch screens and a mouse pad. Alternatively, sweeping gestures may be identified by an electronic stylus, acceleration sensors and/or other sensors for identifying user finger movements. The sensors may be mounted on a surface, on finger caps, on gloves and/or on any other suitable mount. The keys or touch screen may be included with processor in the same housing or may be included partially or entirely in a separate unit connected through wires or wirelessly (e.g., using Bluetooth or Wi-Fi) to the unit including processor.

According to one embodiment of the invention the sweeping gestures may be provided in the air and are detected by suitable sensors such as a camera and/or acceleration sensors.

In some embodiments of the invention, the data entry systems are adapted to provide synthesized voice feedback on the letters or symbols entered and/or the current symbol mode such that the user need not look at the screen while entering data.

While the above description relates to the Latin alphabet, the principles of the invention may be implemented on other alphabets.

The special characters on the second keypad may be assigned mainly to a same key so that the user may easily remember their location. If the second keypad is a standard telephone-type keypad said special characters may be assigned to the key to which the digit “1” is assigned.

The data entry device in accordance with any of the above described embodiments may be included in a mobile phone, a PDA, a computer or any other device.

According to one embodiment of the invention, after the user provides the input information (e.g. key presses) ambiguously corresponding to several words (e.g. of the dictionary of words of the system), the system may show a first selection of at least some of said corresponding words on the screen. According to one method, said first selection of words may be shown on a (e.g. an imaginary) second keypad (model) of the invention such as a three-by-three matrix keypad as described throughout this application wherein, preferably, a key of said second keypad has at most one word of said first selection of words. According to one method, the user may select one of said selected words by interacting with the corresponding key of the second keypad using a method of interaction such as one of the methods described throughout this application (e.g. tapping/gliding, etc.). If the number of the words corresponding to the input information is more than the number of keys of the second keypad and the user's word is not within the keys of the second keypad, then, the user may provide a predefined interaction, such as a long gliding action, etc., and the system may show a second selection of the said corresponding words on the keys of said second keypad, and so on.

According to another embodiment, after the system shows said first selection of at least some of said corresponding words on the (e.g. an imaginary) second keypad (model) of the invention as described above, the user may select one of said words that begins with the first letter of his desired word. If said word is the only word corresponding to the user's input information, or if the user provides an end-of-the-word signal such as a space character, then, the system may consider said word as the user's desired word and enters it. If said word is not the only word corresponding to the user's input information, then, the system selects all of the words corresponding to the user's combined input information (e.g. the words corresponding to said input information and beginning with said first letter) and shows them on the keys of the second keypad. At this time, the user may select one of said words presented on the second keypad if it is for example, his desired word. If his word is not on any of the keys of the second keypad and the system includes more words relating to said combined input information, then, the user may provide a predefined interaction such as a long gliding action, etc., and the system may show another selection of the words corresponding to the combined input information on the keys of said second keypad, and so on.

It must be noted, that a procedure such as a method of the data entry assigned to a first type of interactions with a key of the keypad of the system may be assigned to a second type of interaction with a key, and vise versus. For example, assignment of two different methods of entering a precise character within a word being entered, by relating said precise character to replacing an ambiguous character or inserting/adding it within the word being entered, to two different type of interaction with a letter key, may be reversed between said two types of interaction (e.g. the first type of interaction may be a gliding action provided on/from a letter key relating to a letter on said key, and the second type of interaction may be a tapping action on a letter/letter-zone on said key during the Precise Character Mode Instance.

It must be noted that the examples of interfaces such as a first and second keypads are used to describe the principles of the data entry system of the invention. It must be noted that other types of interface may be used for the same purpose, for example, when a user rejects a predicted word, instead of or in additions to the second (e.g. precise) keyboard (e.g. the plurality of second keypads of the invention), the system may have available or may enable/present another interface such as a microphone and a speech recognition system so that the user being able to enter for precise characters (e.g. for the correction purpose).

It must be noted that the term “combined predicted word” is used in some embodiment, generally refers to an N-gram Current word.

Note that, the term of “during the entry of a word” used throughout this application may preferably refer to a word (e.g. the current predicted word) being typed before an end-of-the-word signal such as a space character is entered at the end of the word.

It will be appreciated that the above described methods may be varied in many ways, including, changing the specific elements used and their layout. It should also be appreciated that the above described description of methods and apparatus are to be interpreted as including apparatus for carrying out the methods and methods of using the apparatus. The present invention has been described using non-limiting detailed descriptions of embodiments thereof that are provided by way of example and are not intended to limit the scope of the invention. Many specific implementation details may be used. The above embodiments may be implemented in hardware, software, firmware or combinations thereof.

It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims.

The titles used in this application and in the related applications may preferably not been considered as part of the specifications.

It must be noted that all of the interactions such as (key) pressing/tapping actions, gestures, movements, handwritings, drawings, etc., as described throughout this application may be provided in the air. A movement detecting means such as a camera, an accelerometer, etc., may be used to detect and/or perceive/capture those interactions.

Note that the titles in this application may preferably not be considered as part of the specifications.

It must be noted that in some embodiments specific types of interactions such as a first and/or second types of the interaction are being used to describe the embodiment. Obviously, instead of said specifically described interactions any type(s) of other interactions may be used for the same purpose in said some embodiments.

1. A data entry system, comprising:
a plurality of first input signals to which one to a few characters are assigned, and
an input signal, separate from said plurality of input signals, to which a significantly larger number of characters are ambiguously assigned; and
a word predictive system using a database of words;
wherein upon receiving a sequence of said input signals the system predicts one or more words from the database of words.

2. The system of claim 1, wherein each of said plurality of input signals ambiguously includes few characters.

3. The system of claim 1, wherein each of said input signals is provided by interacting with a separate key.

4. The system of the claim 1, wherein to each of said plurality of input signals up to three
characters are assigned.

5. The system of claim 1, wherein said plurality of input signals together represent a first group of letters of a language, and the separate input signal represents a group of letters that at least includes the remaining letters of the language.

6. The system of claim 1, wherein each of said plurality of input signals is provided by interacting with a separate key.

7. The system of claim 6, wherein said keys are divided into two groups.

8. The system of claim 6, wherein the separate input signal is provided by interacting with an additional key located between the two groups of keys.

9. The system of claim 6, wherein each of said separate keys represents one
character.

10. The system of claim 6, wherein each of said separate keys represents three characters.

11. The system of claim 6, wherein said separate keys are four keys.

12. The system of claim 6, wherein said keys are on-screen zones.
